SEQUENCE LISTING (45 sequences)

SEQ ID NO: 1 - DNA, 10 bp, Artificial Sequence
  Description of Artificial Sequence Synthetic oligonucleotide
cgttttactg

SEQ ID NO: 2 - DNA, 14 bp, Artificial Sequence
  Description of Artificial Sequence Synthetic oligonucleotide
atcggggggtacgc

SEQ ID NO: 3 - DNA, 16 bp, Artificial Sequence
  Description of Artificial Sequence Synthetic oligonucleotide
tcgacgactcaattac

SEQ ID NO: 4 - DNA, 40 bp, Artificial Sequence
  Description of Artificial Sequence Synthetic oligonucleotide
aggcggaggttgcagtgagccgagatcgcgccactgcact

SEQ ID NO: 5 - DNA, 31 bp, Artificial Sequence
  Description of Artificial Sequence Synthetic oligonucleotide
aggcggaggttgcagatcgcgccactgcact

SEQ ID NO: 6 - DNA, 35 bp, Artificial Sequence
  Description of Artificial Sequence Synthetic oligonucleotide
gaggttgcagtgagccgagatcgcgccactgcact

SEQ ID NO: 7 - DNA, 33 bp, Artificial Sequence
  Description of Artificial Sequence Synthetic oligonucleotide
aggcggaggttgcagagatcgcgccactgcact

SEQ ID NO: 8 - DNA, 37 bp, Artificial Sequence
  Description of Artificial Sequence Synthetic oligonucleotide
aggcggaggttgcagtgagagatcgcgccactgcact

SEQ ID NO: 9 - DNA, 31 bp, Artificial Sequence
  Description of Artificial Sequence Synthetic oligonucleotide
ttgcagtgagccgagatcgcgccactgcact

SEQ ID NO: 10 - DNA, 38 bp, Artificial Sequence
  Description of Artificial Sequence Synthetic oligonucleotide
aggcggaggttgcagtgagccgagatcgccactgcact

SEQ ID NO: 11 - DNA, 37 bp, Artificial Sequence
  Description of Artificial Sequence Synthetic oligonucleotide
aggcggaggttgcagtgagccgagatcgcactgcact

SEQ ID NO: 12 - DNA, 37 bp, Artificial Sequence
  Description of Artificial Sequence Synthetic oligonucleotide
aggcggaggttgcagtgagccgagatgccactgcact

SEQ ID NO: 13 - DNA, 36 bp, Artificial Sequence
  Description of Artificial Sequence Synthetic oligonucleotide
aggcggaggttgcagtgagccgagatccactgcact

SEQ ID NO: 14 - DNA, 33 bp, Artificial Sequence
  Description of Artificial Sequence Synthetic oligonucleotide
aggcggaggttgcagtgagccgagatctgcact

SEQ ID NO: 15 - DNA, 21 bp, Artificial Sequence
  Description of Artificial Sequence Synthetic oligonucleotide
gttgcagtgagccgagatcgc

SEQ ID NO: 16 - DNA, 21 bp, Artificial Sequence
  Description of Artificial Sequence Synthetic oligonucleotide
gttgcagagagcccanatgcc

SEQ ID NO: 17 - DNA, 21 bp, Artificial Sequence
  Description of Artificial Sequence Synthetic oligonucleotide
aggttgcagtgagccgagatc

SEQ ID NO: 18 - DNA, 21 bp, Artificial Sequence
  Description of Artificial Sequence Synthetic oligonucleotide
aggtttcaatgaaccgagatc

SEQ ID NO: 19 - DNA, 40 bp, Artificial Sequence
  Description of Artificial Sequence Synthetic oligonucleotide
ttttcttttctgtctttttttttttaacctttattgtagg

SEQ ID NO: 20 - DNA, 41 bp, Artificial Sequence
  Description of Artificial Sequence Synthetic oligonucleotide
ttttcttttctgtctttttcttttttaacctttattgtagg

SEQ ID NO: 21 - DNA, 35 bp, Artificial Sequence
  Description of Artificial Sequence Synthetic oligonucleotide
ttttcttttctgtcttttttaacctttattgtagg

SEQ ID NO: 22 - DNA, 36 bp, Artificial Sequence
  Description of Artificial Sequence Synthetic oligonucleotide
ttttcttttctgtctttttttaacctttattgtagg

SEQ ID NO: 23 - DNA, 37 bp, Artificial Sequence
  Description of Artificial Sequence Synthetic oligonucleotide
ttttcttttctgtcttttttttaacctttattgtagg

SEQ ID NO: 24 - DNA, 38 bp, Artificial Sequence
  Description of Artificial Sequence Synthetic oligonucleotide
ttttcttttctgtctttttttttaacctttattgtagg

SEQ ID NO: 25 - DNA, 40 bp, Artificial Sequence
  Description of Artificial Sequence Synthetic oligonucleotide
ttttcttttctgtctttttcttttttaacctttattgtag

SEQ ID NO: 26 - DNA, 34 bp, Artificial Sequence
  Description of Artificial Sequence Synthetic oligonucleotide
ttttcttttctgtctttttaacctttattgtagg

SEQ ID NO: 27 - DNA, 37 bp, Artificial Sequence
  Description of Artificial Sequence Synthetic oligonucleotide
ttttcttttctgtcttttttttttcctttattgtagg

SEQ ID NO: 28 - DNA, 31 bp, Artificial Sequence
  Description of Artificial Sequence Synthetic oligonucleotide
ttttcttttctgtctttttctttattgtagg

SEQ ID NO: 29 - DNA, 35 bp, Artificial Sequence
  Description of Artificial Sequence Synthetic oligonucleotide
ttttcttttctgtctttttttttttttattgtagg

SEQ ID NO: 30 - DNA, 29 bp, Artificial Sequence
  Description of Artificial Sequence Synthetic oligonucleotide
ttttcttttctgtctttttttattgtagg

SEQ ID NO: 31 - DNA, 28 bp, Artificial Sequence
  Description of Artificial Sequence Synthetic oligonucleotide
ttttcttttctgtcttttttattgtagg

SEQ ID NO: 32 - DNA, 27 bp, Artificial Sequence
  Description of Artificial Sequence Synthetic oligonucleotide
ttttcttttctgtctttttattgtagg

SEQ ID NO: 33 - DNA, 26 bp, Artificial Sequence
  Description of Artificial Sequence Synthetic oligonucleotide
ttttcttttctgtctttttttgtagg

SEQ ID NO: 34 - DNA, 25 bp, Artificial Sequence
  Description of Artificial Sequence Synthetic oligonucleotide
ttttcttttctgtcttttttgtagg

SEQ ID NO: 35 - DNA, 24 bp, Artificial Sequence
  Description of Artificial Sequence Synthetic oligonucleotide
ttttcttttctgtctttttgtagg

SEQ ID NO: 36 - DNA, 23 bp, Artificial Sequence
  Description of Artificial Sequence Synthetic oligonucleotide
ttttcttttctgtcttttttagg

SEQ ID NO: 37 - DNA, 27 bp, Artificial Sequence
  Description of Artificial Sequence Synthetic oligonucleotide
ttttcttttctgtcttttttttttagg

SEQ ID NO: 38 - DNA, 39 bp, Artificial Sequence
  Description of Artificial Sequence Synthetic oligonucleotide
ttttcttttctgtcttttttttttaacctttattgtagg

SEQ ID NO: 39 - DNA, 24 bp, Artificial Sequence
  Description of Artificial Sequence Synthetic oligonucleotide
ttttcttttctgtctttttttttt

SEQ ID NO: 40 - DNA, 19 bp, Artificial Sequence
  Description of Artificial Sequence Synthetic oligonucleotide
ttttcttttctgtcttttt

SEQ ID NO: 41 - DNA, 36 bp, Artificial Sequence
  Description of Artificial Sequence Synthetic oligonucleotide
ttttcttttctgtcttttttttttttaacctttatt

SEQ ID NO: 42 - DNA, 25 bp, Artificial Sequence
  Description of Artificial Sequence Synthetic oligonucleotide
tttctgtctttttttttttaacctt

SEQ ID NO: 43 - DNA, 25 bp, Artificial Sequence
  Description of Artificial Sequence Synthetic oligonucleotide
ttttgttttttttttttttaacctt

SEQ ID NO: 44 - DNA, 23 bp, Artificial Sequence
  Description of Artificial Sequence Synthetic oligonucleotide
ctgtctttttttttttaaccttt

SEQ ID NO: 45 - DNA, 24 bp, Artificial Sequence
  Description of Artificial Sequence Synthetic oligonucleotide
ctgtctttttcttttttaaccttt

(19) United States
(12) Patent Application Publication
(10) Pub. No.: US 2013/0173177 A1
(43) Pub. Date: Jul. 4, 2013

(54) NUCLEIC ACID SEQUENCE ANALYSIS

(71) Applicant: Linda L. Pelleymounter, Rochester, MN (US)

(72) Inventor: Linda L. Pelleymounter, Rochester, MN (US)

(73) Assignee: MAYO FOUNDATION FOR MEDICAL EDUCATION AND RESEARCH, Rochester, MN (US)

(21) Appl. No.: 13/818,593

(22) PCT Filed: Aug. 24, 2011
(86) PCT No.: PCT/US2011/048925

§ 371 Date: Mar. 6, 2013

Related U.S. Application Data
(60) Provisional application No. 61/376,641, filed on Aug. 24, 2010.

(51) Int. Cl. G06F 19/22

(52) U.S. Cl. CPC G06F 19/22
USPC 702/20

(57) ABSTRACT

This document provides materials and methods involved in nucleic acid sequence analysis. For example, methods and materials for distinguishing sequencing errors (e.g., sequencing and/or PCR artifacts) from true polymorphic sequence variations (e.g., single-nucleotide polymorphisms, sequence insertions, sequence deletions, or combinations thereof) are provided. In addition, methods and materials for determining homozygosity or heterozygosity are provided.

### CROSS-REFERENCE TO RELATED APPLICATIONS

This application claims priority to U.S. Provisional Application Ser. No. 61/376,641, filed on Aug. 24, 2010. The disclosure of the prior application is considered part of (and is incorporated by reference in) the disclosure of this application.

### STATEMENT AS TO FEDERALLY SPONSORED RESEARCH

This invention was made with government support under GM061388 awarded by the National Institute of Health. The government has certain rights in the invention.

### BACKGROUND

1. Technical Field

This document relates to materials and methods involved in nucleic acid sequence analysis. For example, this document relates to methods and materials for distinguishing sequence analysis errors (e.g., false sequence calls and/or missed true sequence calls) from true polymorphic sequence variations (e.g., single-nucleotide polymorphisms, sequence insertions, sequence deletions, or combinations thereof).

2. Background Information

Knowledge of DNA sequences has become indispensable for basic biological research, other research branches utilizing DNA sequencing, and in numerous applied fields such as diagnostic, biotechnology, forensic biology, and biological systematics. The advent of DNA sequencing has significantly accelerated biological research and discovery. For example, the discovery of disease related regions can aid in diagnosing and treating such diseases.

### SUMMARY

This document relates to materials and methods involved in nucleic acid sequence analysis. For example, this document relates to methods and materials for distinguishing sequence analysis errors (e.g., false sequence calls and/or missed true sequence calls) from true polymorphic sequence variations (e.g., single-nucleotide polymorphisms, sequence insertions, sequence deletions, or combinations thereof), present in a population. Such methods and materials can be used to provide highly accurate sequence information from large data sets that can provide insight into human evolution, aid in the discovery of disease related regions, and provide knowledge of currently unexplored areas of a genome.

In general, one aspect of this document features a method for assessing nucleic acid sequence information. The method comprises, or consists essentially of, (a) obtaining a collection of at least five sequence output data sets, wherein each of the sequence output data sets comprises a determined sequence that is assembled from a collection of sequence reads of a nucleic acid region and that is aligned to a reference sequence to identify a sequence difference between the determined sequence and the reference sequence, wherein at least one assembly or alignment parameter used to assemble or align the determined sequence is different for each of the sequence output data sets, and (b) determining whether the sequence difference is (i) a processing artifact or (ii) a true sequence difference present in the nucleic acid region as compared to the reference sequence based on a rule set established for the collection of at least five sequence output data sets. The nucleic acid region can be a region of a human chromosome. The collection of sequence reads can be a collection obtained using a second generation sequencing technique. The collection of sequence reads can comprise sequence reads ranging from about 25 to 250 nucleotides in length. The determined sequence for each of the sequence output data sets can be different. The collection of at least five sequence output data sets can be a collection of nine or more sequence output data sets. The at least one assembly or alignment parameter can be selected from the group consisting of a mutation percentage parameter, a coverage parameter, an alignment method parameter, and a matching base parameter. The determined sequence of at least one of the sequence output data sets can be assembled or aligned using a matching base parameter of between 40 and 60 percent. The determined sequence of at least one of the sequence output data sets can be assembled or aligned using a matching base parameter of greater than 90 percent. The determined sequence of at least one of the sequence output data sets can be assembled from a collection of forward paired end sequence reads. The determined sequence of at least one of the sequence output data sets can be assembled from a collection of forward paired end sequence reads and not reverse paired end sequence reads. The determined sequence of at least one of the sequence output data sets can be assembled from a collection of forward paired end sequence reads and reverse paired end sequence reads. The sequence difference can be a single nucleotide difference. The sequence difference can be a single nucleotide deletion. The sequence difference can be a multiple nucleotide deletion or insertion. The sequence difference can be a complex deletion.

In another aspect, this document features a method for assessing a mammal for homozygosity or heterozygosity. The method comprises, or consists essentially of, (a) obtaining a collection of at least five sequence output data sets, wherein each of the sequence output data sets comprises a determined sequence that is assembled from a collection of sequence reads of a nucleic acid region, wherein at least one assembly parameter used to assemble the determined sequence is different for each of the sequence output data sets, and (b) determining whether the mammal is homozygous or heterozygous for a sequence within the nucleic acid region based on a rule set established for the collection of at least five sequence output data sets.

In another aspect, this document features a method for assessing a mammal for homozygosity or heterozygosity. The method comprises, or consists essentially of, (a) obtaining a collection of at least five sequence output data sets, wherein each of the sequence output data sets comprises a determined sequence that is assembled from a collection of sequence reads of a nucleic acid region and that is aligned to a reference sequence of the nucleic acid region, wherein at least one assembly or alignment parameter used to assemble or align the determined sequence is different for each of the sequence output data sets, and (b) determining whether the mammal is homozygous or heterozygous for a sequence within the nucleic acid region based on a rule set established for the collection of at least five sequence output data sets.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flowchart of one example of experimental settings and column and population rules. Once the output for each experimental setting and paired end is finished, the called single-nucleotide polymorphisms (SNPs) and insertions-deletions (indels) can be separated into two bins. The indels can be separated further into insertions and deletions and can be subjected to manual inspection.

FIGS. 2A-E are graphs of experimental coverage by gene location. Coverage was averaged over all 96 samples for each experimental setting and paired end. The polymorphic sites found by this method for each experimental setting are plotted on the x-axis and the coverage on the y-axis. FIGS. 2A-E show the effects of “consolidation,” where the number of reads are reduced and the coverage is more uniform. The mean coverage was 52× and the mode was 56. Many polymorphic sites were detected with coverage below 20× read depth and most sites were detected below 56×. FIG. 2E represents experiment five, where the paired ends were run together and the raw read count was maintained. This resulted in much higher coverage. The extreme spikes are polymorphic sites within or adjacent to primers.

FIGS. 3A-B are graphs of the distribution of homopolymers. Homopolymers of significant length are difficult to align when the read length is short; therefore, the accurate detection of simple (multi) indels within these regions is not reliable. FIG. 3A shows the majority of single nucleotide runs were A's and T's and their locations within this region were found to be almost exclusively in introns in the 5′ part of the FKBP5 gene and from an internal intron, extending to the 3′-flanking region. Runs of G's and C's were shorter, with an average length of five bp, and found predominantly in the 5′-flanking region and 5′-untranslated regions. FIG. 3B shows the majority of homopolymers within this region were shorter than 11 bp. Because this method does not detect indels within homopolymers greater than 11 bp, the majority of indels should have been detected.

FIGS. 4A-E are graphs showing predominant patterns for a verified, “true” polymorphic site. FIG. 4A shows the first set was verified by Sanger over 519 sites. The predominant pattern was for all experiments to have successfully called a SNP at that locus; i.e., pattern “A.” All 519 sites were verified to be true and pattern “A”, indicative of adequate coverage. Unambiguous alignment occurred the most. FIG. 4B shows the second set was verified by Sanger over 84 sites on the same chromosome and same region. All 84 sites were verified to be true and pattern “A” occurred the most often. FIG. 3C shows the third set was verified by Sanger over 19 sites on chromosome 4. All 19 sites were verified to be true and again pattern “A” was seen the most often. FIG. 4 D shows the fourth set was verified by genotyping with either the Illumina or Affymetrix platforms on chromosome 6. All 25 sites were verified to be true and pattern “A” occurred the most often. FIG. 4E shows a table with the three most frequent patterns seen in “true” SNPs from the first set.

FIGS. 5A-D are graphs showing the average number of polymorphic sites detected for each experimental setting. FIG. 5C is representative of test set one, which consisted of 20 total alleles and 192 kb amplified on chromosome 6. FIG. 5D is representative of test set two which consisted of four pooled samples and a 5.5 kb region amplified on chromosome 4.

FIGS. 6A-F are diagrams of insertions and deletions of different samples. FIG. 6A shows NextGENe output of heterozygote deletion of TGAGCCGAG for sample NA17208. This was the largest complex indel. FIG. 6A includes SEQ ID NOs 4-8, 7, 7-8, 6, 6, 8, 7, 7, 5-6, 8, 8-9, 9, 5, 5, 5, 5, 5, 5, 10, 5, 11, 5, 5, 5, 10, 5, 5, 12, 8, 5, 5, 5, 5, 5, 5, 13, 9, 4-5, 4, 4-5, 5, 14 and 5, respectively, in order of appearance. FIG. 6B shows a Sanger chromatogram of the same deletion for sample NA17208. FIG. 6B includes SEQ ID NOs 15, 15-16, 15, 15-16 and 15, respectively, in order of appearance. FIG. 6C shows sample NA17204 did not show a deletion at this site as verified by Sanger chromatogram. FIG. 6C includes SEQ ID NOs 17, 17, 17-18, 17, 17, 17-18 and 17, respectively, in order of appearance. FIG. 6D shows NextGENe output of a heterozygote insertion of C in sample NA17204. FIG. 6D includes SEQ ID NOs 19-20, 19, 21-24, 24, 24, 23, 25, 22, 21, 26-29, 20, 30-33, 20, 20, 34-36, 20, 20, 20, 37, 20, 38, 20, 39, 19, 24, 38, 19-20, 38, 19-20, 19, 38, 40, 20, 20, 20, 20, 20 and 41, respectively, in order of appearance. FIG. 6E shows Sanger chromatogram of sample NA17204, verifying the heterozygosity. FIG. 6E includes SEQ ID NOs 42, 42 and 42-43, respectively, in order of appearance. FIG. 6F shows Sanger chromatogram of sample NA17230 homozygote for the insertion. FIG. 6F includes SEQ ID NOs 44, 44-45, 45, 44, 44-45, 45 and 44, respectively, in order of appearance.

FIGS. 7A-B are diagrams showing characteristics of the chromosomal region on 6p21.31. FIG. 7A shows repetitive elements within this region and GC content on chromosome 6. FIG. 7B shows the proximity to HLA loci.

FIG. 8 is a visual representation (e.g., a “Gap Map”) of the population reliability index. It shows coverage variability among samples. For each subject, variants detected within 200 bp surrounding a gap are shaded gray. With NGS, read coverage is gradual across areas and so genotypes adjacent to gaps should be interpreted with caution. Gray shaded with bold text cells are discordant genotypes for that individual between NGS and Illumina and/or Affymetrix.

FIGS. 9A and B contain exemplary column rules. A) Rows with patterns in the table are removed from the merged output files for each experiment per individual. Rows with “0” indicate patterns removed from the SNP bin. Rows with “X” refer to additional patterns removed from the indel bin. B) Three of the column rule patterns are found in the merged output files of two samples. Experiment 1 settings detected a variant at nucleotide position 4623 in sample 1. No other settings detected that variant. Experiment 4 settings and Experiment 1 settings for paired end 1 only detected a variant at position 5220 for sample 1. Experiment 4 settings detected a variant at position 4628 in sample 2. All these patterns were not found in true polymorphic sites. These variants are assumed false and consequently removed. This is the first step in removing false variant sites at the individual level.

FIG. 10 contains a schematic diagram illustrating FKBP5 genomic organization (NM_{—}004117.2) and the location of 3 of the 24 variants in linkage disequilibrium (r²=1).

FIG. 11. Effects of silent and 3′UTR SNPs on predicted mRNA secondary structures (A-H). (A) through (H) are the mRNA folding structures predicted by Mfold. (A) and (B) are the wild-type structure with snapshots of the Exon 10 (A) and 3′UTR (B) local stem-loop structures; ΔG=−995.33 kcal/mol. (C) and (D) are the Exon 10 variant (C) and 3′UTR wild-type (D) structures; ΔG=−986.64 kcal/mol. The (C) and (D) haplotype codes for the least stable structure. (E) and (F) are the Exon 10 wild-type (E) and 3′UTR variant (F) structures; A G=−995.22 kcal/mol. (G) and (H) are the Exon 10 variant (G) and 3′UTR variant (H) structures; A G=−991.97 kcal/mol. The boxes in the left-hand corners of (C), (E) and (G) are from SNPfold and represent the (C-D), (E-F), and (G-H) haplotypes. The x-axis is the nucleotide position of the mRNA, and the y-axis is the average change in partition function. This is determining the extent to which the wild-type and SNP matrices differ, as well as where the base-pairing probabilities are most different.

FIG. 12. The “silent” SNP affects base-pairing probabilities within TPR domains. SNPfold graph is a zoomed-in view of the “silent” SNP (solid bold vertical line) and its effects on the mRNA. Nucleotides 960-1059 of the mRNA correspond to TPR1 when translated (first shaded area). The second shaded area corresponds to TPR2 when translated. The third shaded area corresponds to TPR3 when translated. Note the absence of perturbations within TPR2 and areas preceding the TPR domain.

FIG. 13 contains Nassi-Shneiderman diagrams of an overall algorithm (A), column rules (B), and population rules (C), in accordance with some embodiments.

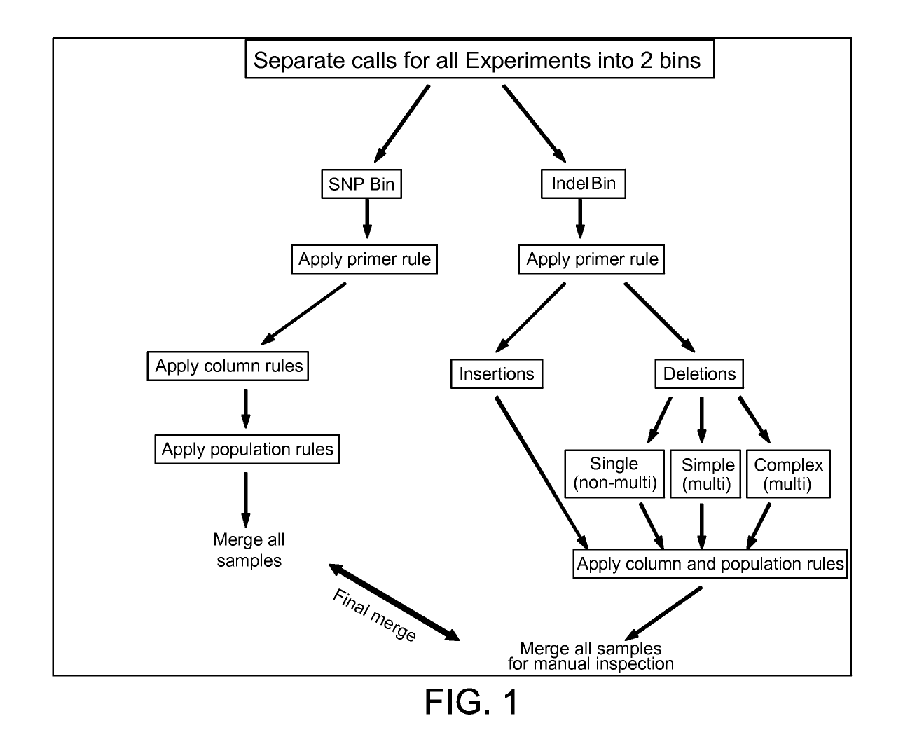

### DETAILED DESCRIPTION

This document provides materials and methods involved in nucleic acid sequence analysis. Any appropriate sample can be used to obtain a nucleic acid for nucleic acid analysis. For example, nucleic acids can be obtained from blood samples or tissue samples. In some cases, a blood sample, a cheek swab sample, or a hair sample can be used to obtain nucleic acid. Any type of nucleic acid can be used including, without limitation, genomic DNA, cDNA, or plasmid DNA. In some cases, genomic DNA obtained from a human can be used.

Once the nucleic acid sample is obtained, the nucleic acid can be amplified. For example, a portion of a chromosome, a portion of a gene of interest, or a non-coding region within a genome can be amplified. In some instances, introns, exons, 3′ untranslated regions, 5′ untranslated regions, and/or promoter regions can be amplified. Any appropriate method can be used to amplify a region of nucleic acid. For example, long-range PCR or short-range PCR can be used to amplify a region of nucleic acid. In some cases, nucleic acid can be sequenced without performing a nucleic acid amplification process.

Once the nucleic acid is obtained and/or amplified, it can be fragmented into smaller segments. Any appropriate method can be used to fragment nucleic acid. For example, adaptive focused acoustics (e.g., sonication), nebulization, and/or enzymatic digestion with, for example, DNAse I can be used to generate nucleic acid segments. In some cases, restriction enzymes (e.g., BglII, EcoRI, EcoRV, HindIll, etc.) can be used to fragment nucleic acid. In some cases, more than one reaction enzyme (e.g., a combination of two, three, four, five, or more restriction enzymes) can be used. The resulting fragmented nucleic acid can range in length from about 20 to about 1500 base pairs (e.g., about 50 to about 1200 base pairs, about 100 to about 1000 base pairs, about 150 to about 800 base pairs, about 150 to about 500 base pairs, or about 150 to about 300 base pairs). In some cases, the fragmented nucleic acid can be separated based on size. For example, fragments between about 100 and about 300 base pairs (e.g., about 200 base pairs) in length can be separated from larger and smaller fragments using standard fractionation techniques. In some cases, nucleic acid can be sequenced without performing a nucleic acid fragmentation process.

Once the nucleic acid is obtained, amplified, and/or fragmented, it can be sequenced using any appropriate sequencing techniques. For example, adaptors can be added to the nucleic acid which is then subjected to, for example, Illumina®-based sequencing techniques. Such adaptors can provide each fragment to which they are added with a known sequence designed to provide a binding site for a primer that is used during the sequencing process. Other examples of sequencing techniques that can be used include, without limitation, Sanger sequencing, Next Generation Sequencing (or second generation sequencing), high-throughput sequencing, ultrahigh-throughput sequencing, ultra-deep sequencing, massively parallel sequencing, 454-based sequencing (Roche), Genome Analyzer-based sequencing (Illumina/Solexa), and ABI-SOLiD-based sequencing (Applied Biosystems). In some cases, Illumina®-based sequencing techniques are used to sequence a large number of nucleic acid fragments that were generated from long range PCRs. In some cases, nucleic acid from different individuals (e.g., two, three, four, five, six, seven, eight, nine, ten, eleven, twelve, or more different humans) can be sequenced at the same time. In such cases, unique adaptors can be used for each individual such that each sequenced fragment can be assigned to the particular individual from which the fragment originated.

Once the nucleic acids are sequenced, the resulting sequence reads can be assembled and aligned to a reference sequence. Any appropriate sequence can be used as a reference. In some cases, a reference sequence can be obtained from the National Center for Biotechnology Information (e.g., GenBank). Any appropriate software program can be used to assemble and/or align sequences, including, for example, NextGENe® software. In some cases, alignment methods such as BLAT and/or BLAST can be used.

As described herein, the alignment and/or assembly can be performed with stringency and other settings or parameters, such that multiple outputs (e.g., four, five, six, seven, eight, nine, ten, eleven, twelve, 13, 14, 15, 20, 25, or more outputs) are generated. Each output can include a determined sequence that is based on a different set of alignment and/or assembly parameters. For example, a collection of five or more (e.g., six or more, seven or more, eight or more, nine or more, ten or more, eleven or more, twelve or more) output data sets can be obtained with each determined sequence being based on either a highly stringent, a moderately stringent, and a less than moderately stringent set of assembly/alignment parameters.

Each output can include one paired end (e.g., a forward paired end read or a reverse paired end read) in the absence of the other paired end or both paired ends assembled together. For example, a collection of seven output data sets can include (1) a first output data set of forward paired end sequence reads that were aligned and assembled using a first set of parameters, (2) a second output data set of the reverse paired end sequence reads that were aligned and assembled using the same first set of parameters, (3) a third output data set of forward paired end sequence reads that were aligned and assembled using a second set of parameters, (4) a fourth output data set of the reverse paired end sequence reads that were aligned and assembled using the same second set of parameters, (5) a fifth output data set of forward paired end sequence reads that were aligned and assembled using a third set of parameters, (6) a sixth output data set of the reverse paired end sequence reads that were aligned and assembled using the same third set of parameters, and (7) a seventh output data set of both forward and reverse paired end sequence reads that were aligned and assembled using a fourth set of parameters. Any combination of parameters can be used to generate additional output data sets, whether using forward sequence reads, reverse sequence reads, and both forward and reverse sequence reads. In some cases, the order for each output of an output data set can be maintained for each analyzed sample.

Once the output data sets are generated, comparison of each determined sequence to a reference sequence can be performed to identify any sequence differences. These sequence differences can be assessed across each output data set to determine whether the sequence difference is a true difference with respect to the reference sequence, or whether the sequence difference is a false difference (e.g., a false sequence call and/or a missed true sequence call). For each collection of output data sets, a rule set can be established using a known nucleic acid sample having various known sequence differences, e.g., SNPs and indels, as compared to a reference sequence. This established rule set can be used to assess additional sequences to distinguish true sequence difference (e.g., a SNP) from sequence analysis errors (e.g., false sequence calls and/or missed true sequence calls).

In some cases, patterns can be identified that correspond to true sequence differences (e.g., SNPs or indels) as opposed to sequence analysis errors (e.g., false sequence calls and/or missed true sequence calls). For example, when using a collection of nine output data sets, as disclosed herein, the presence of a single nucleotide difference in all output data sets can indicate that that single nucleotide difference is a true SNP. Likewise, the presence of a single nucleotide difference in the first eight outputs (paired ends run separately) and not the ninth output (paired ends run together) can indicate that that single nucleotide difference is a true SNP. In addition, the presence of a single nucleotide difference in only the ninth output, and not in the first eight outputs, can indicate that that single nucleotide difference is a true SNP. Other patterns can be found in Table 1. It is understood that other rule sets can be used for other different collections of output data sets.

TABLE 1
Patterns seen in verified control set.

| | | | | | | | | | | Number of |
|---|---|---|---|---|---|---|---|---|---|---|
| | | | | | | | | | | times seen |
| | | | | | | | | | | in this |
| | Exp1PE1 | Exp1PE2 | Exp2PE1 | Exp2PE2 | Exp3PE1 | Exp3PE2 | Exp4PE1 | Exp4PE2 | Exp5 | sample set |
| A | X | X | X | X | X | X | X | X | X | 391 |
| B | X | X | X | X | X | X | X | X | | 47 |
| C | | | | | | | | | X | 16 |
| D | X | | | | | | | | X | 9 |
| E | X | X | X | X | X | X | | X | X | 8 |
| F | X | | X | | X | | X | | X | 6 |
| G | X | X | X | X | X | | X | X | X | 6 |
| H | X | X | X | X | X | X | | | X | 6 |
| I | X | X | X | | X | | X | | X | 5 |
| J | X | | | | | | | | | 4 |
| K | X | X | X | X | X | X | | | | 3 |
| L | X | X | X | X | X | | | | X | 2 |
| M | X | | | | | | X | | X | 2 |
| N | X | X | | | | | | | X | 2 |
| O | X | X | | X | | X | | X | | 2 |
| P | | | X | X | X | X | X | X | X | 1 |
| Q | | X | X | X | X | X | X | X | X | 1 |
| R | X | | X | | X | | X | | | 1 |
| S | | | | | | | | X | | 1 |
| T | X | X | X | | | | X | | X | 1 |
| U | X | X | X | X | X | | X | | X | 1 |
| V | X | X | | | | | | | | 1 |
| W | X | X | X | X | X | X | | X | | 1 |
| X | X | X | X | X | X | X | X | | X | 1 |
| Y | X | X | X | X | X | | | | | 1 |

As shown in Table 1, pattern D is when experiment 1, paired end 1 called a variant, and experiment 5 called a variant. No other experimental settings called a variant. This pattern was seen for true variant sites nine times in our sample set.

In some cases, when analyzing deletions, the deletions can be grouped into (a) simple or single (non-multi), (b) simple (multi), and (c) complex deletions. A simple (multi) deletion is a deletion of more than one by of the same nucleotide. A single (non-multi) deletion is a deletion of one bp. A complex deletion is a deletion of more than one by of different nucleotides. For simple or single deletions, the collection of output data sets can be analyzed by percent nucleotide content. For complex deletions, the collection of output data sets can be analyzed by the entire sequenced unit.

Table 2 contains an example of a complex deletion. The deletion is 9 bp. The person is heterozygote for this TGAGCCGAG deletion. The percentages in Table 2 range from 41% for the last G to 60% for the “CCG”. Because of these frequency differences, complex deletions are analyzed as an entire unit. The TGAGCCGAG unit travels together in the experimental settings.

TABLE 2

| Reference | | | | | | | | |
|---|---|---|---|---|---|---|---|---|
| location | Reference | Coverage | A (%) | C (%) | G (%) | T (%) | Ins (%) | Del (%) |
| 66884 | T | 46 | 0 | 0 | 0 | 47.83 | 0 | 52.17 |
| 66885 | G | 46 | 0 | 0 | 47.83 | 0 | 0 | 52.17 |
| 66886 | A | 46 | 47.83 | 0 | 0 | 0 | 0 | 52.17 |
| 66887 | G | 46 | 0 | 0 | 47.83 | 0 | 0 | 52.17 |
| 66888 | C | 40 | 0 | 40 | 0 | 0 | 0 | 60 |
| 66889 | C | 40 | 0 | 40 | 0 | 0 | 0 | 60 |
| 66890 | G | 40 | 0 | 0 | 40 | 0 | 0 | 60 |
| 66891 | A | 57 | 57.89 | 0 | 0 | 0 | 0 | 42.11 |
| 66892 | G | 58 | 0 | 0 | 58.62 | 0 | 0 | 41.38 |

Any SNP, insertion, or deletion that does not meet a rule established for that collection of output data sets can be removed as a sequence or PCR artifact, thereby establishing the final sequence for the analyzed nucleic acid.

In some cases, the methods and materials provided herein can not only be used to differentiate true polymorphisms from artifacts, but also can be used to determine homozygosity and heterozygosity at any particular nucleotide position or positions.

In some cases, a reference sequence presented in GenBank® may represent only a haploid consensus sequence. If the reference shows a “G” at a chromosomal position, a mammal (e.g., a human) could carry the homozygote form and inherited G/G from mother/father, but that mammal may be heterozygote and carry G/A from mother/father. The father having the “A”. In this case, the millions of fragmented DNA reads would consist of both father's and mother's alleles. They would consist of G's and A's. If 50 reads aligned to the reference at that position, 25 would be G's and 25 would be A's. This does not happen very often due to the randomness of this process. The percentages can be different. For example, if 50 reads aligned, only 10 may be A's, and 40 may be G's. In such cases, these results still indicated that the mammal is a heterozygote at this position.

### EXAMPLES

### Human Samples

DNA samples from 96 Caucasian-Americans were obtained from the Coriell Cell Repository (Camden, N.J.), Human Variation Panel—Caucasian Panel of 100 (Internet site: “www” dot “coriell” dot “org” slash). In addition, ten tumor samples and four anonymized clinical samples were used. Written and informed consent was obtained from all subjects on their use.

### Public Data

The human reference genome was obtained from the National Center for Biotechnology Information, (Build 36 v3; NT_{—}007592.14; subsequence 26,398,617-26,558,272 and NT_{—}016354.19; subsequence 89,146,844-89,218,953). HapMap data for the Centre d'Etude du Polymorphisme Humain (Utah residents with ancestry from northern and western Europe) was downloaded from internet site “http” colon “hapmap” dot “org.” 1000 Genomes Project data was obtained from internet site (“http” colon slash slash “browser” dot “1000genomes” dot “org” slash) and the Single Nucleotide Polymorphism Database (dbSNP) Build 130.

### Short-Range Polymerase Chain Reaction (PCR)

Eleven amplicons, totaling 9.6 kb which targeted 1000 bp of the 5′FR, all exons, and 152 bp of the 3′UTR were produced. Each of the 11 reactions was performed in 20 μL containing 10˜15 ng genomic DNA, five pmol each of forward and reverse primers (Table 3) and FastStart Taq DNA polymerase (Roche). PCR cycling parameters included 95° C. for five minutes, 30 cycles at 95° C. for 30 seconds, 55˜59° C. for 30 seconds, 72° C. for 30˜120 seconds, and a final extension at 72° C. for seven minutes. PCR products were subsequently purified with ExoSAP-IT (USB corp). Amplicons were sequenced on both strands with an ABI 3730 DNA sequencer using ABI BigDye Terminator sequencing chemistry. Four additional regions, totaling 1.1 kb were amplified. All chromatograms were analyzed using Mutation Surveyor v 2.2 (SoftGenetics, LLC, State College, Pa.). The forward and reverse reads were manually inspected.

TABLE 3
Short-range PCR primers.

| | Forward or | | | |
|---|---|---|---|---|
| | Reverse | | | Length of |
| chromosomal locations | primer | Reaction(s) | Exons | amplicon |
| chr6: 35,805,383-35,805,359 | F | Reaction 1 | 5′FR and Exon 1 | 1272 bp |
| chr6: 35,804,133-35,804,112 | R | Reaction 2 | according to BC042605.1 | |
| chr6: 35,796,475-35,796,452 | F | Reaction 3 | Exon 2 according to | 567 bp |
| chr6: 35,795,932-35,795,909 | R | | BC042605.1 | |
| chr6: 35,765,693-35,765,672 | F | Reaction 4 | 5′FR and Exon 1 | 1922 bp |
| chr6: 35,763,793-35,763,772 | R | Reaction 5 | according to | |
| | | | NM_004117.2 | |
| chr6: 35,718,822-35,718,801 | F | Reaction 6 | Exon 2 | 650 bp |
| chr6: 35,718,194-35,718,173 | R | | | |
| chr6: 35,713,020-35,712,999 | F | Reaction 7 | Exon 3 | 515 bp |
| chr6: 35,712,527-35,712,506 | R | | | |
| chr6: 35,696,169-35,696,148 | F | Reaction 8 | Exon 4 and Exon 5 | 1393 bp |
| chr6: 35,694,799-35,694,777 | R | Reaction 9 | | |
| chr6: 35,673,252-35,673,231 | F | Reaction 10 | Exon 6 | 408 bp |
| chr6: 35,672,866-35,672,845 | R | | | |
| chr6: 35,667,120-35,667,098 | F | Reaction 11 | Exon 7 | 433 bp |
| chr6: 35,666,709-35,666,688 | R | | | |
| chr6: 35,663,019-35,662,996 | F | Reaction 12 | Exon 8 | 352 bp |
| chr6: 35,662,691-35,662,668 | R | | | |
| chr6: 35,656,081-35,656,062 | F | Reaction 13 | Exon 9 | 371 bp |
| chr6: 35,655,730-35,655,711 | R | | | |
| chr6: 35,653,195-35,653,174 | F | Reaction 14 | Exon 10 and Exon 11 and | 1758 bp |
| chr6: 35,651,459-35,651,438 | R | Reaction 15 | a small part of the 3′UTR | |

### Long-Range PCR

Long-range PCR (LR-PCR) was performed producing a total of 21 amplicons for each of the 96 Caucasian Coriell samples. The amplicons ranged in size from 3000 bp to 14,581 bp. The 21 LR-PCR reactions used 20-100 ng genomic DNA, 0.4 μM each forward and reverse primers (Table 4), in a total reaction volume of 20-50 μL. The 21 amplicons produced were quantified by the PicoGreen dye binding assay, combined in equimolar amounts and used to create libraries for Illumina GA. The genomic region on 6p was divided into two sections. The first section consisted of nine amplicons and the last section consisted of twelve. An overlap of 19,003 bp resulted from two of the amplicons. The overlap reactions were designated Rxn 20 and Rxn 21.

TABLE 4
Long-range PCR primers.

| | Forward or | | | |
|---|---|---|---|---|
| | Reverse | | | Length of |
| chromosomal locations | primer | Reaction(s) | Exons | amplicon |
| chr6: 35,805,383-35,805,359 | F | Reaction 16 | Exon 1 and Exon 2 | 9475 bp |
| chr6: 35,795,932-35,795,909 | R | | according to BC042605 | |
| chr6: 35,796,475-35,796,452 | F | Reaction 17 | Exon 2 according to | 9051 bp |
| chr6: 35,787,448-35,787,425 | R | | BC042605 | |
| chr6: 35,788,272-35,788,251 | F | Reaction | | 5704 bp |
| chr6: 35,782,590-35,782,569 | R | 18A | | |
| chr6: 35,782,869-35,782,848 | F | Reaction | | 3000 bp |
| chr6: 35,779,894-35,779,870 | R | 18G1 | | |
| chr6: 35,780,272-35,780,247 | F | Reaction | | 4049 bp |
| chr6: 35,776,250-35,776,224 | R | 18D | | |
| chr6: 35,776,775-35,776,750 | F | Reaction | | 4307 bp |
| chr6: 35,772,493-35,772,469 | R | 19A | | |
| chr6: 35,772,726-35,772,702 | F | Reaction | | 4537 bp |
| chr6: 35,768,214-35,768,190 | R | 19B | | |
| chr6: 35,768,636-35,768,612 | F | Reaction 20 | Exon 1 according to | 9471 bp |
| chr6: 35,759,190-35,759,166 | R | | NM_004117.2 | |
| chr6: 35,759,521-35,759,495 | F | Reaction 21 | | 9888 bp |
| chr6: 35,749,660-35,749,634 | R | | | |
| chr6: 35,749,955-35,749,931 | F | Reaction 22 | | 9852 bp |
| chr6: 35,740,128-35,740,104 | R | | | |
| chr6: 35,740,321-35,740,297 | F | Reaction 23 | | 9766 bp |
| chr6: 35,730,580-35,730,556 | R | | | |
| chr6: 35,730,985-35,730,961 | F | Reaction 24 | | 9040 bp |
| chr6: 35,721,970-35,721,946 | R | | | |
| chr6: 35,722,249-35,722,225 | F | Reaction 25 | Exon 2 and Exon 3 | 9888 bp |
| chr6: 35,712,386-35,712,362 | R | | | |
| chr6: 35,712,657-35,712,633 | F | Reaction 26 | | 9921 bp |
| chr6: 35,702,761-35,702,737 | R | | | |
| chr6: 35,702,956-35,702,932 | F | Reaction 27 | Exon 4 and Exon 5 | 9603 bp |
| chr6: 35,693,378-35,693,354 | R | | | |
| chr6: 35,693,669-35,693,645 | F | Reaction 28 | | 9677 bp |
| chr6: 35,684,017-35,683,993 | R | | | |
| chr6: 35,684,532-35,683,509 | F | Reaction 29 | Exon 6 | 11646 bp |
| chr6: 35,672,910-35,672,887 | R | | | |
| chr6: 35,673,252-35,673,231 | F | Reaction 30 | Exon 6 and Exon 7 and | 10585 bp |
| chr6: 35,662,691-35,662,668 | R | | Exon 8 | |
| chr6: 35,662,987-35,662,963 | F | Reaction 31 | Exon 8 and Exon 9 and | 14581 bp |
| chr6: 35,648,431-35,648,407 | R | | Exon 10 and Exon 11 | |

### Library Preparation and Sequencing

Paired-end indexed libraries were prepared following the manufacturer's protocol (Illumina). Briefly, 2-5 μg of genomic DNA in 100 μL TE buffer was fragmented using the Covaris E210 sonicator. Double-stranded DNA fragments with blunt or sticky ends were generated with a fragment size mode between 400-500 bp. The overhangs were converted to blunt ends using Klenow and T4 DNA polymerases, after which an “A” base was added to the 3′ ends of double-stranded DNA using Klenow exo− (3′ to 5′ exo minus). Paired-end index DNA adaptors (Illumina) with a single “T” base overhang at the 3′ end were then ligated and the resulting constructs were separated on a 2% agarose gel. DNA fragments of approximately 500 bp were excised from the gel and purified (Qiagen Gel Extraction Kits). The adaptor-modified DNA fragments were enriched by PCR. Indexes were added by 18 cycles of PCR using the Multiplexing Sample Prep Oligo kit (Illumina). The concentration and size distribution of the libraries was determined on an Agilent Bioanalyzer. Four indexed libraries per lane were mixed at equimolar concentrations. Clusters were generated at a concentration of 4.5 μM using the Illumina cluster station and Paired-end cluster kit version 2, following Illumina's protocol. This resulted in cluster densities of 130,000-160,000/tile. The flow cells were sequenced as 51×2 paired-end indexed reads on Illumina's GA and GAIIx using SBS sequencing kit version 3 and SCS version 2.0.1 data collection software. Base-calling was performed using Illumina's Pipeline version 1.0. Reads were converted to FASTA, aligned to the reference and analyzed using NextGENe software v1.04 and v1.10 (SoftGenetics, LLC, State College, Pa.).

### Statistics

An exact test was used to test Hardy-Weinberg equilibrium. Linkage disequilibrium was calculated as the D′ and r² measures. Tajima's D measures and π (average difference between nucleotide pairs) were estimated as described elsewhere (Tajima, Genetics, 123:585-595 (1989)). Agreement of next-generation sequencing and other genotyping techniques was calculated as the number of sites in agreement between the platforms over total number of sites considered. A confidence interval for this agreement measure was constructed using a sandwich estimator assuming compound symmetric covariance, clusters were individual samples.

### Automation

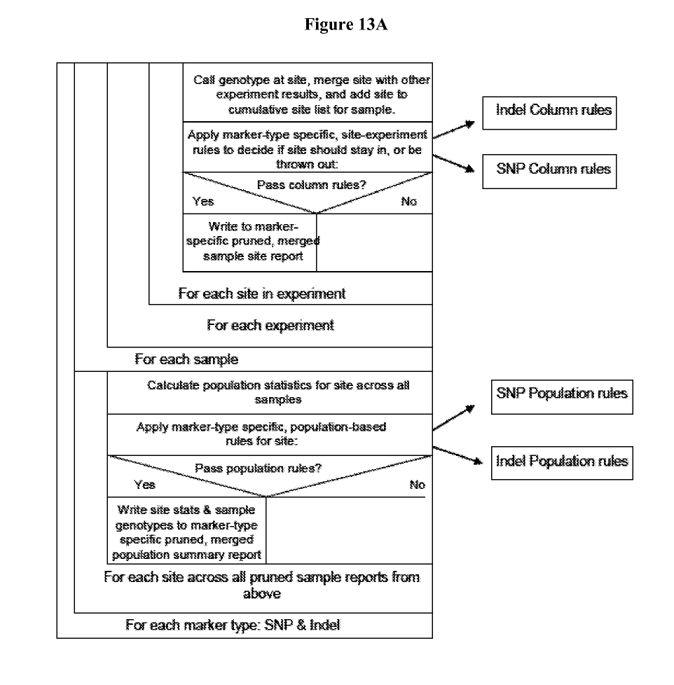

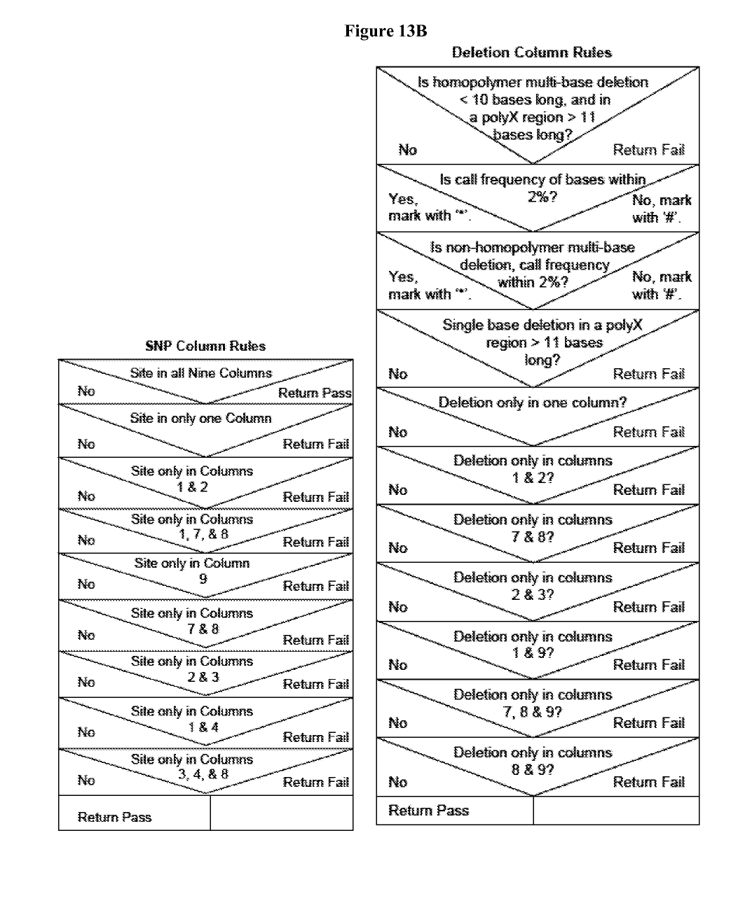

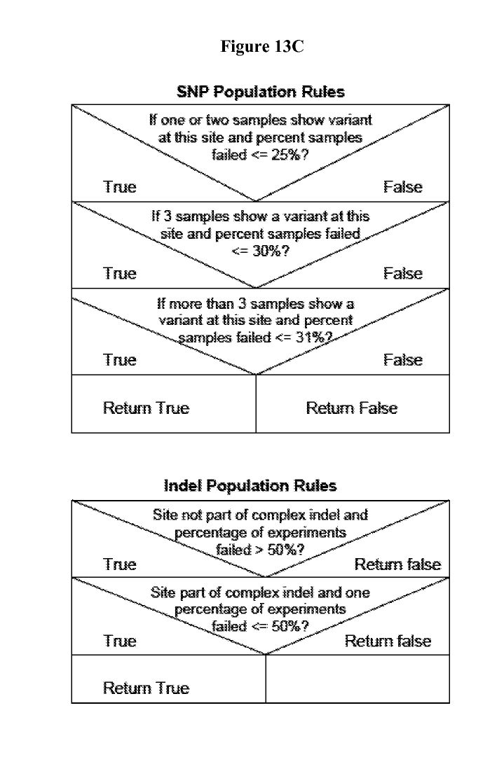

JAVA and Perl languages were used in a PolyX program. Excel (2007) VBA and VLOOKUP can also be used for merging the output spreadsheets. This is not in replacement of the automated program. A Perl program parsed the nine NextGENe reports produced by the five experiments for each sample, merged them, and applied “column-based” rules to filter out non-true polymorphic sites. A summary report of the polymorphisms that met the thresholds was produced for each sample. A Java program then collected all of the sample summary reports and applied “population-based” rules to further determine the true polymorphic sites across the population. Input into the rule-set for determining deletions included the so-called “poly-X” program; a Java program that interrogated the reference sequence identifying the length of homopolymers. A structured flowchart (Nassi-Schneiderman diagram) of the overall algorithm, and column and population rules are is set forth in FIGS. 13A-C. The “poly-X” and downstream filter programs required input files in FASTA and .csv, respectively.

### Experimental Logic

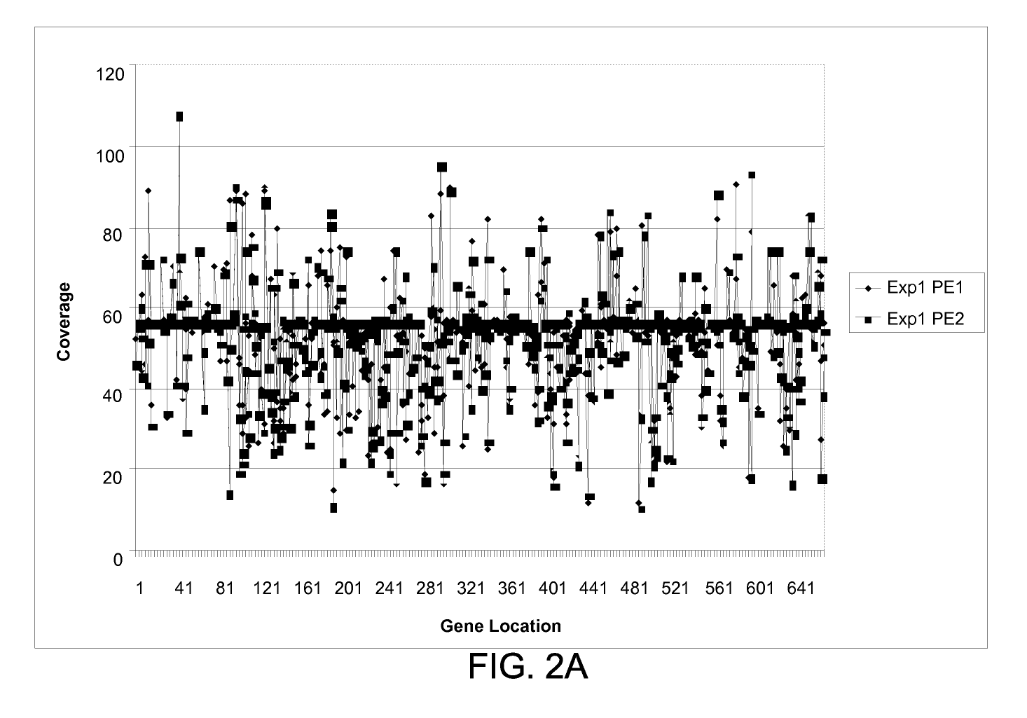

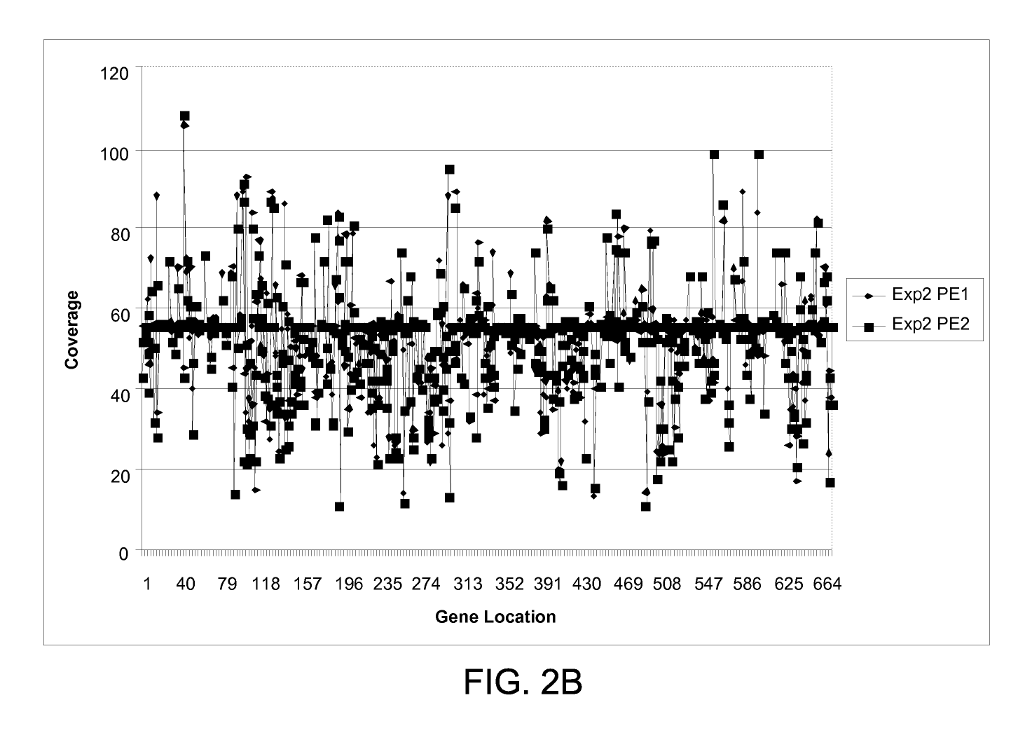

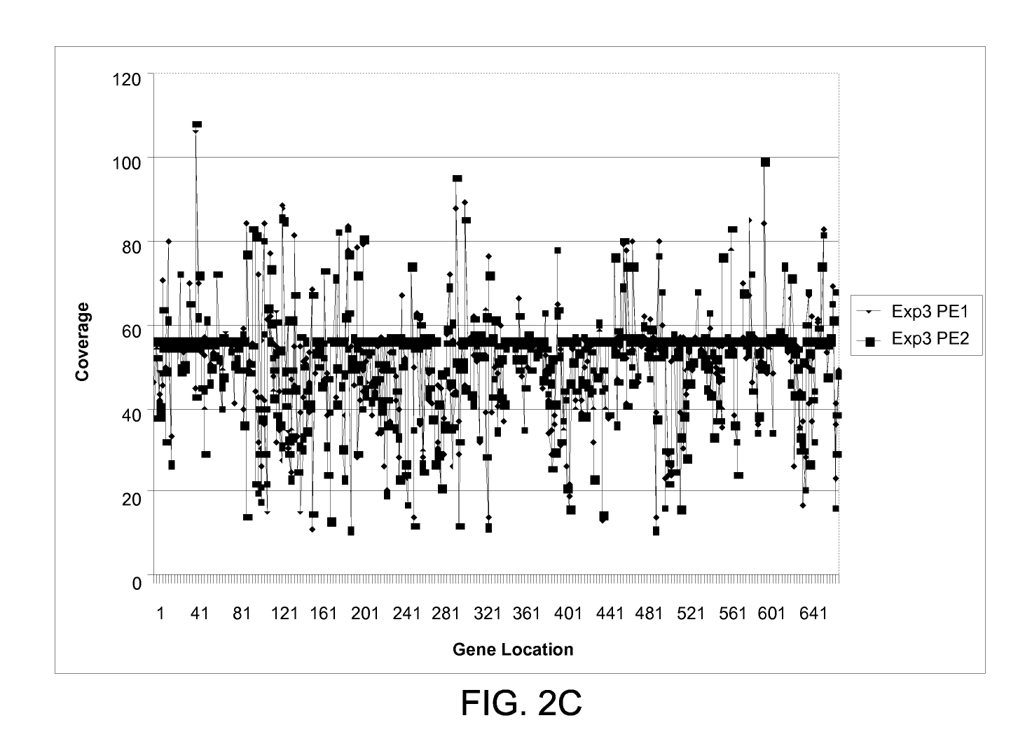

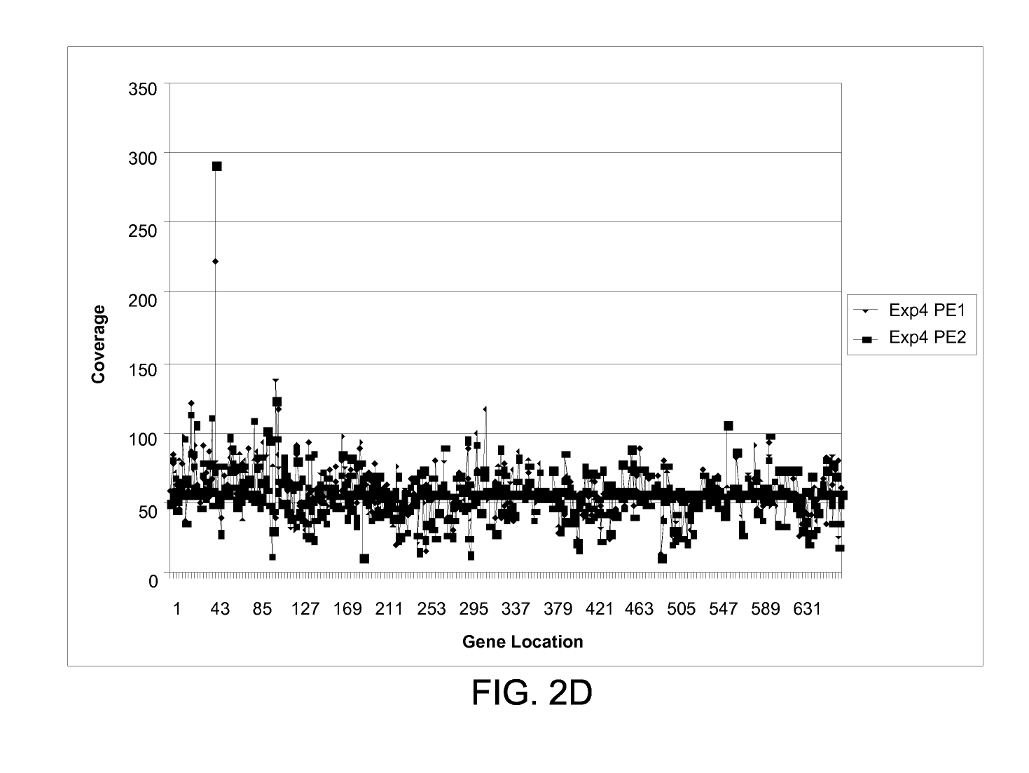

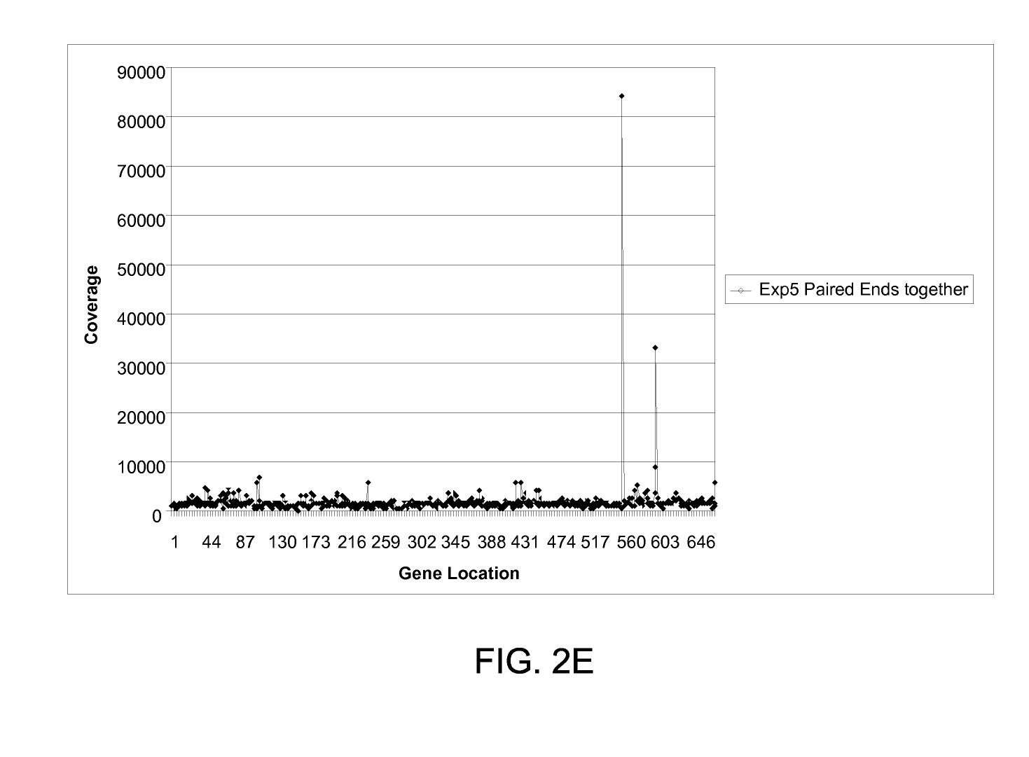

Five bioinformatic experiments were designed to manipulate two basic settings: reads chosen for alignment, and alignment strategies for chosen reads. All experiments used a median quality score threshold greater and equal to 20, and any reads containing more than three uncalled bases were removed. For the first four experiments, the paired ends were separated and run individually through one cycle of “consolidation.” Consolidation corrects errors in the original reads and elongates them. It also reduces the number of reads by eliminating redundancy. Consequently, the read count and coverage was lower. Although there was less coverage, when using consolidation, it was found to be more uniform across the entire region (FIGS. 2A-E). The starting read length of 49 bp increased on average to 66 bp and the percent alignable reads only decreased by 10%; from 94% to 84%. The original average raw read count ranged from the lowest of 1,417,962 (NA17222) to the highest 4,594,338 (NA17290) with an overall average across all 96 samples of 2,707,501. The correlation between read count and percent alignable reads was not as expected for these two individuals, as well as others. NA17222, with the lower read count, had 95% alignable reads before consolidation, and 91% after. NA17290, with the higher read count, had 95% alignable reads before consolidation and 74% after, thus intimating that although original read count is important and a certain minimum threshold is necessary, the quality of those reads, as well as the insert size (Harismendy and Frazer, BioTechniques, 46:229-231 (2009)), may be of equivalent importance. Once the reads were chosen and “corrected,” two alignment strategies which are intimately linked were altered, namely, what percent of variant reads need to be aligned in order to be called a mutation, and the minimum number of variants, or coverage at that location. One strategy determines how many departures from the reference are needed to be considered for the other one to take effect. Finally, the alignment method and the matching base percentage, determining how many bases in the read need to be the same as the reference were altered. Experiments 1-3 used a BLAST-Like Alignment Tool (BLAT) alignment method and experiment 4 used a Basic Local Alignment Search Tool (BLAST) method. The matching base percentage for experiments 1 and 2 was set low at 50% and high at 92% for experiments 3 and 4. Experiment 5 placed the paired ends together. Because of the higher number of reads, and much higher average coverage of 1590 (or 1590 read depth, i.e., the number of times a base within the reference in the region of interest was covered by a mapped read), the settings were adjusted accordingly, but the matching base percentage was maintained at 92%. For experiment 5, elongation instead of consolidation was used. Elongation maintains the raw read count, therefore keeping the integrity of putting the paired ends together. The percent alignable reads diminished on average from 68% to 44% after elongation.

The experimental settings are provided in Table 5.

TABLE 5
Table of experimental settings

| | Conden- | | | | |
|---|---|---|---|---|---|
| | sation Use | Alignment | | Align- | Matching |
| | Coverage to | Mutation | Cover- | ment | Base |
| | Set Index | Percentage | age | Method | Percentage |
| Paired Ends | | | | | |
| run separately | | | | | |
| Experiment 1 | no | 20 | 3 | 1 | 50 |
| Experiment 2 | 500 | 20 | 10 | 1 | 50 |
| Experiment 3 | 500 | 20 | 10 | 1 | 92 |
| Experiment 4 | 500 | 20 | 10 | 2 | 92 |
| Paired Ends | | | | | |
| run together | | | | | |
| Experiment 5 | 800 | 10 | 30 | 1 | 92 |

Additional settings added to experiment 5 only include:
Forward and Reverse Balance: (0.1).
Groups by the Flexible Number of Extend bases: (10, 8, 6).
Load Pair End Data Gap Range: From 100 to 600.

### Indels

### Homopolymers

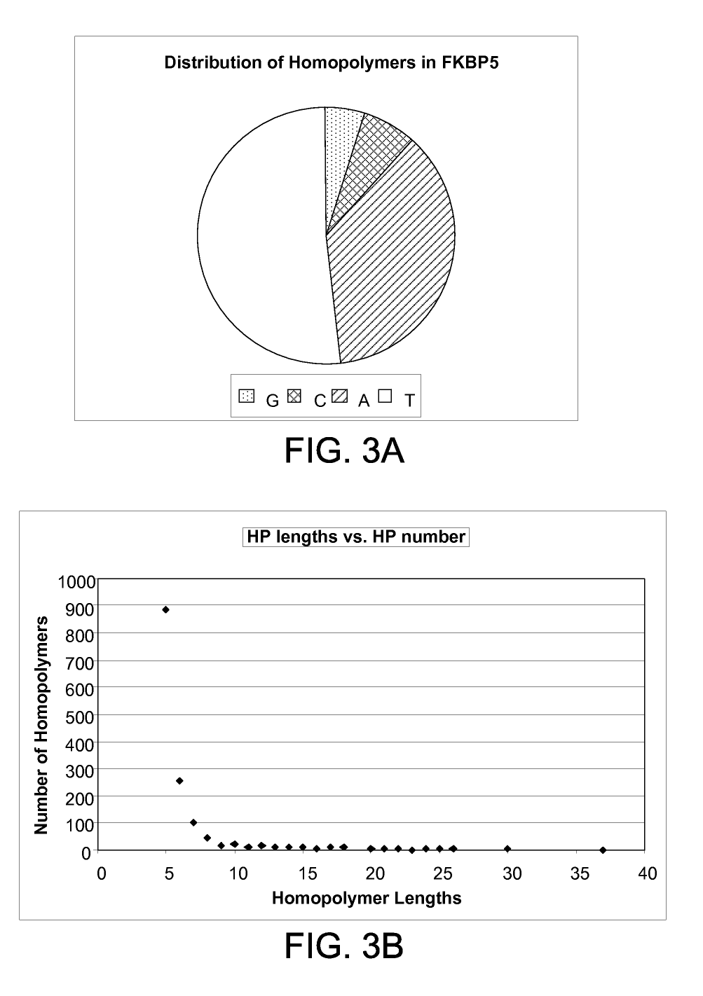

Because Homopolymers (HPs) are associated with microdeletions and microinsertions, it was attempted to determine how many were within the 160 kb location on chromosome 6p (Denver et al., Abundance, distribution, and mutation rates of homopolymeric nucleotide runs in the genome of Caenorhabditis elegans, Department of Biology, Indiana University, Bloomington, Ind., USA). A HP was defined as being a single nucleotide repeat greater or equal to five by (Ball et al., Human Mutation, 26(3):205-13 (2005)). There were a total of 1,403 HPs within this region, and the lengths ranged from 5-37 bp and decreased in number with increasing length, with only one 37 bp single nucleotide run found. Since the majority of HPs fell within the 5-11 bp range, and PCR and sequencing of these can be difficult, this method was designed to only detect a homopolymer indel, if it fell within a nucleotide run less than or equal to 11 bp. As seen in FIGS. 3A-B, most of the nucleotide runs fell within this category, so the majority of them could be detected. Because the larger HPs (greater than 11 bp) were concentrated in two genomic regions (chr6:35,764,693-35,796,082 and chr6:35,718,599-35,764,558), this method loses indel data in these two areas only.

A “poly-X program” was written to locate the homopolymers within the genomic region used as a reference and to record their length. This information was integrated into the detection of deletions. Deletions were separated into three categories and paths. Simple (multi) deletions were defined as a greater or equal to two by deletion of the same nucleotide. If it was within a homopolymer region greater than 11 bp, it was ignored. If it was not within the region, the percentages of the nucleotides had to be within 1% of each other, since if they are both deleted, they would be appearing as a unit within the reads most of the time. “Column” and “population” rules were then applied, and the prospective indel put off for manual inspection. Single (non-multi) deletions were defined as a one by deletion. Again, if it was within a homopolymer region greater than 11 bp, it was ignored. If it was not within the region, it was subjected to column and population rules and put off for manual inspection. Complex (multi) deletions were defined as unique, non-repetitive, nucleotide sequences of any size, which consistently appeared as a unit in each experiment. If the frequencies of the nucleotides within this unit were within two percent of each other, it was considered highly reliable. If the frequencies were not within two percent of each other, it was still considered worthy of inspection, as beginnings and ends of reads vary within the alignment, especially if the unit is large (Table 2). Genotypes were determined, the units subjected to column and population rules, and then put off for manual inspection. Insertions had their genotypes determined based on percentages. They were subjected to column and population rules and manually inspected. The actual nucleotide(s) inserted was manually determined.

### Column and Population Rules

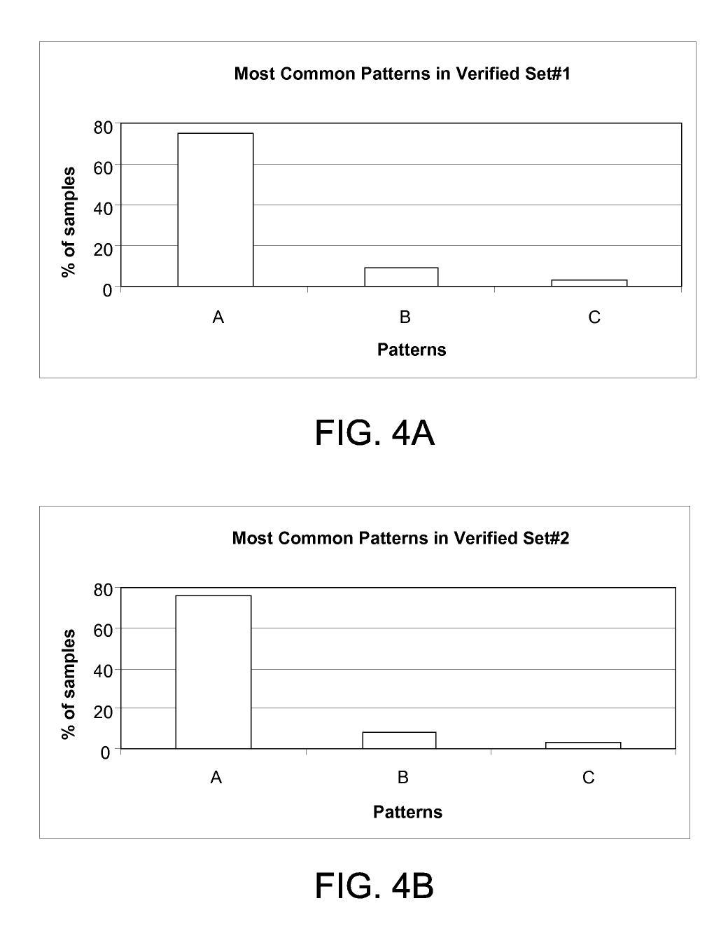

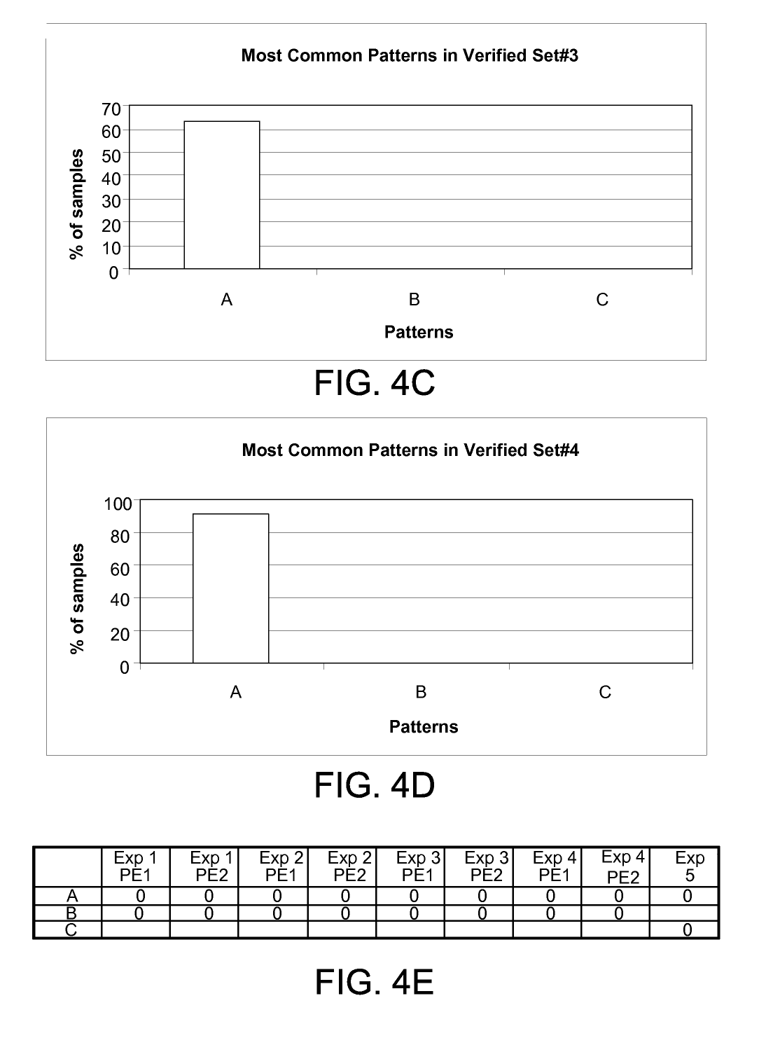

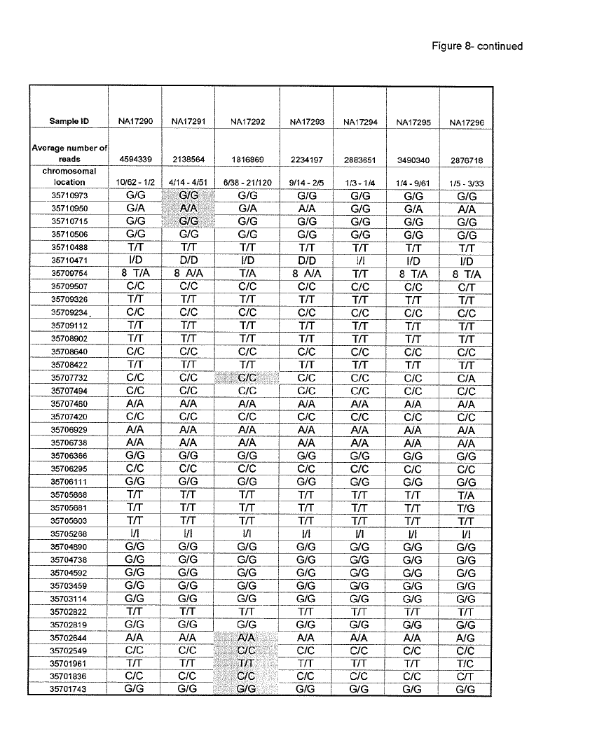

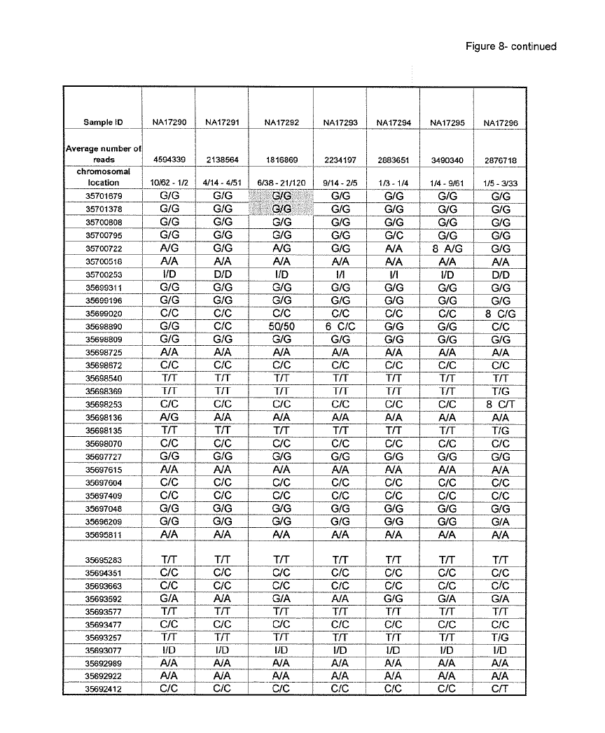

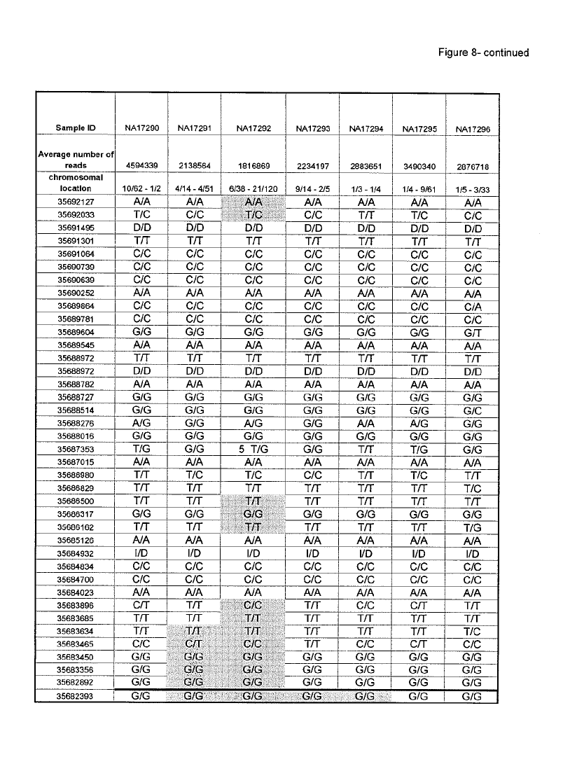

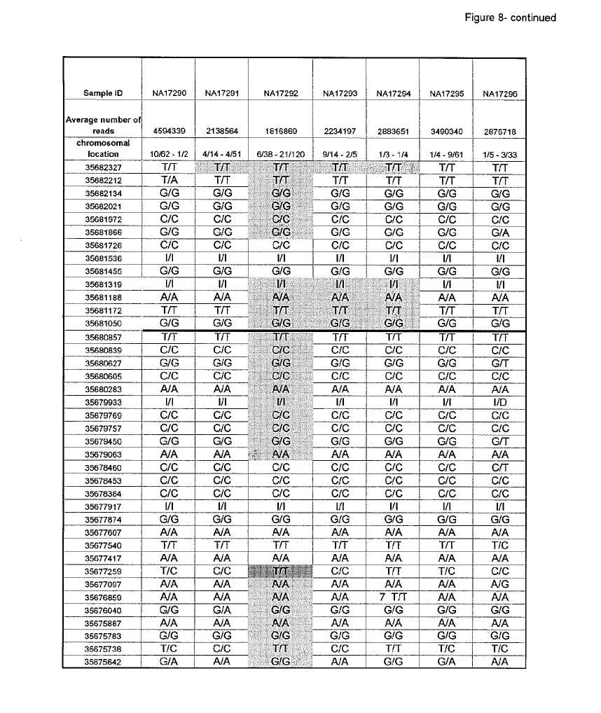

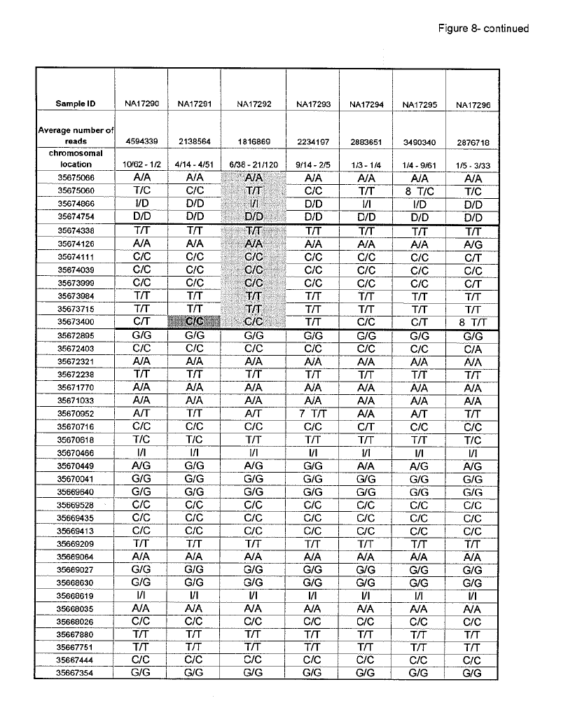

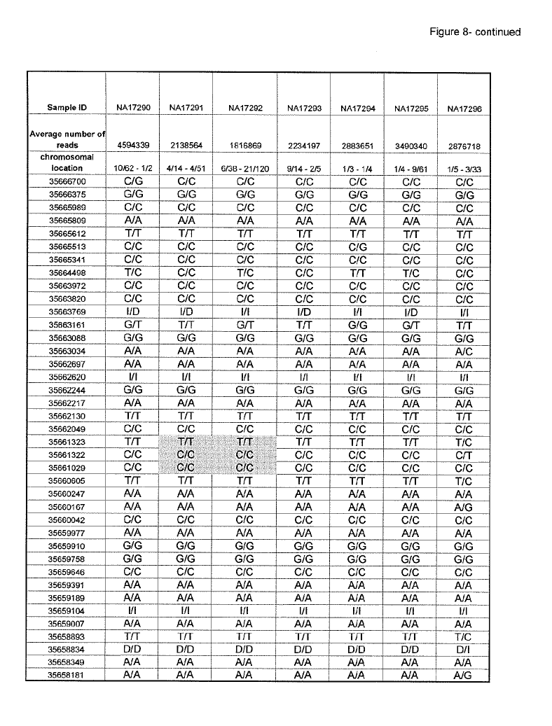

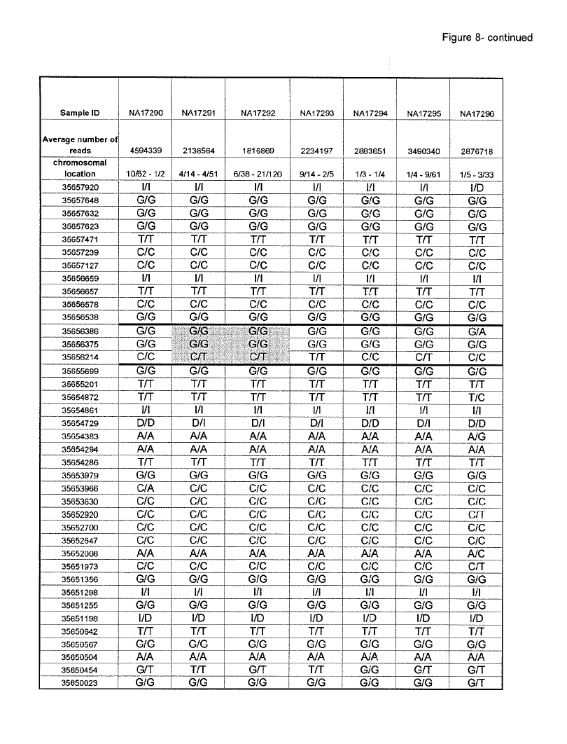

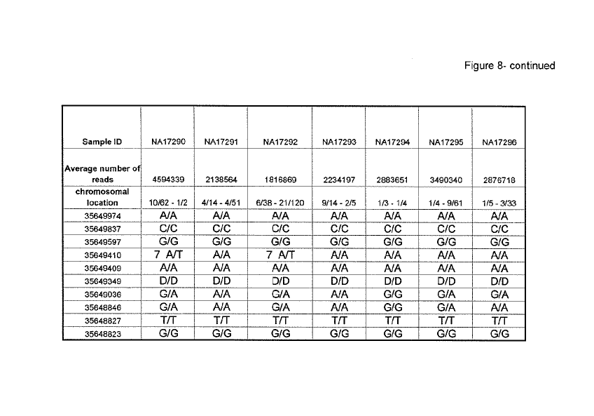

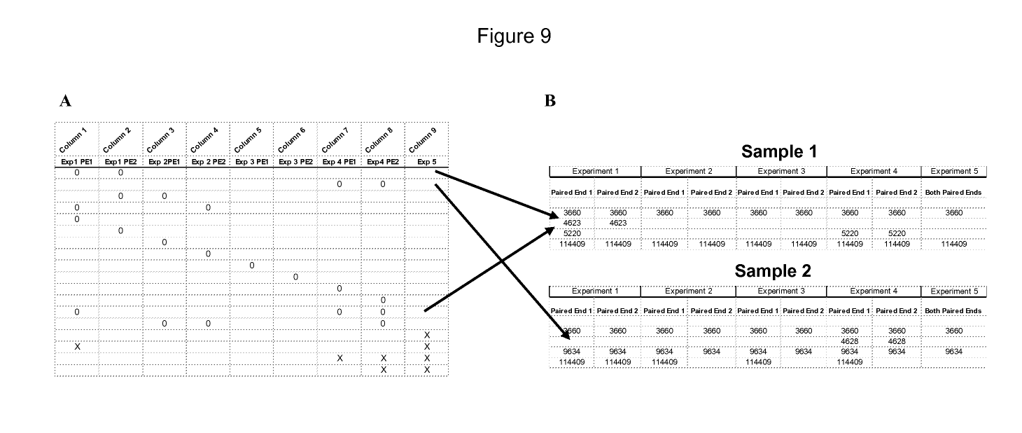

Because it is preferable to analyze a group of individuals all at one time, it was decided to determine the inherent variability in a real vs. simulated dataset as well as the variability of 96 samples versus one sample. The hypothesis was that the five experiments would establish some consistency and that a set of patterns would emerge among true polymorphic sites. If all settings detected a SNP, a pattern of “9 columns” would result. This would indicate adequate coverage and unambiguous alignments. On the other hand, if only some settings detected a SNP, this would indicate difficulty in alignment or a lack of quality reads, and low coverage. To verify this hypothesis, prior Sanger data was used on 6% of the genomic region under study for all 96 samples. Over the 519 verified markers, patterns emerged. The most frequent pattern for a true polymorphic site was pattern A (FIGS. 4A-E). Samples were genotyped at additional sites that were distributed across the genomic region in a random fashion, with no bias towards any region and its inherent genetic composition. These samples too showed the same pattern. To verify further, different DNA samples and a region on a different chromosome were used, and the same patterns emerged. The patterns fell into three categories; those experimental combinations, e.g., “patterns” that were seen in true SNPs, those which were found in both verified true and verified not true, and those that were found in not true. It was the latter category that formed the basis for the column rules and initial elimination of false variant sites (FIGS. 9A-B).

After the column rules were applied to each individual merged datasets, all datasets across the population were combined for each putative polymorphic locus. In a subset verified by Sanger, the total percentage of failed experiments tolerated to maintain reasonable genotype accuracy across the entire population fell within the 0-31% range for SNPs and 0-50% for indels. Higher percentages of failed experiments showed to be inaccurate across 96 subjects, indicative of systematic alignment difficulties within a region which would compromise correct zygosity determinations per sample.

If a position is called to be a polymorphic site, but when looking at the experimental results for all 96 people, most experiments showed no calls, then it can be a difficult area. If it was a good area, all the experimental settings should have mostly picked up a variant at that position. An example of this is position 44049 discussed below. 44049 is a true SNP, but it is in a GC rich area and many experimental settings were not able to detect a variant at that position.

### Population Rules

The following population rules were developed:

If a SNP is seen only once in the population, and the percent of failed experiments is greater than 0.25, then remove it.
If a SNP is seen twice in the population, and the percent of failed experiments is greater than 0.25, then remove it.
If a SNP is seen three times in the population, and the percent of failed experiments is greater than 0.30, then remove it.
If a SNP is seen four times or more in the population, and the percent of failed experiments is greater than 0.31, then remove it.
In each case, a failed experiment is one where the parameters selected did not detect a variant at that chromosomal location. For instance, experiment 1-paired end 1 may detect a variant. Experiment 1-paired end 2 may not detect a variant. In this cases, experiment 1-paired end 2 is a “failed experiment.”

Population Rules for Indels (All Indels are Subject to Manual Inspection)

For Simple (multi) and Single (non-multi) deletions, if the percent of failed experiments is greater than 0.50, then remove it.

For Complex deletions, if all members of the unit have a percent of failed experiments greater than 0.50, then remove it. If some members of the unit have a percent of failed experiments greater than 0.50 and other members of the unit have a percent of failed experiments less than 0.50, then do not remove it.

For Insertions, if the percent of failed experiments is greater than 0.50, then remove it.

The following is an example of the implementation of the population rules. The

RefNum is the location of the variant within the subsequence of a contig. It is equivalent to a chromosomal location (Table 6). In this example, a variant was called at position 44049. Hyphens indicate that variant was not called by the experimental setting. For instance, sample CA03 shows that Exp.1 PE2, Exp2 PE1 and PE2, Exp.3 PE 1 and PE2 and Exp.4 PE1 and PE2 did not detect a variant at position 44049.

In this case, the experiments were performed in order. Position 44049 is a true variant site. The rs10947564 is the ID given by dbSNP on NCBI. For the experimental results for CA01 (Caucasian sample 1), the exp. 1-PE1 settings detected a SNP. Exp. 1-PE2 did not. There is a hyphen there to indicate it did not. Exp.2-PE1 also did not detect a SNP. Exp2-PE2 also did not detect a SNP at that position. There are 7 hyphens, which indicate the parameters that did not detect a SNP. Only the settings for Experiment 1-paired end 1 and Experiment 5 were able to detect a SNP at that location.

Twenty-three failed calls out of 36 (four samples X nine possible)=64 percent total failed. This percentage is greater than 0.31, so the putative marker was removed from the final set.

TABLE 6
Implementation of population rules.

| | | | Detected | Majority |
|---|---|---|---|---|
| RefNum | RefSNP ID | Sample | Variant/Setting | Genotype |
| 44049 | rs10947564 | CA01 | 44049\|-\|-\|-\|-\|-\|-\|-\|44049 | A/G |
| 44049 | rs10947564 | CA02 | | |
| 44049 | rs10947564 | CA03 | 44049\|44049\|-\|44049\|- | A/G |
| | | | \|44049\|-44049\|- | |
| 44049 | rs10947564 | CA04 | | |
| 44049 | rs10947564 | CA05 | | |
| 44049 | rs10947564 | CA06 | | |
| 44049 | rs10947564 | CA07 | | |
| 44049 | rs10947564 | CA08 | | |
| 44049 | rs10947564 | CA09 | | |
| 44049 | rs10947564 | CA10 | | |
| 44049 | rs10947564 | CA11 | | |
| 44049 | rs10947564 | CA12 | | |
| 44049 | rs10947564 | CA13 | | |
| 44049 | rs10947564 | CA14 | 44049\|44049\|-\|-\|-\|-\|- | A/G |
| | | | \|44049\|- | |
| 44049 | rs10947564 | CA15 | | |
| 44049 | rs10947564 | CA16 | | |
| 44049 | rs10947564 | CA17 | | |
| 44049 | rs10947564 | CA18 | 44049\|44049\|-\|-\|-\|-\|-\|- | A/G |
| | | | \|44049 | |
| 44049 | rs10947564 | CA19 | | |
| 44049 | rs10947564 | CA20 | | |

### Genotype Determinations

Parameters for genotype calls were developed using NextGENe software and comparison to prior Sanger data. The parameters were as follows:

Parameters for Deletion Variant Calls

Simple (multi): Example CGTTTTACTG (SEQ ID NO: 1) (two by deletion of the same nucleotide).

Homozygous Variant:

A homozygous variant is assigned if any of the five experiments are showing the same nucleotide consecutively less than or equal to ten times, AND that nucleotide equals Ref, and the Ref(s) is within a homopolymer less than or equal to 11 bp OR not within a homopolymer, AND the consecutive Ref nucleotides are within one percent of each other AND Del is greater than or equal to 0.80.

Heterozygote:

A heterozygote is assigned if any of the five experiments are showing the same nucleotide consecutively less than or equal to ten times, AND that nucleotide equals Ref, AND the Ref(s) is within a homopolymer less than or equal to 11 bp OR not within a homopolymer, AND the consecutive Ref nucleotides are within one percent of each other AND Del is less than 0.80.

Single (non-multi): Examples ATCGTCAAT (one by deletion) or ATCGGGGGGTACGC (SEQ ID NO: 2) (one by deletion within a homopolymer less than or equal to 11 bp).

Homozygous Variant:

A homozygous variant is assigned if Ref is within a homopolymer less than or equal to 11 bp OR not within a homopolymer AND Del is greater than or equal to 0.80 AND Ref equals the highest percentage (A, C, G, T).

Heterozygote:

A heterozygote is assigned if Ref is within a homopolymer less than or equal to 11 bp OR not within a homopolymer AND Del is greater than 0.80 AND Ref equals the highest percentage (A, C, G, T).

(SEQ ID NO: 3)
Complex: Example TCGACGACTCAATTAC

Homozygous Variant:

A homozygous variant is assigned if any of the five experiments are showing the same consecutive unit (series) of nucleotides AND Del (deletion) percent is greater than or equal to Ref (reference; A, C, G, T) plus 0.40 OR Del percent is greater than or equal to (highest percentage of A, C, G, T, which must equal Ref) plus 0.40.

A homozygous variant is also assigned if some of the nucleotides within the unit show Del percent less than Ref and some show Del percent greater than Ref, then find the member of the unit which has the highest coverage. If the corresponding member of the unit has Del percent greater than the Ref nucleotide, then the entire unit is a homozygote.

Heterozygote:

A heterozygote is assigned if any of the five experiments show the same consecutive unit (series) of nucleotides AND Del percent is less than Ref (A, C, G, T) plus 0.40 OR Del percent less than (highest percentage of A, C, G, T, which must equal Ref) plus 0.40.

A heterozygote is also assigned if some of the nucleotides within the unit show Del percent less than Ref and some show Del percent greater than Ref, then find the member of the unit which has the highest coverage. If the corresponding member of the unit has Del percent is less than Ref nucleotide, then the entire unit is a heterozygote.

Parameters for Insertions

Homozygous Variant:

A homozygous variant is assigned if the Ins percent is greater than or equal to 0.80 AND Ref equals the highest percentage (A,C,G,T).

Heterozygote:

A heterozygote is assigned if the Ins percent is greater than 0.80 AND Ref equals highest percentage (A,C,G,T).

Parameters for SNP Variant Calls

Homozygous Variant:

A homozygous variant is assigned if Alt is greater than or equal to 0.98 and Ref equals 100 minus Alt.

A homozygous variant is also assigned if there are multiple percentages and neither of the two highest percentages equals Ref, then default to the highest percentage variant nucleotide as being homozygous.

A homozygous variant is also assigned if there are multiple percentages and one of the highest percentages equals Ref, and the other highest percentage is greater than or equal to 0.98.

Heterozygote Variant:

A heterozygote variant is assigned if Alt is greater than 0.98, and Ref equals 100 minus Alt.

A heterozygote variant is also assigned if there are multiple percentages and one of the highest two percentages equals Ref, and the other highest percentage is less than 0.98.

### Majority Rule

Once the genotypes are determined for all five experiments (nine columns), the consensus genotype across all experiments is chosen as the correct one. With this, there is consistency across nine putative duplicate genotypes as a built-in quality control. Replicates can be important. If there is not a clear majority, and the ratio is 50:50, the genotype with the highest coverage is designated as true. In some instances, the reference homozygous genotype is not calculated, and therefore it is not considered in the majority rule to determine the genotype. The reference homozygous genotype is a default genotype to be added at the end of the method.

### Primer Rule (Optional)

If a variant is within a region less than the first nucleotide of the forward primer and greater than the last nucleotide of the reverse primer, remove it.

### Discordant Genotype

A discordant genotype can be defined if the Next Generation Sequencing (NGS) genotype does not equal the Applied Biosystems, Inc. Sanger genotype.

A discordant genotype can be defined if the NGS genotype does not equal the Illumina genotype.

A discordant genotype can be defined if the NGS genotype does not equal the Affymetrix genotype.

### False Variant Site

A false variant site is defined as within the boundaries of the PCR forward and reverse primers used for Sanger sequencing if NGS detects either a heterozygote or homozygote variant and Sanger has a homozygous reference. The zygosity, whether true or false, is not considered in this definition. There can be a genotype (zygosity) that is discrepant between the platforms for one or more individuals, but the SNP/Indel marker was still found by NGS since one or more individuals did have the variant.

### Missed Variant Site

A missed variant site is defined as within the boundaries of the PCR forward and reverse primers used for Sanger sequencing if NGS did not detect either a heterozygote or homozygote variant among all the individuals and Sanger did detect a heterozygote or homozygous variant. In some instances, the SNP genotype array cannot detect true false variant sites or missed variant sites. It can only determine discordance or concordance. The array can have pre-selected SNPs which are of tested quality and frequency and do not allow for detection of de novo variants (Harismendy et al., Genome Biol., 10(3):R32 (2009)).

### Common Polymorphism

A common polymorphism is defined as a DNA variant that is greater than 1% in a population (Roden and Altman, Ann. Intern. Med., 145:749-757 (2006)).

### Results

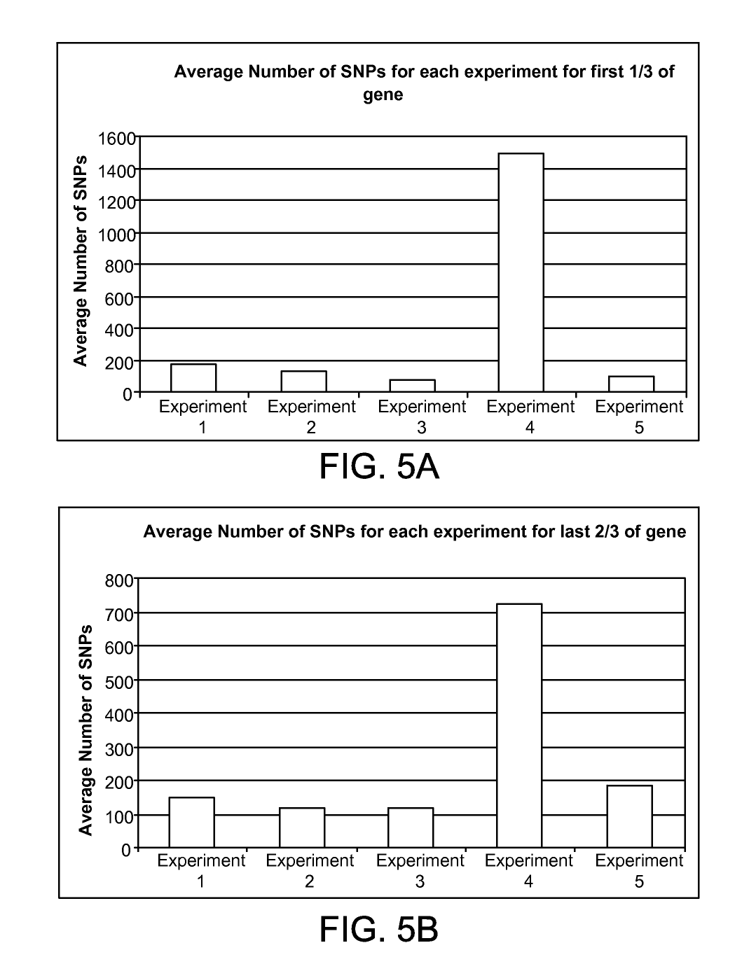

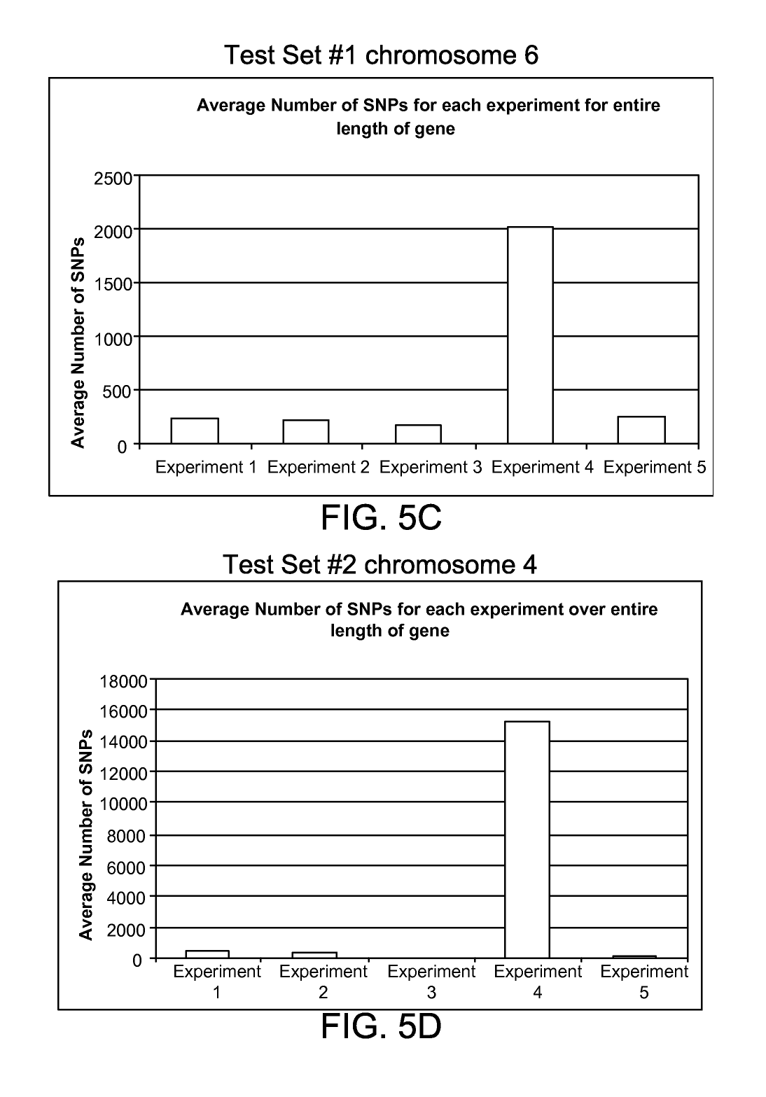

When comparing the five experiments, experiment four, with the different alignment method produced the largest number of called variants with an average (over both paired ends) of 1,113.5 calls. Experiment one resulted in 158.9 calls. Experiment five resulted in 142.5 calls. Experiment two resulted in 128.4 calls. Experiment three, which had the most stringent parameters, resulted in 96.7 calls (FIGS. 5A-D). In a controlled group of 519 Sanger verified variants, experiment three showed the highest percentage of false negatives, followed by experiment two and four with near equivalent percentages and finally experiments one and five with the lowest. No single experimental setting overwhelmed any of the others.

### Indels and SNPs

Overall, 613 SNPs and 57 indels were detected (Table 7). Of the 57 indels, 16 were insertions, 41 were deletions, 21 were singletons and 35 had frequencies over 1%. Thirty-four of the indels were within genomic regions of repetitive elements, and 22 were within or immediately next to a homopolymer. The largest complex microdeletion was nine by in length, and the largest structural variant was 3.3 kb in size. Both of these were verified with Sanger sequencing methods. Of the 613 SNPs, 313 were singletons, and 300 were common polymorphisms.

TABLE 7

| Chromosomal | | dbSNP build | NGS |
|---|---|---|---|
| location | | 130 | frequency |
| | SNP | | |
| 35804864 | g.26555136G > C | rs2766537 | 0.469 |
| 35804849 | g.26555121C > T | n/a | 0.005 |
| 35804361 | g.26554633G > T | rs45545133 | 0.005 |
| 35804341 | g.26554613C > T | rs2817035 | 0.234 |
| 35804267 | g.26554539A > G | rs2817034 | 1.000 |
| 35804257 | g.26554529A > G | rs2817033 | 0.464 |
| 35803569 | g.26553841G > A | rs28435135 | 0.146 |
| 35803519 | g.26553791C > A | rs2766536 | 0.224 |
| 35803496 | g.26553768G > T | n/a | 0.010 |
| 35803252 | g.26553524C > T | rs7751693 | 0.042 |
| 35803203 | g.26553475A > G | n/a | 0.005 |
| 35803171 | g.26553443C > T | n/a | 0.021 |
| 35802904 | g.26553176C > T | rs10947565 | 0.234 |
| 35802883 | g.26553155T > G | n/a | 0.005 |
| 35802555 | g.26552827G > A | n/a | 0.042 |
| 35802223 | g.26552495G > A | n/a | 0.063 |
| 35802128 | g.26552400C > T | n/a | 0.026 |
| 35801866 | g.26552138G > A | n/a | 0.005 |
| 35801095 | g.26551367T > C | n/a | 0.005 |
| 35800906 | g.26551178G > A | rs12203716 | 0.234 |
| 35800620 | g.26550892C > T | rs9462106 | 0.005 |
| 35800163 | g.26550435C > T | n/a | 0.005 |
| 35800126 | g.26550398G > A | n/a | 0.005 |
| 35799973 | g.26550245G > T | n/a | 0.005 |
| 35799760 | g.26550032T > C | rs2766535 | 0.464 |
| 35799618 | g.26549890G > A | rs4236047 | 0.245 |
| 35799414 | g.26549686T > G | n/a | 0.036 |
| 35799311 | g.26549583T > C | n/a | 0.042 |
| 35799193 | g.26549465C > T | n/a | 0.005 |
| 35798870 | g.26549142G > T | n/a | 0.005 |
| 35798603 | g.26548875A > G | n/a | 0.005 |
| 35798495 | g.26548767G > A | n/a | 0.010 |
| 35798423 | g.26548695C > T | n/a | 0.021 |
| 35798367 | g.26548639C > T | n/a | 0.005 |
| 35797810 | g.26548082T > C | rs13198515 | 0.297 |
| 35797771 | g.26548043G > A | rs12206670 | 0.234 |
| 35797716 | g.26547988T > C | n/a | 0.042 |
| 35797537 | g.26547809C > T | n/a | 0.005 |
| 35797371 | g.26547643G > T | rs7747780 | 0.042 |
| 35797116 | g.26547388T > A | n/a | 0.005 |
| 35796597 | g.26546869A > G | rs2817032 | 0.240 |
| 35796438 | g.26546690T > A | n/a | 0.005 |
| 35796280 | g.26546552C > A | n/a | 0.005 |
| 35795915 | g.26546187C > T | n/a | 0.036 |
| 35795227 | g.26545499A > C | rs9348981 | 0.333 |
| 35795203 | g.26545475C > A | n/a | 0.005 |
| 35794415 | g.26544687A > G | rs6914582 | 0.005 |
| 35794369 | g.26544641A > G | rs6914554 | 0.005 |
| 35793933 | g.26544205C > T | rs12200498 | 0.234 |
| 35793776 | g.26544048A > G | n/a | 0.010 |
| 35793692 | g.26543964C > A | rs2766534 | 0.198 |
| 35793468 | g.26543740C > T | rs2766533 | 0.479 |
| 35793330 | g.26543602C > T | n/a | 0.021 |
| 35793171 | g.26543443A > G | rs2817031 | 0.240 |
| 35792913 | g.26543185G > A | n/a | 0.005 |
| 35792818 | g.26543090T > C | rs2766532 | 0.224 |
| 35792687 | g.26542959T > C | rs6922997 | 0.005 |
| 35792241 | g.26542513T > G | n/a | 0.005 |
| 35791526 | g.26541798T > C | rs4711429 | 0.255 |
| 35791107 | g.26541379T > C | n/a | 0.005 |
| 35791037 | g.26541309C > T | rs9394314 | 0.005 |
| 35790057 | g.26540329T > G | n/a | 0.005 |
| 35789861 | g.26540133C > T | rs73729766 | 0.005 |
| 35789755 | g.26540027A > G | rs4713921 | 0.255 |
| 35789706 | g.26539978T > C | rs57599664 | 0.005 |
| 35789554 | g.26539826G > A | n/a | 0.005 |
| 35789347 | g.26539619C > T | n/a | 0.005 |
| 35788582 | g.26538854C > T | n/a | 0.010 |
| 35788393 | g.26538665G > A | n/a | 0.005 |
| 35788084 | g.26538356A > T | rs6909804 | 0.255 |
| 35787725 | g.26537997C > T | n/a | 0.005 |
| 35787670 | g.26537942G > A | n/a | 0.010 |
| 35787100 | g.26537372C > T | n/a | 0.005 |
| 35786749 | g.26537021G > A | rs11963190 | 0.005 |
| 35786601 | g.26536873G > C | rs4711428 | 0.490 |
| 35786597 | g.26536869T > A | rs4713920 | 0.260 |
| 35786126 | g.26536398A > C | n/a | 0.021 |
| 35786032 | g.26536304C > T | rs58580399 | 0.005 |
| 35785949 | g.26536221A > G | n/a | 0.005 |
| 35785861 | g.26536133G > T | n/a | 0.005 |
| 35785763 | g.26536035G > A | n/a | 0.010 |
| 35785031 | g.26535303G > T | rs4711427 | 0.266 |
| 35785005 | g.26535277C > A | rs4711426 | 0.266 |
| 35784969 | g.26535241T > C | rs4713919 | 0.255 |
| 35784863 | g.26535135A > G | rs4713918 | 0.255 |
| 35784578 | g.26534850A > G | rs7764780 | 0.005 |
| 35784296 | g.26534568A > G | rs6457842 | 0.255 |
| 35783851 | g.26534123C > T | rs6905674 | 0.245 |
| 35783674 | g.26533946T > C | rs9380529 | 0.464 |
| 35783639 | g.26533911G > T | rs6900592 | 0.250 |
| 35783557 | g.26533829G > A | rs55694295 | 0.208 |
| 35783334 | g.26533606T > G | rs11965924 | 0.005 |
| 35783310 | g.26533582G > T | rs11961024 | 0.005 |
| 35783272 | g.26533544C > T | n/a | 0.005 |
| 35783218 | g.26533490G > A | n/a | 0.005 |
| 35783059 | g.26533331G > A | rs9296160 | 0.464 |
| 35783032 | g.26533304G > A | n/a | 0.005 |
| 35783013 | g.26533285G > A | rs9470084 | 0.484 |
| 35782823 | g.26533095A > G | rs9462104 | 0.177 |
| 35782595 | g.26532867G > A | rs9394313 | 0.005 |
| 35782461 | g.26532733G > A | n/a | 0.005 |
| 35781693 | g.26531965G > C | n/a | 0.005 |
| 35781310 | g.26531582C > A | rs13213010 | 0.443 |
| 35780890 | g.26531162G > A | n/a | 0.005 |
| 35780625 | g.26530897C > T | n/a | 0.005 |
| 35780536 | g.26530808T > G | n/a | 0.005 |
| 35780308 | g.26530580C > G | rs9394312 | 0.448 |
| 35779689 | g.26529961T > C | n/a | 0.016 |
| 35779629 | g.26529901A > G | rs10456432 | 0.229 |
| 35779143 | g.26529415T > C | rs2395635 | 0.255 |
| 35779060 | g.26529332C > T | n/a | 0.010 |
| 35778999 | g.26529271G > C | rs7745324 | 0.260 |
| 35778812 | g.26529084G > A | n/a | 0.005 |
| 35778585 | g.26528857G > A | rs6902321 | 0.292 |
| 35778454 | g.26528726C > T | rs12190582 | 0.208 |
| 35778443 | g.26528715C > T | n/a | 0.016 |
| 35777961 | g.26528233T > C | rs4713916 | 0.260 |
| 35777894 | g.26528166A > G | n/a | 0.005 |
| 35777525 | g.26527797C > T | n/a | 0.031 |
| 35777322 | g.26527594C > T | n/a | 0.005 |
| 35777288 | g.26527560T > C | rs4713915 | 0.276 |
| 35777278 | g.26527550C > T | rs9470082 | 0.016 |
| 35777233 | g.26527505G > A | n/a | 0.031 |
| 35777220 | g.26527492C > T | n/a | 0.005 |
| 35777122 | g.26527394G > C | rs4713914 | 0.432 |
| 35776563 | g.26526835T > G | rs9394311 | 0.318 |
| 35776478 | g.26526750G > C | n/a | 0.005 |
| 35776477 | g.26526749G > A | n/a | 0.005 |
| 35776462 | g.26526734G > A | n/a | 0.016 |
| 35776273 | g.26526545C > T | n/a | 0.005 |
| 35775985 | g.26526257C > T | n/a | 0.005 |
| 35775969 | g.26526241T > C | rs12153967 | 0.271 |
| 35775947 | g.26526219C > T | n/a | 0.010 |
| 35775838 | g.26526110A > G | rs943297 | 0.255 |
| 35775376 | g.26525648C > T | rs59520042 | 0.005 |
| 35774523 | g.26524795G > A | n/a | 0.031 |
| 35773892 | g.26524164C > A | n/a | 0.005 |
| 35773174 | g.26523446A > G | rs4713911 | 0.354 |
| 35772983 | g.26523255T > C | n/a | 0.021 |
| 35772531 | g.26522803T > A | n/a | 0.005 |
| 35772230 | g.26522502C > T | rs9380528 | 0.490 |
| 35771923 | g.26522195T > G | n/a | 0.005 |
| 35771840 | g.26522112G > A | n/a | 0.010 |
| 35771726 | g.26521998A > G | n/a | 0.005 |
| 35771074 | g.26521346T > C | n/a | 0.005 |
| 35770631 | g.26520903A > G | rs56311918 | 0.229 |
| 35770379 | g.26520651T > C | n/a | 0.005 |
| 35770196 | g.26520468G > C | rs11969123 | 0.005 |
| 35770084 | g.26520356G > T | rs7763535 | 0.255 |
| 35770010 | g.26520282G > A | rs55987213 | 0.214 |
| 35769797 | g.26520069G > A | rs7759392 | 0.250 |
| 35769420 | g.26519692G > A | n/a | 0.005 |
| 35768979 | g.26519251C > T | rs73417698 | 0.005 |
| 35768959 | g.26519231G > A | n/a | 0.005 |
| 35768703 | g.26518975C > T | n/a | 0.010 |
| 35768679 | g.26518951A > G | n/a | 0.010 |
| 35768574 | g.26518846G > C | n/a | 0.005 |
| 35767825 | g.26518097G > T | rs62402145 | 0.021 |
| 35767647 | g.26517919C > T | n/a | 0.005 |
| 35767548 | g.26517820C > G | n/a | 0.005 |
| 35767003 | g.26517275C > A | n/a | 0.005 |
| 35766630 | g.26516902C > T | n/a | 0.005 |
| 35766622 | g.26516894T > C | rs9368885 | 0.302 |
| 35766305 | g.26516577G > A | rs9380526 | 0.302 |
| 35766013 | g.26516285G > A | n/a | 0.005 |
| 35765816 | g.26516088T > C | n/a | 0.005 |
| 35765499 | g.26515771C > T | n/a | 0.010 |
| 35765189 | g.26515461T > C | n/a | 0.005 |
| 35763223 | g.26513495C > T | rs3800372 | 0.297 |
| 35762954 | g.26513226C > T | n/a | 0.005 |
| 35762773 | g.26513045G > A | n/a | 0.005 |
| 35761573 | g.26511845G > T | n/a | 0.026 |
| 35761535 | g.26511807C > T | n/a | 0.005 |
| 35761415 | g.26511687C > T | rs10947563 | 0.260 |
| 35761150 | g.26511422A > G | n/a | 0.005 |
| 35760898 | g.26511170A > G | n/a | 0.010 |
| 35760871 | g.26511143T > C | n/a | 0.026 |
| 35760821 | g.26511093T > G | rs34110646 | 0.052 |
| 35760682 | g.26510954A > G | n/a | 0.005 |
| 35760680 | g.26510952G > A | n/a | 0.005 |
| 35760487 | g.26510759C > T | n/a | 0.005 |
| 35759965 | g.26510237C > T | rs6899478 | 0.255 |
| 35759261 | g.26509533G > A | n/a | 0.031 |
| 35759185 | g.26509457G > C | n/a | 0.042 |
| 35759082 | g.26509354A > G | n/a | 0.005 |
| 35758826 | g.26509098G > T | n/a | 0.005 |
| 35758735 | g.26509007G > A | n/a | 0.005 |
| 35758265 | g.26508537A > G | n/a | 0.042 |
| 35758256 | g.26508528T > G | n/a | 0.026 |
| 35757942 | g.26508214A > G | n/a | 0.005 |
| 35757285 | g.26507557A > G | n/a | 0.005 |
| 35756883 | g.26507155G > C | rs6923648 | 0.005 |
| 35756808 | g.26507080G > A | rs6457839 | 0.260 |
| 35756791 | g.26507063T > C | n/a | 0.005 |
| 35756716 | g.26506988G > A | n/a | 0.005 |
| 35756236 | g.26506508A > G | n/a | 0.005 |
| 35756071 | g.26506343C > T | n/a | 0.010 |
| 35755688 | g.26505960T > A | n/a | 0.005 |
| 35755572 | g.26505844C > G | n/a | 0.021 |
| 35755372 | g.26505644A > G | rs73417691 | 0.005 |
| 35755288 | g.26505560T > C | rs4713908 | 0.031 |
| 35754491 | g.26504763C > G | n/a | 0.005 |
| 35754413 | g.26504685A > G | rs9470080 | 0.297 |
| 35753953 | g.26504225T > C | n/a | 0.005 |
| 35753356 | g.26503628C > T | n/a | 0.005 |
| 35753063 | g.26503335A > G | rs7758906 | 0.281 |
| 35753029 | g.26503301A > G | rs11963574 | 0.005 |
| 35752936 | g.26503208G > T | rs11960963 | 0.005 |
| 35752898 | g.26503170C > T | rs73417690 | 0.005 |
| 35752631 | g.26502903G > A | n/a | 0.010 |
| 35752611 | g.26502883C > A | n/a | 0.005 |
| 35751701 | g.26501973A > G | rs73748221 | 0.031 |
| 35751398 | g.26501670G > T | rs73748220 | 0.031 |
| 35751395 | g.26501667T > A | rs6931036 | 0.005 |
| 35751293 | g.26501565G > A | n/a | 0.005 |
| 35751053 | g.26501325C > T | rs4713907 | 0.031 |
| 35751041 | g.26501313C > T | rs9470079 | 0.135 |
| 35750793 | g.26501065G > C | n/a | 0.005 |
| 35750117 | g.26500389T > C | n/a | 0.005 |
| 35749202 | g.26499474C > T | n/a | 0.016 |
| 35748720 | g.26498992C > T | n/a | 0.016 |
| 35747785 | g.26498057T > C | n/a | 0.005 |
| 35747666 | g.26497938A > G | rs9394310 | 0.260 |
| 35747029 | g.26497301T > G | n/a | 0.005 |
| 35746954 | g.26497226T > C | rs9368882 | 0.229 |
| 35746589 | g.26496861G > A | n/a | 0.005 |
| 35745355 | g.26495627G > A | n/a | 0.005 |
| 35745319 | g.26495591C > T | rs7762760 | 0.005 |
| 35744292 | g.26494564A > G | n/a | 0.005 |
| 35744207 | g.26494479G > A | n/a | 0.005 |
| 35743496 | g.26493768G > T | rs7752084 | 0.031 |
| 35743215 | g.26493487T > C | rs73417687 | 0.005 |
| 35742637 | g.26492909T > A | n/a | 0.005 |
| 35742501 | g.26492773C > T | rs73417685 | 0.005 |
| 35742452 | g.26492724A > G | n/a | 0.016 |
| 35742266 | g.26492538T > C | rs9368881 | 0.401 |
| 35742017 | g.26492289C > T | n/a | 0.005 |
| 35741871 | g.26492143G > A | n/a | 0.005 |
| 35741493 | g.26491765C > T | n/a | 0.005 |
| 35741434 | g.26491706T > C | rs13192954 | 0.052 |
| 35741286 | g.26491558G > A | n/a | 0.005 |
| 35741016 | g.26491288C > G | rs9380525 | 0.307 |
| 35740968 | g.26491240A > G | n/a | 0.005 |
| 35740895 | g.26491167G > T | n/a | 0.026 |
| 35740361 | g.26490633C > G | n/a | 0.021 |
| 35739800 | g.26490072A > G | n/a | 0.005 |
| 35739570 | g.26489842A > G | n/a | 0.005 |
| 35738877 | g.26489149C > T | n/a | 0.005 |
| 35737387 | g.26487659C > T | n/a | 0.063 |
| 35737296 | g.26487568A > G | n/a | 0.078 |
| 35737178 | g.26487450T > G | rs7747647 | 0.078 |
| 35736456 | g.26486728G > A | rs4713905 | 0.078 |
| 35735245 | g.26485517C > T | rs7775489 | 0.063 |
| 35735216 | g.26485488C > T | n/a | 0.005 |
| 35734910 | g.26485182C > G | n/a | 0.063 |
| 35734831 | g.26485103A > G | n/a | 0.010 |
| 35734478 | g.26484750G > A | rs4711425 | 0.089 |
| 35733914 | g.26484186C > T | rs13215497 | 0.318 |
| 35733683 | g.26483955T > C | rs6929523 | 0.224 |
| 35733616 | g.26483888G > A | n/a | 0.047 |
| 35733450 | g.26483722G > T | n/a | 0.005 |
| 35733125 | g.26483397G > A | rs4713904 | 0.240 |
| 35732947 | g.26483219C > G | n/a | 0.005 |
| 35732913 | g.26483185G > A | n/a | 0.005 |
| 35732689 | g.26482961C > T | rs12197246 | 0.208 |
| 35732606 | g.26482878G > A | n/a | 0.021 |
| 35732521 | g.26482793C > T | rs9296159 | 0.286 |
| 35731464 | g.26481736A > G | n/a | 0.005 |
| 35730693 | g.26480965C > T | n/a | 0.016 |
| 35730506 | g.26480778T > C | n/a | 0.005 |
| 35730468 | g.26480740A > G | n/a | 0.005 |
| 35730299 | g.26480571A > G | n/a | 0.005 |
| 35730238 | g.26480510A > C | rs58312291 | 0.005 |
| 35730185 | g.26480457C > T | rs2092427 | 0.036 |
| 35729899 | g.26480171A > G | rs17614642 | 0.083 |
| 35729759 | g.26480031C > T | rs9394309 | 0.297 |
| 35729217 | g.26479489A > C | n/a | 0.005 |
| 35728877 | g.26479149C > T | n/a | 0.005 |
| 35728809 | g.26479081A > G | n/a | 0.005 |
| 35728790 | g.26479062G > T | n/a | 0.005 |
| 35728631 | g.26478903A > T | n/a | 0.005 |
| 35728619 | g.26478891C > T | n/a | 0.005 |
| 35728605 | g.26478877A > G | rs10456431 | 0.229 |
| 35728550 | g.26478822C > T | rs11754441 | 0.297 |
| 35728528 | g.26478800G > A | rs6931118 | 0.297 |
| 35727956 | g.26478228C > T | rs4544902 | 0.286 |
| 35727532 | g.26477804C > T | rs1475774 | 0.031 |
| 35726664 | g.26476936T > A | n/a | 0.010 |
| 35726280 | g.26476552C > T | n/a | 0.047 |
| 35725929 | g.26476201G > A | rs73417678 | 0.005 |
| 35725799 | g.26476071G > T | rs4713903 | 0.250 |
| 35725691 | g.26475963T > C | n/a | 0.005 |
| 35725675 | g.26475947T > C | n/a | 0.005 |
| 35725563 | g.26475835T > A | rs6912833 | 0.250 |
| 35724864 | g.26475136C > T | n/a | 0.016 |
| 35724644 | g.26474916G > A | rs9357201 | 0.307 |
| 35723690 | g.26473962A > G | rs9462100 | 0.016 |
| 35723226 | g.26473498T > C | n/a | 0.005 |
| 35723137 | g.26473409G > A | n/a | 0.005 |
| 35723108 | g.26473380G > A | rs1334894 | 0.089 |
| 35722911 | g.26473183G > A | n/a | 0.005 |
| 35722862 | g.26473134G > A | n/a | 0.005 |
| 35722836 | g.26473108A > G | n/a | 0.005 |
| 35722722 | g.26472994T > C | rs17542466 | 0.208 |
| 35722504 | g.26472776C > A | n/a | 0.016 |
| 35722306 | g.26472578A > G | rs59595954 | 0.026 |
| 35722105 | g.26472377G > C | rs73748211 | 0.021 |
| 35722004 | g.26472276A > G | rs4713902 | 0.302 |
| 35721976 | g.26472248C > T | rs7771722 | 0.031 |
| 35721953 | g.26472225C > T | rs7771718 | 0.005 |
| 35721689 | g.26471961C > G | n/a | 0.005 |
| 35721310 | g.26471582A > G | rs73748209 | 0.026 |
| 35721176 | g.26471448C > T | rs9767565 | 0.031 |
| 35720889 | g.26471161T > A | n/a | 0.010 |
| 35720279 | g.26470551A > G | n/a | 0.005 |
| 35720105 | g.26470377G > T | n/a | 0.005 |
| 35719590 | g.26469862C > T | n/a | 0.005 |
| 35719588 | g.26469860C > T | n/a | 0.005 |
| 35719506 | g.26469778A > G | rs11964534 | 0.005 |
| 35719211 | g.26469483A > G | rs58549426 | 0.005 |
| 35719210 | g.26469482T > A | rs9394307 | 0.370 |
| 35718951 | g.26469223C > T | n/a | 0.005 |
| 35718729 | g.26469001T > A | rs12527329 | 0.089 |
| 35718659 | g.26468931A > G | rs2143404 | 0.120 |
| 35718568 | c.12T > C | n/a | 0.005 |
| 35718375 | c.105 + 100T > G | rs7740621 | 0.005 |
| 35718318 | c.105 + 157G > A | rs12110366 | 0.031 |
| 35718286 | c.105 + 189G > T | rs6902124 | 0.281 |
| 35718242 | c.105 + 233C > T | n/a | 0.010 |
| 35718193 | c.105 + 282T > C | rs9348979 | 0.302 |
| 35717792 | c.105 + 683A > G | rs7756437 | 0.083 |
| 35717594 | c.105 + 881A > G | rs60103601 | 0.005 |
| 35717470 | c.105 + 1005G > T | n/a | 0.005 |
| 35717408 | c.105 + 1067T > A | n/a | 0.005 |
| 35717407 | c.105 + 1068T > G | n/a | 0.005 |
| 35716907 | c.105 + 1568A > T | rs71569306 | 0.010 |
| 35716217 | c.105 + 2258C > T | n/a | 0.010 |
| 35716117 | c.105 + 2358T > C | n/a | 0.005 |
| 35716074 | c.105 + 2401A > G | rs55922240 | 0.094 |
| 35715933 | c.105 + 2542G > A | rs73748206 | 0.026 |
| 35715599 | c.105 + 2876G > A | rs7763114 | 0.005 |
| 35715549 | c.105 + 2926A > G | rs1360780 | 0.281 |
| 35715475 | c.105 + 3000G > C | n/a | 0.005 |
| 35715307 | c.105 + 3168C > T | n/a | 0.005 |
| 35715301 | c.105 + 3174C > T | n/a | 0.005 |
| 35714942 | c.105 + 3533T > G | n/a | 0.005 |
| 35714442 | c.105 + 4033T > C | n/a | 0.005 |
| 35714379 | c.105 + 4096G > A | rs58873316 | 0.026 |
| 35714239 | c.105 + 4236A > T | n/a | 0.010 |
| 35714156 | c.105 + 4319A > G | n/a | 0.010 |
| 35713845 | c.105 + 4630A > G | n/a | 0.005 |
| 35713178 | c.105 + 5297T > C | rs7751598 | 0.286 |
| 35712673 | c.250 + 96A > T | rs73748205 | 0.031 |
| 35712623 | c.250 + 146T > C | rs7746850 | 0.146 |
| 35712085 | c.250 + 684C > T | rs1591365 | 0.292 |
| 35711567 | c.250 + 1202T > C | rs72921237 | 0.021 |
| 35711180 | c.250 + 1589G > A | n/a | 0.010 |
| 35711097 | c.250 + 1672A > G | rs7760951 | 0.156 |
| 35710973 | c.250 + 1796G > A | n/a | 0.021 |
| 35710950 | c.250 + 1819G > A | rs7740395 | 0.156 |
| 35710715 | c.250 + 2054G > A | n/a | 0.010 |
| 35710506 | c.250 + 2263G > A | n/a | 0.005 |
| 35710488 | c.250 + 2281T > C | n/a | 0.005 |
| 35709754 | c.250 + 3015T > A | rs3798347 | 0.281 |
| 35709507 | c.250 + 3262C > T | rs28675670 | 0.031 |
| 35709326 | c.250 + 3443T > G | rs4713901 | 0.005 |
| 35709234 | c.250 + 3535C > T | n/a | 0.005 |
| 35709112 | c.250 + 3657T > C | n/a | 0.005 |
| 35708902 | c.250 + 3867T > A | n/a | 0.005 |
| 35708640 | c.250 + 4129C > T | n/a | 0.005 |
| 35708422 | c.250 + 4347T > C | rs57985230 | 0.005 |
| 35707732 | c.250 + 5037C > A | n/a | 0.021 |
| 35707494 | c.250 + 5275C > T | n/a | 0.005 |
| 35707460 | c.250 + 5309A > G | n/a | 0.005 |
| 35707420 | c.250 + 5349C > T | n/a | 0.005 |
| 35706929 | c.250 + 5840A > G | n/a | 0.005 |
| 35706738 | c.250 + 6031A > G | n/a | 0.005 |
| 35706366 | c.250 + 6403G > T | n/a | 0.005 |
| 35706295 | c.250 + 6474C > T | n/a | 0.005 |
| 35706111 | c.250 + 6658G > A | n/a | 0.005 |
| 35705868 | c.250 + 6901T > A | n/a | 0.026 |
| 35705681 | c.250 + 7088T > G | rs16879378 | 0.036 |
| 35705603 | c.250 + 7166T > G | n/a | 0.005 |
| 35704890 | c.250 + 7879G > A | rs10947562 | 0.083 |
| 35704738 | c.250 + 8031G > T | n/a | 0.005 |
| 35704592 | c.250 + 8177G > A | n/a | 0.010 |
| 35703459 | c.250 + 9310G > A | n/a | 0.005 |
| 35703114 | c.250 + 9655G > T | n/a | 0.005 |
| 35702822 | c.250 + 9947T > A | n/a | 0.005 |
| 35702819 | c.250 + 9950G > A | n/a | 0.036 |
| 35702644 | c.250 + 10125A > G | n/a | 0.021 |
| 35702549 | c.250 + 10220C > A | n/a | 0.005 |
| 35701961 | c.250 + 10808T > C | rs7747121 | 0.036 |
| 35701836 | c.250 + 10933C > T | rs7743425 | 0.026 |
| 35701743 | c.250 + 11026G > A | n/a | 0.010 |
| 35701679 | c.250 + 11090G > A | n/a | 0.010 |
| 35701378 | c.250 + 11391G > A | n/a | 0.005 |
| 35700808 | c.250 + 11961G > A | n/a | 0.005 |
| 35700795 | c.250 + 11974G > C | n/a | 0.005 |
| 35700722 | c.250 + 12047A > G | rs7748266 | 0.141 |
| 35700518 | c.250 + 12251A > G | n/a | 0.016 |
| 35699311 | c.250 + 13458G > A | rs62402121 | 0.021 |
| 35699196 | c.250 + 13573G > A | n/a | 0.005 |
| 35699020 | c.250 + 13749C > G | n/a | 0.005 |
| 35698890 | c.250 + 13879G > C | rs4713900 | 0.224 |
| 35698809 | c.250 + 13960G > T | n/a | 0.005 |
| 35698725 | c.250 + 14044A > G | n/a | 0.005 |
| 35698672 | c.250 + 14097C > T | n/a | 0.005 |
| 35698540 | c.250 + 14229T > C | rs73417655 | 0.010 |
| 35698369 | c.250 + 14400T > G | rs16879318 | 0.036 |
| 35698253 | c.250 + 14516C > T | n/a | 0.031 |
| 35698136 | c.250 + 14633A > G | n/a | 0.016 |
| 35698135 | c.250 + 14634T > G | n/a | 0.026 |
| 35698070 | c.250 + 14699C > T | rs7754668 | 0.089 |
| 35697727 | c.250 + 15042G > A | n/a | 0.010 |
| 35697615 | c.250 + 15154A > G | rs72921231 | 0.089 |
| 35697604 | c.250 + 15165C > T | n/a | 0.005 |
| 35697409 | c.250 + 15360C > T | rs7749799 | 0.005 |
| 35697048 | c.250 + 15721G > T | rs9380524 | 0.089 |
| 35696209 | c.250 + 16560G > A | n/a | 0.036 |
| 35695811 | c.250 + 16958A > T | n/a | 0.005 |
| 35695283 | c.393 + 154T > C | n/a | 0.005 |
| 35694351 | c.508 + 500C > T | rs747411 | 0.094 |
| 35693663 | c.508 + 1188C > T | n/a | 0.005 |
| 35693592 | c.508 + 1259G > A | rs9368878 | 0.286 |
| 35693577 | c.508 + 1274T > A | n/a | 0.005 |
| 35693477 | c.508 + 1374C > T | n/a | 0.005 |
| 35693257 | c.508 + 1594T > G | n/a | 0.031 |
| 35692989 | c.508 + 1862A > T | n/a | 0.005 |
| 35692922 | c.508 + 1929A > G | n/a | 0.010 |
| 35692412 | c.508 + 2439C > T | rs73748204 | 0.026 |
| 35692127 | c.508 + 2724A > G | n/a | 0.005 |
| 35692033 | c.508 + 2818T > C | rs4401662 | 0.151 |
| 35691301 | c.508 + 3550T > C | n/a | 0.005 |
| 35691064 | c.508 + 3787C > T | n/a | 0.005 |
| 35690739 | c.508 + 4112C > T | n/a | 0.016 |
| 35690639 | c.508 + 4212C > G | rs9470069 | 0.083 |
| 35690252 | c.508 + 4599A > T | n/a | 0.005 |
| 35689864 | c.508 + 4987C > A | n/a | 0.031 |
| 35689781 | c.508 + 5070C > G | rs72913427 | 0.094 |
| 35689604 | c.508 + 5247G > T | rs73748203 | 0.031 |
| 35689545 | c.508 + 5306A > G | n/a | 0.005 |
| 35688972 | c.508 + 5879T > C | n/a | 0.005 |
| 35688782 | c.508 + 6069A > G | rs9462099 | 0.005 |
| 35688727 | c.508 + 6124G > A | rs58327994 | 0.005 |
| 35688514 | c.508 + 6337G > C | n/a | 0.031 |
| 35688276 | c.508 + 6575A > G | rs6457836 | 0.151 |
| 35688016 | c.508 + 6835G > A | n/a | 0.005 |
| 35687353 | c.508 + 7498T > G | rs6926133 | 0.146 |
| 35687015 | c.508 + 7836A > C | n/a | 0.005 |
| 35686980 | c.508 + 7871T > C | rs3777747 | 0.469 |
| 35686829 | c.508 + 8022T > C | rs73746499 | 0.031 |
| 35686500 | c.508 + 8351T > C | n/a | 0.005 |
| 35686317 | c.508 + 8534G > A | n/a | 0.010 |
| 35686162 | c.508 + 8689T > G | n/a | 0.031 |
| 35685126 | c.508 + 9725A > G | n/a | 0.005 |
| 35684834 | c.508 + 10017C > T | rs9470067 | 0.016 |
| 35684700 | c.508 + 10151C > T | n/a | 0.005 |
| 35684023 | c.508 + 10828A > G | n/a | 0.005 |
| 35683896 | c.508 + 10955C > T | rs10807152 | 0.156 |
| 35683685 | c.508 + 11166T > C | rs72913423 | 0.078 |
| 35683634 | c.508 + 11217T > C | rs11966198 | 0.036 |
| 35683465 | c.508 + 11386C > T | rs737054 | 0.300 |
| 35683450 | c.508 + 11401G > A | n/a | 0.005 |
| 35683356 | c.508 + 11495G > A | rs11961270 | 0.005 |
| 35682892 | c.508 + 11959G > A | n/a | 0.005 |
| 35682393 | c.508 + 12458G > C | n/a | 0.005 |
| 35682327 | c.508 + 12524T > C | n/a | 0.005 |
| 35682212 | c.508 + 12639T > A | n/a | 0.005 |
| 35682134 | c.508 + 12717G > A | n/a | 0.005 |
| 35682021 | c.508 + 12830G > A | n/a | 0.047 |
| 35681972 | c.508 + 12879C > T | n/a | 0.005 |
| 35681866 | c.508 + 12985G > A | n/a | 0.031 |
| 35681726 | c.508 + 13125C > A | n/a | 0.005 |
| 35681455 | c.508 + 13396G > A | n/a | 0.005 |
| 35681188 | c.508 + 13663A > G | n/a | 0.005 |
| 35681172 | c.508 + 13679T > C | n/a | 0.005 |
| 35681050 | c.508 + 13801G > T | rs11969602 | 0.005 |
| 35680857 | c.508 + 13994T > G | n/a | 0.010 |
| 35680839 | c.508 + 14012C > T | rs73417635 | 0.005 |
| 35680627 | c.508 + 14224G > T | n/a | 0.026 |
| 35680605 | c.508 + 14246C > G | n/a | 0.005 |
| 35680283 | c.508 + 14568A > G | n/a | 0.005 |
| 35679769 | c.508 + 15082C > A | n/a | 0.005 |
| 35679757 | c.508 + 15094C > T | n/a | 0.010 |
| 35679450 | c.508 + 15401G > T | n/a | 0.031 |
| 35679063 | c.508 + 15788A > C | n/a | 0.021 |
| 35678460 | c.508 + 16391C > T | rs73746498 | 0.031 |
| 35678453 | c.508 + 16398C > T | n/a | 0.005 |
| 35678384 | c.508 + 16467C > T | n/a | 0.010 |
| 35677874 | c.508 + 16977G > A | rs57744001 | 0.005 |
| 35677607 | c.508 + 17244A > C | n/a | 0.005 |
| 35677540 | c.508 + 17311T > C | rs16878812 | 0.115 |
| 35677417 | c.508 + 17434A > C | n/a | 0.005 |
| 35677259 | c.508 + 17592T > C | rs4713899 | 0.151 |
| 35677097 | c.508 + 17754A > G | rs16878806 | 0.031 |
| 35676859 | c.508 + 17992A > T | n/a | 0.016 |
| 35676040 | c.508 + 18811G > A | n/a | 0.005 |
| 35675887 | c.508 + 18964A > G | n/a | 0.021 |
| 35675783 | c.508 + 19068G > T | n/a | 0.005 |
| 35675738 | c.508 + 19113T > C | rs2395634 | 0.271 |
| 35675642 | c.508 + 19209G > A | rs2395633 | 0.151 |
| 35675066 | c.508 + 19785A > G | rs11961905 | 0.005 |
| 35675060 | c.508 + 19791T > C | rs9296158 | 0.271 |
| 35674338 | c.508 + 20513T > C | n/a | 0.005 |
| 35674126 | c.508 + 20725A > G | n/a | 0.031 |
| 35674111 | c.508 + 20740C > T | n/a | 0.031 |
| 35674039 | c.508 + 20812C > T | n/a | 0.005 |
| 35673999 | c.508 + 20852C > T | n/a | 0.031 |
| 35673984 | c.508 + 20867T > C | n/a | 0.005 |
| 35673715 | c.508 + 21136T > C | n/a | 0.016 |
| 35672895 | c.665 + 108G > A | n/a | 0.005 |
| 35672403 | c.665 + 600C > A | rs73746495 | 0.031 |
| 35672321 | c.665 + 682A > T | n/a | 0.010 |
| 35672238 | c.665 + 765T > C | n/a | 0.005 |
| 35671770 | c.665 + 1233A > G | n/a | 0.010 |
| 35671033 | c.665 + 1970A > G | n/a | 0.005 |
| 35670952 | c.665 + 2051A > T | rs9366890 | 0.151 |
| 35670716 | c.665 + 2287C > T | n/a | 0.005 |
| 35670618 | c.665 + 2385T > C | rs3798346 | 0.266 |
| 35670449 | c.665 + 2554A > G | rs3798345 | 0.188 |
| 35670041 | c.665 + 2962G > A | n/a | 0.005 |
| 35669640 | c.665 + 3363G > C | n/a | 0.005 |
| 35669528 | c.665 + 3475C > T | n/a | 0.005 |
| 35669435 | c.665 + 3568C > T | n/a | 0.005 |
| 35669413 | c.665 + 3590C > T | n/a | 0.005 |
| 35669209 | c.665 + 3794T > G | n/a | 0.005 |
| 35669064 | c.665 + 3939A > G | n/a | 0.005 |
| 35669027 | c.665 + 3976G > A | n/a | 0.016 |
| 35668630 | c.665 + 4373G > T | n/a | 0.005 |
| 35668035 | c.665 + 4968A > C | n/a | 0.005 |
| 35668026 | c.665 + 4977C > G | rs7754690 | 0.016 |
| 35667880 | c.665 + 5123T > G | n/a | 0.005 |
| 35667751 | c.665 + 5252T > G | rs10498734 | 0.073 |
| 35667444 | c.665 + 5559C > T | n/a | 0.005 |
| 35667354 | c.665 + 5649G > C | n/a | 0.005 |
| 35666700 | c.756 + 185C > G | n/a | 0.005 |
| 35666375 | c.756 + 510G > C | n/a | 0.005 |
| 35665989 | c.756 + 896C > G | n/a | 0.005 |
| 35665809 | c.756 + 1076A > G | n/a | 0.005 |
| 35665612 | c.756 + 1273T > C | n/a | 0.005 |
| 35665513 | c.756 + 1372C > G | n/a | 0.005 |
| 35665341 | c.756 + 1544C > T | n/a | 0.010 |
| 35664498 | c.756 + 2387T > C | rs7771727 | 0.120 |
| 35663972 | c.756 + 2913C > T | n/a | 0.005 |
| 35663820 | c.756 + 3065C > T | n/a | 0.005 |
| 35663161 | c.756 + 3724G > T | rs992105 | 0.135 |
| 35663088 | c.756 + 3797G > A | rs2294807 | 0.073 |
| 35663034 | c.756 + 3851A > C | rs73746494 | 0.031 |
| 35662697 | c.840 + 92A > G | n/a | 0.005 |
| 35662244 | c.840 + 545 G > A | n/a | 0.036 |
| 35662217 | c.840 + 572A > G | n/a | 0.005 |
| 35662130 | c.840 + 659T > C | n/a | 0.005 |
| 35662049 | c.840 + 740C > T | n/a | 0.010 |
| 35661323 | c.840 + 1466T > C | rs73746493 | 0.026 |
| 35661322 | c.840 + 1467C > T | rs73746492 | 0.026 |
| 35661029 | c.840 + 1760C > A | n/a | 0.005 |
| 35660605 | c.840 + 2184T > C | rs16878591 | 0.026 |
| 35660247 | c.840 + 2542A > G | n/a | 0.005 |
| 35660167 | c.840 + 2622A > G | rs73746491 | 0.031 |
| 35660042 | c.840 + 2747C > T | n/a | 0.005 |
| 35659977 | c.840 + 2812A > G | n/a | 0.005 |
| 35659910 | c.840 + 2879G > A | n/a | 0.005 |
| 35659758 | c.840 + 3031G > T | n/a | 0.005 |
| 35659646 | c.840 + 3143C > T | n/a | 0.021 |
| 35659391 | c.840 + 3398A > T | rs7755289 | 0.005 |
| 35659189 | c.840 + 3600A > G | n/a | 0.005 |
| 35659007 | c.840 + 3782A > G | rs7754640 | 0.005 |
| 35658893 | c.840 + 3896T > C | rs59320339 | 0.026 |
| 35658349 | c.840 + 4440A > G | n/a | 0.005 |
| 35658181 | c.840 + 4608A > G | rs73746490 | 0.031 |
| 35657648 | c.840 + 5141G > A | rs755658 | 0.073 |
| 35657632 | c.840 + 5157G > A | n/a | 0.005 |
| 35657623 | c.840 + 5166G > A | n/a | 0.005 |
| 35657471 | c.840 + 5318T > C | n/a | 0.005 |
| 35657239 | c.840 + 5550C > T | n/a | 0.005 |
| 35657127 | c.840 + 5662C > T | n/a | 0.005 |
| 35656657 | c.840 + 6132T > C | n/a | 0.005 |
| 35656578 | c.840 + 6211C > T | n/a | 0.005 |
| 35656538 | c.840 + 6251G > A | n/a | 0.005 |
| 35656386 | c.840 + 6403G > A | n/a | 0.031 |
| 35656375 | c.840 + 6414G > C | n/a | 0.005 |
| 35656214 | c.840 + 6575C > T | rs7757037 | 0.464 |
| 35655699 | c.1026 + 92G > A | n/a | 0.005 |
| 35655201 | c.1026 + 590T > C | n/a | 0.016 |
| 35654872 | c.1026 + 919T > C | rs61188051 | 0.026 |
| 35654383 | c.1026 + 1408A > G | n/a | 0.036 |
| 35654294 | c.1026 + 1497A > G | n/a | 0.005 |
| 35654286 | c.1026 + 1505T > A | n/a | 0.005 |
| 35653979 | c.1026 + 1812G > A | n/a | 0.005 |
| 35653966 | c.1026 + 1825C > A | n/a | 0.005 |
| 35653630 | c.1026 + 2161C > T | n/a | 0.005 |
| 35652920 | c.1095C > T | rs34866878 | 0.031 |
| 35652700 | c.1266 + 49C > T | n/a | 0.005 |
| 35652647 | c.1266 + 102C > T | n/a | 0.005 |
| 35652008 | c.1266 + 741A > C | rs56002954 | 0.031 |
| 35651973 | c.1266 + 776C > T | rs45586932 | 0.026 |
| 35651356 | c.*234G > A | n/a | 0.005 |
| 35651255 | c.*335G > A | n/a | 0.005 |
| 35650642 | c.*948T > C | n/a | 0.005 |
| 35650567 | c.*1023G > A | n/a | 0.005 |
| 35650504 | c.*1086A > T | rs11545925 | 0.073 |
| 35650454 | c.*1136G > T | rs3800373 | 0.240 |
| 35650023 | c.*1567G > T | rs41270080 | 0.031 |
| 35649974 | c.*1616A > G | n/a | 0.005 |
| 35649837 | c.*1753C > T | n/a | 0.005 |
| 35649597 | c.*1993G > A | n/a | 0.005 |
| 35649410 | c.*2180A > T | rs11545924 | 0.094 |
| 35649409 | c.*2181A > T | n/a | 0.005 |
| 35649036 | g.26399308G > A | rs12055438 | 0.245 |
| 35648846 | g.26399118G > A | rs10807151 | 0.141 |
| 35648827 | g.26399099T > G | n/a | 0.005 |
| 35648823 | g.26399095G > C | n/a | 0.005 |
| | Indel | | |
| 35799741 | g.26550013delA | n/a | 0.005 |
| 35797853 | g.26548125delG | rs56362135 | 0.245 |
| 35797103 | g.26547375delT | n/a | 0.458 |
| 35796662 | g.26538675delA | rs10710071 | 0.234 |
| 35792528 | g.26542800_26542801insC | rs34618058 | 0.240 |
| 35784332 | g.26534604delA | rs34417388 | 0.365 |
| 35781866-35781863 | g.26532138_26532135delTTTG | n/a | 0.005 |
| 35780465 | g.26530737delA | rs34727090 | 0.370 |
| 35780348 | g.26530620delA | rs35718174 | 0.458 |
| 35778129 | g.26528400_26528401insC | n/a | 0.224 |
| 35778124 | g.26528396delT | n/a | 0.104 |
| 35776865-35776864 | g.26527137_26527136delAC | n/a | 0.005 |
| 35776541-35776540 | g.26526813_26526812delAG | n/a | 0.005 |
| 35772111 | g.26522382_26522383insT | n/a | 0.021 |
| 35769411 | g.26519683delT | rs35253763 | 0.302 |
| 35769299 | g.26519570_26519571insGACT | n/a | 0.005 |
| 35762578 | g.26512849_26512850insA | rs59134480 | 0.021 |
| 35762134 | g.26512405_26512406insAA | rs10637154 | 0.026 |
| 35760816 | g.26511088delT | n/a | 0.375 |
| 35759226 | g.26509498delA | n/a | 0.161 |
| 35749569-35749568 | g.26499841_26499840delCT | n/a | 0.005 |
| 35748516 | g.26498787_26498788insT | rs11412183 | 0.307 |
| 35745279 | g.26495550_26495551insT | n/a | 0.005 |
| 35742835 | g.26493107delT | n/a | 0.021 |
| 35742300 | g.26492571_26492572insT | n/a | 0.010 |
| 35741117-35741109 | g.26491389_26491381delTGAGCCGAG | n/a | 0.010 |
| 35734411-35737722 | g.26487994_26484683del3312 | rs67674318 | ND |
| 35732811 | g.26483083delT | rs35090133 | 0.484 |
| 35728171 | g.26478443delG | n/a | 0.005 |
| 35725188 | g.26475459_26475460insA | rs35993478 | 0.370 |
| 35723845-35723844 | g.26474117_26474116delCT | rs66503860 | 0.083 |
| 35710471-35710469 | c.250 + 2298_250 + 2300delAAG | rs66500202 | 0.286 |
| 35705268-35705265 | c.250 + 7501_250 + 7504delGTTT | n/a | 0.005 |
| 35700253 | c.250 + 12516delA | rs35508106 | 0.338 |
| 35693077 | c.508 + 1774delA | n/a | 0.417 |
| 35691495 | c.508 + 3355_508 + 3356insTT | n/a | 0.005 |
| 35688972 | c.508 + 5878_508 + 5879insA | n/a | 0.005 |
| 35684932 | c.508 + 9919delA | n/a | 0.344 |
| 35681536-35681534 | c.508 + 13315_508 + 13317delGAG | n/a | 0.005 |
| 35681319 | c.508 + 13532delA | n/a | 0.005 |
| 35679933-35679931 | c.508 + 14918_508 + 14920delCAA | n/a | 0.036 |
| 35677917 | c.508 + 16934delT | n/a | 0.089 |
| 35674866-35674862 | c.508 + 19985_508 + 19989delAAGTA | rs66525542 | 0.172 |
| 35674754 | c.508 + 20096_508 + 20097insT | n/a | 0.005 |
| 35670466-35670465 | c.665 + 2537_665 + 2538delAT | n/a | 0.005 |
| 35668619 | c.665 + 4384delG | rs35236464 | 0.068 |
| 35663769-35663767 | c.756 + 3116_756 + 3118delTAA | n/a | 0.313 |
| 35662620-35662619 | c.840 + 169_840 + 170delAT | n/a | 0.005 |
| 35659104 | c.840 + 3685delT | rs35283903 | 0.005 |
| 35658834 | c.840 + 3954_840 + 3955insAG | rs10631894 | 0.036 |
| 35657920-35657916 | c.840 + 4869_840 + 4873delCTCCT | n/a | 0.031 |
| 35656659-35656654 | c.840 + 6130_840 + 6135delCTTTTC | n/a | 0.005 |
| 35654861-35654856 | c.1026 + 930_1026 + 935delTGCCCA | n/a | 0.005 |
| 35654729 | c.1026 + 1061_1026 + 1062insAC | rs34629132 | 0.245 |
| 35651298 | c.*292delA | n/a | 0.005 |
| 35651198 | c.*392delA | n/a | 0.480 |
| 35649349 | c.*2240_2241insA | n/a | 0.005 |

### The Overlap Region

When the 160 kb region was amplified, it was divided into two sections: chr6:35805383-35749634 and 35768636-35648407. This created an overlap of 19,002 bp. Because the 19 kb area was situated between two of the LR-PCR amplicons, there were two different amplifications of the same area. Consequently, the duplicates were compared and used as a built-in quality control. Overall, there were 66 polymorphisms within this region, and most were duplicates. The duplicates mostly showed identical genotypes, and the non-duplicates could be explained by inconsistent coverage in either of the two amplicons. However, there were some exceptions. For example, it was discovered that eight samples had primer SNPs, and preferential amplification of an allele was occurring (Mutter and Boynton, Nucleic Acids Research, 23(8):1411-8 (1995); Walsh et al., PCR Methods Applications, 1(4):241-50 (1992); Quinlanand and Marth, Nature Methods, 4(3):192 (2007)). The LR-PCR conditions were also different between these two amplifications, causing some differences, especially when there was an indel in the vicinity, thus causing additional PCR bias. Where this occurred, all 18 columns plus coverage were taken into account, and the majority genotype with the highest coverage was designated as correct. Because there was not coverage over the entire 160 kb with more than one amplicon, the missed heterozygote rate (MHR) was minimized by building in leniency to the threshold frequencies for alternate and reference alleles in the variant parameters. This was done by excluding a cut-off for the reference.

### Validation

Several measures were taken to validate results. On a broader scale, heterozygosity (r), was calculated for the entire 160 kb region, as well as regions within the gene structure (Table 8). These values were striking, showing a 40-fold difference (π=0.00002−0.0008) between flanking regions, introns and Untranslated Regions (UTR), intimating unique genetic histories at these loci. Higher heterozygosity in GC-rich areas agreed with previous reports of similar findings (Sachidanandam et al., Nature, 409(6822):928-33 (2001)).

TABLE 8

| | | | | | | Number of | |
|---|---|---|---|---|---|---|---|
| | | | | | | SNPs | Number of |
| | | | | | | within | singletons |
| | | Heterozygosity | Length | GC | AT | each | in this |
| Region | Tajima's D | (π) ± SE | (bp) | content | content | region. | region |
| 5′FR | 0.512 | 0.0008 ± 0.0006 | 1045 | 59% | 41% | 4 | 2 |
| 5′UTR according to | −0.96 | 0.00003 ± 0.00003 | 297 | 60% | 40% | 2 | 1 |
| mRNA BC042605.1 | | | | | | | |
| Intron 1A | −0.58 | 0.0006 ± 0.0003 | 7959 | 52% | 48% | 40 | 16 |
| Intron 2A | −0.28 | 0.0006 ± 0.0003 | 31390 | 46% | 54% | 133 | 63 |
| 5′UTR according to | ND | ND | 153 | 73% | 27% | 0 | 0 |
| mRNA NM_004117.2 | | | | | | | |
| coding region | −1.09 | 0.00005 ± 0.0001 | 1374 | 45% | 55% | 2 | 1 |
| Intron 1 | −1.44 | 0.0003 ± 0.0001 | 45960 | 39% | 61% | 159 | 82 |
| Intron 2 | −1.37 | 0.0004 ± 0.0002 | 5561 | 39% | 61% | 27 | 13 |
| Intron 3 | −1.87 | 0.0002 ± 0.0001 | 16739 | 40% | 60% | 70 | 33 |
| Intron 4 | −1.29 | 0.00002 ± 0.00009 | 921 | 37% | 63% | 2 | 2 |
| Intron 5 | −1.81 | 0.0003 ± 0.0001 | 21691 | 40% | 60% | 97 | 50 |
| Intron 6 | −1.85 | 0.0002 ± 0.0001 | 6027 | 41% | 59% | 27 | 17 |
| Intron 7 | −1.65 | 0.0001 ± 0.0001 | 4012 | 43% | 57% | 13 | 8 |
| Intron 8 | −2.25 | 0.0002 ± 0.0001 | 6812 | 41% | 59% | 39 | 25 |
| Intron 9 | −2.04 | 0.00008 ± 0.0001 | 2802 | 39% | 61% | 10 | 7 |
| Intron 10 | −1.44 | 0.0001 ± 0.0002 | 1051 | 48% | 52% | 4 | 2 |
| 3′UTR | −1.64 | 0.0003 ± 0.0003 | 2245 | 40% | 60% | 14 | 10 |
| 3′FR | −0.13 | 0.0006 ± 0.0005 | 938 | 42% | 58% | 4 | 2 |

N.D. stands for “not-determined.”

### Nucleotide Diversity

For the entire 160 kb region, π=4×10⁻⁴ was obtained (Table 8). This value is much lower than expected, and the negative Tajima's D value of −1.44 conflicts with previous reports of this region on chromosome six as being under balancing selection. Upon inspection, the dissimilar reports were based on small data sets which disregarded low frequency polymorphisms. The complete NGS data shows a dramatic increase in low frequency polymorphisms, thus changing the landscape of evolutionary conclusions.

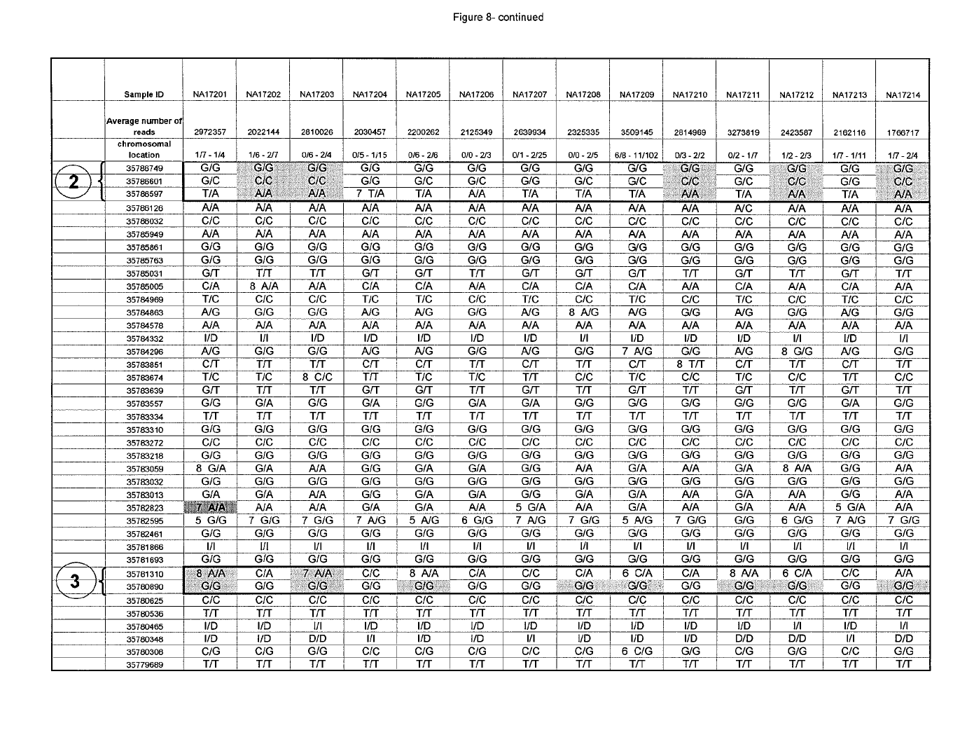

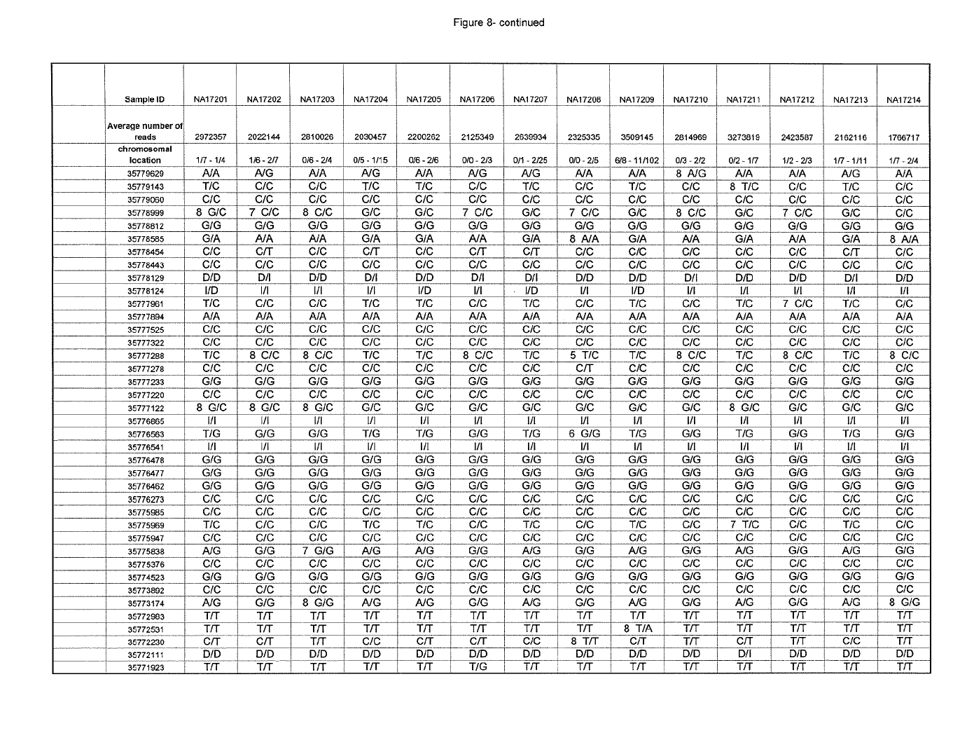

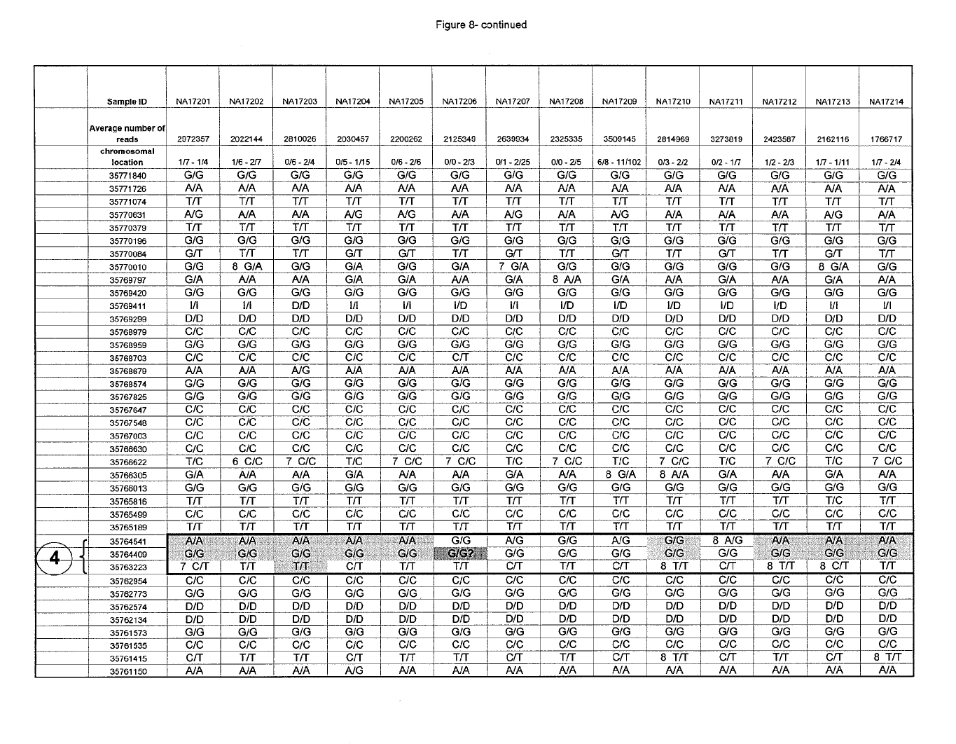

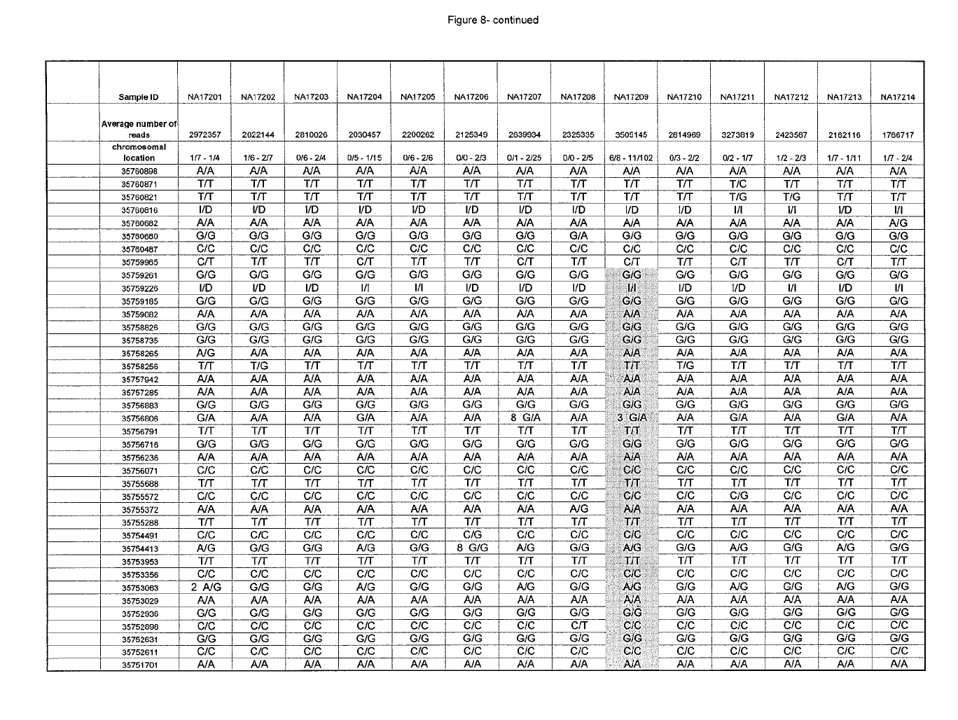

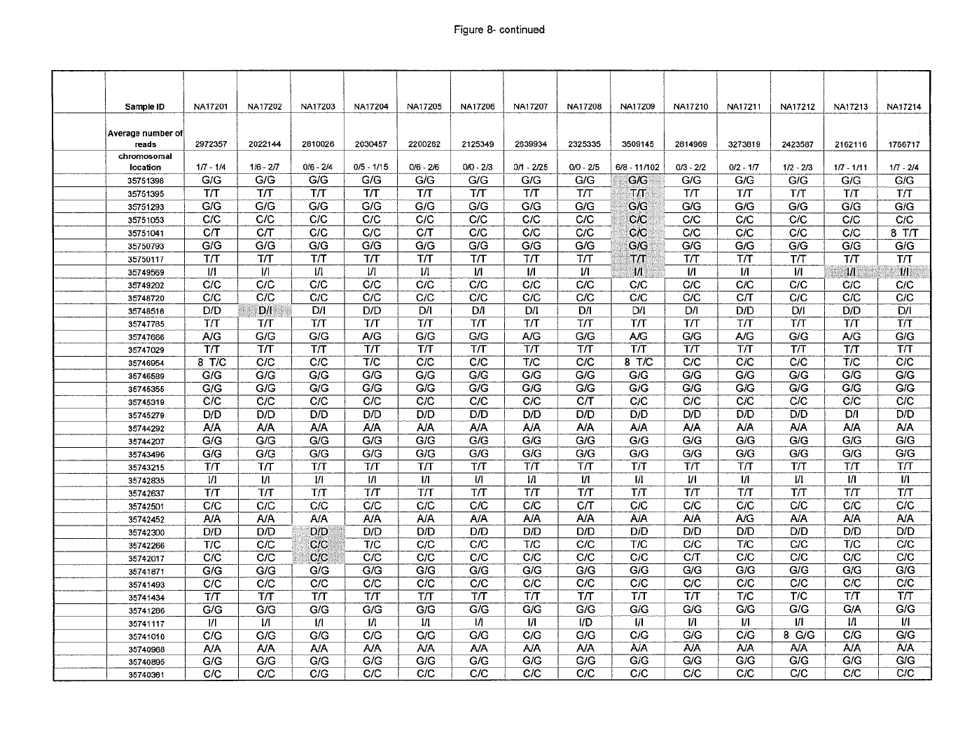

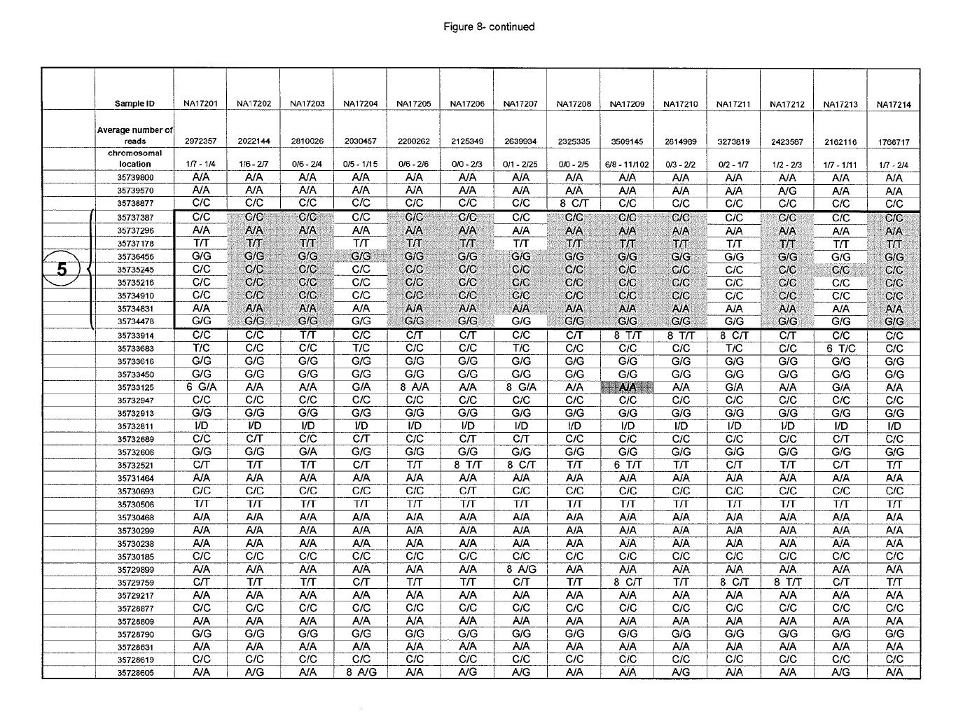

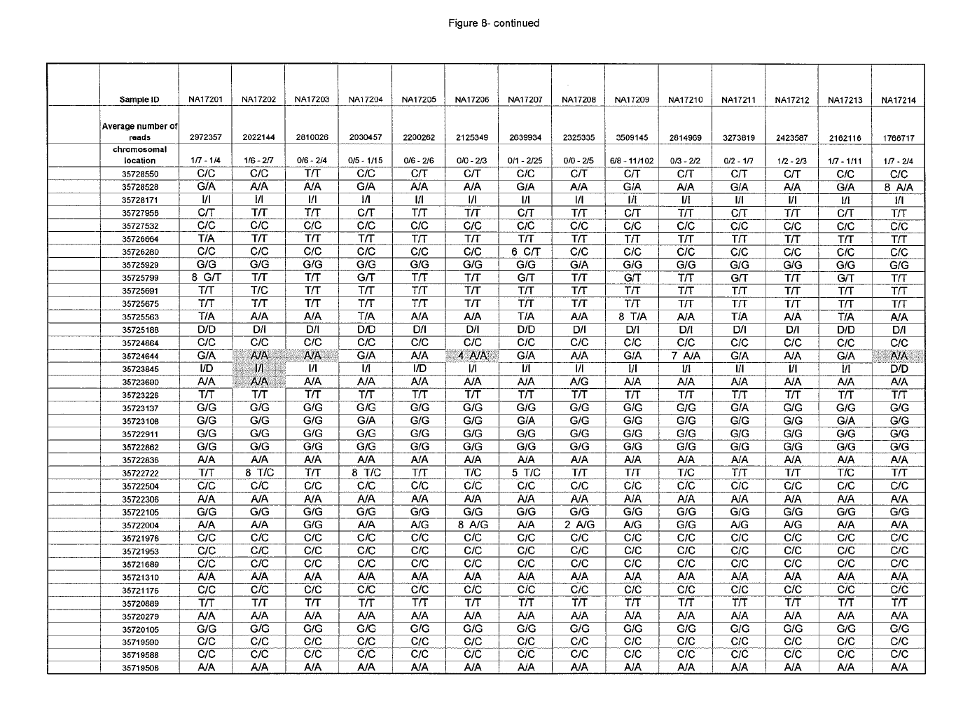

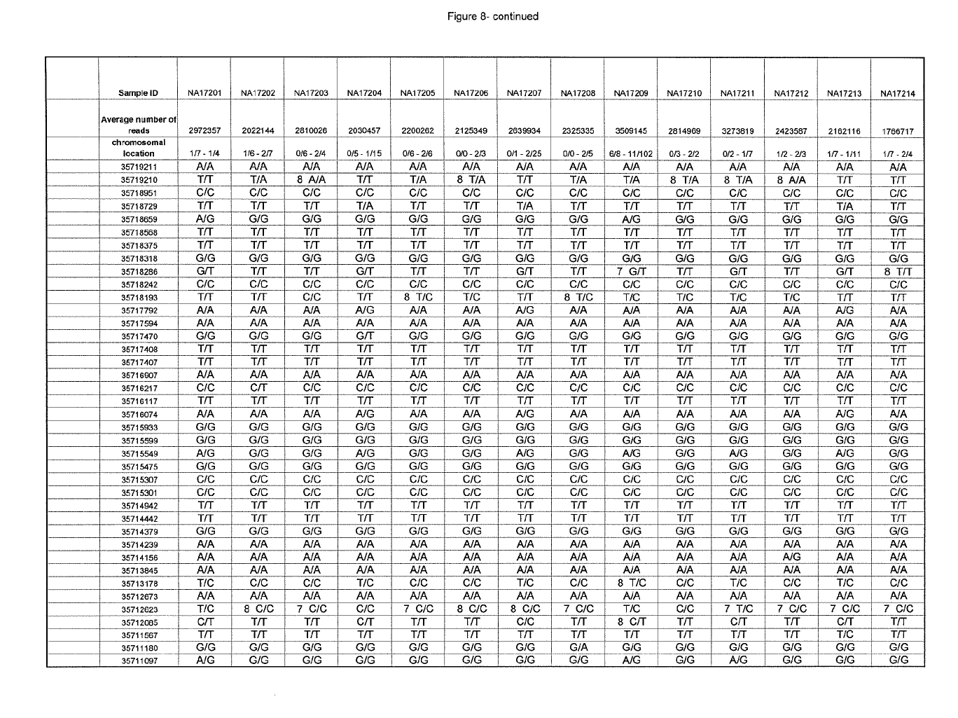

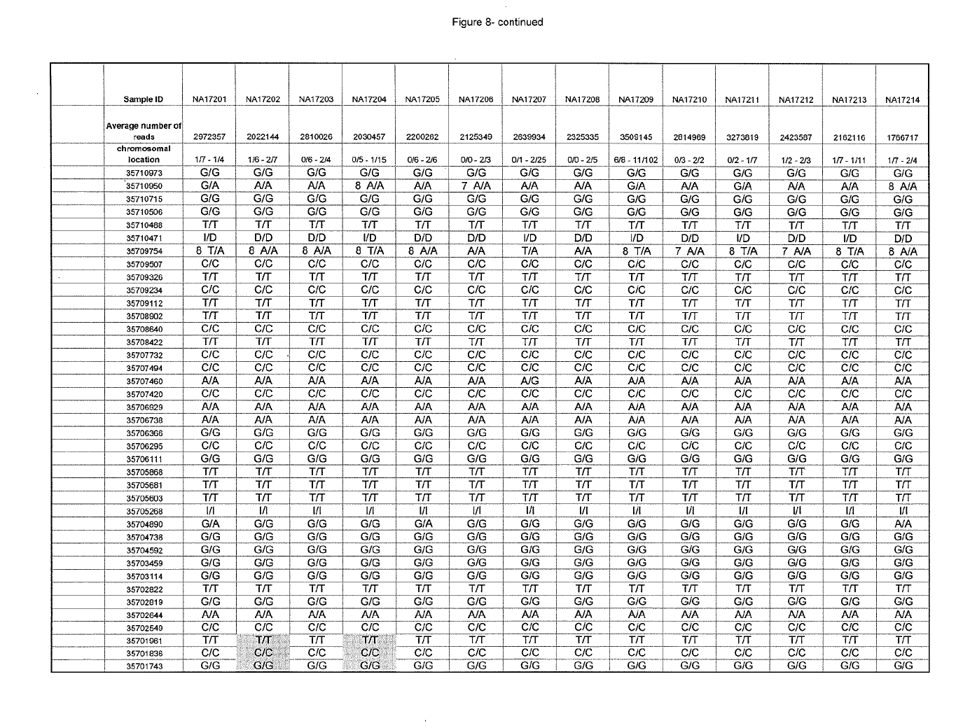

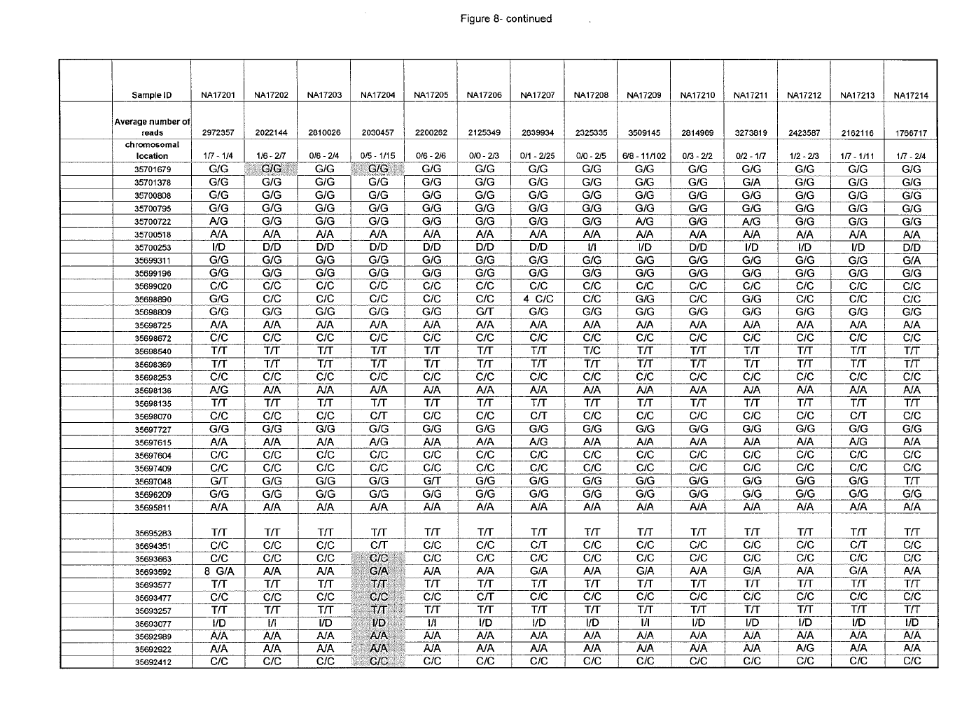

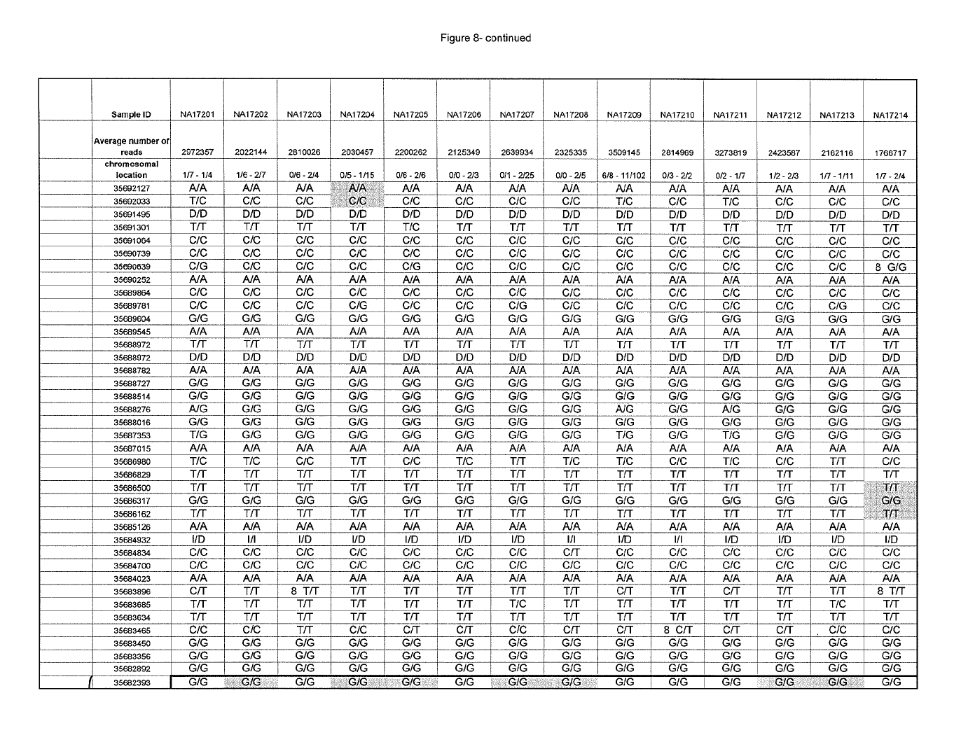

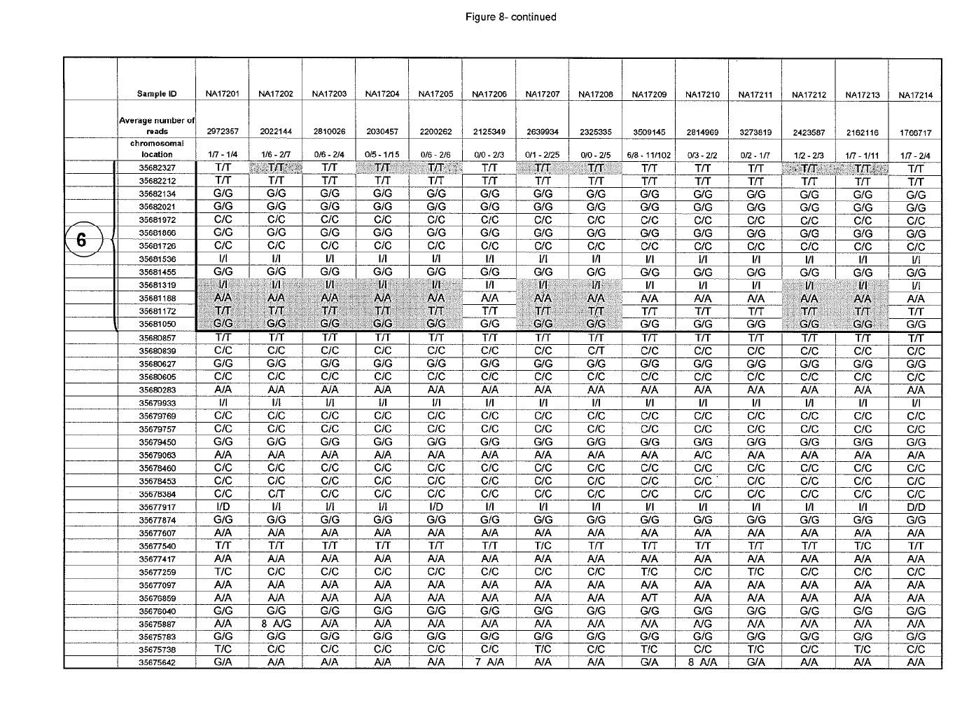

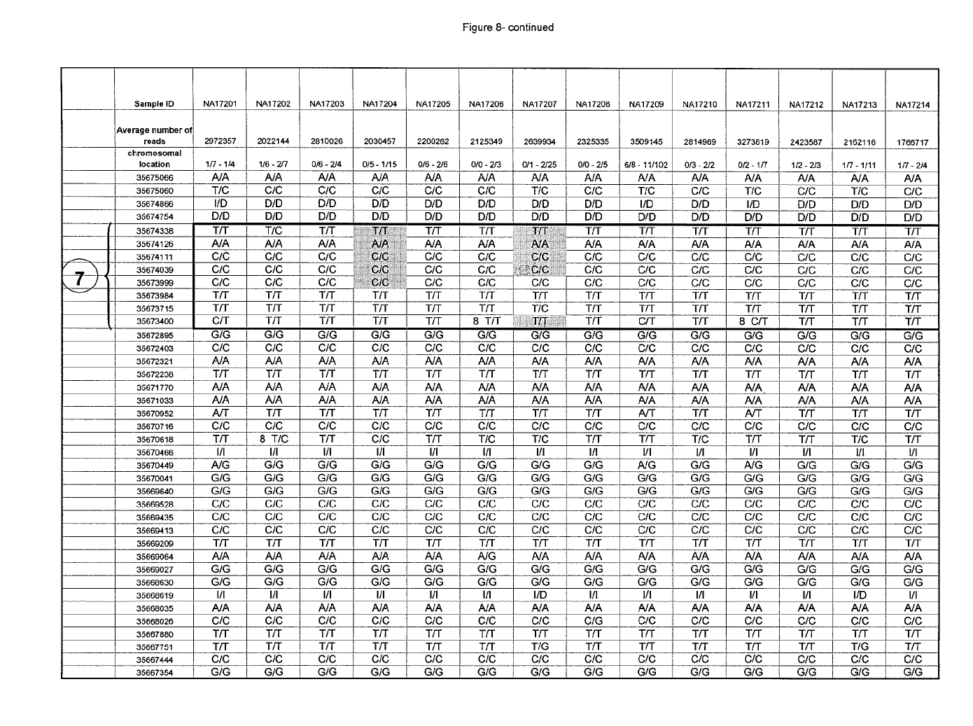

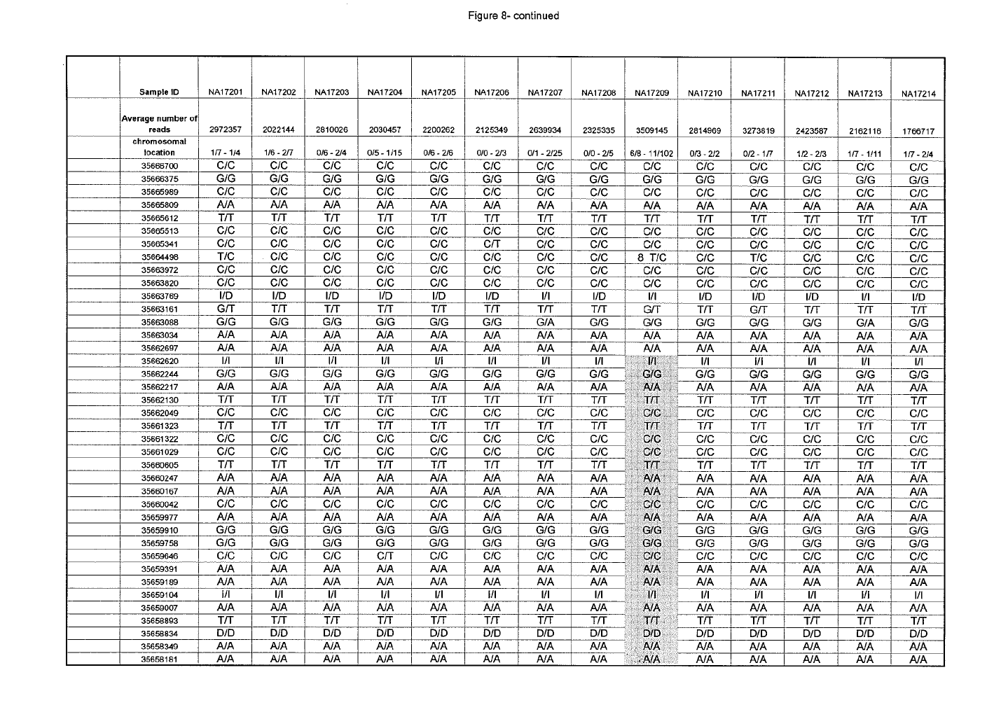

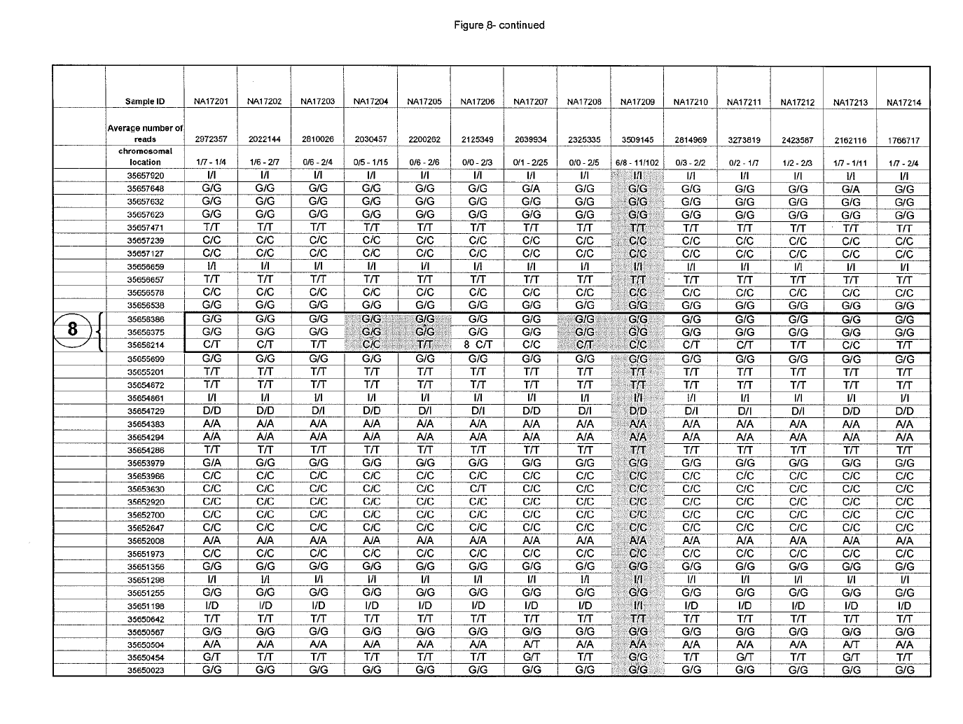

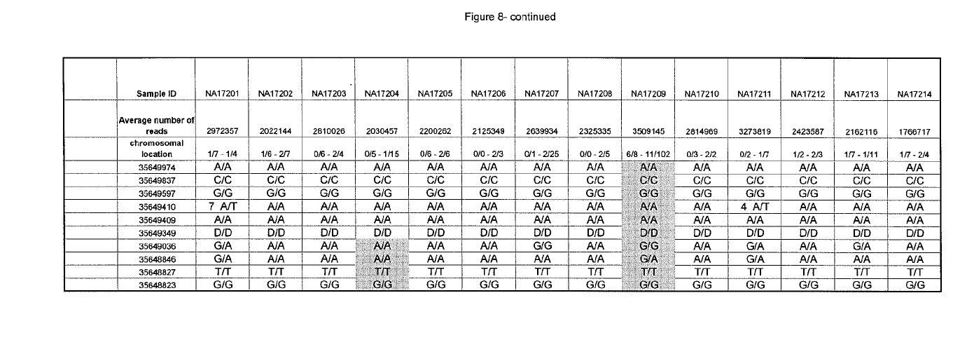

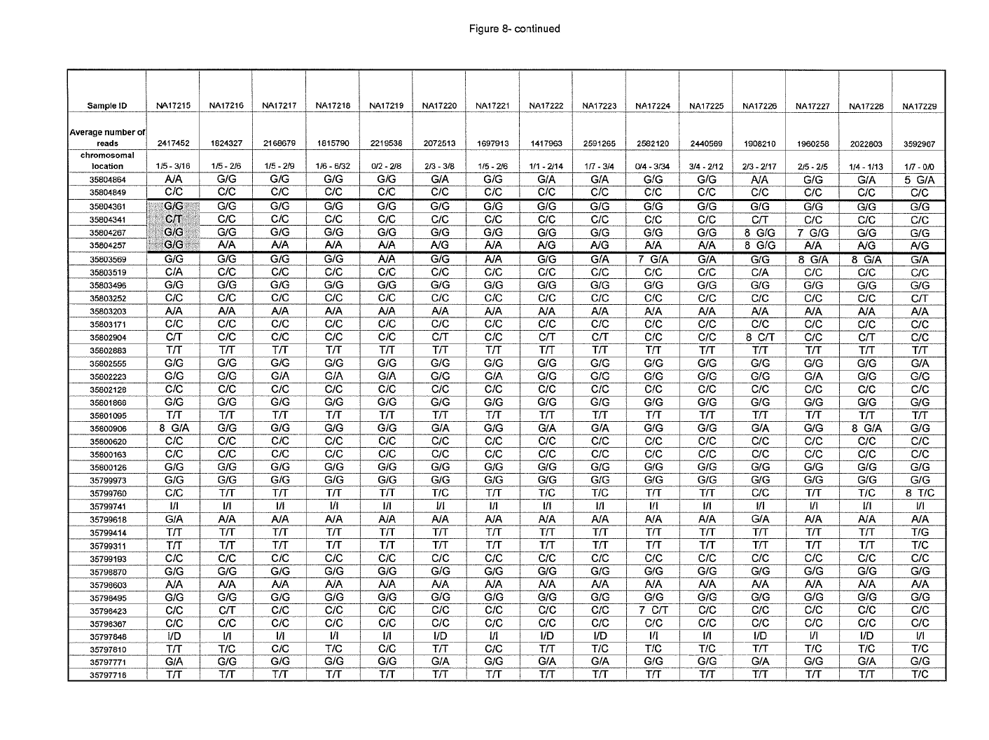

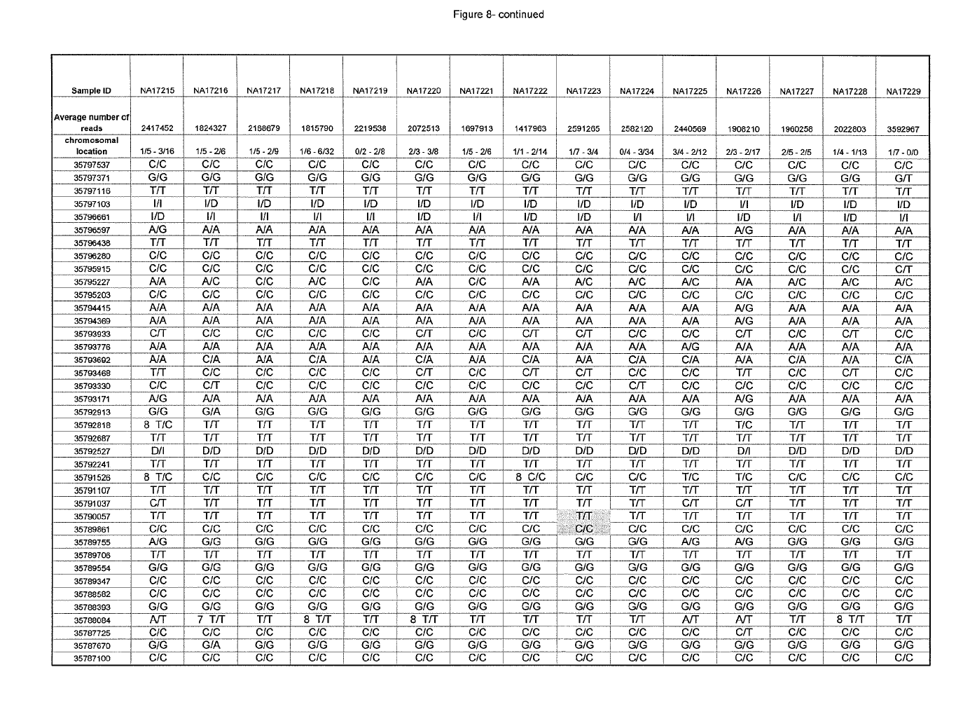

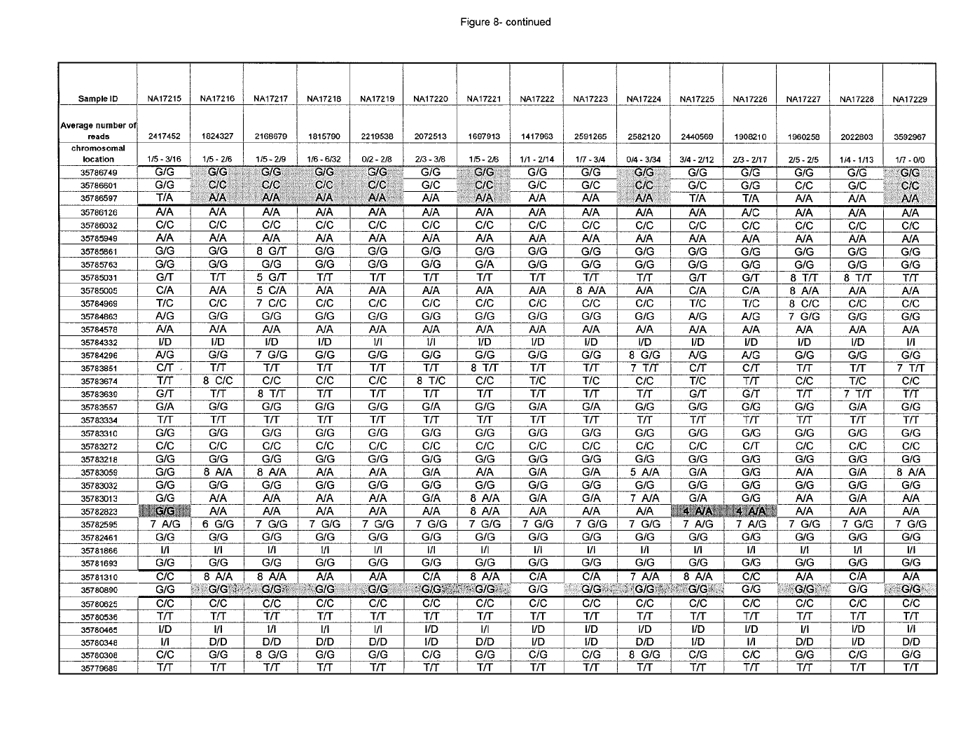

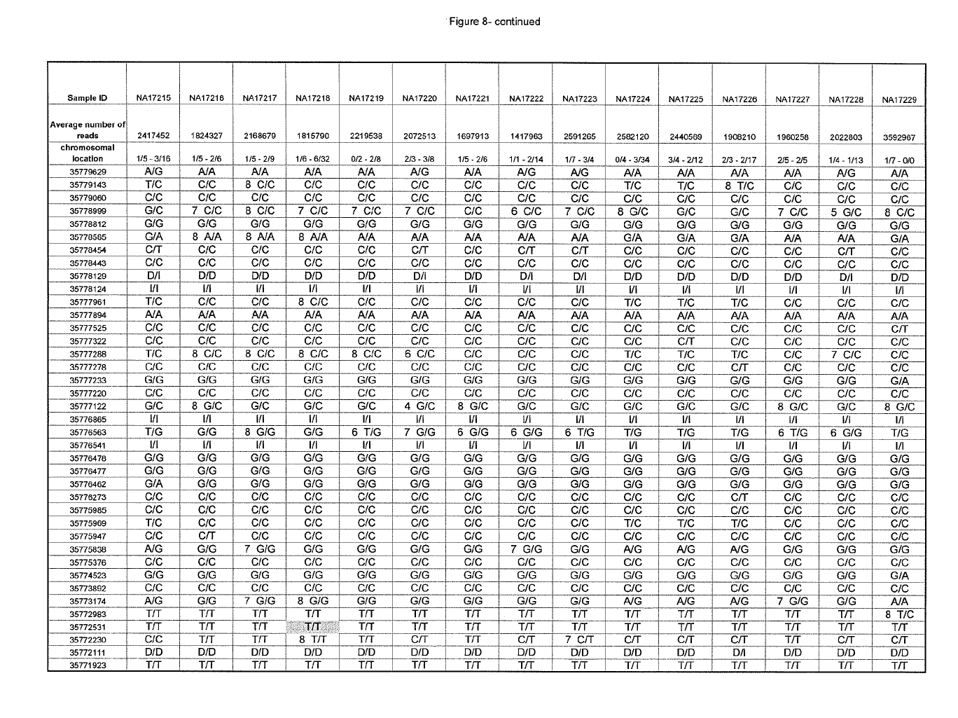

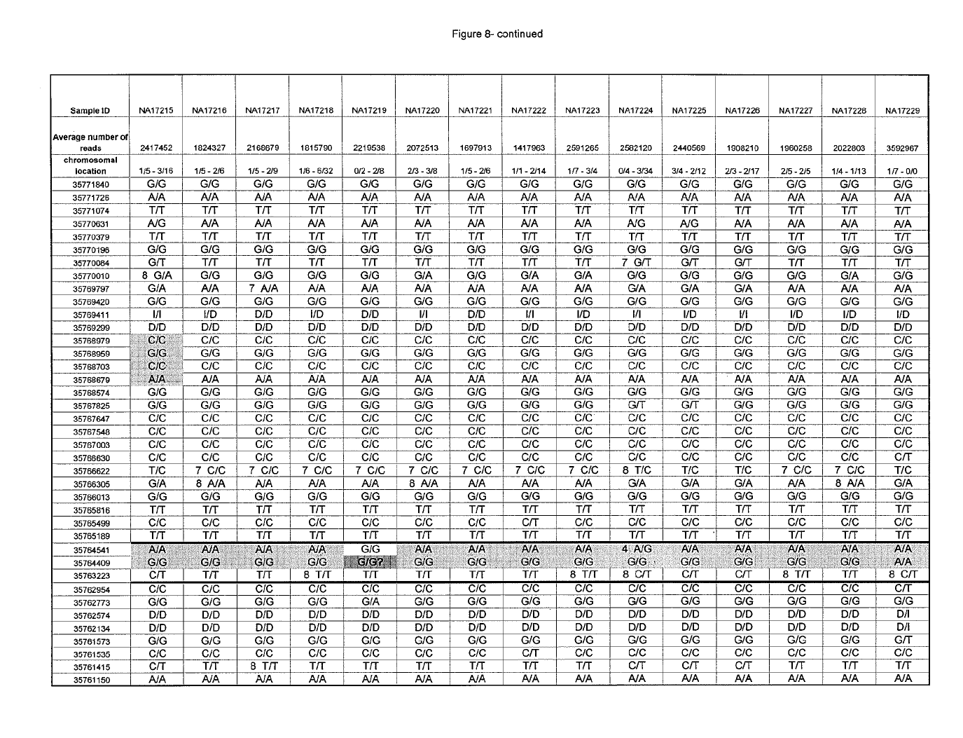

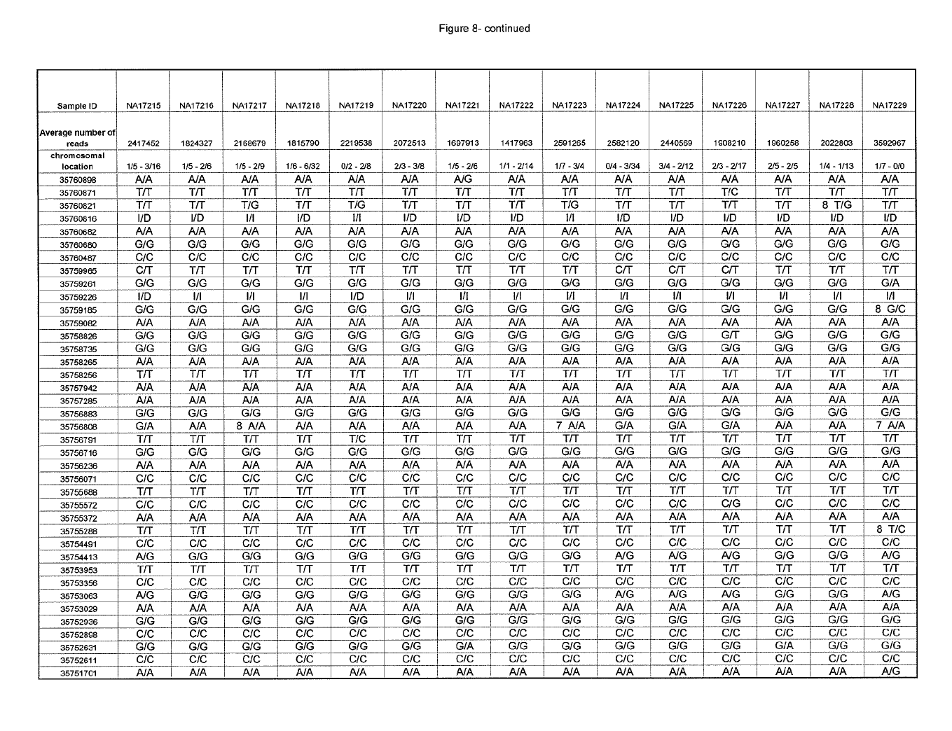

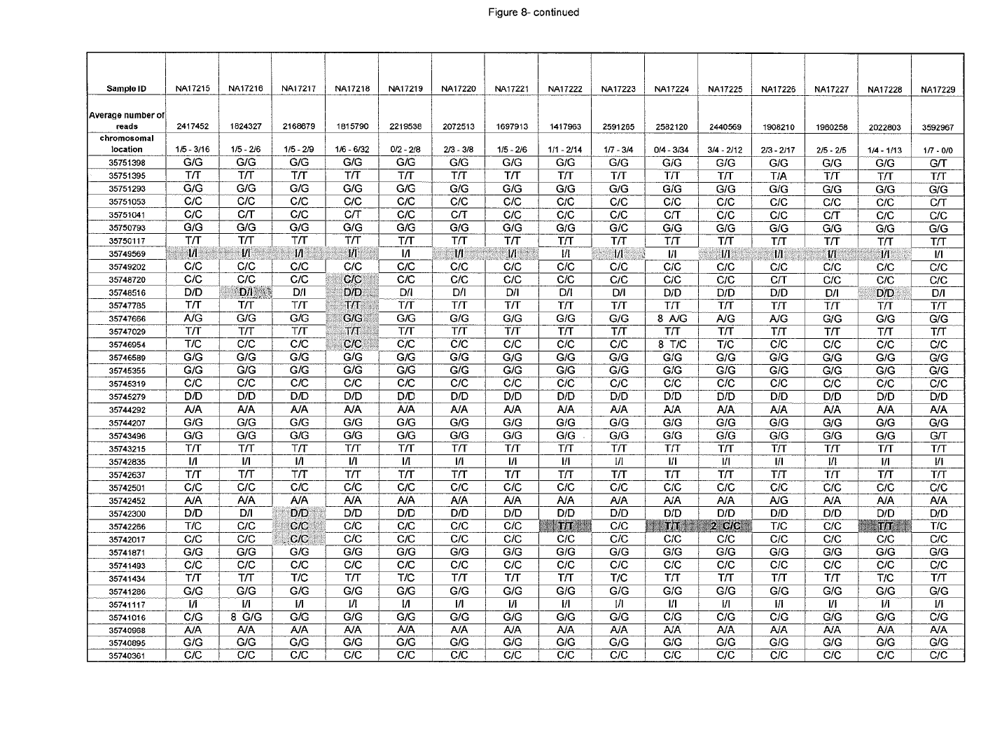

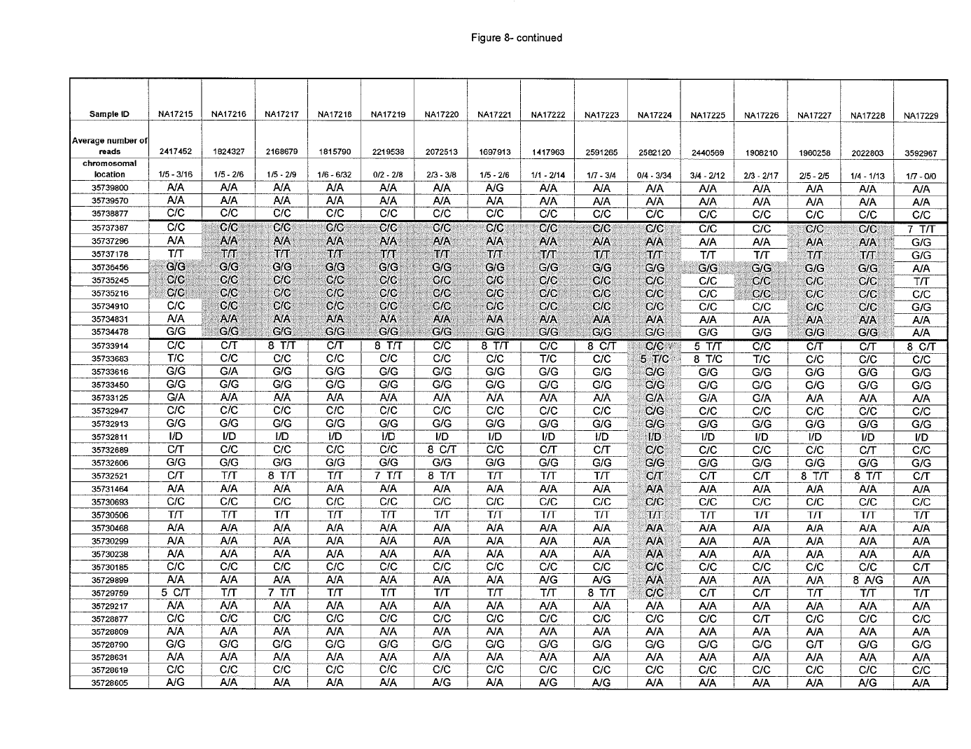

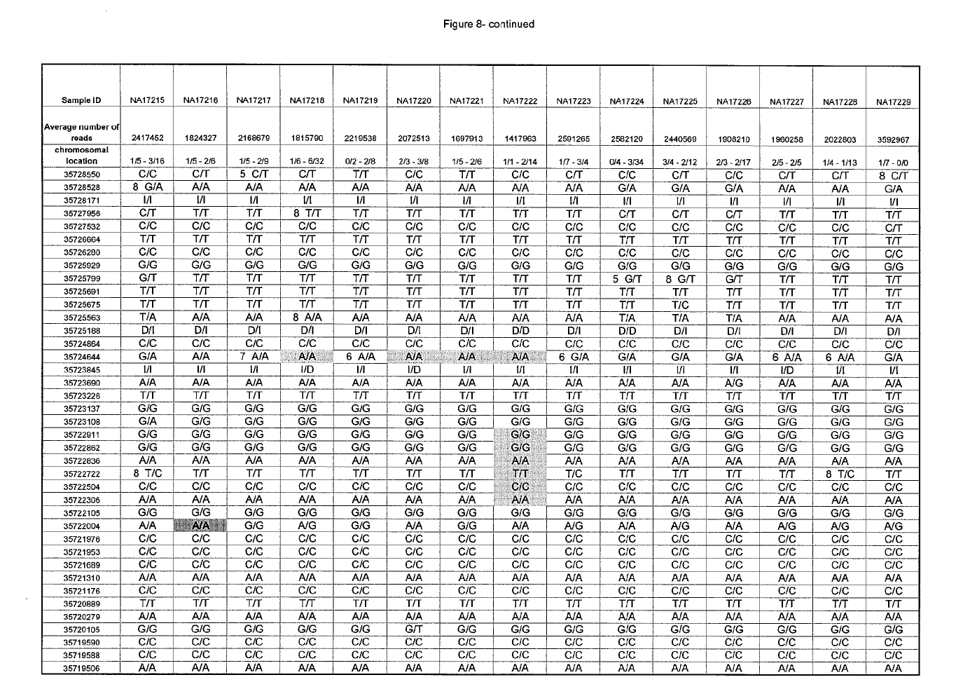

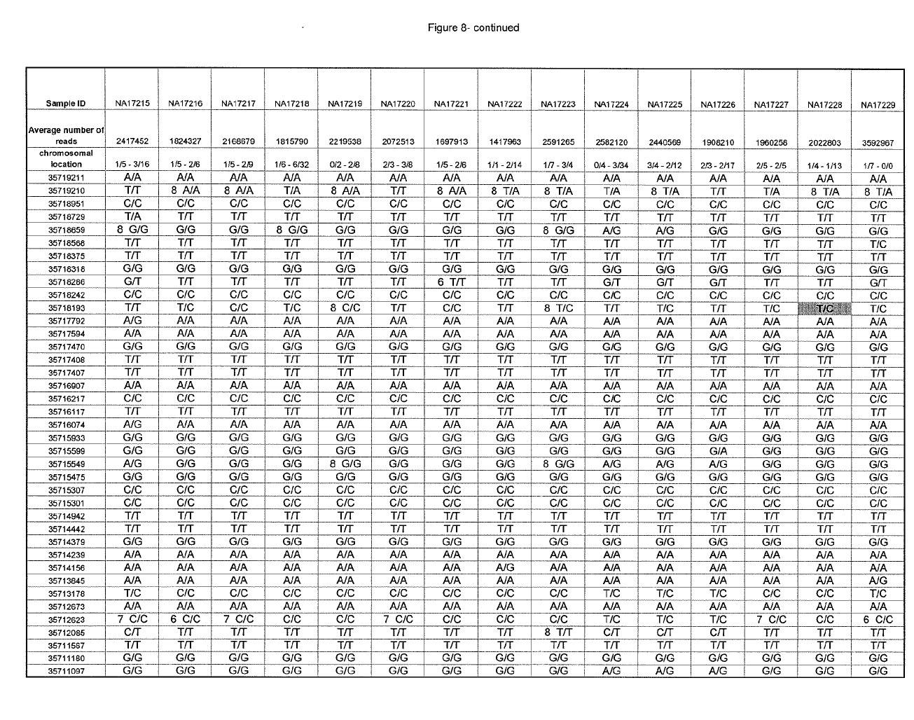

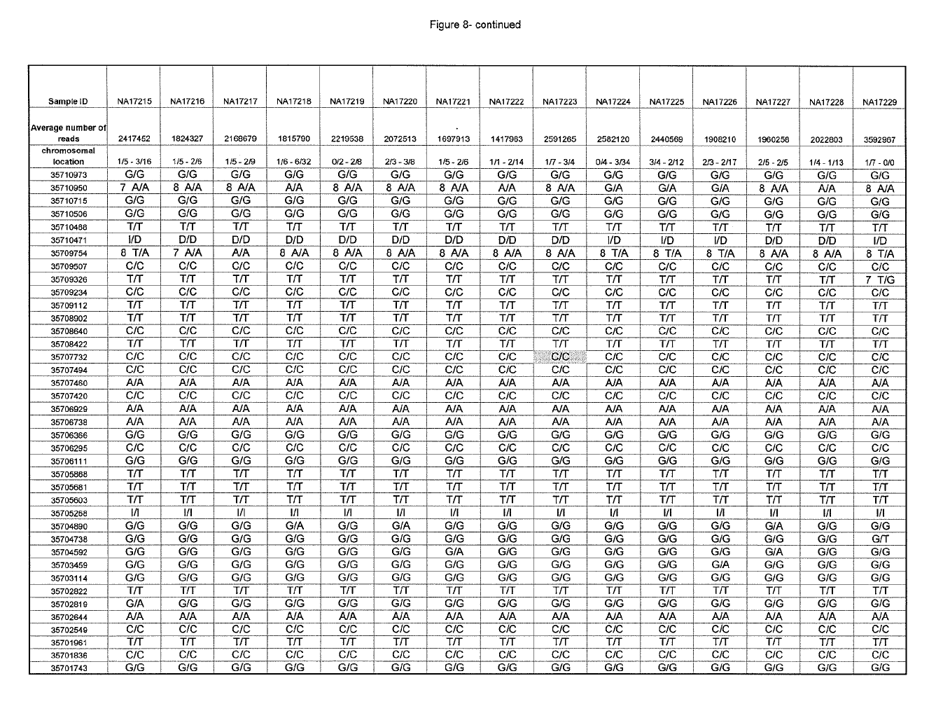

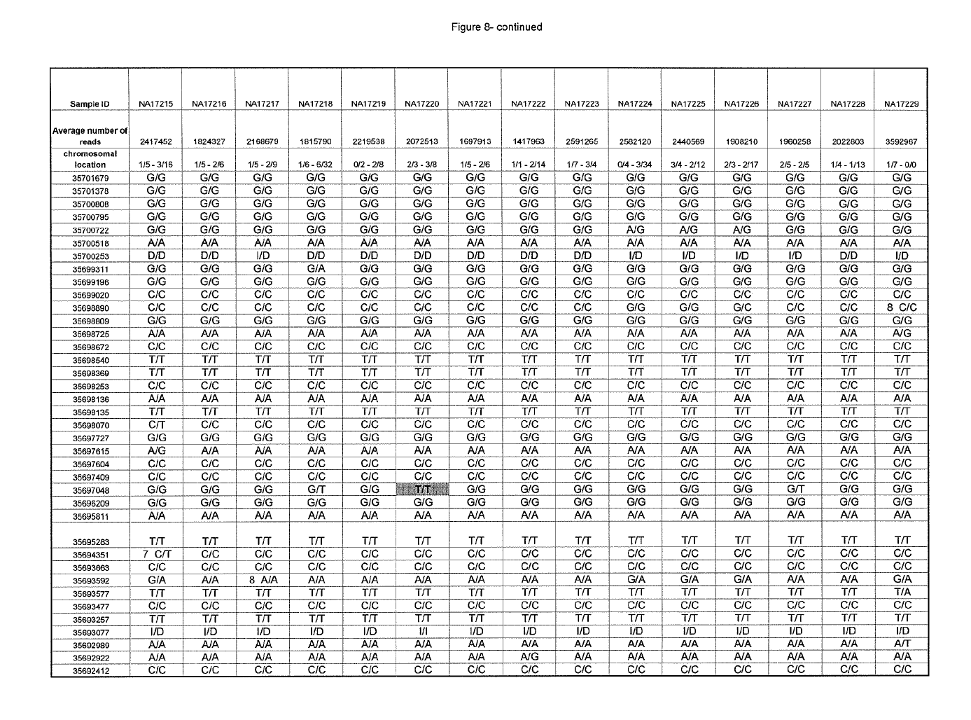

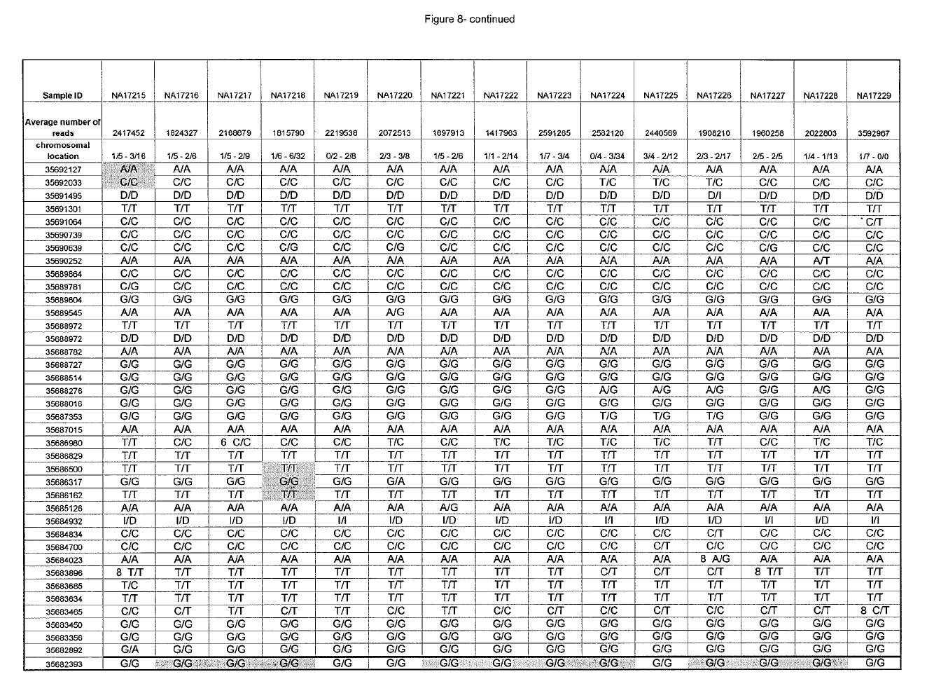

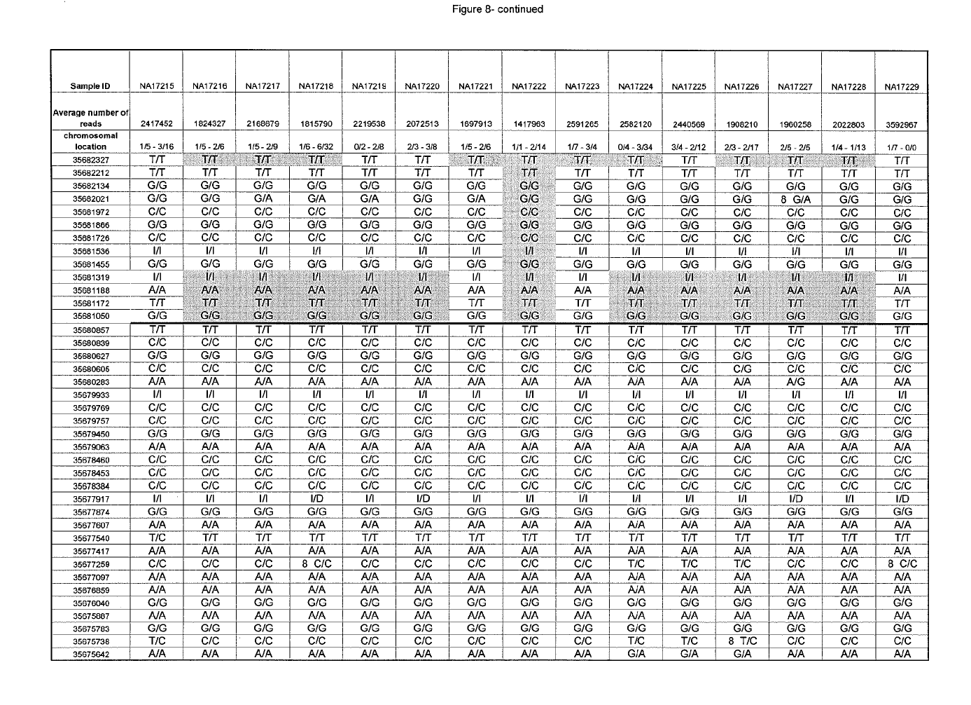

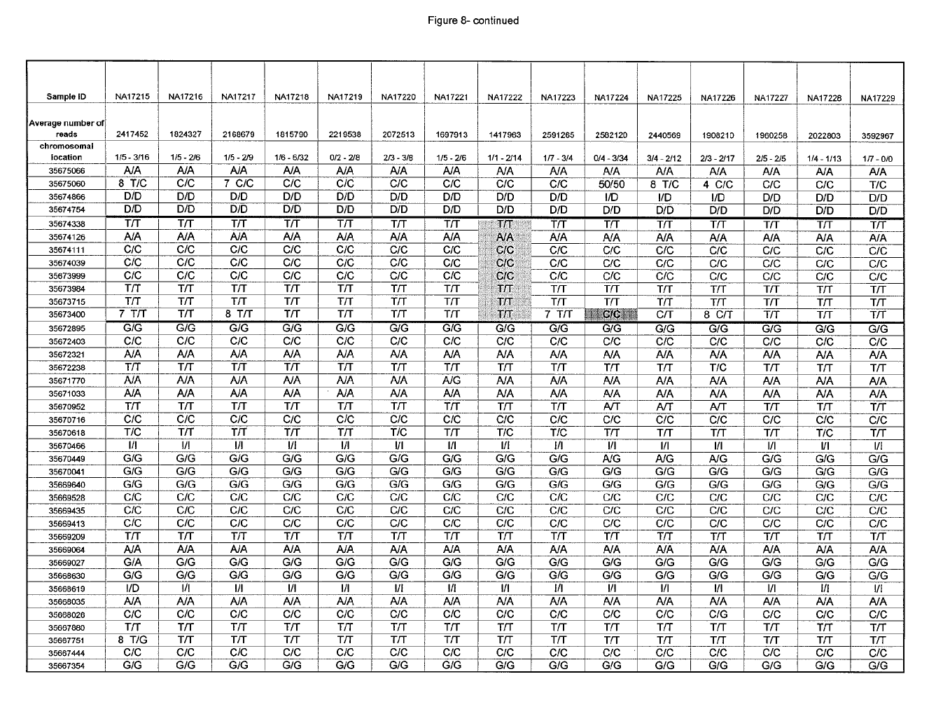

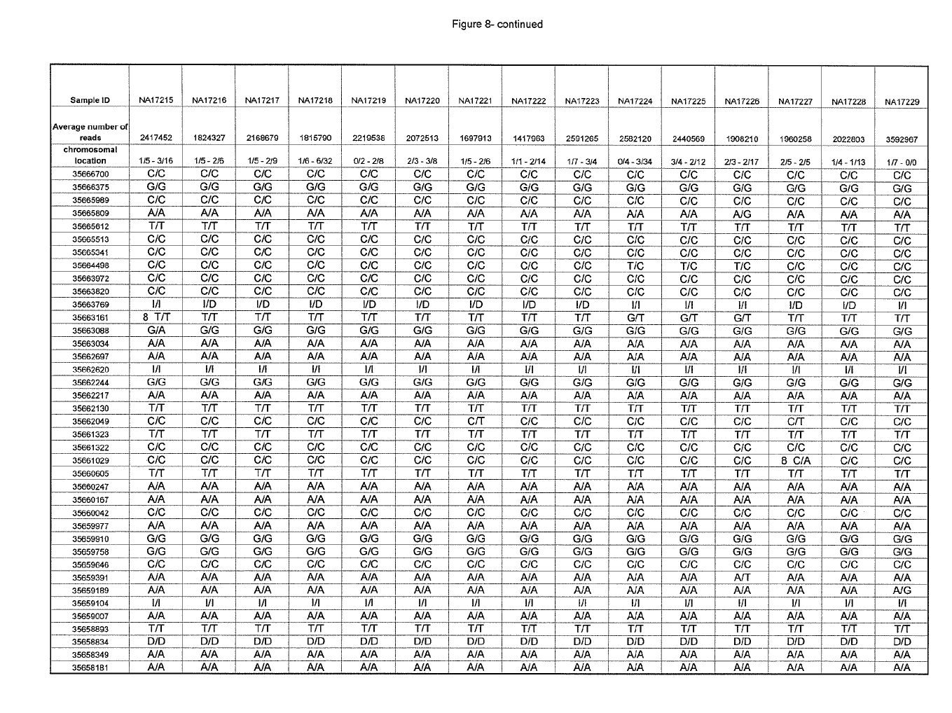

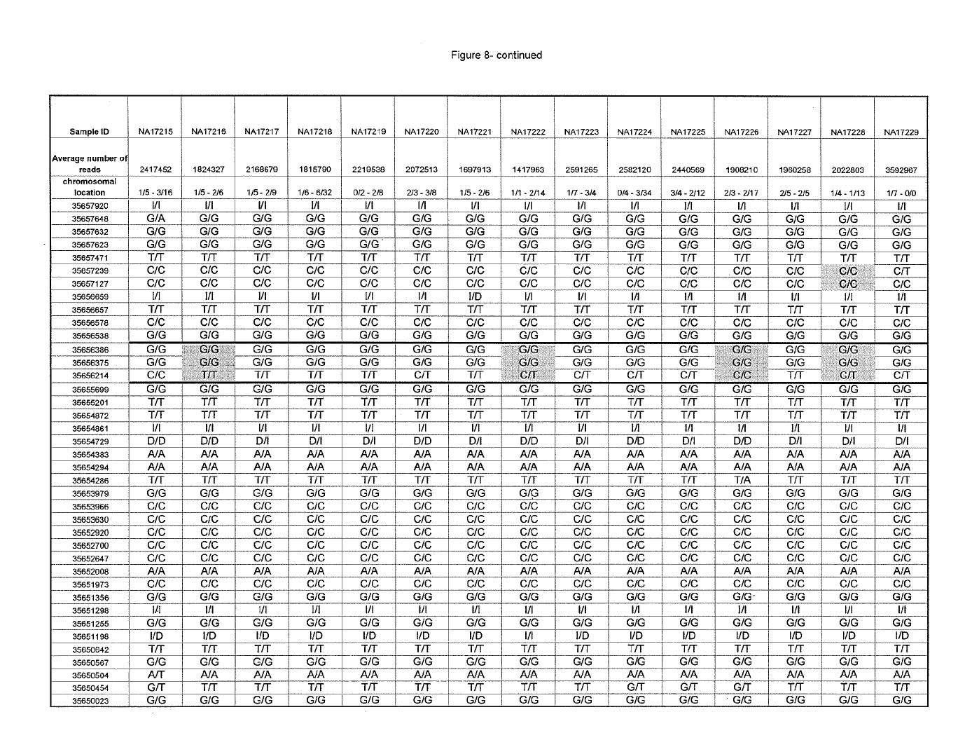

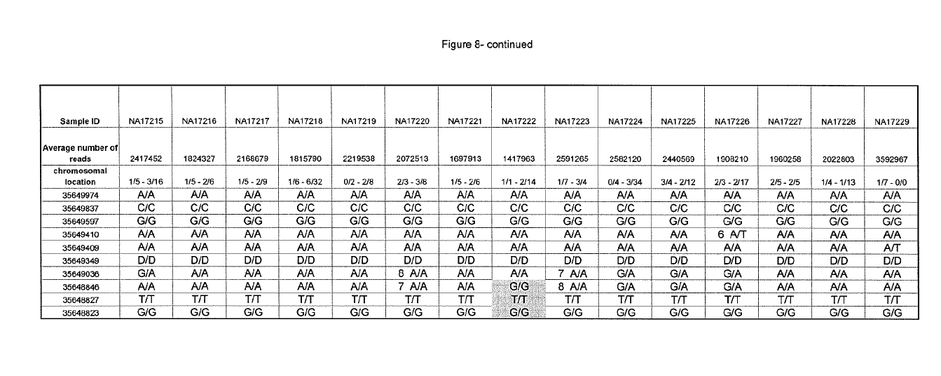

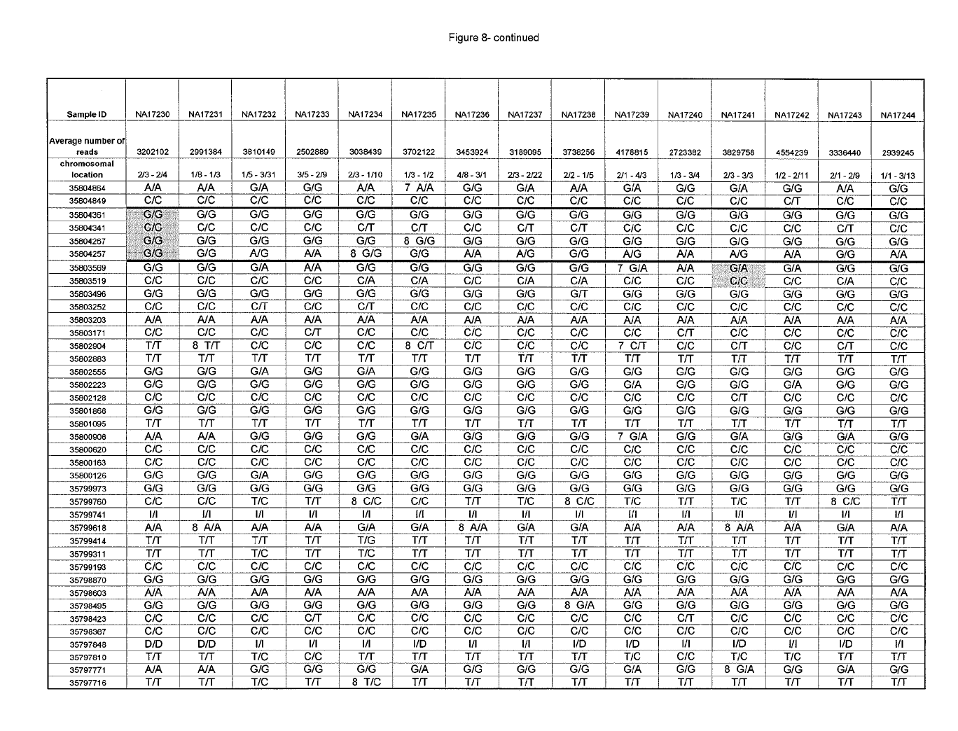

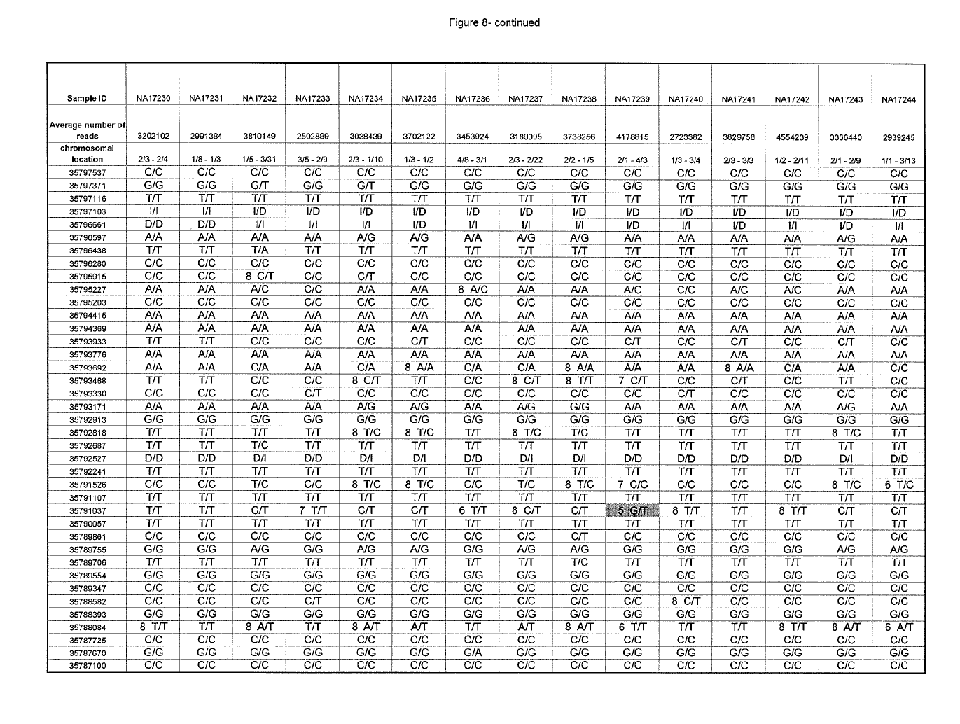

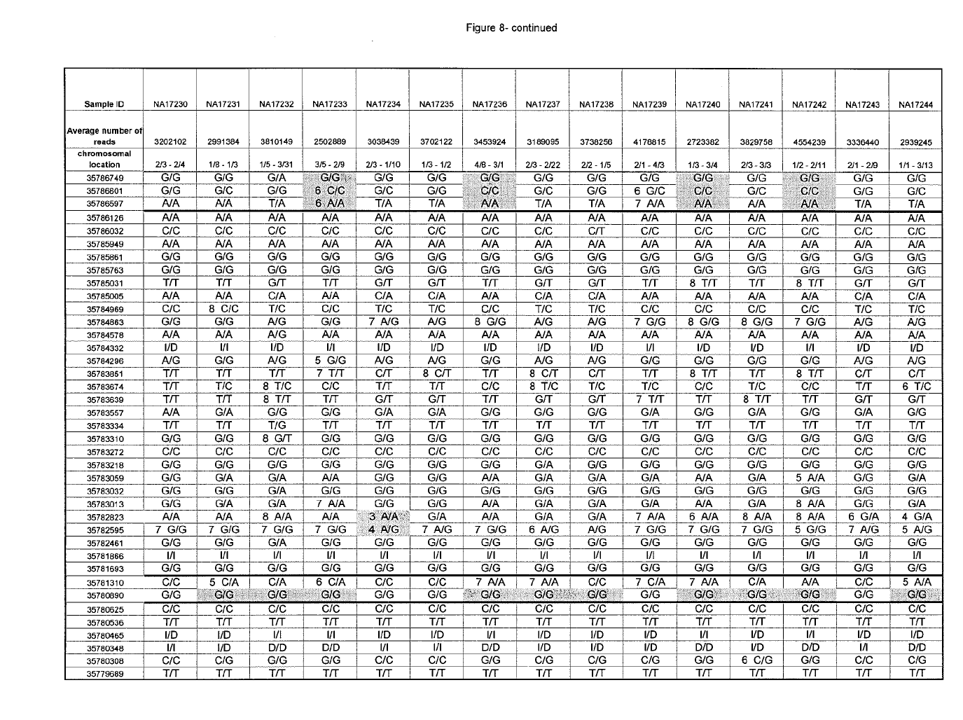

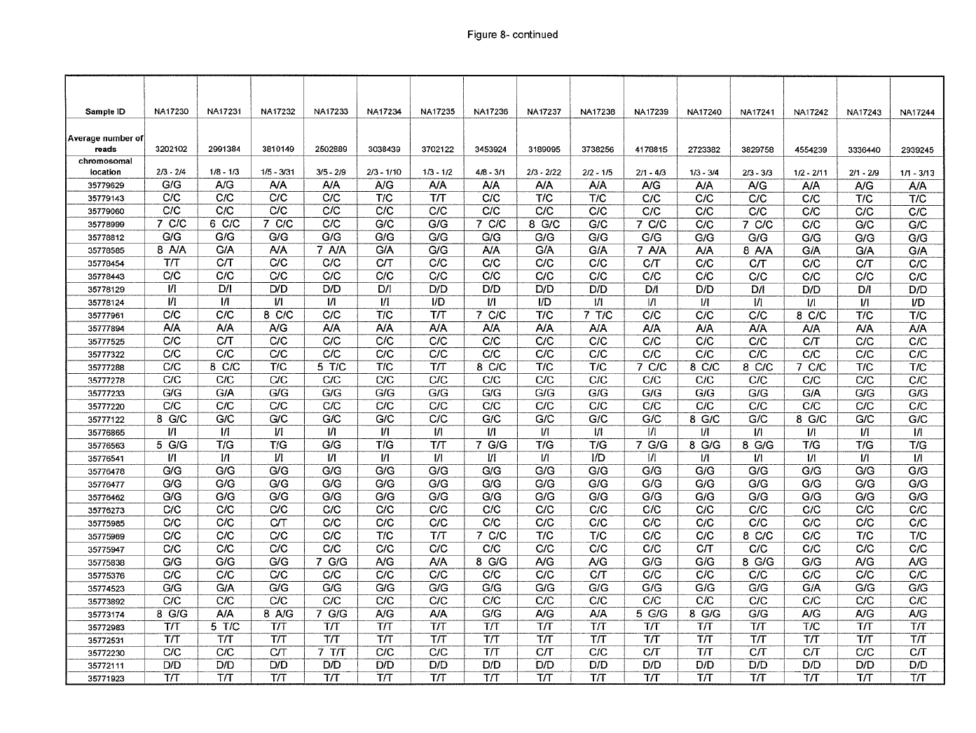

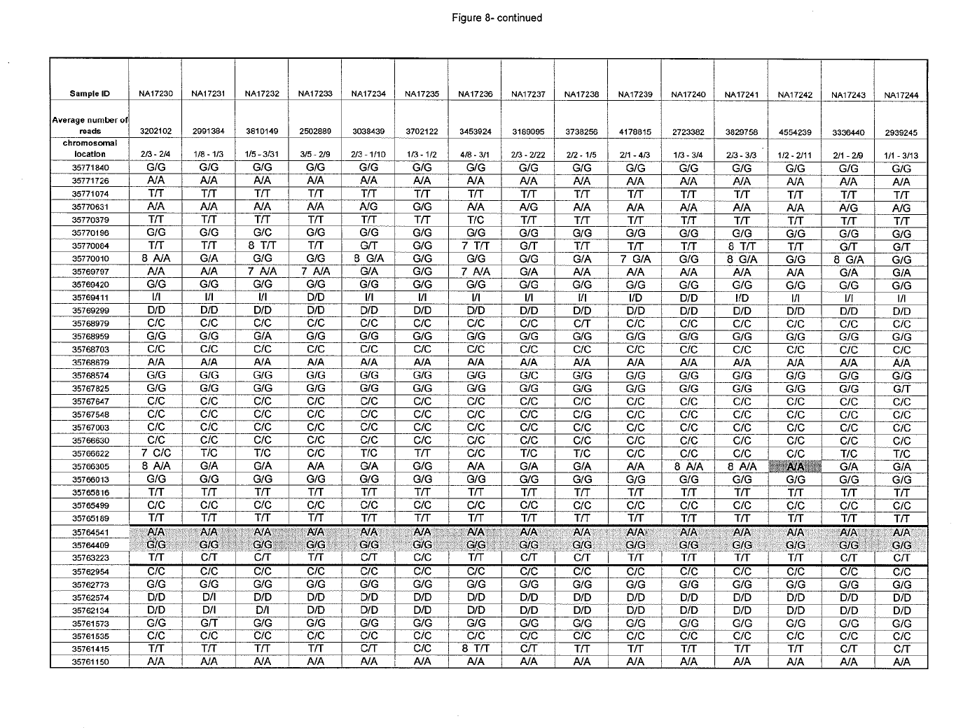

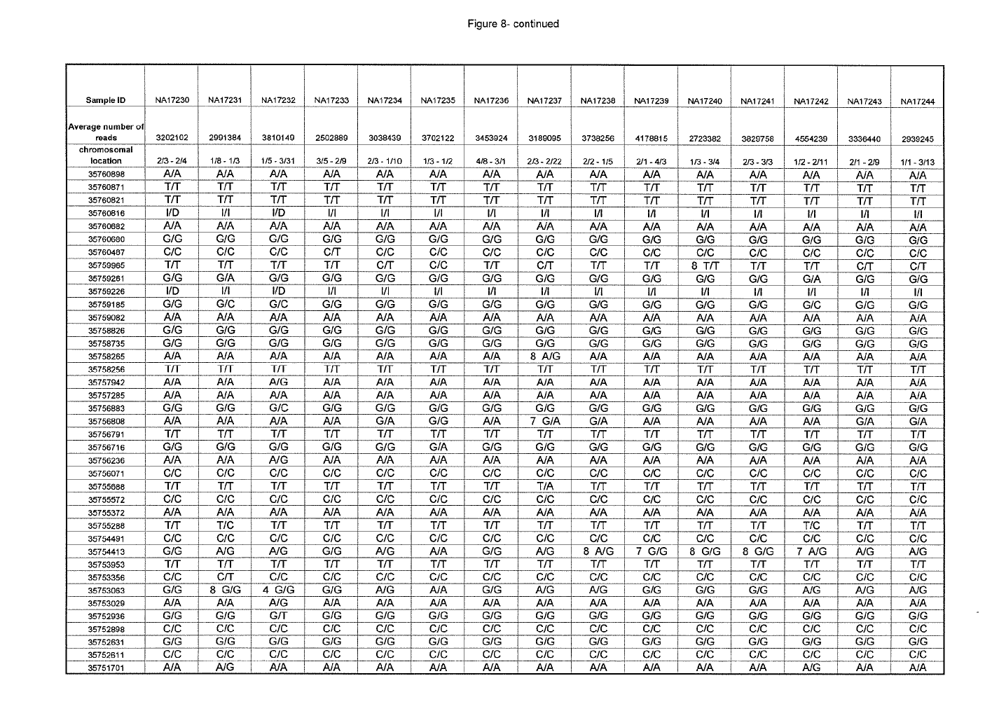

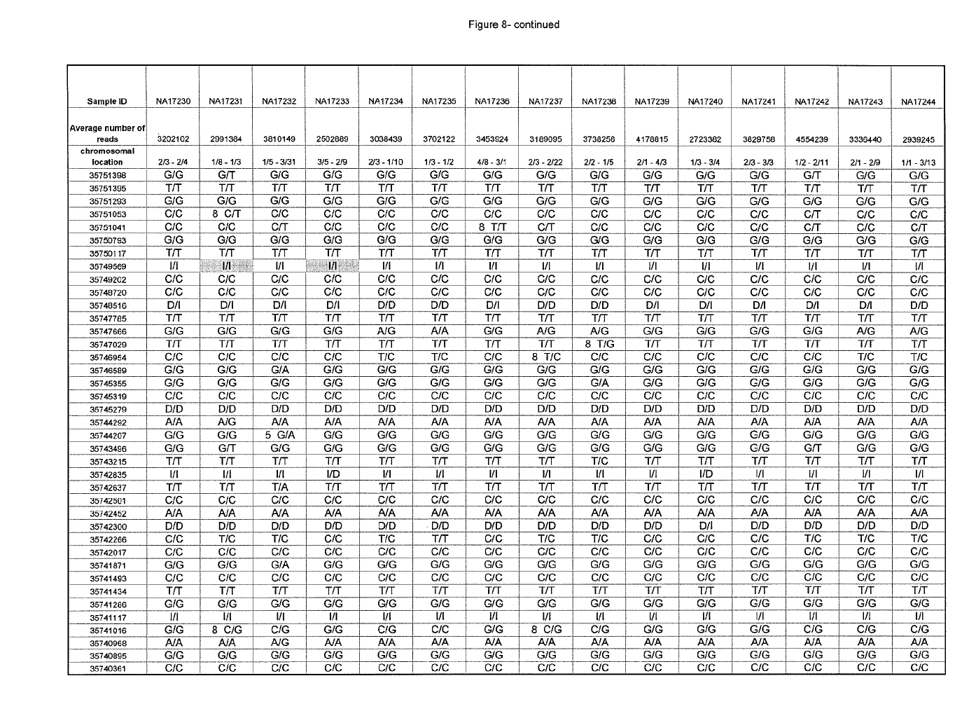

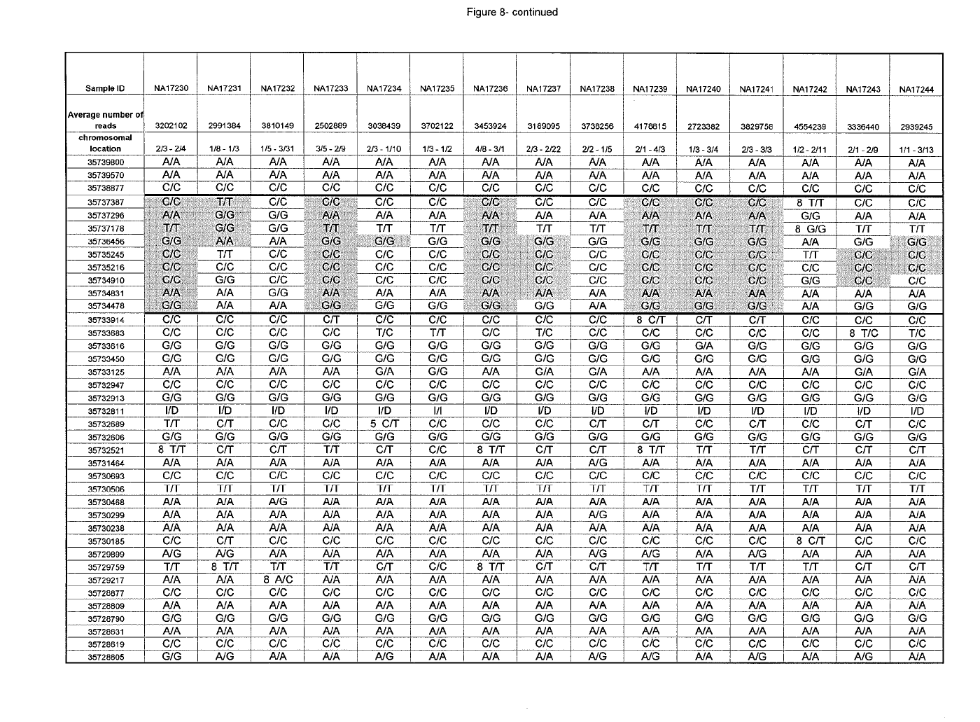

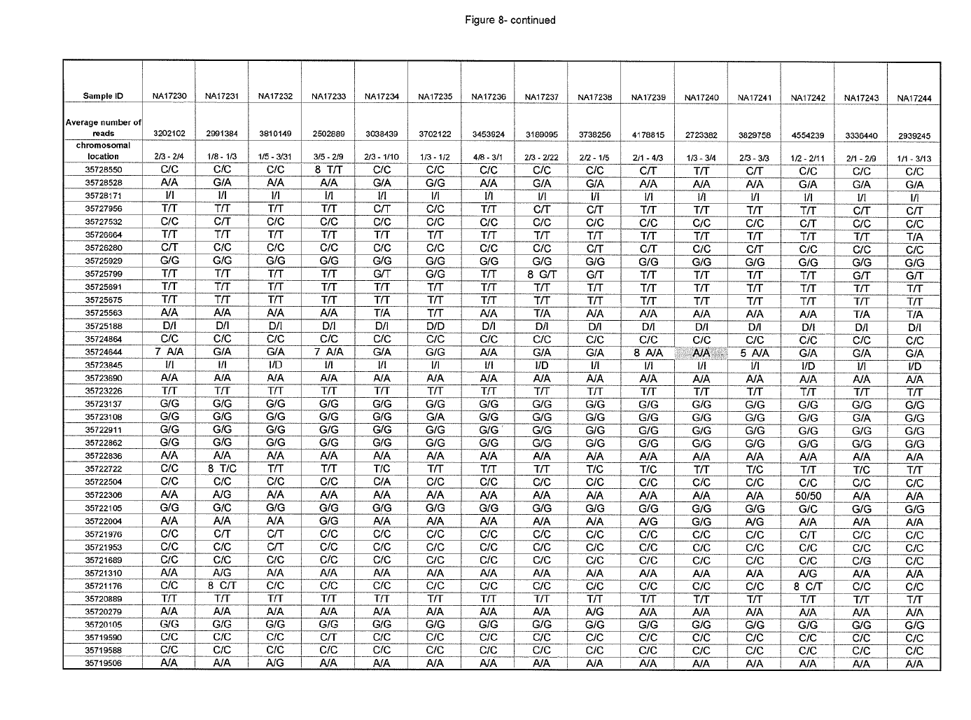

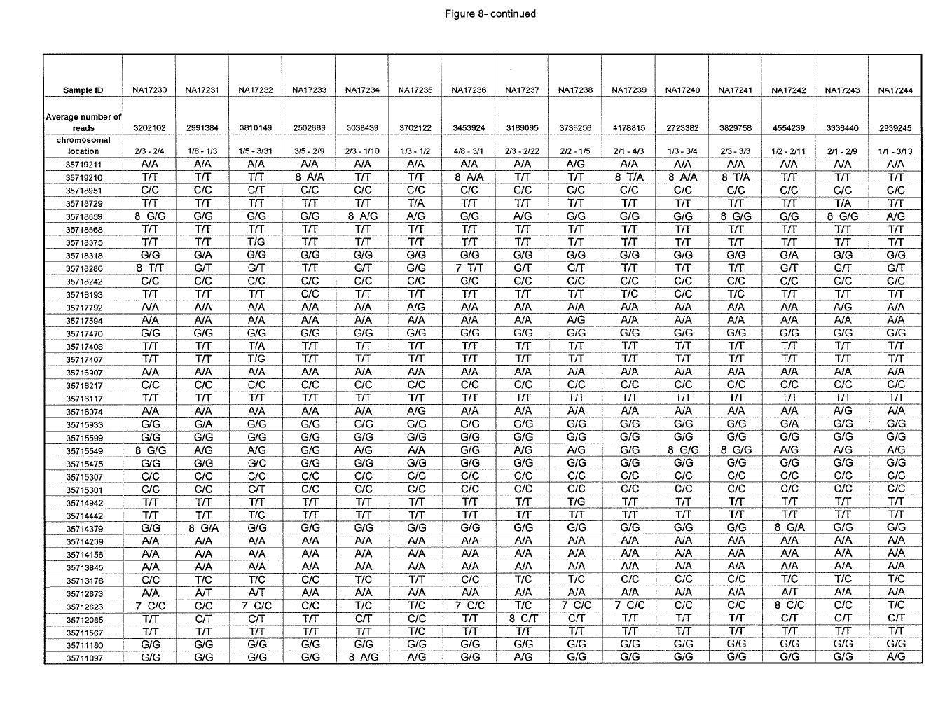

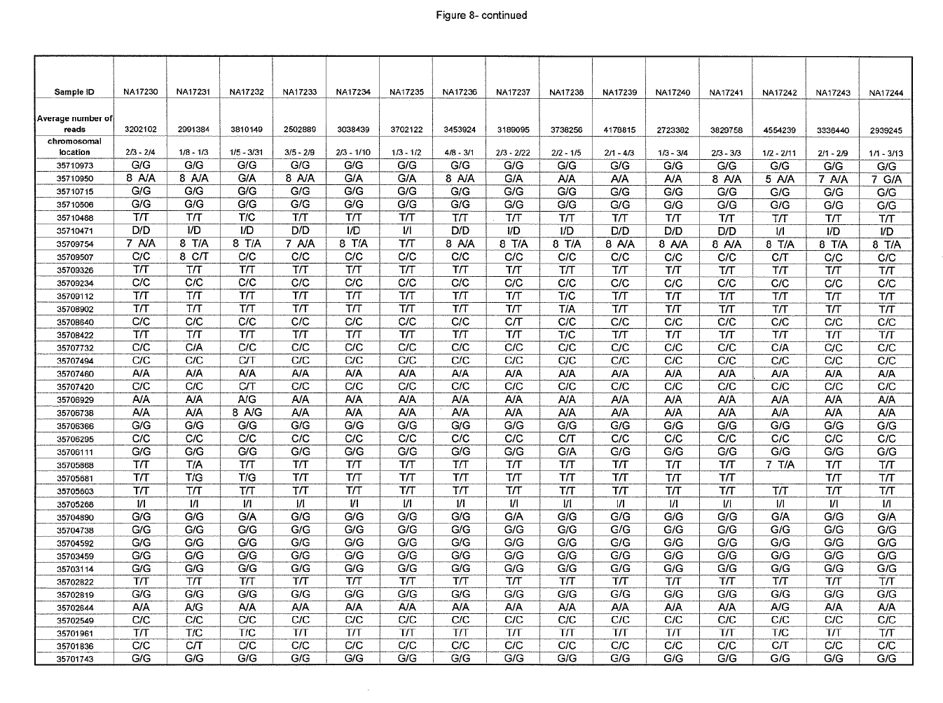

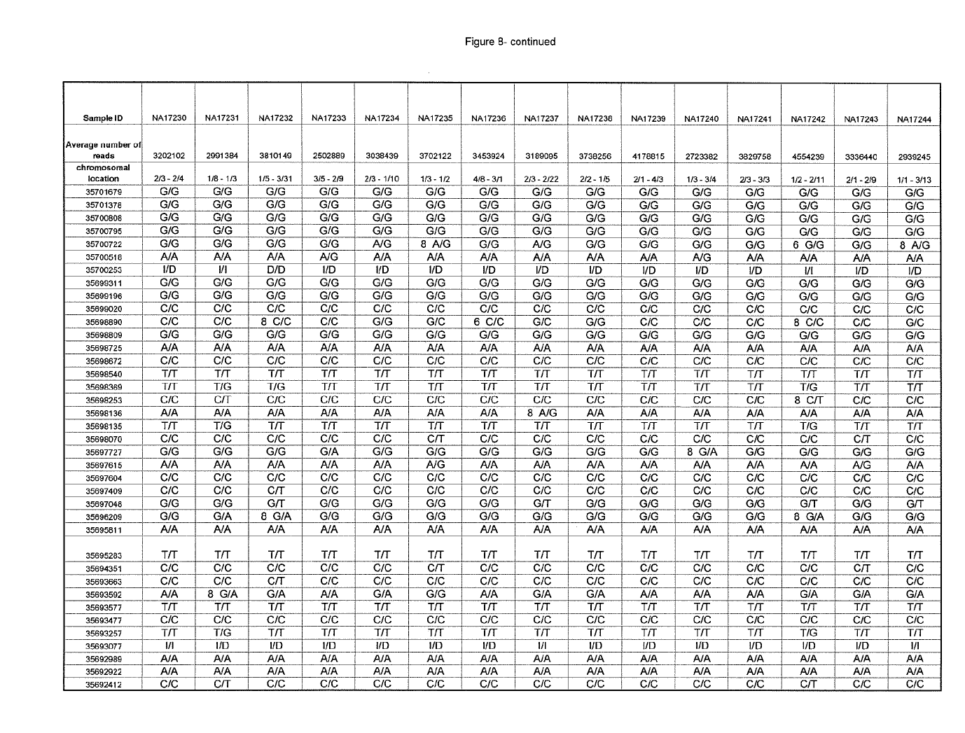

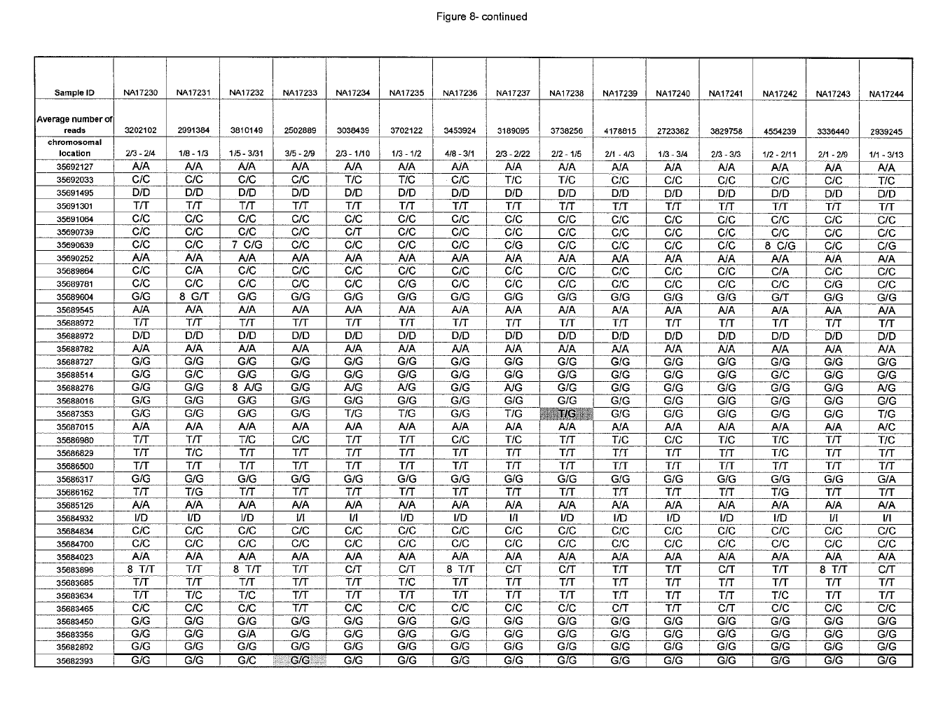

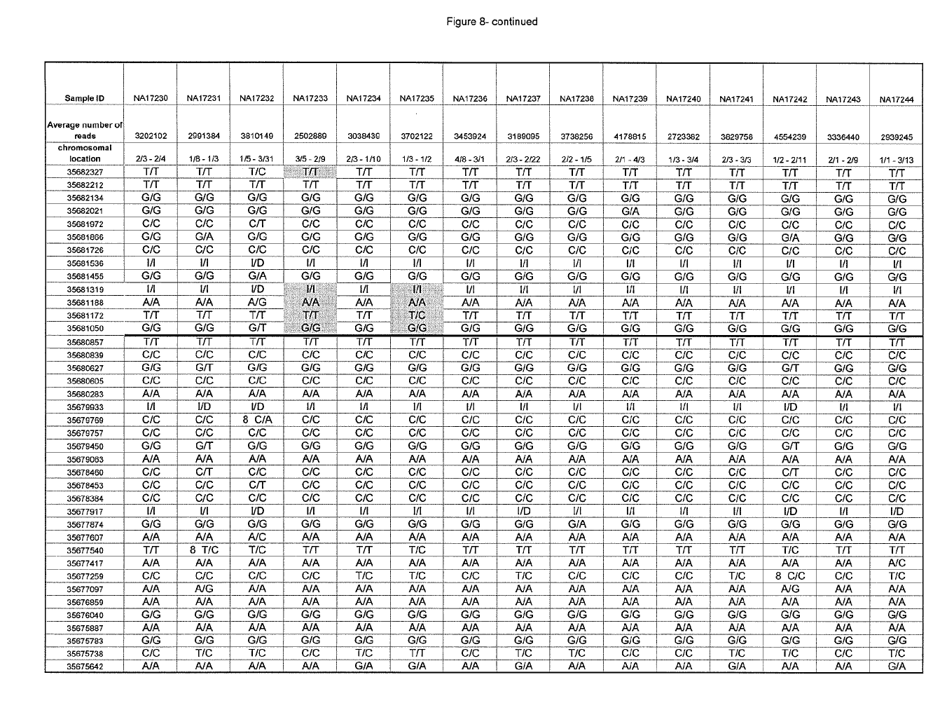

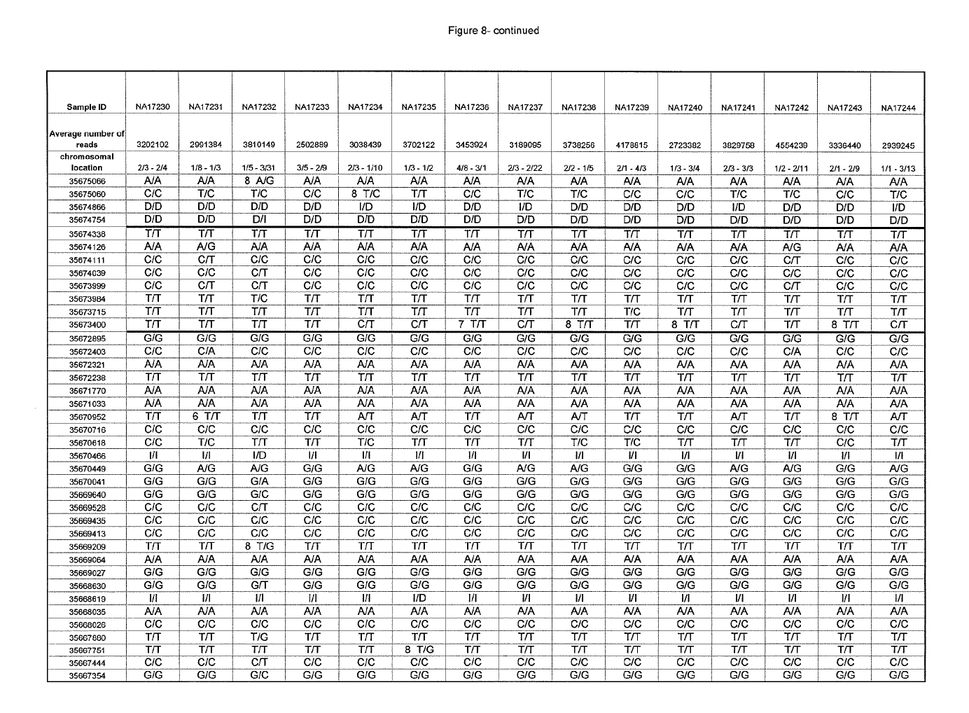

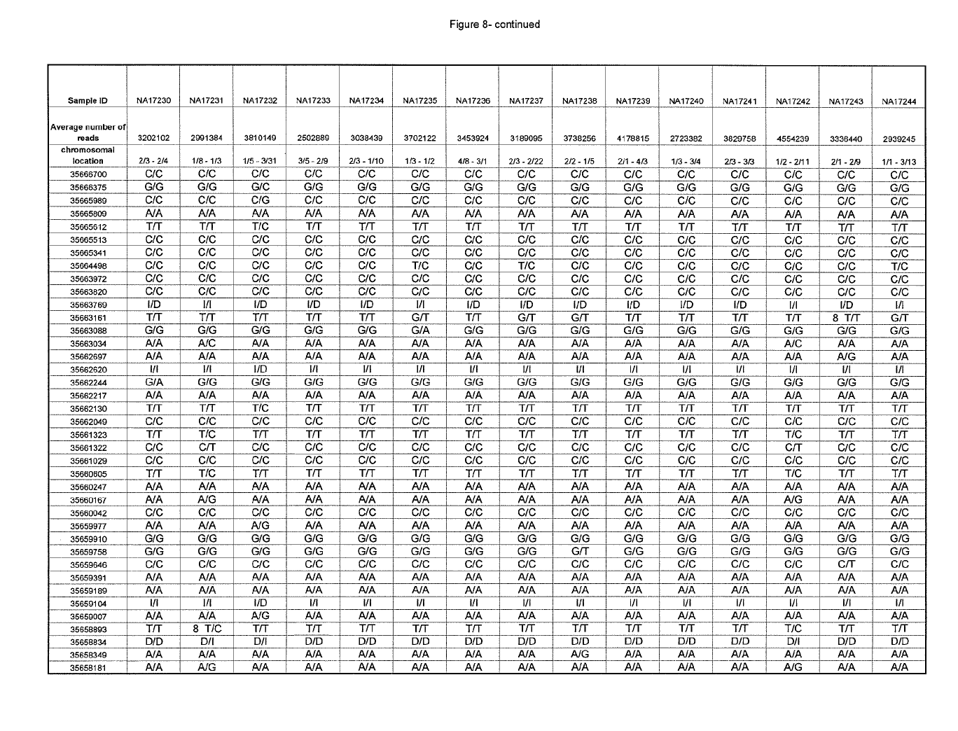

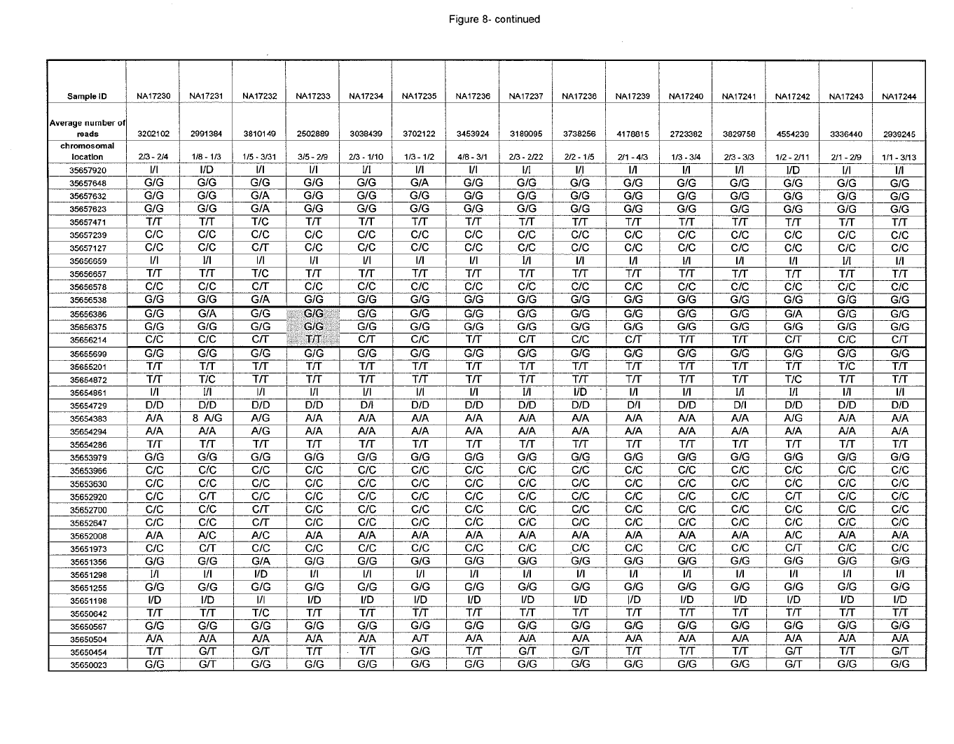

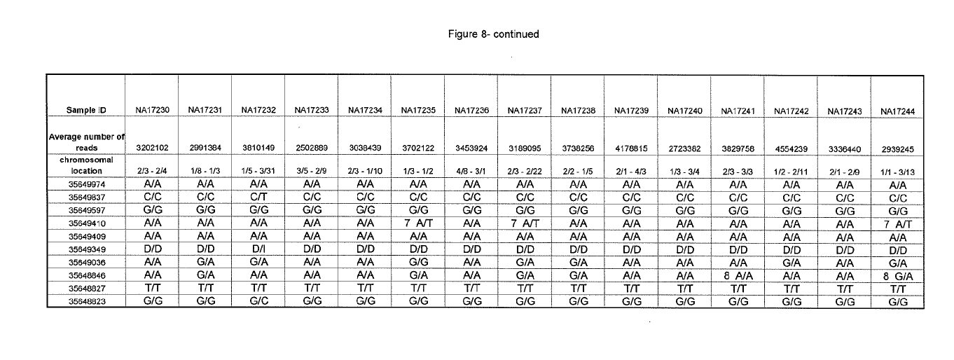

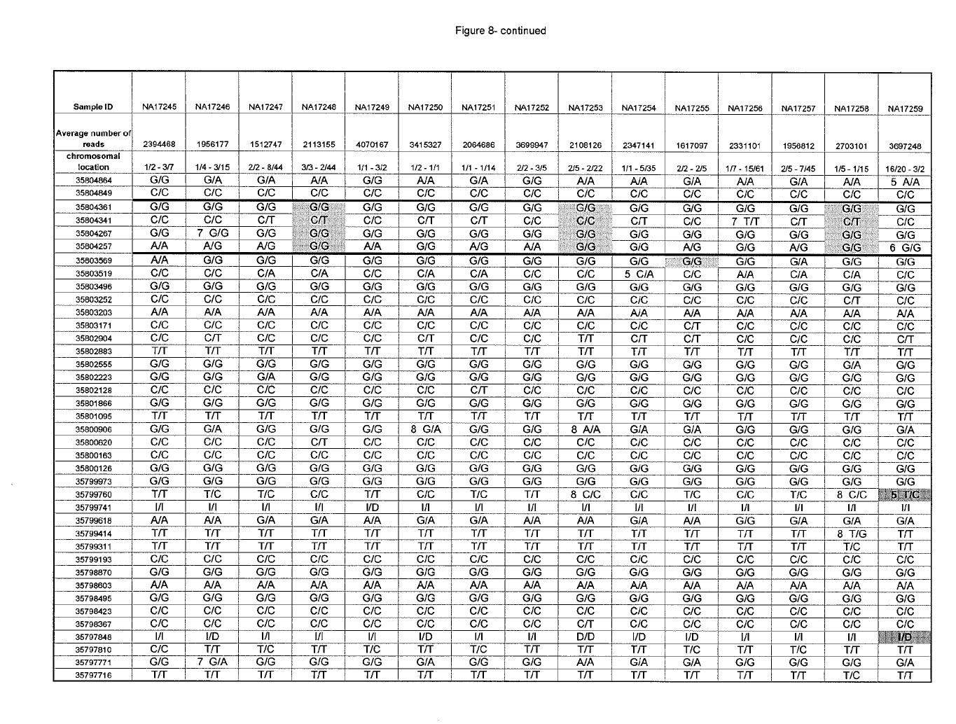

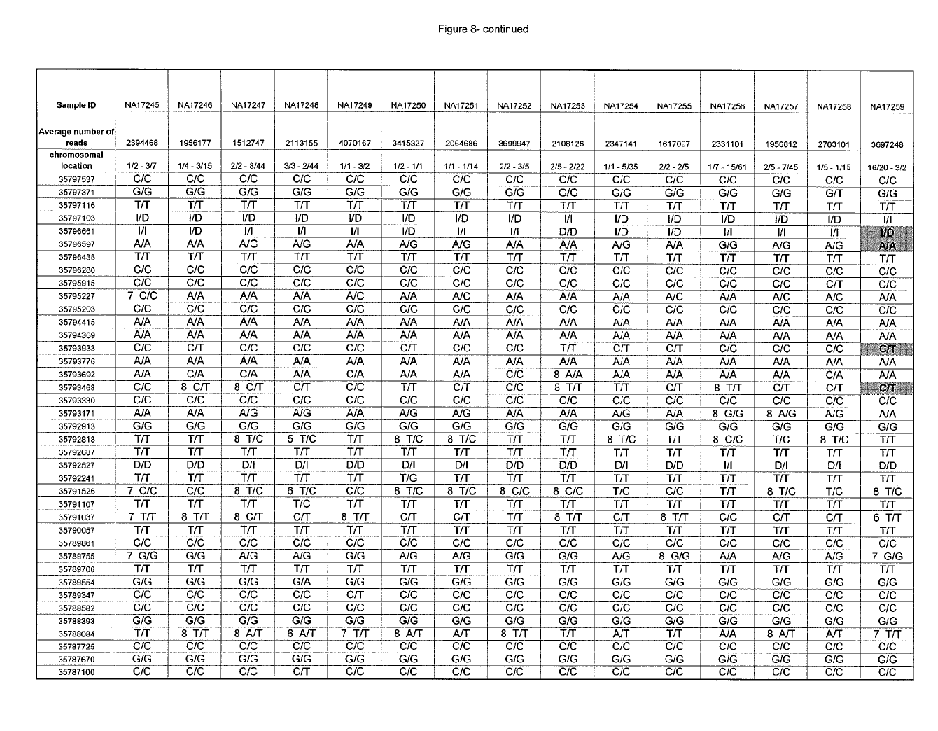

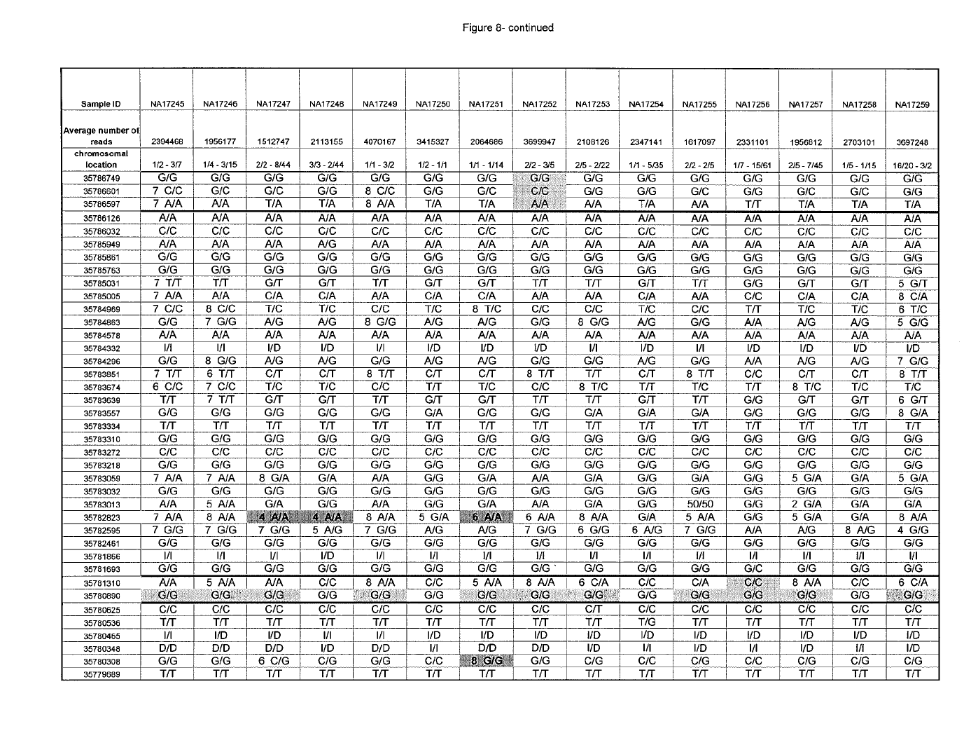

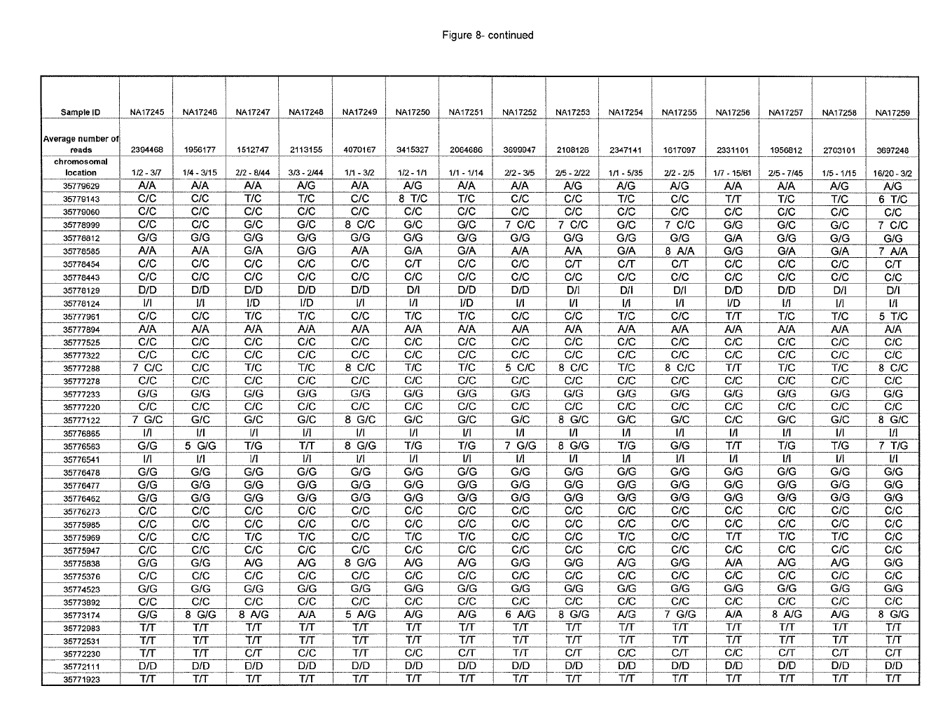

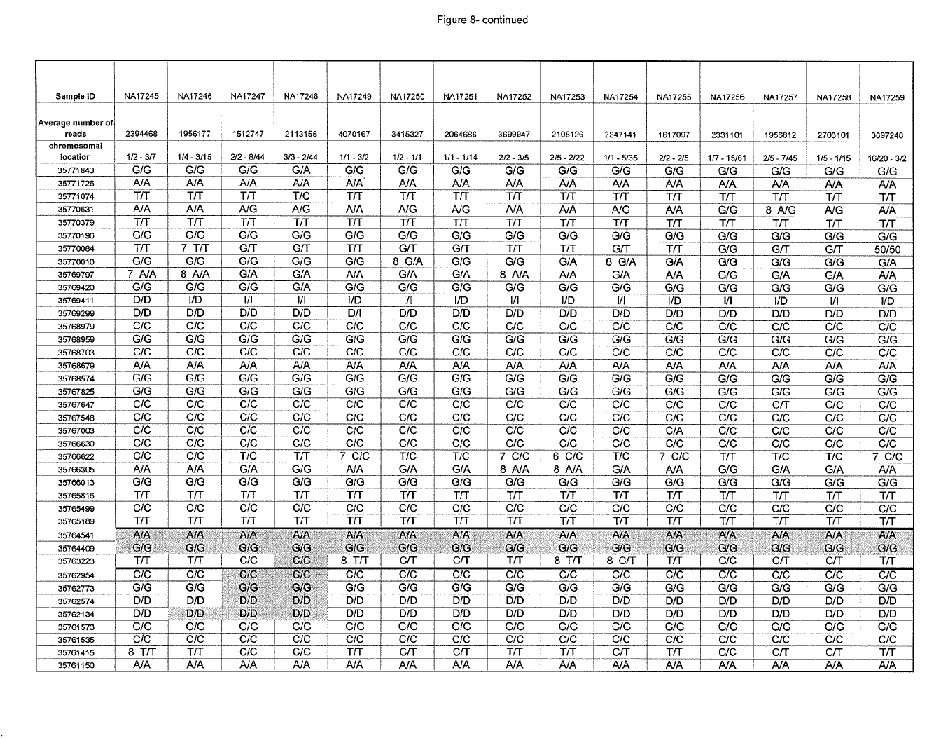

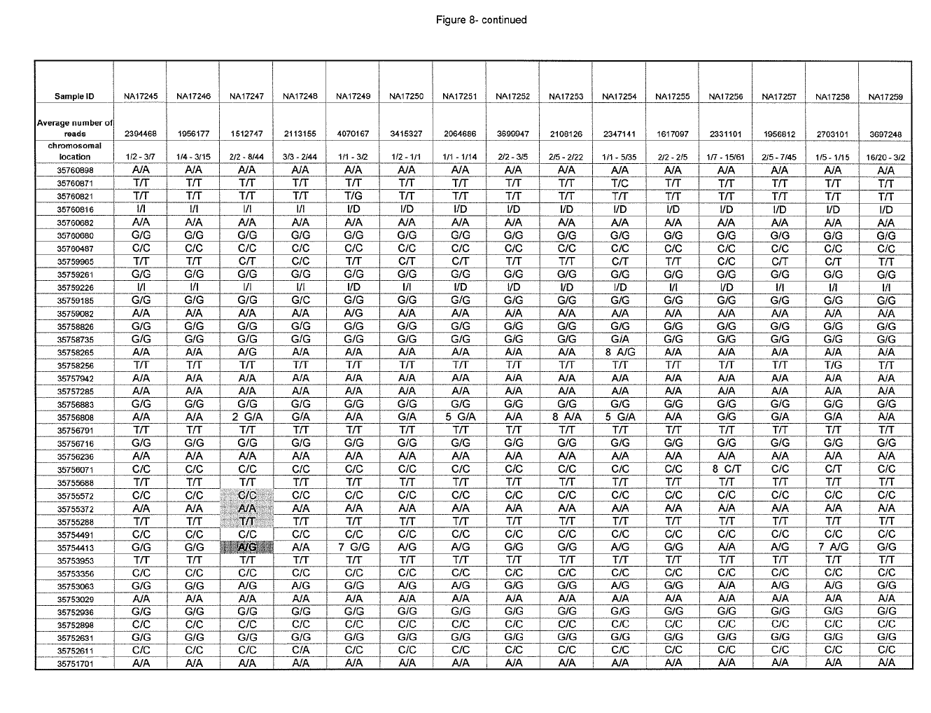

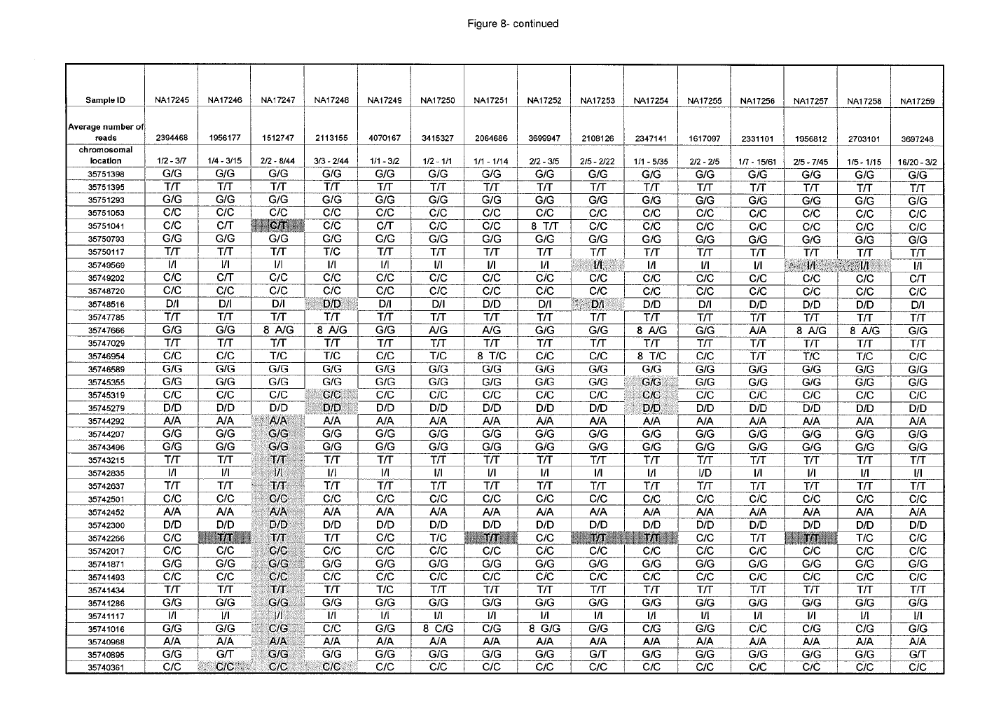

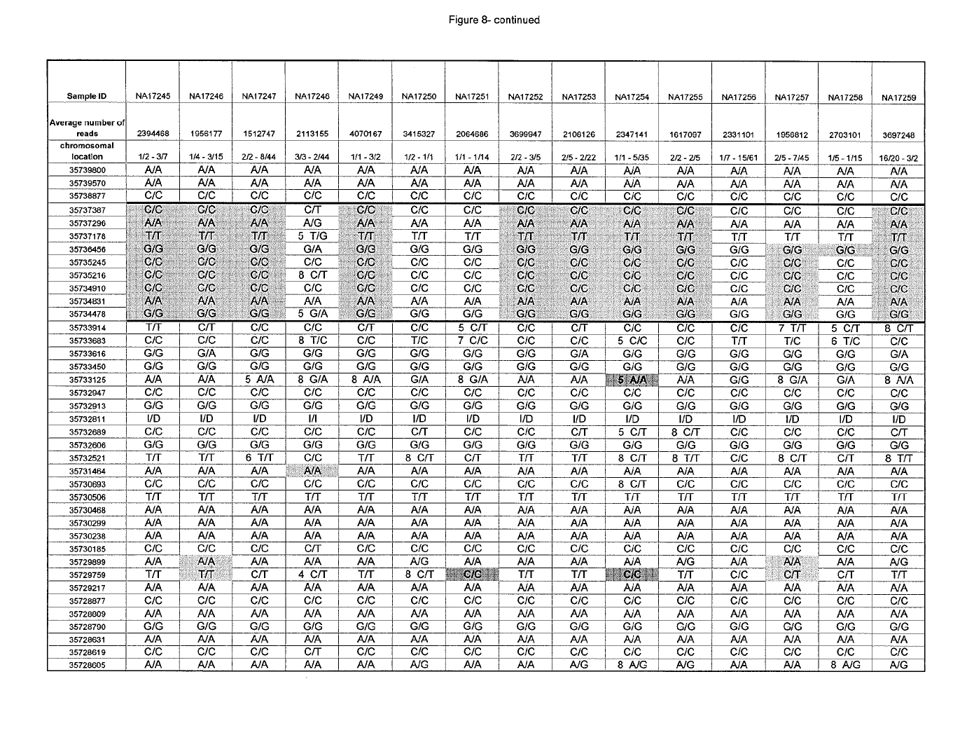

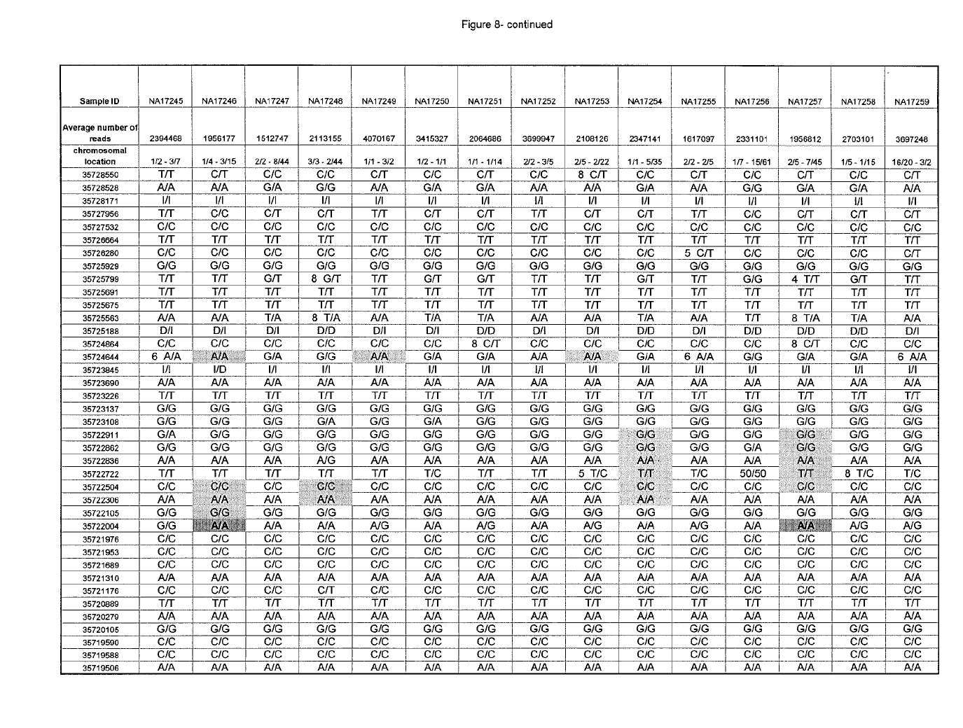

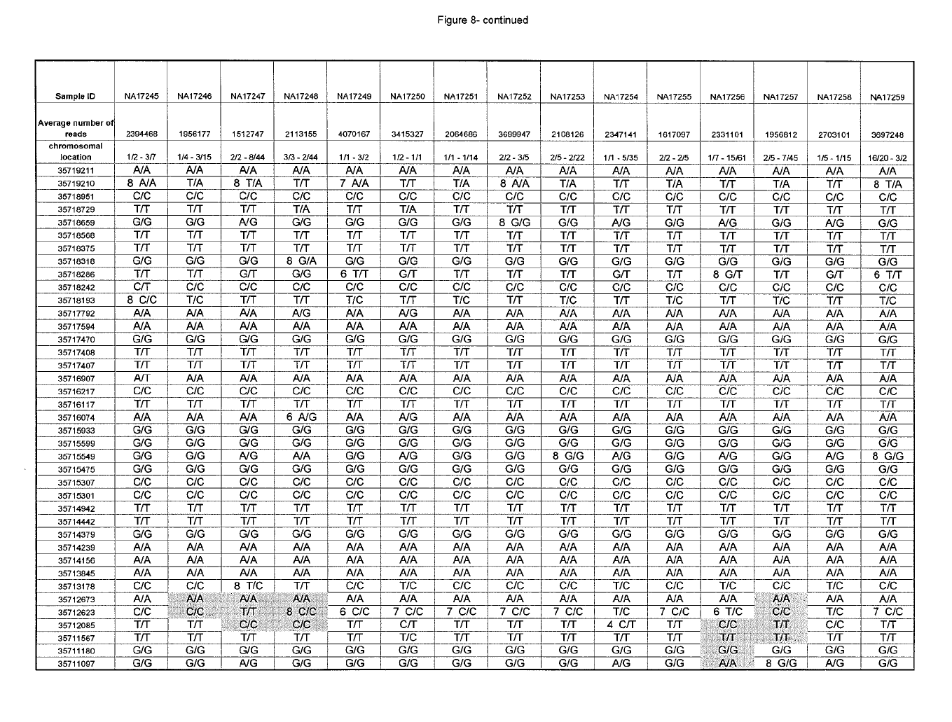

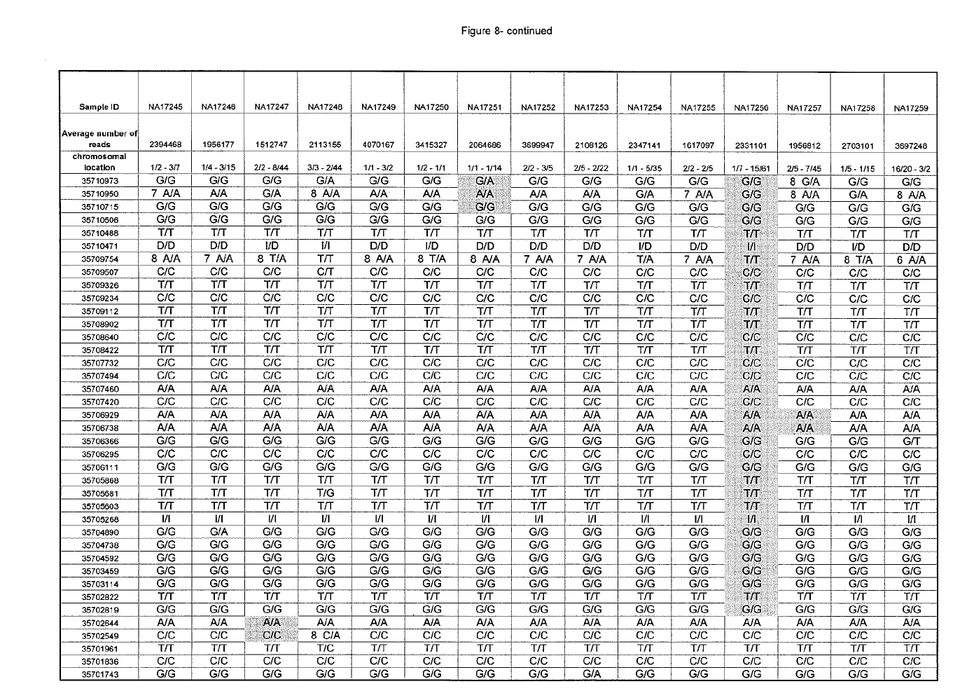

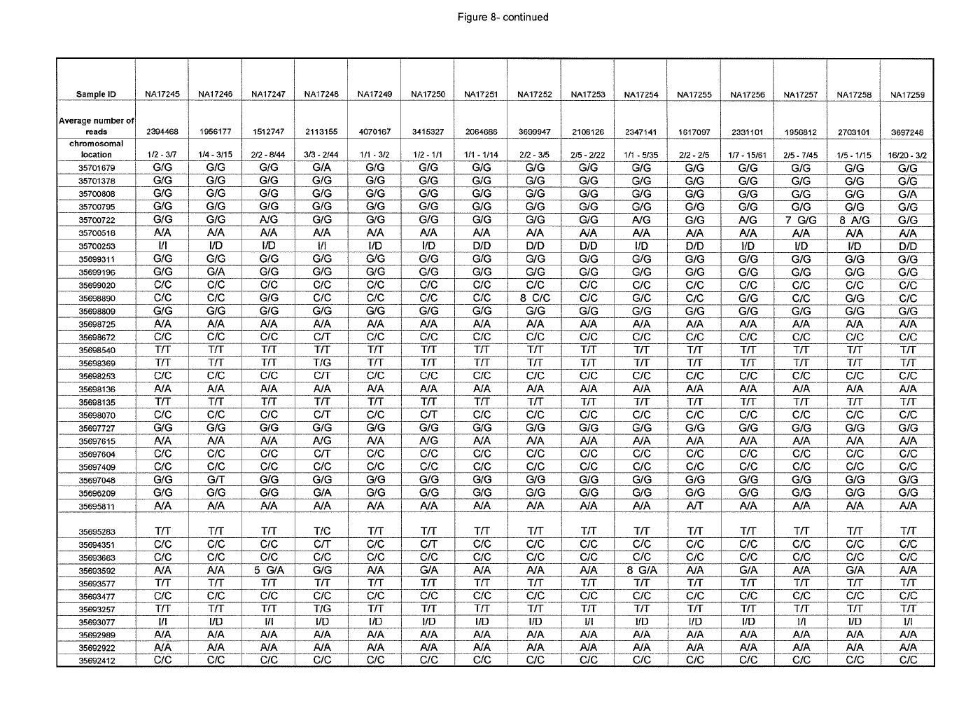

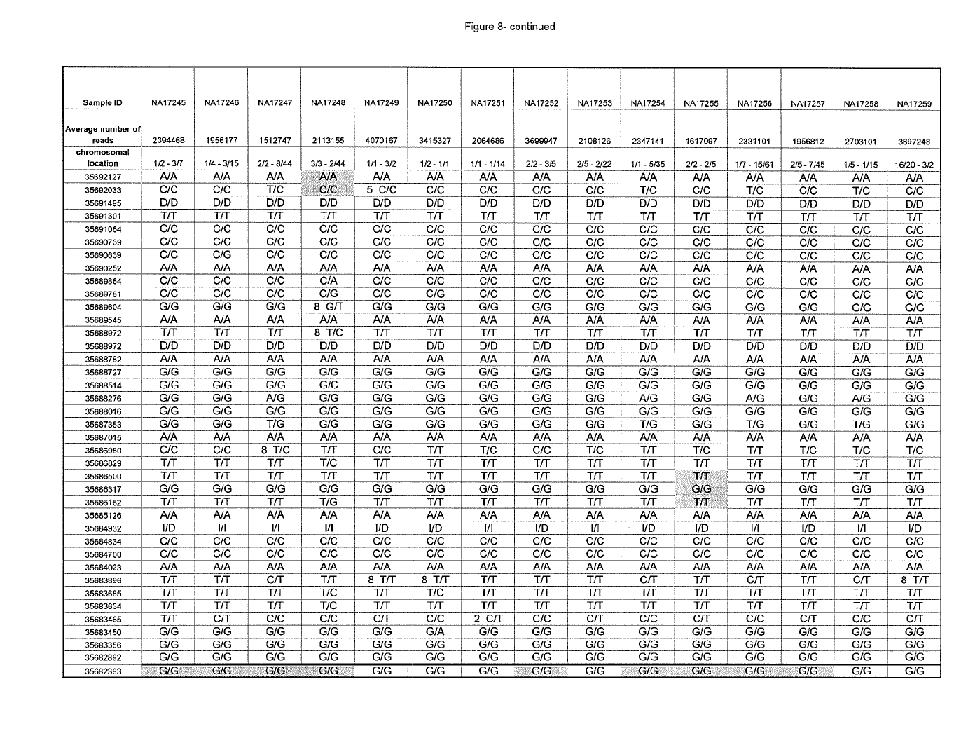

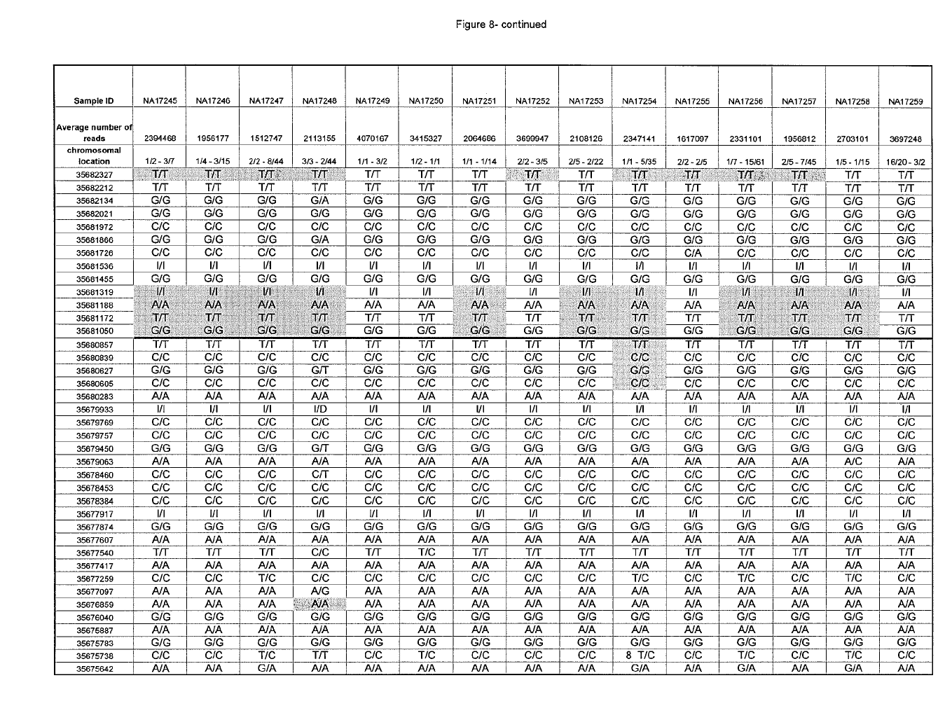

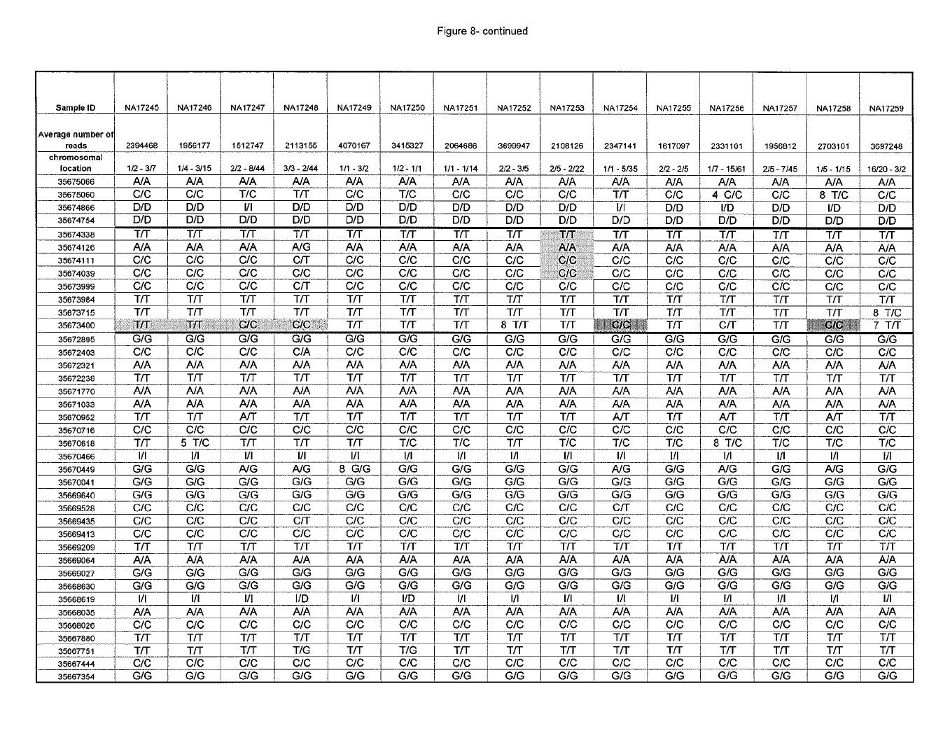

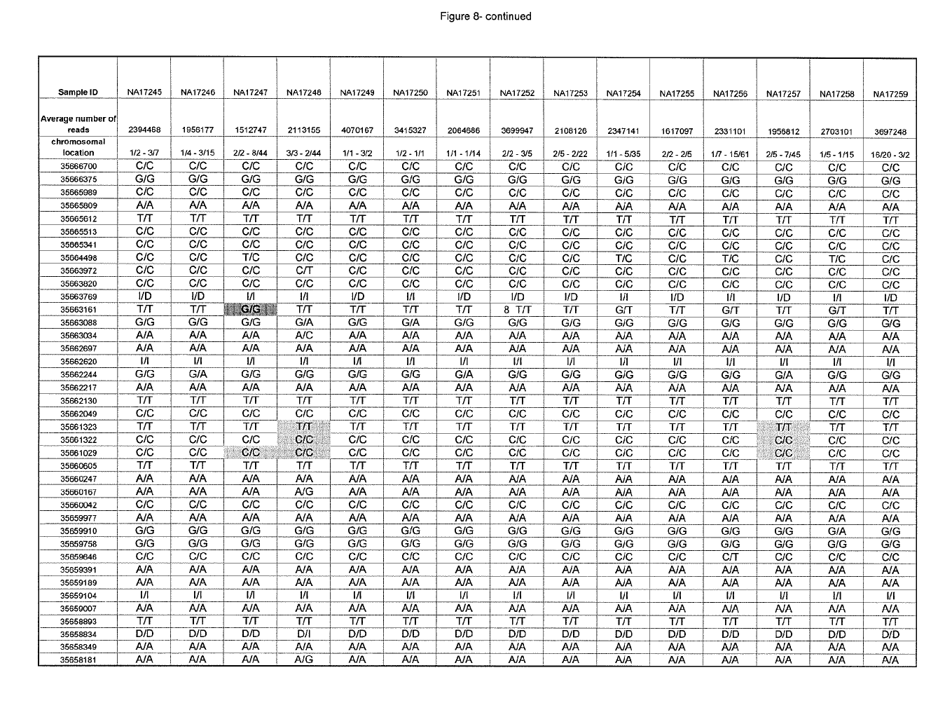

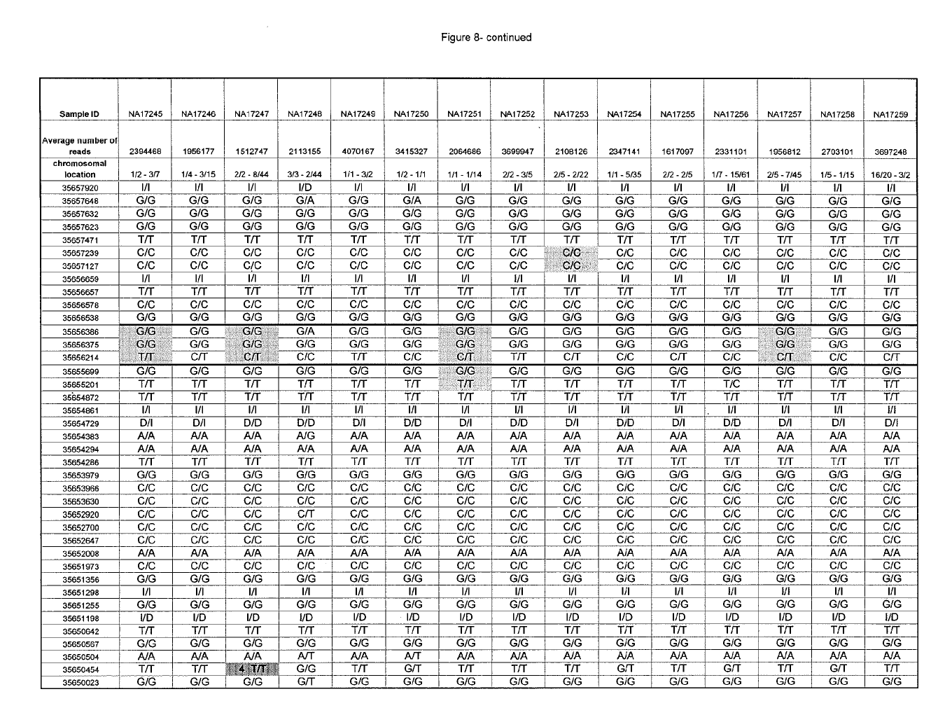

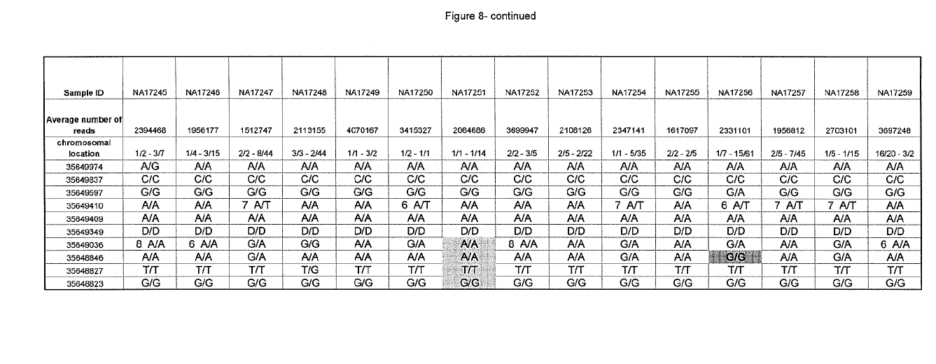

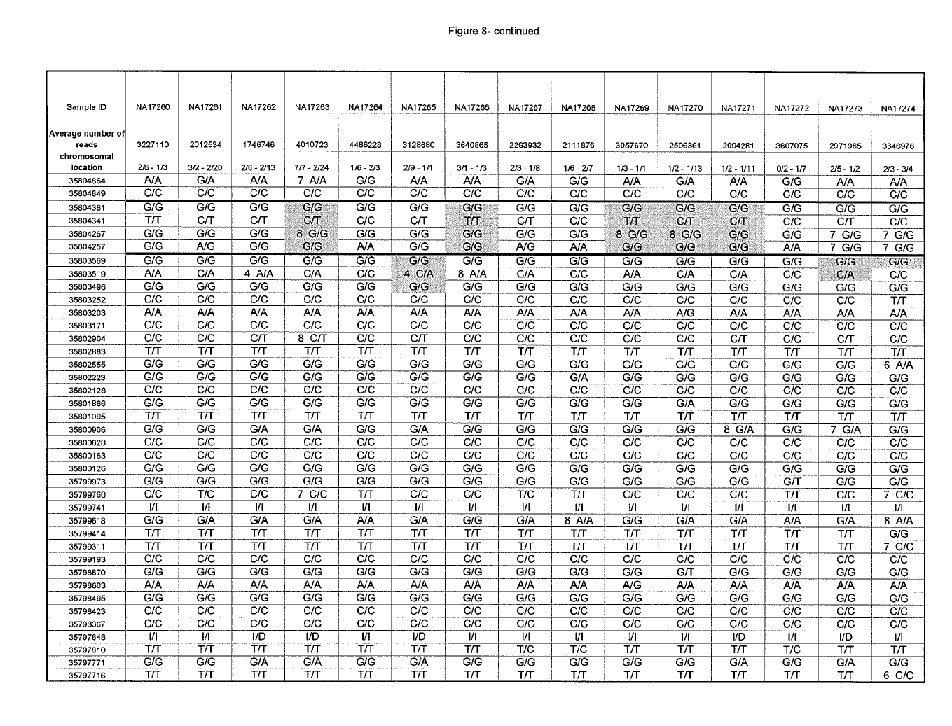

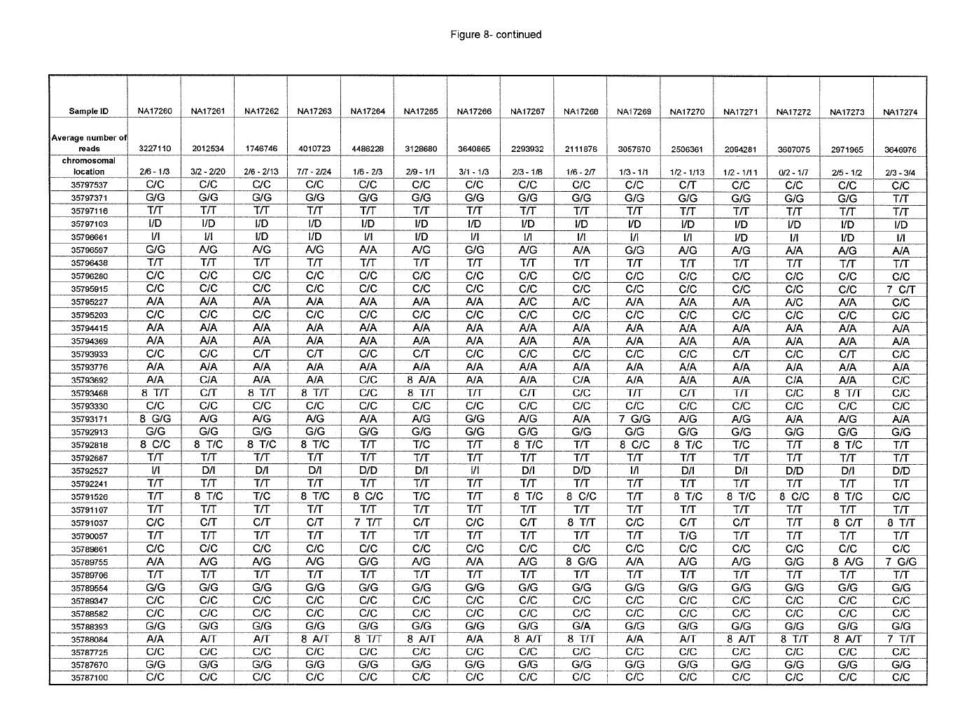

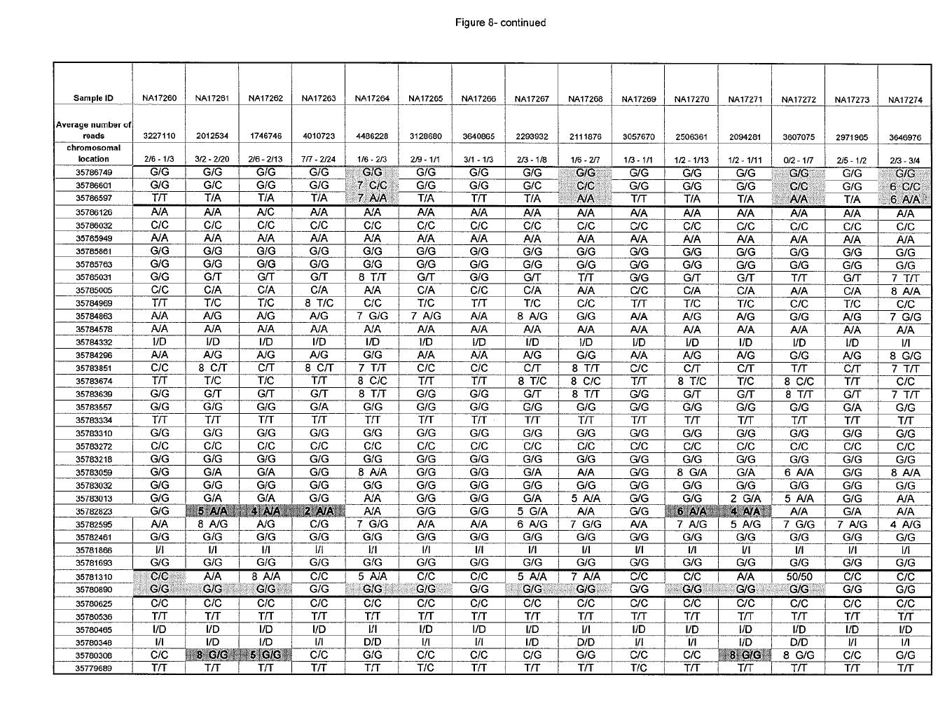

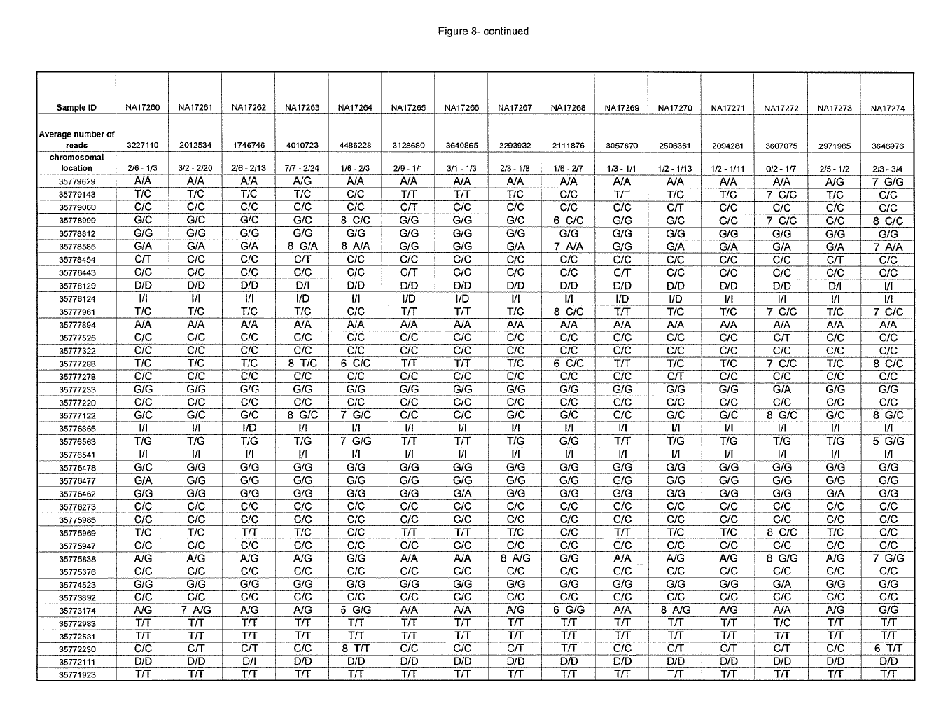

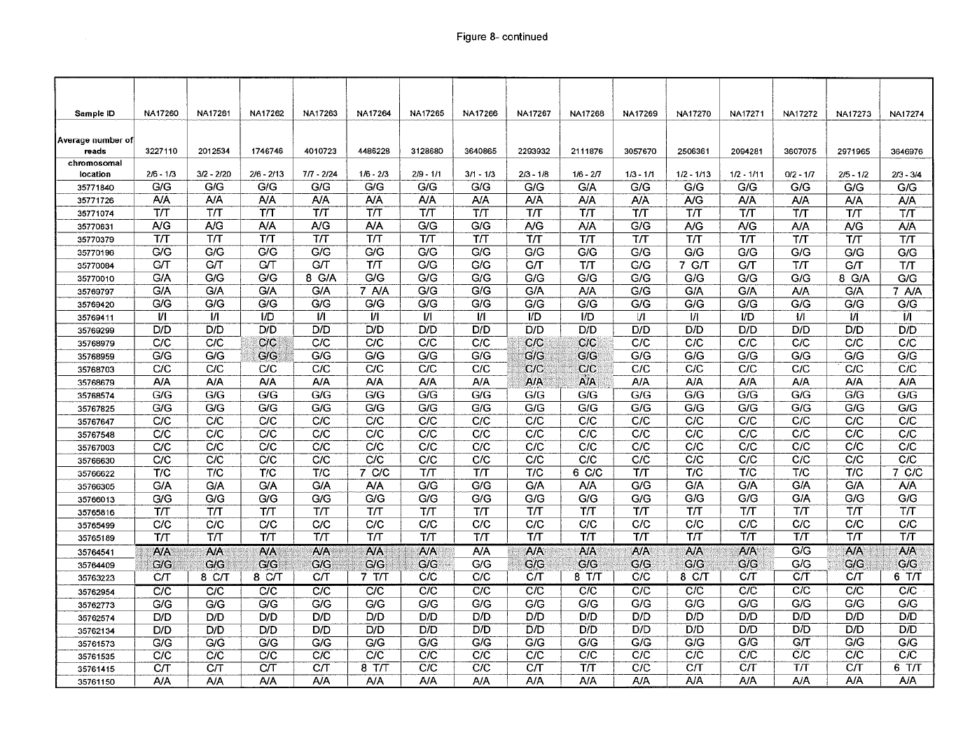

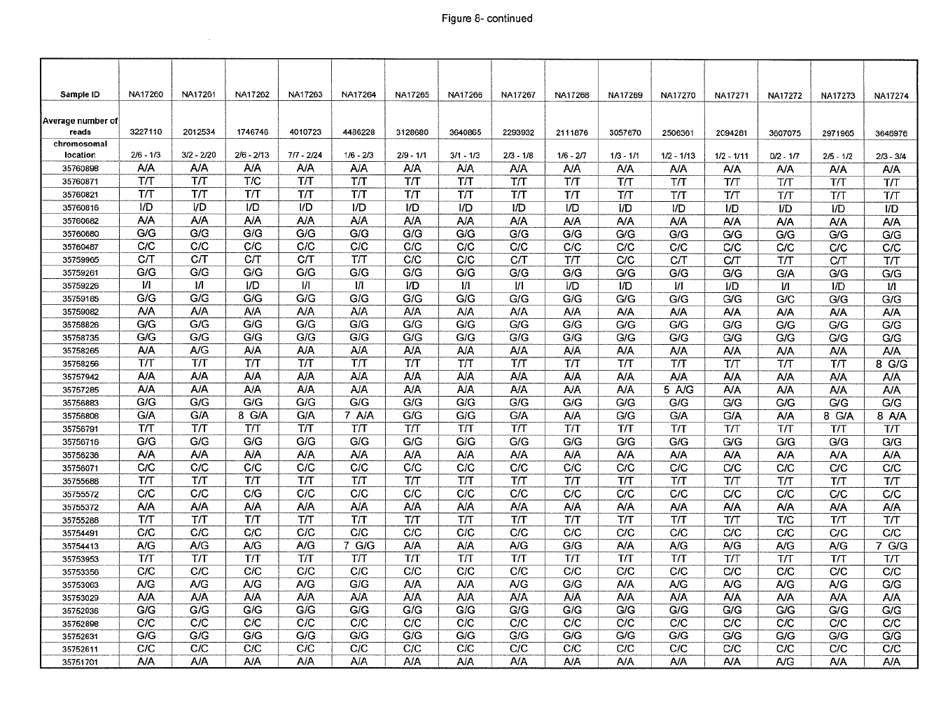

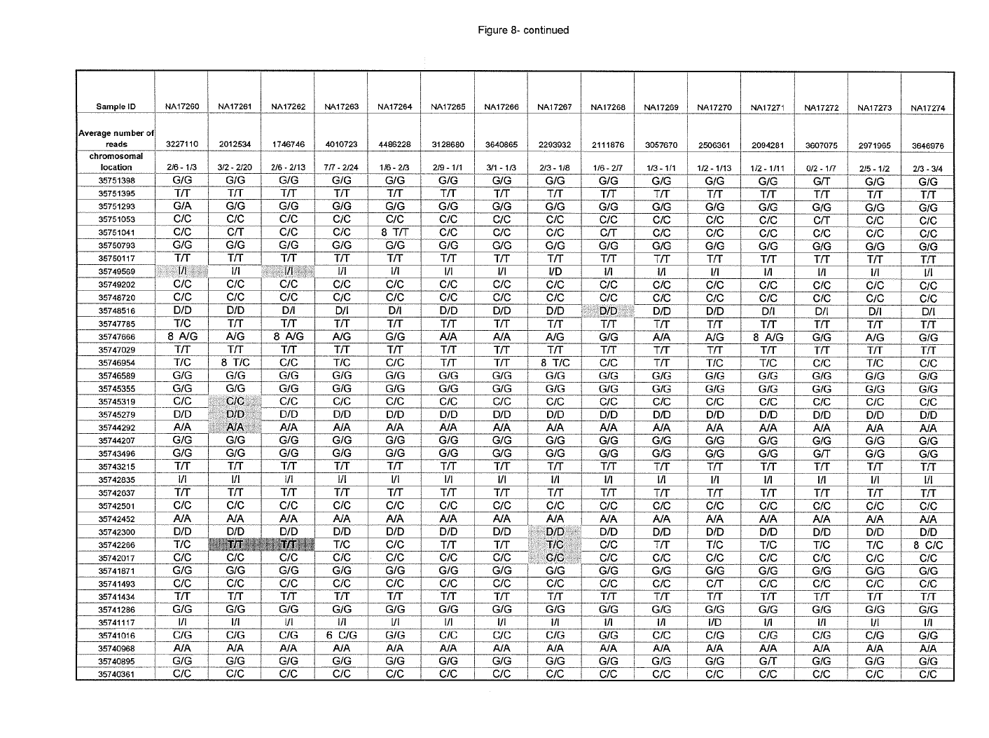

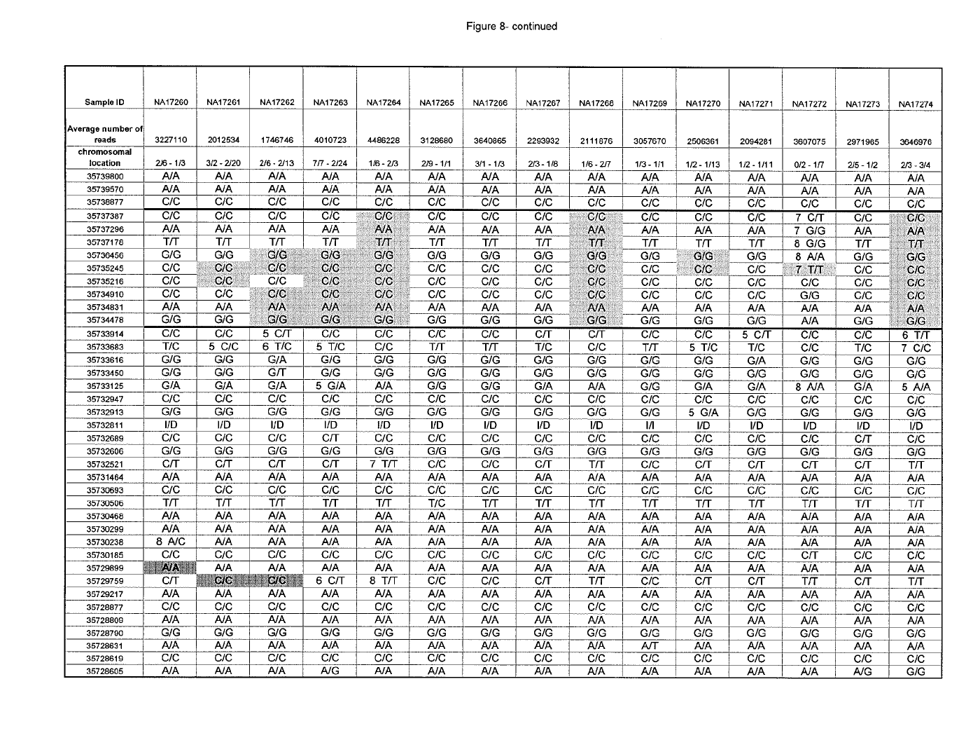

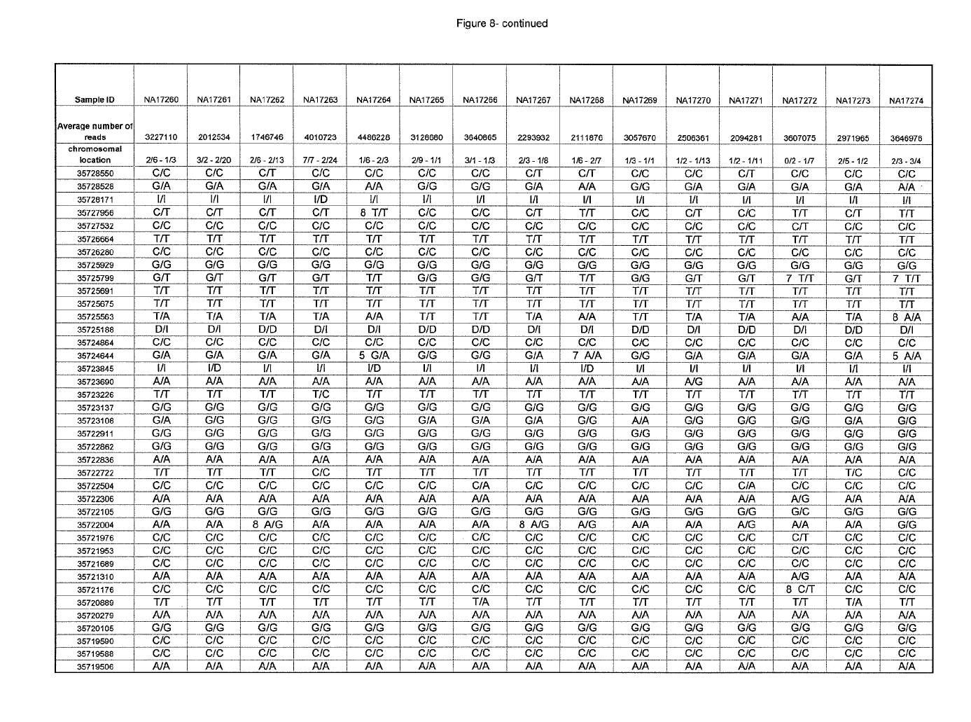

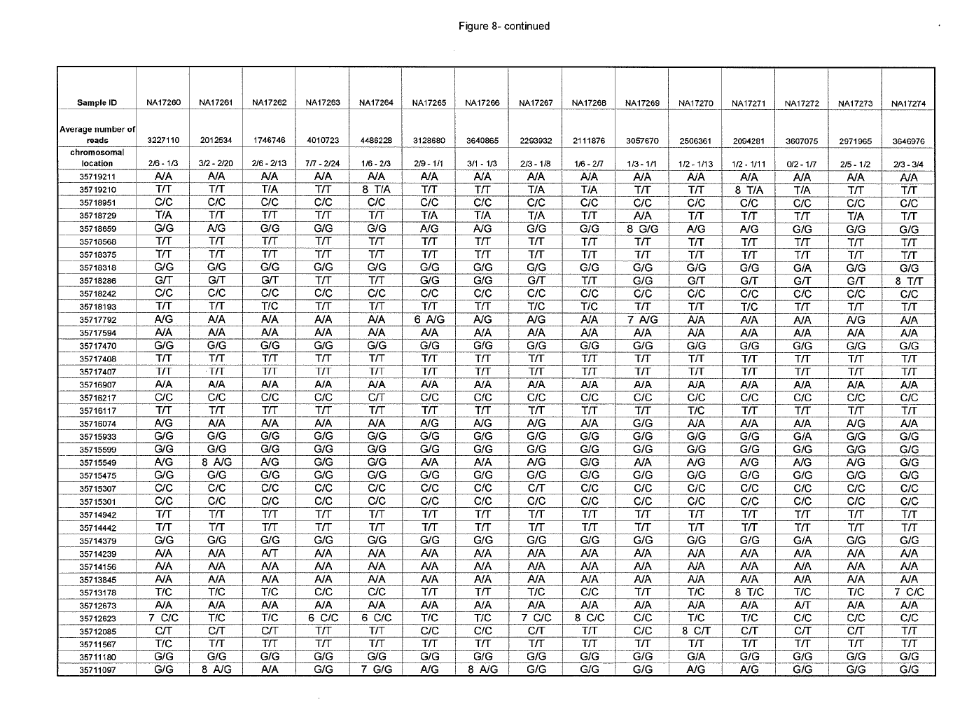

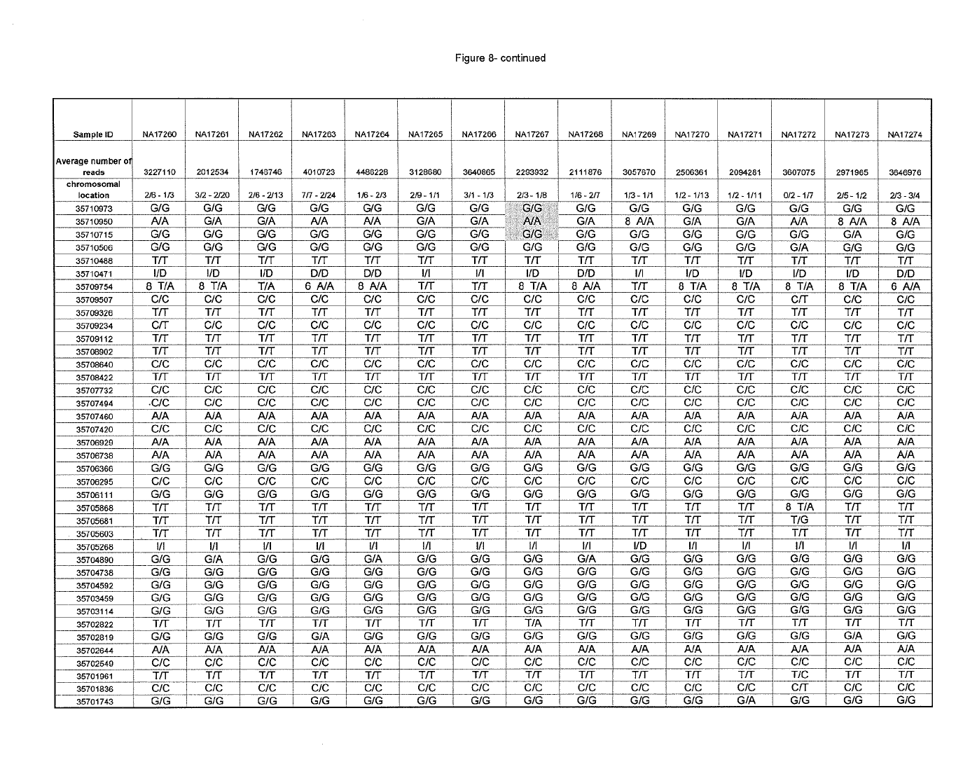

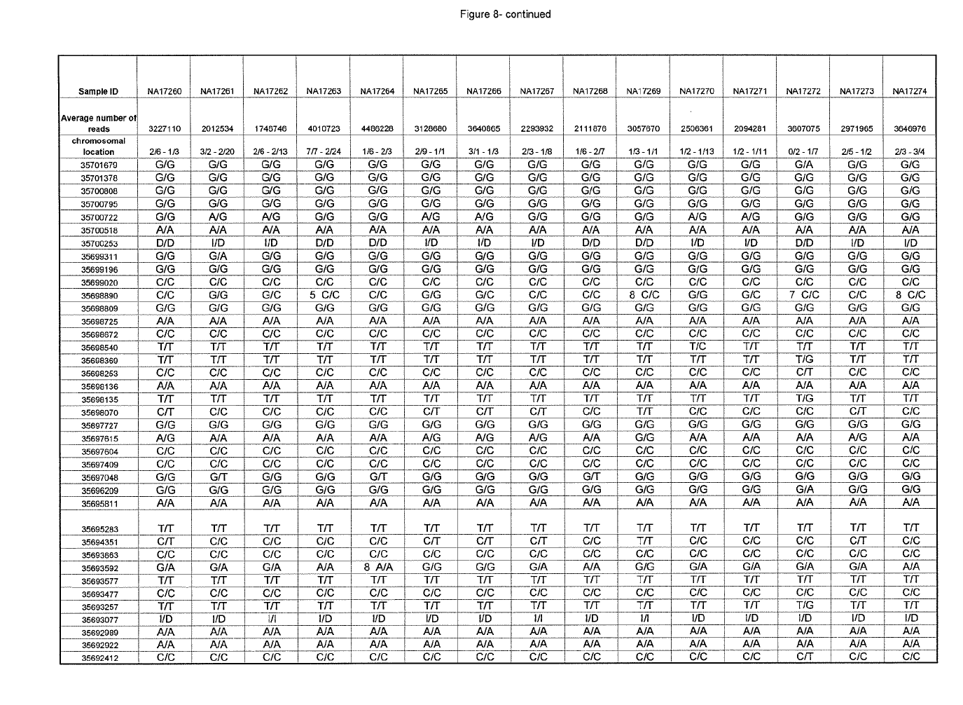

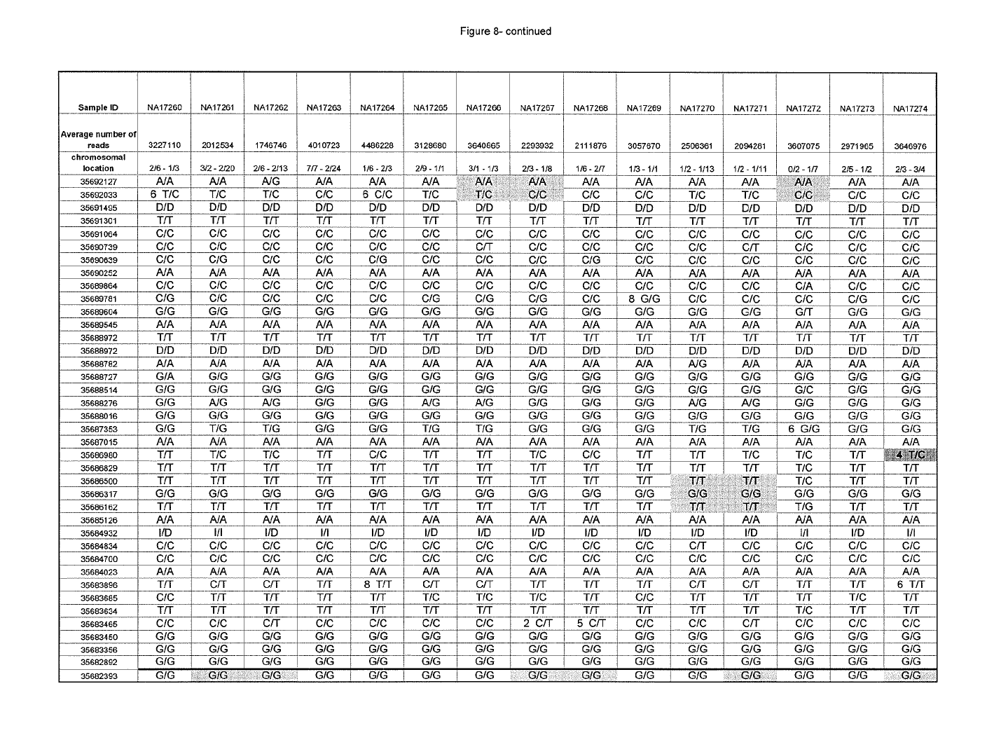

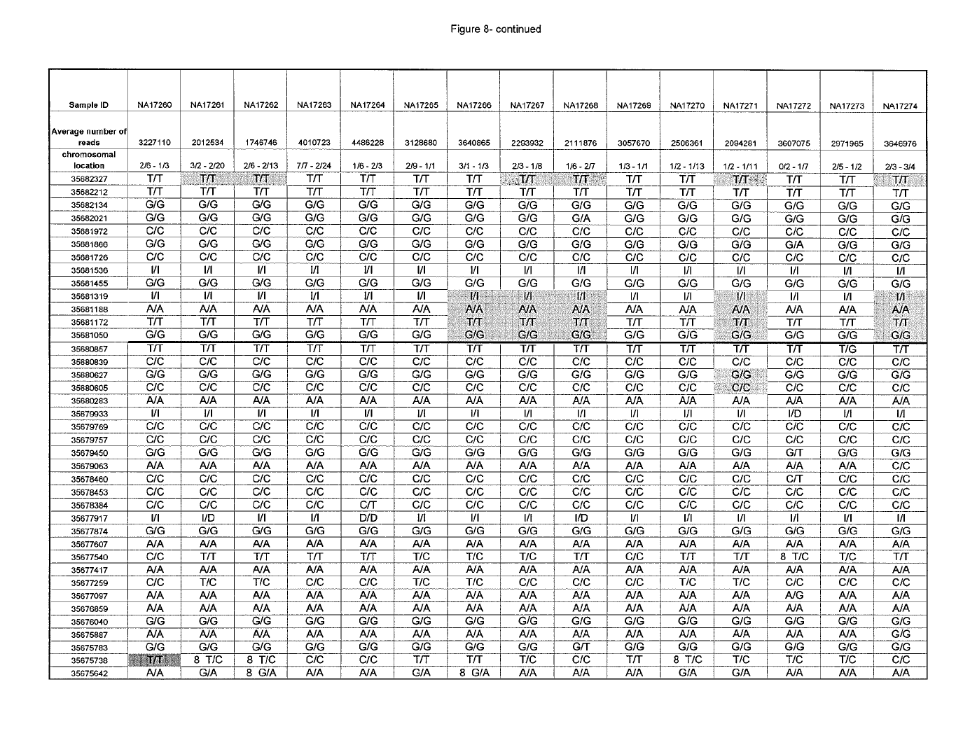

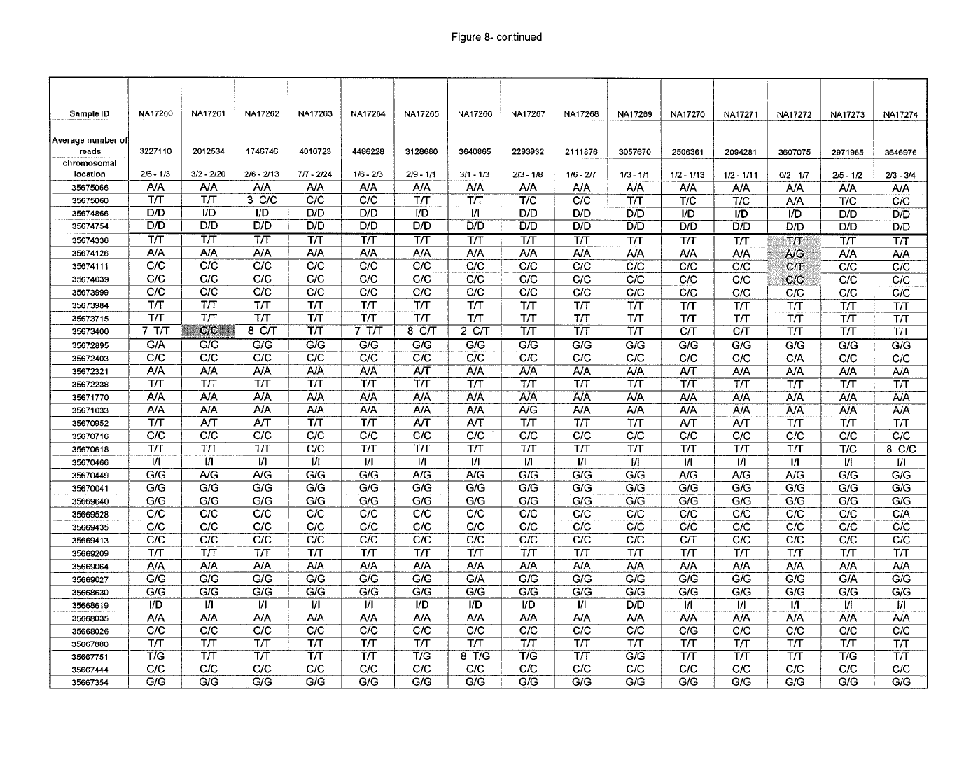

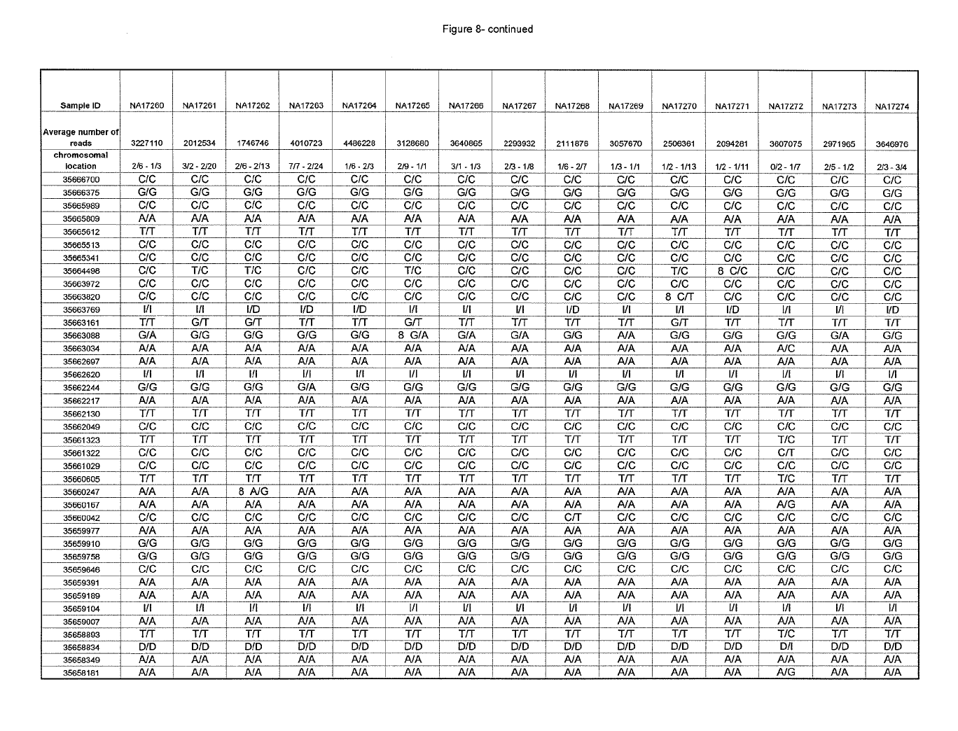

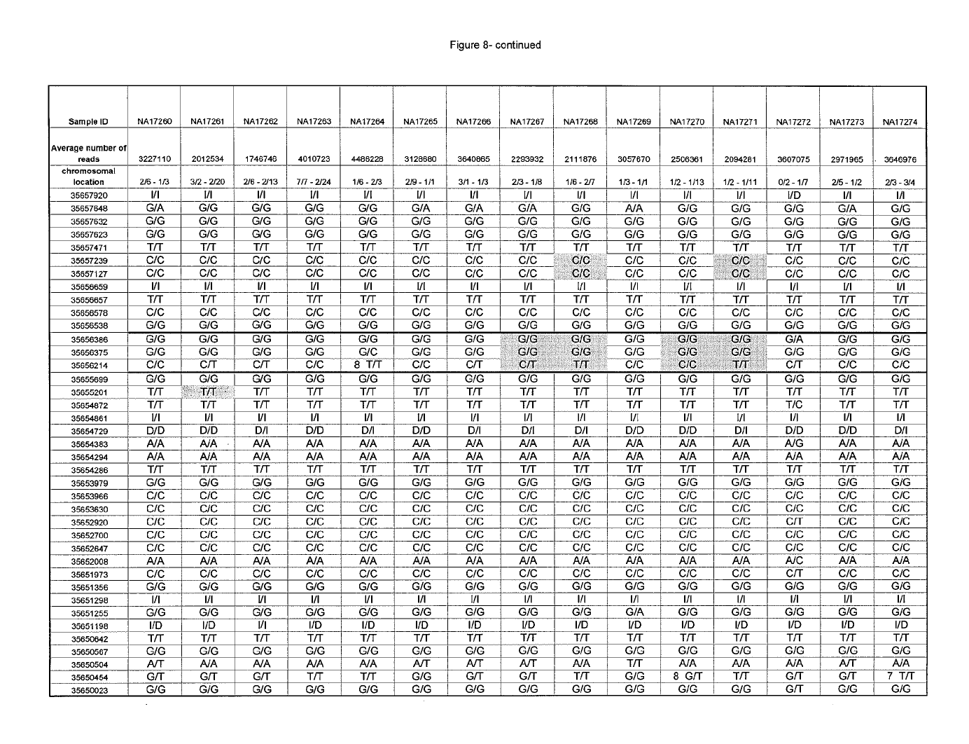

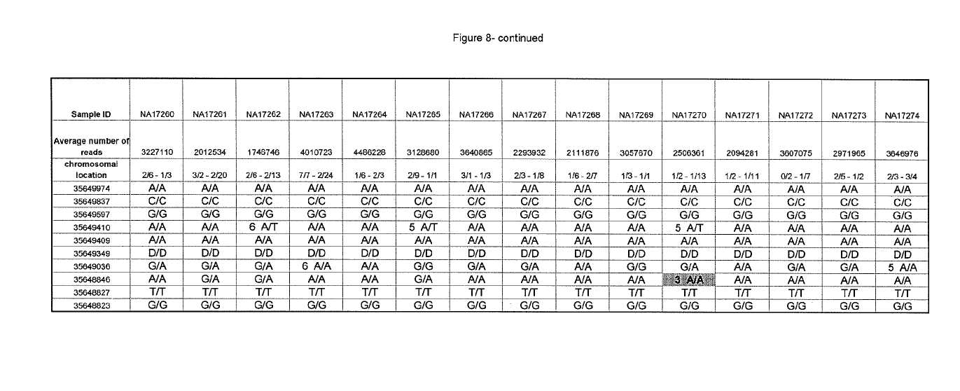

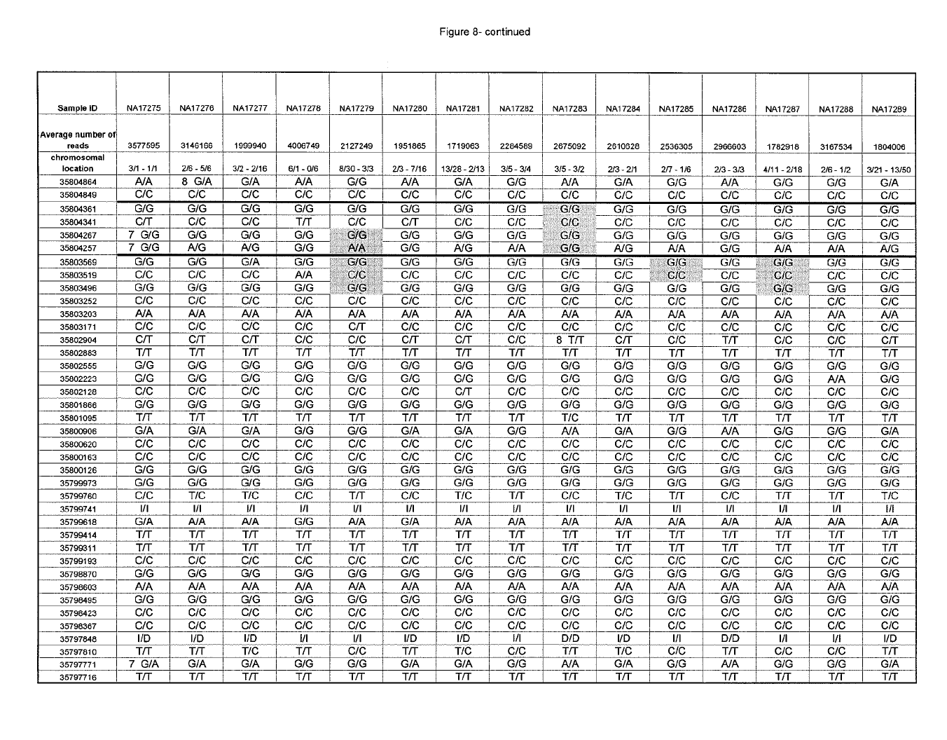

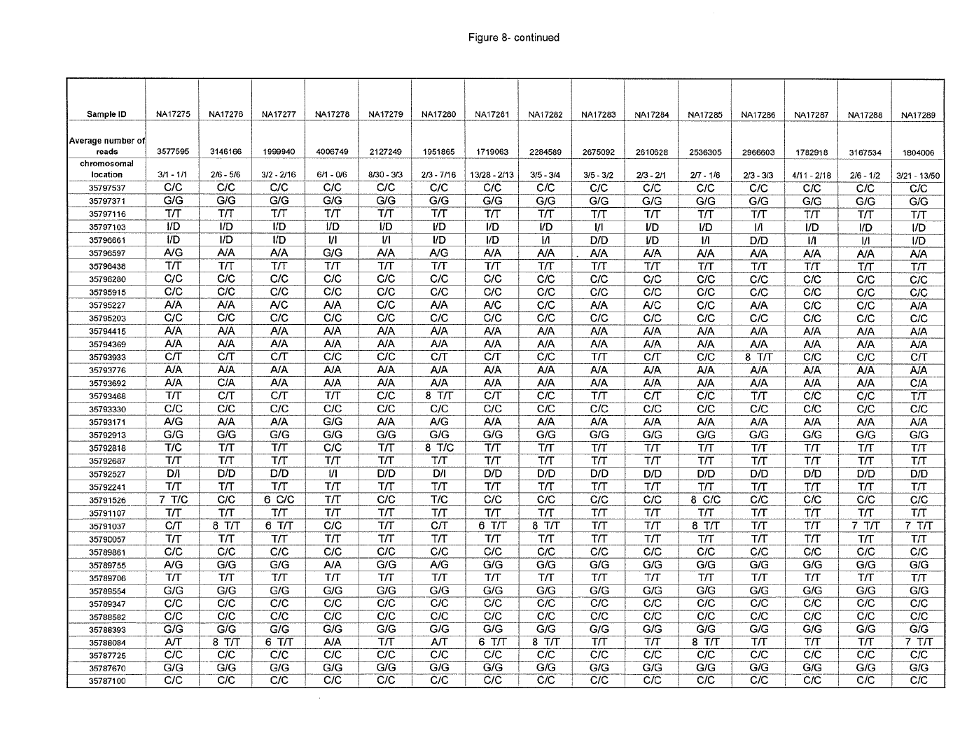

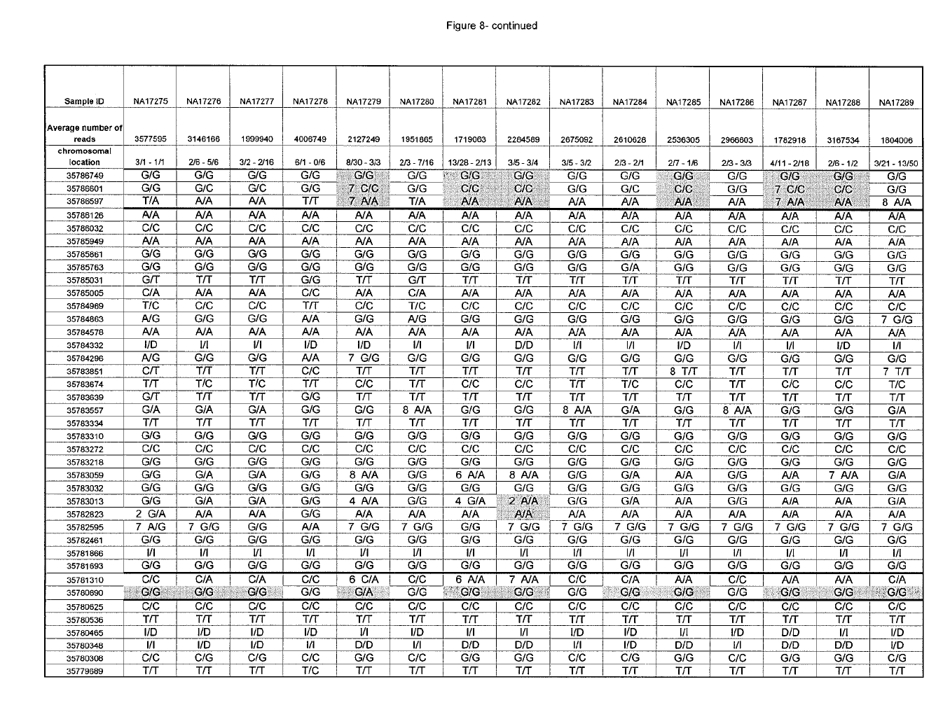

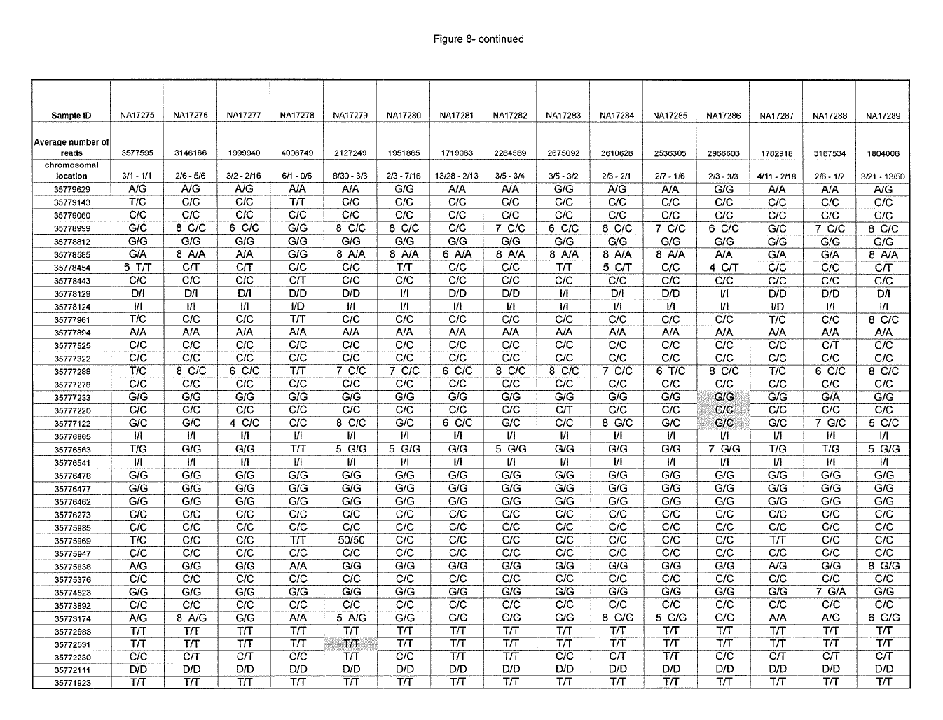

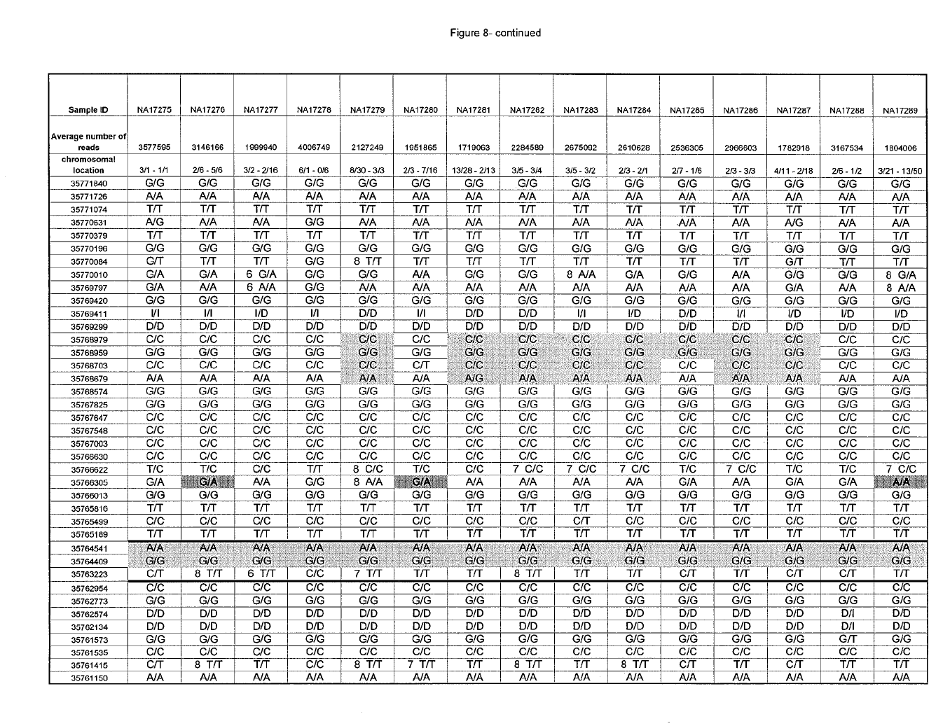

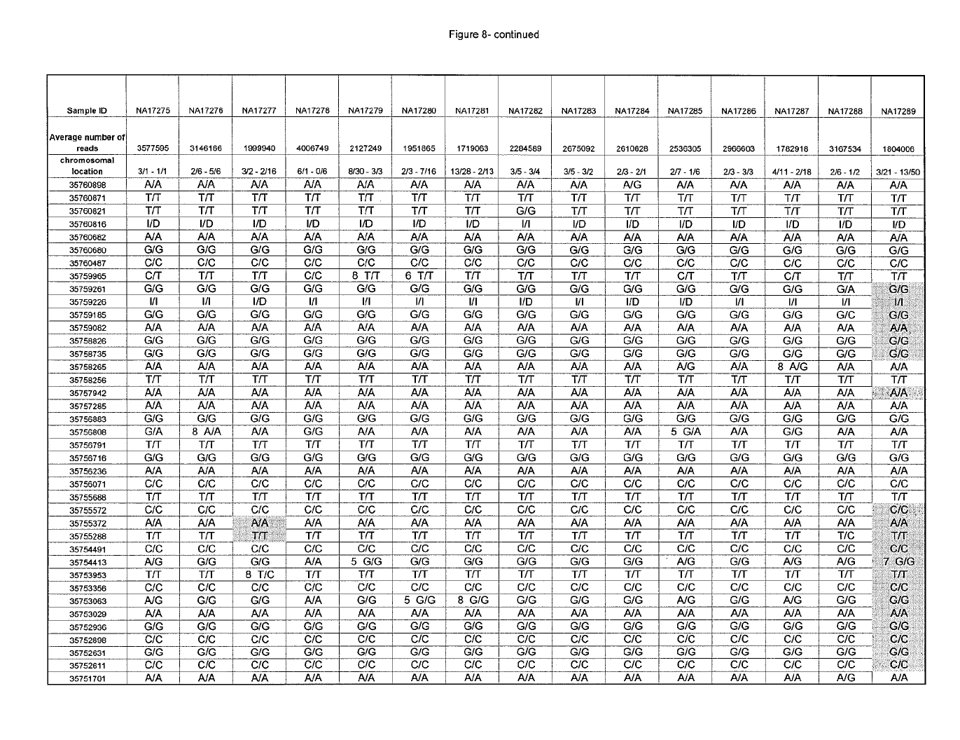

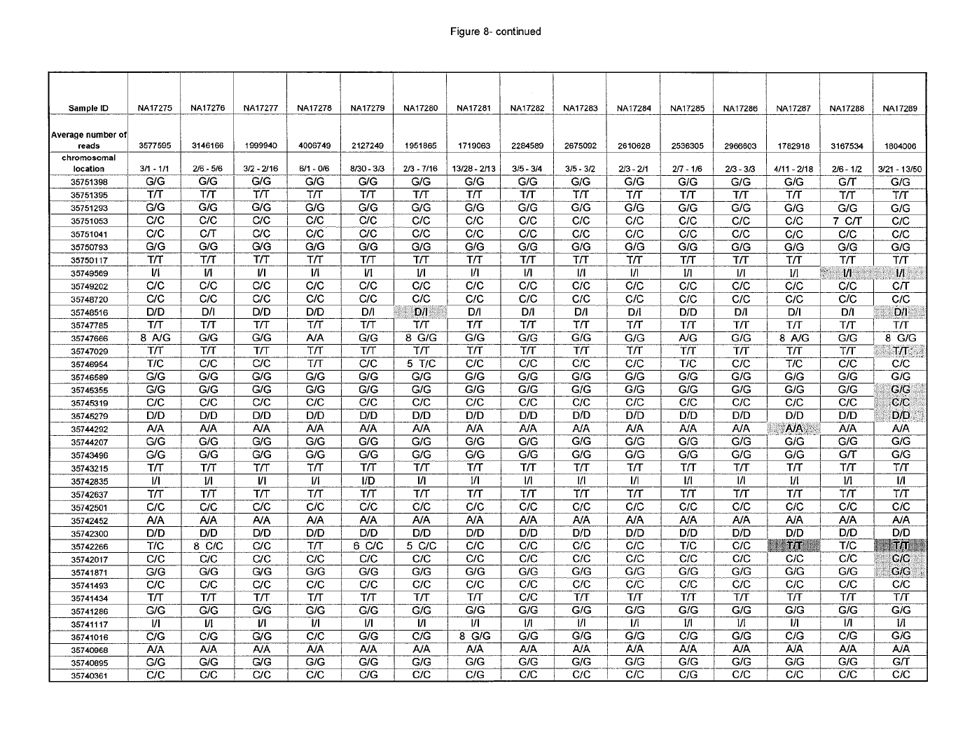

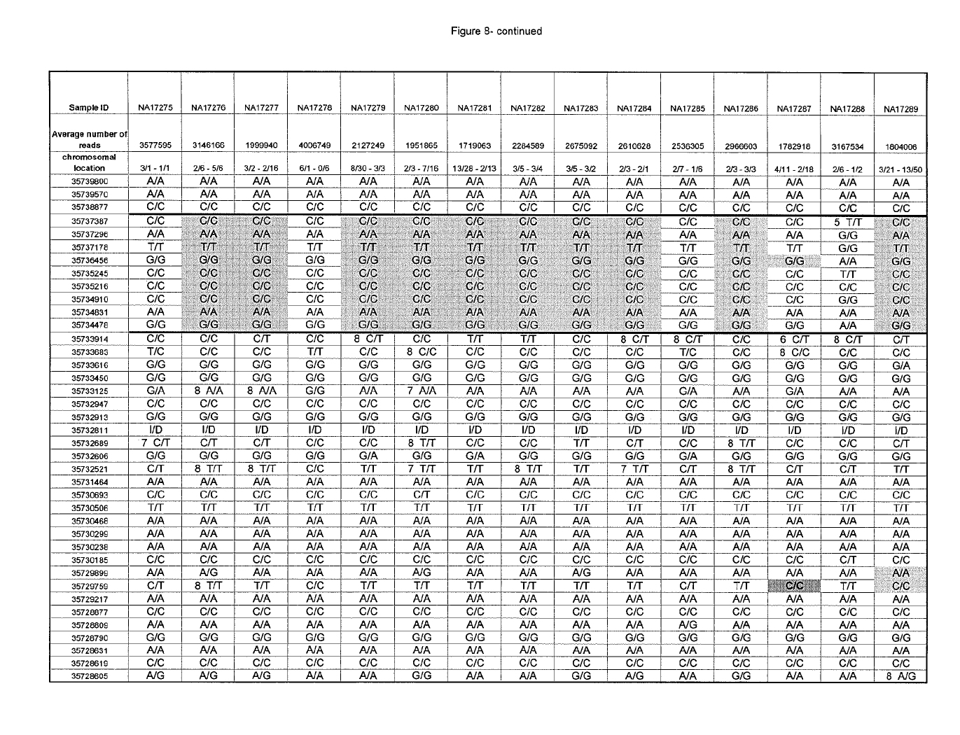

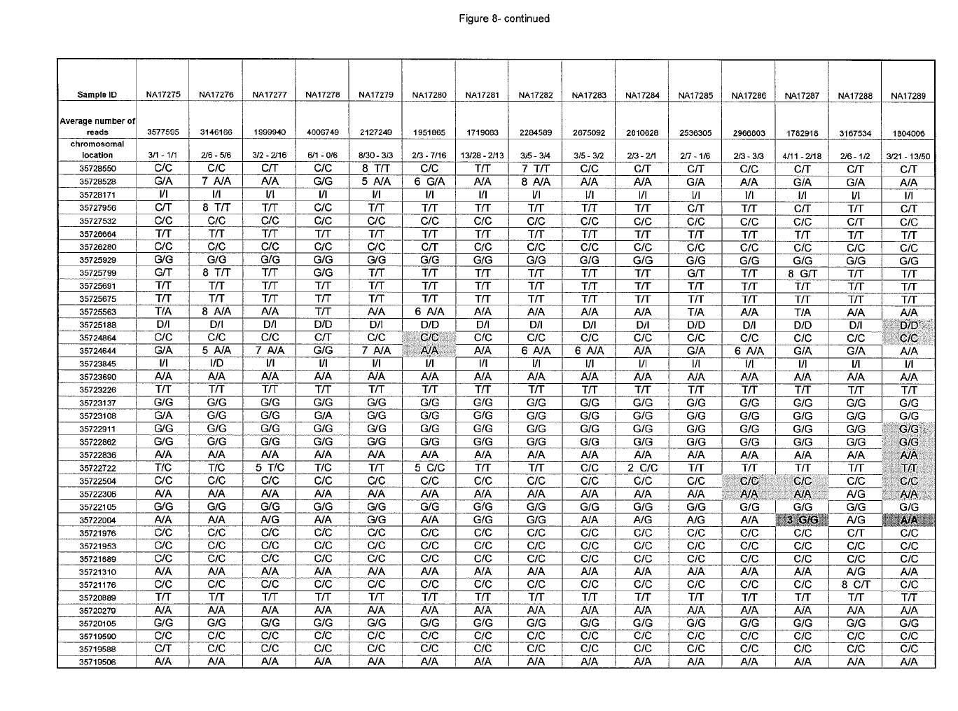

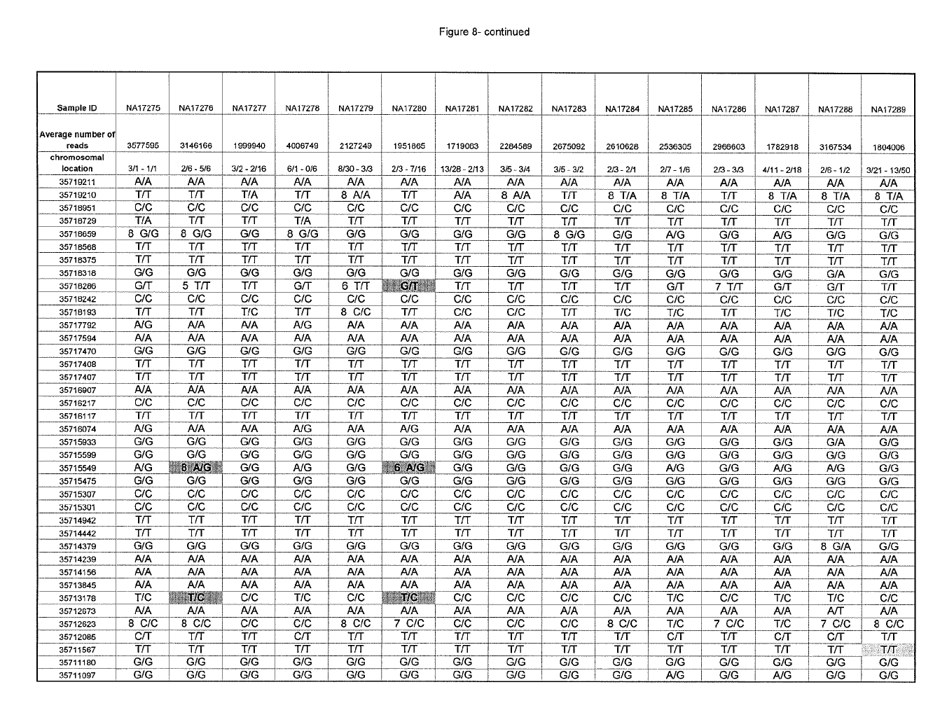

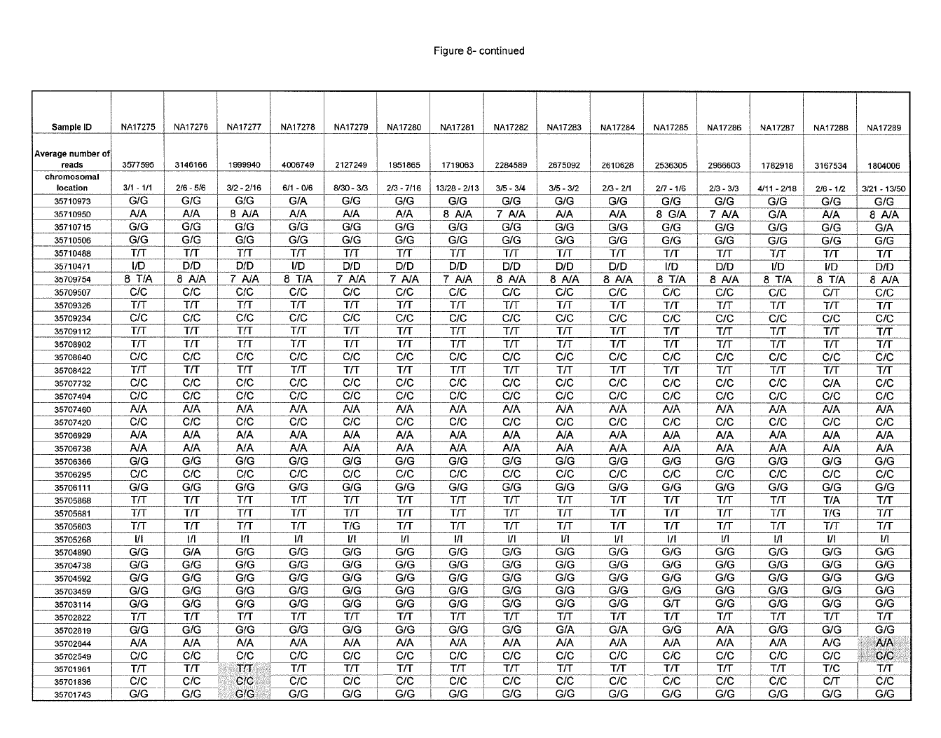

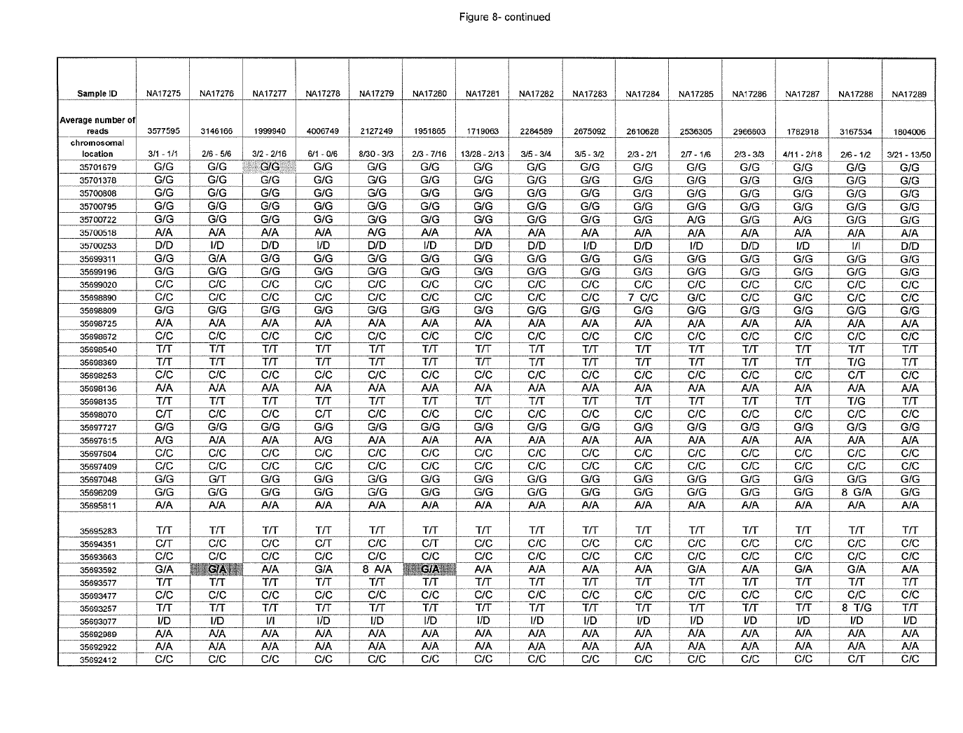

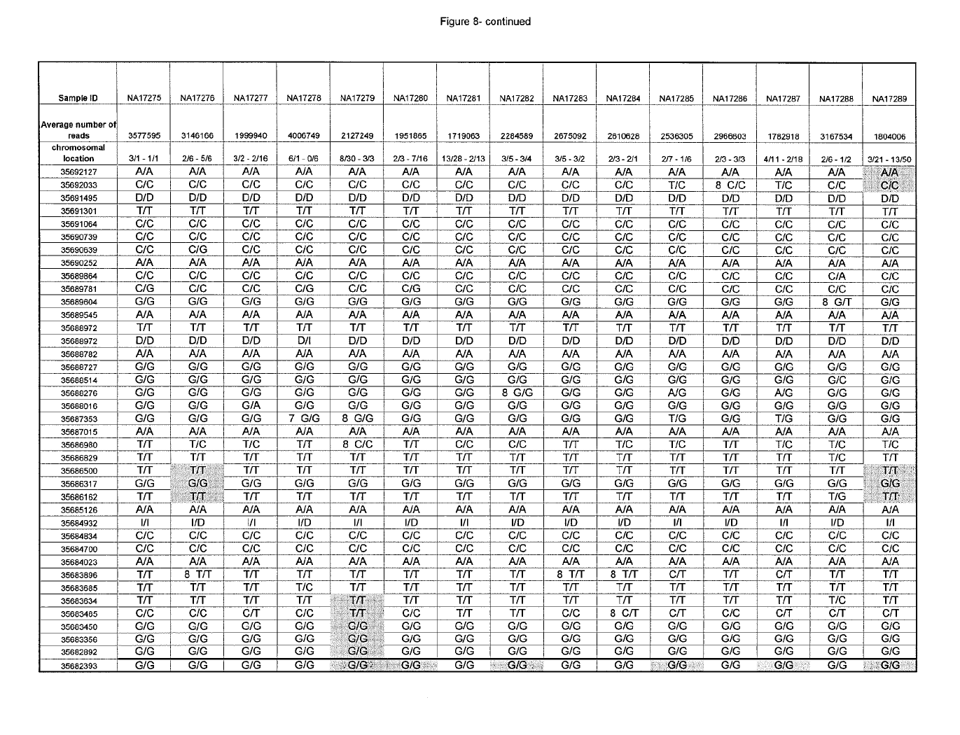

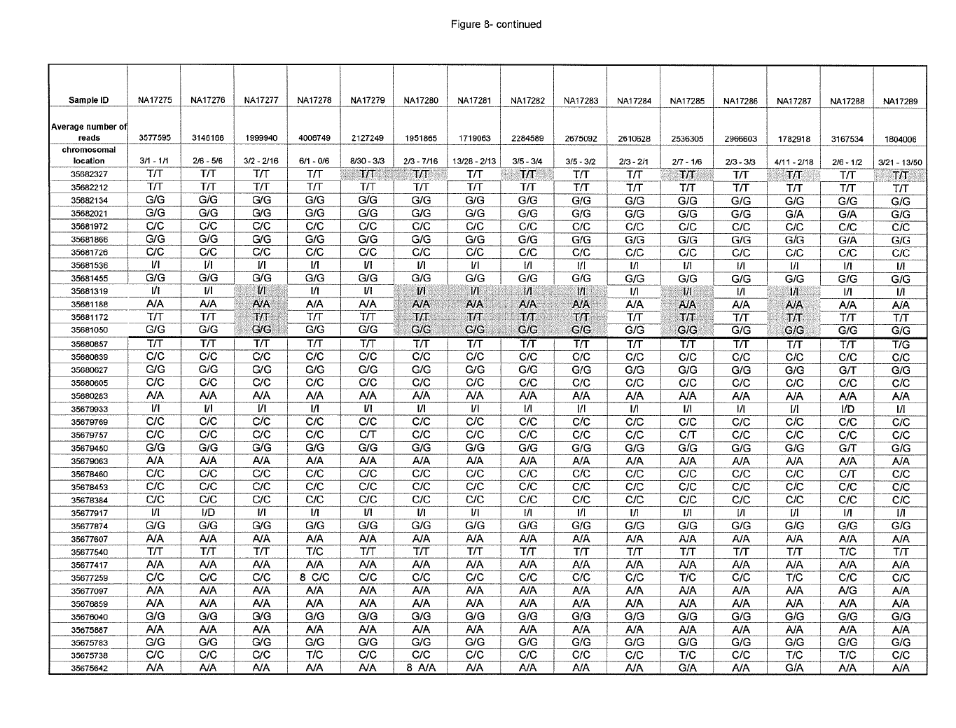

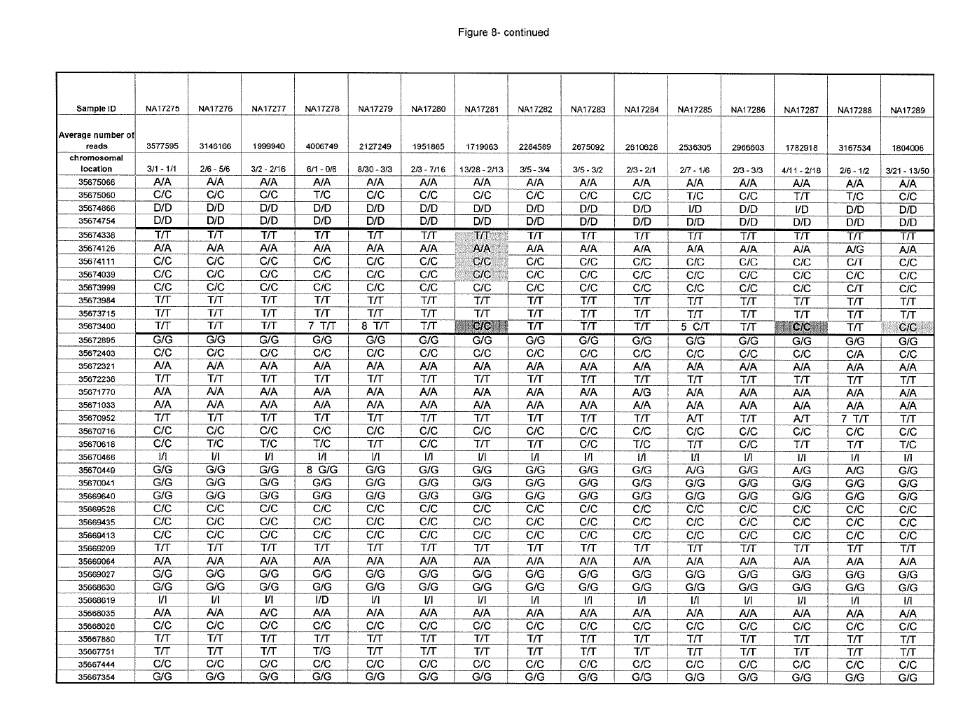

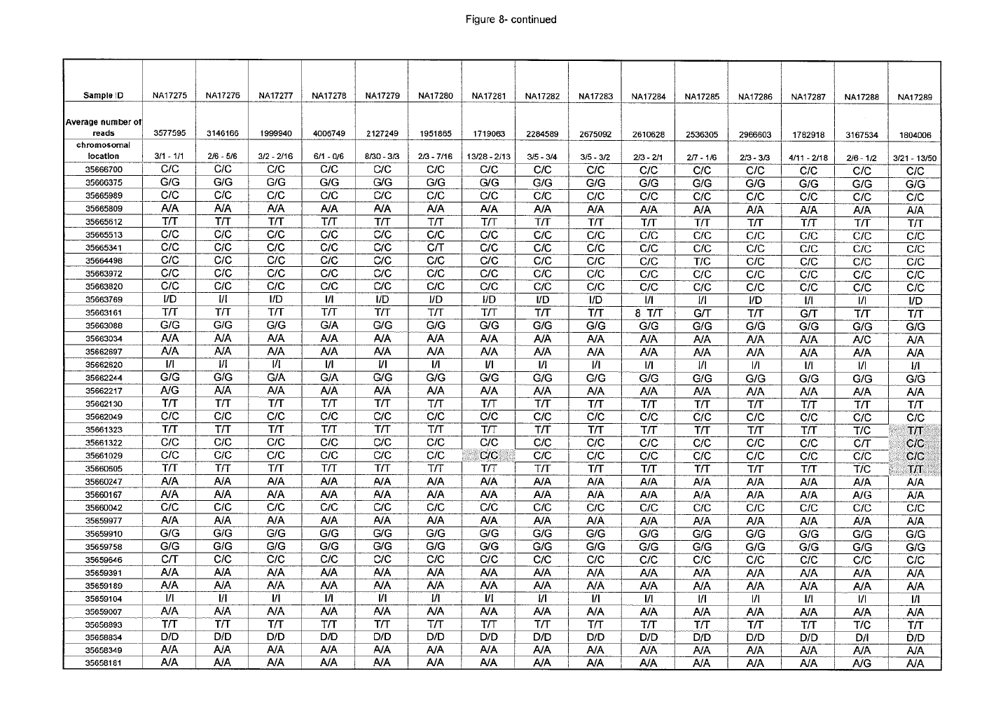

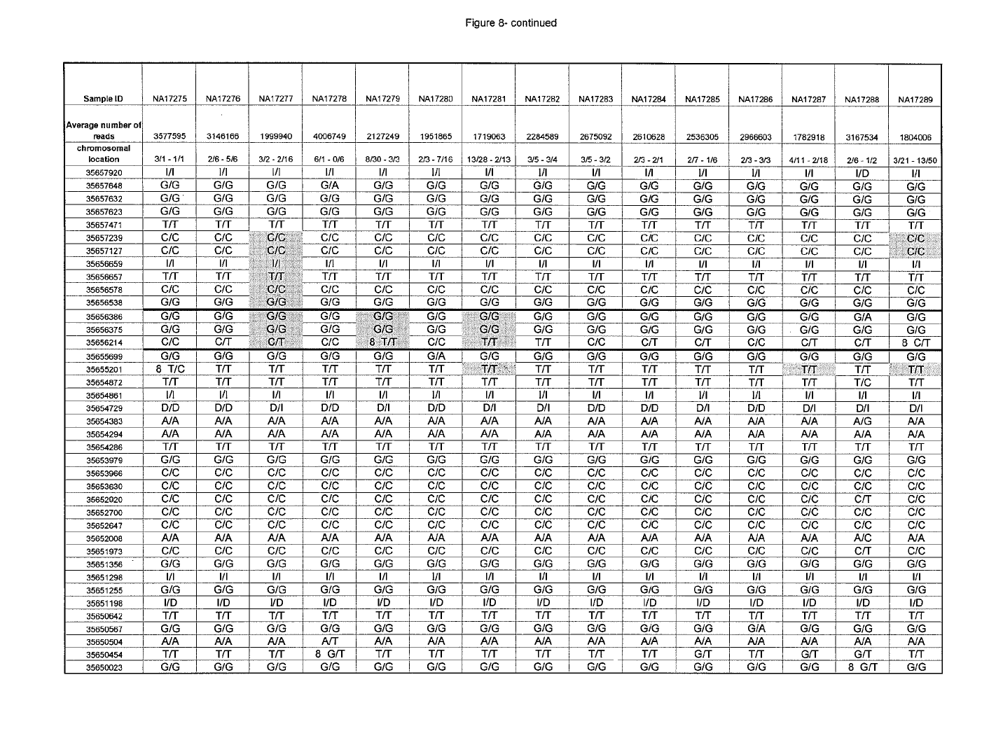

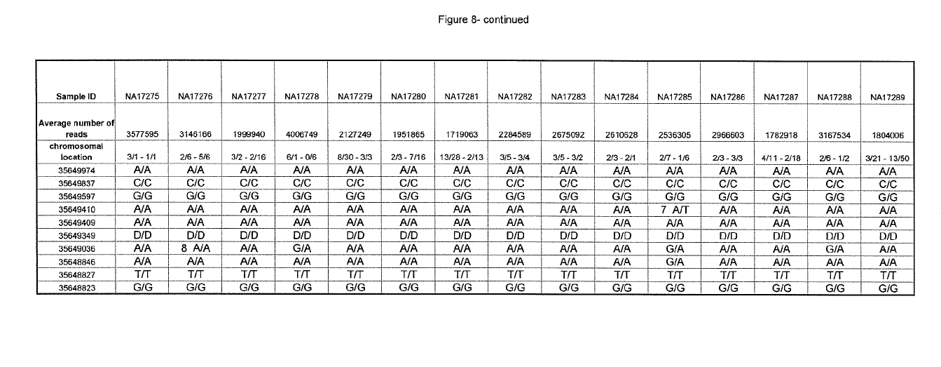

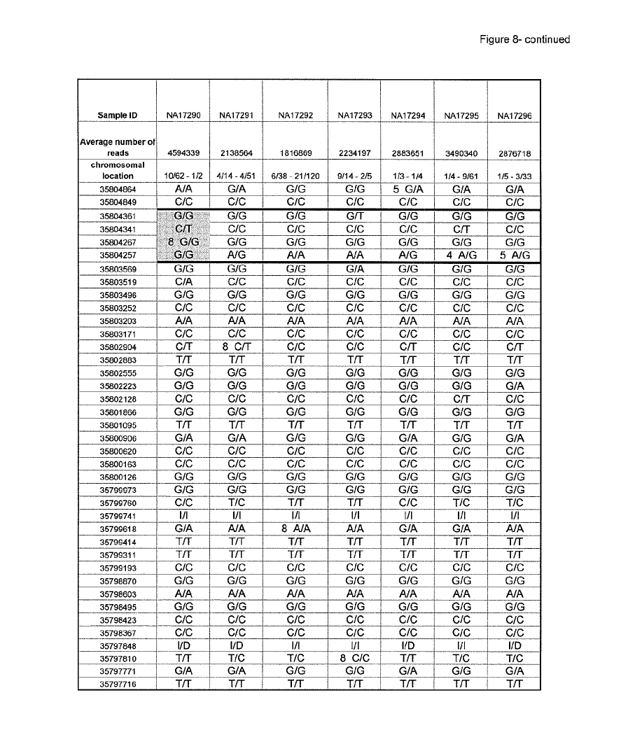

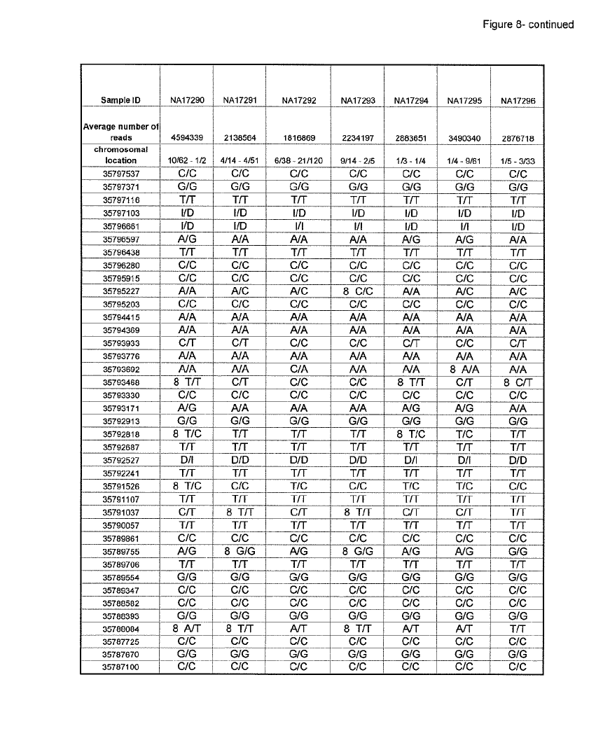

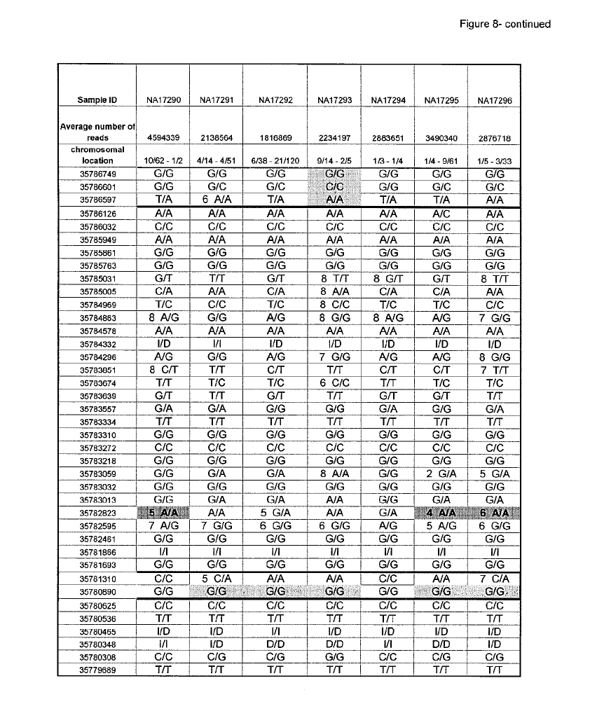

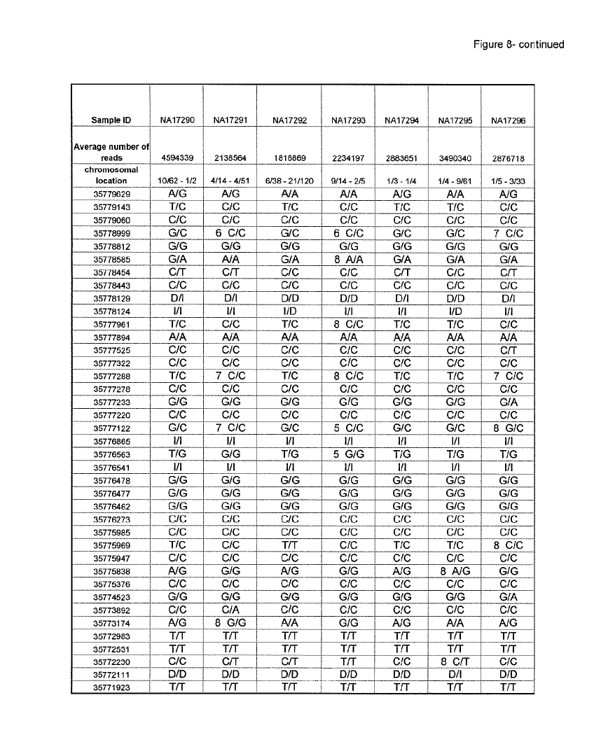

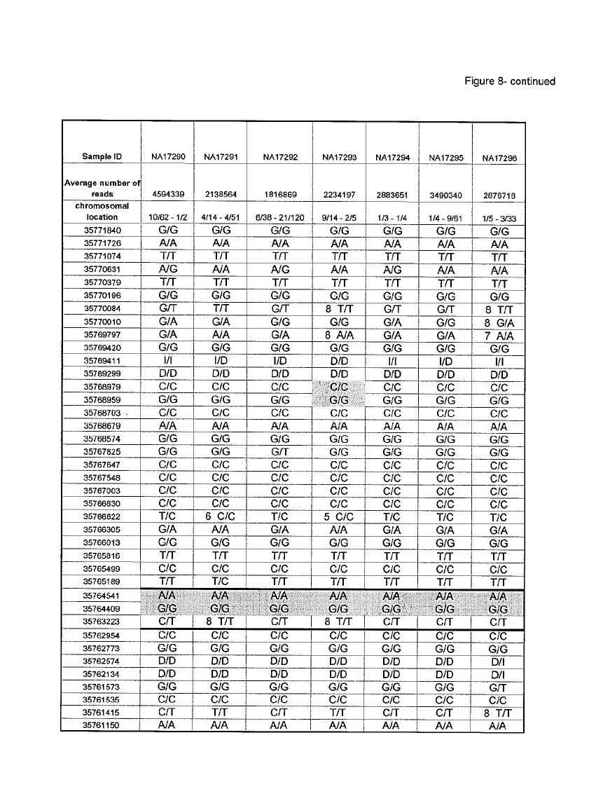

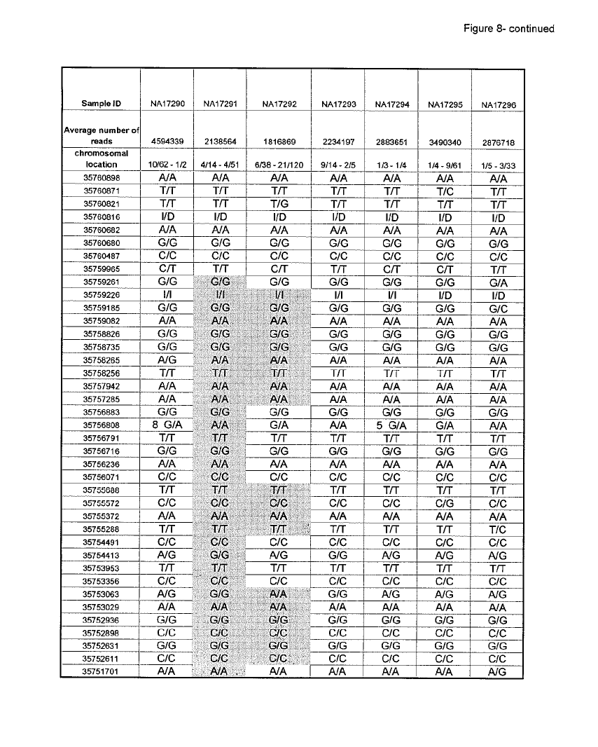

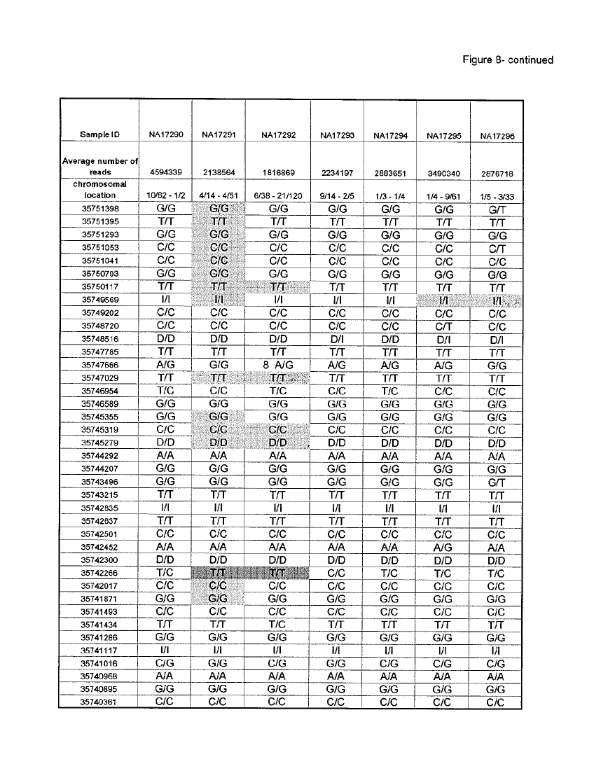

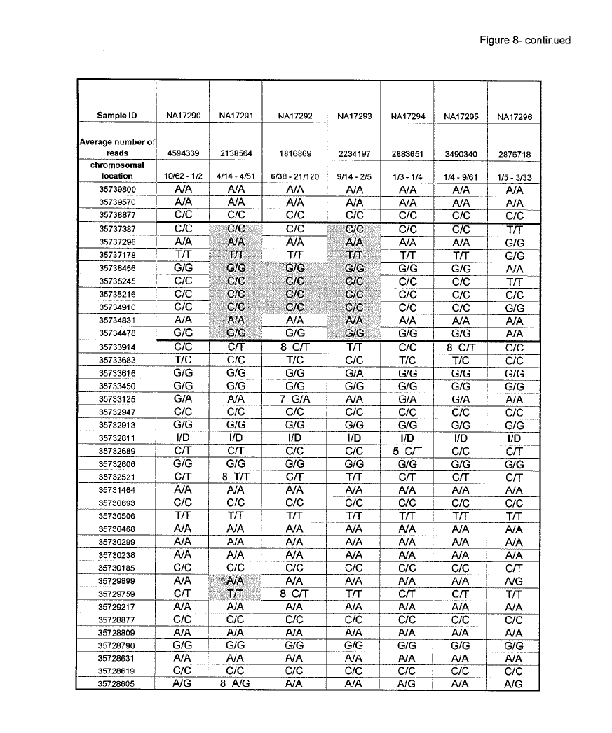

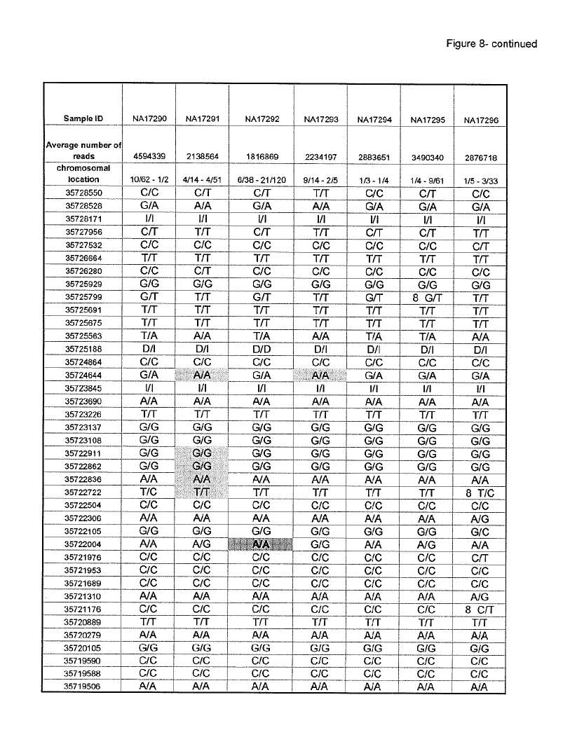

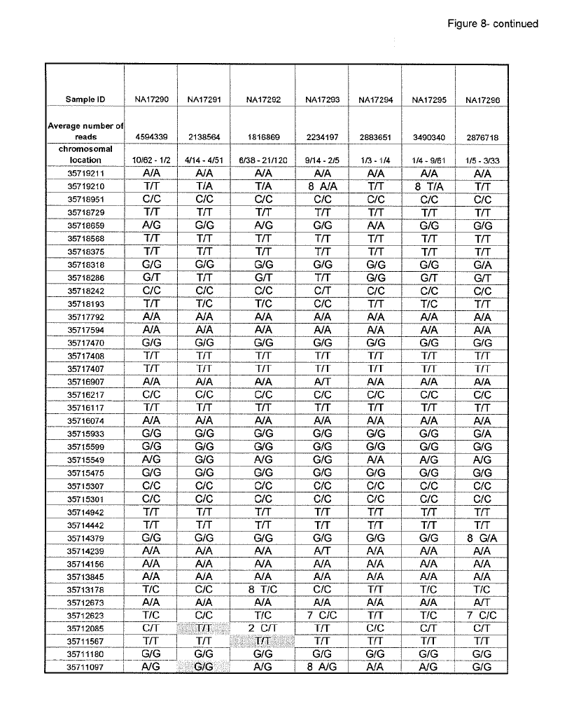

The Sanger method of sequencing, long considered the “gold standard” for accuracy, was performed. Three thousand three hundred and sixty genotypes were interrogated. No comparison could be made for 53 genotypes because the Sanger results failed. All of these were in intronic areas. Five genotypes were discordant between NGS and Sanger, and these too were in introns. This resulted in a 99.8% concordance between the two methods. With this, it also was possible to determine the number of false variant sites and missed variant sites over the areas amplified. The results showed no false variant sites and no missed variant sites with the exception of “gap 4” (FIG. 8).

There was genotyping data on these same samples from the Illumina 550 Kv3 and 510S SNP chips, as well as Affymetrix 6.0. Of the 5,088 genotypes, 17 were failed calls in one or the other technology, and 81 were discordant between the two. This resulted in a 98.4% concordance. Two of the SNPs, one from Illumina (rs7749607) and one from Affymetrix (rs9470065) had been previously genotyped in 96 Coriell Caucasian samples, and they were not found with NGS. To validate this further, Sanger sequencing was used and found the NGS results in agreement for rs9470065 but not for rs7749607. This was not surprising since the single sample in which rs7749607 was found had a reliability index of 3/31, indicating numerous gaps and consequent alignment ambiguities (Table 9). Overall, when combining the two, this method revealed a 98.97% concordance (95% CI: 98.6-99.2). Only one of the Sanger SNPs (rs2143404) overlapped with the Illumina genotyping set. All three methods (NGS, ABI Sanger, and Illumina) revealed 100% concordance across all 96 genotypes.

TABLE 9
Reliability Index
Population Reliability Index

| First ⅓ of the gene | | | | Second ⅔ of the gene | | | |
|---|---|---|---|---|---|---|---|
| | | Within primer | | | | Within primer | |
| DNA sample | | areas; data | | DNA sample | | areas; data | |
| ID taken from | First ⅓ of | taken from | | ID taken from | Second ⅔ | taken from | |
| the Coriell | the gene | v1.10 Exp | | the Coriell | of the gene | v1.10 Exp | |
| Institute | nice_print | 5 out put | | Institute | nice_print | 5 out put | |
| Human | 2618-58367 | Number of | | Human | 39365-159594 | Number of | |
| Variation | chr6: | major gaps | | Variation | chr6: | major gaps | |
| Panel- | 35,805,383-35,749,634 | A major | | Panel- | 35,768,636-35,648,407 | A major | |
| Caucasian | Number of | gap is | Number of | Caucasian | Number of | gap is | Number of |
| Panel of 100 | reads | >100 bp | minor gaps | Panel of 100 | reads | >100 bp | minor gaps |
| NA17206 | 1232963 | 0 | 0 | NA17229 | 5427820 | 0 | 0 |
| NA17207 | 3223018 | 0 | 1 | | | | |
| NA17208 | 2393629 | 0 | 1 | | | | |
| NA17211 | 2998353 | 0 | 2 | | | | |
| NA17219 | 1911028 | 0 | 2 | | | | |
| NA17272 | 3646316 | 0 | 2 | | | | |
| NA17210 | 2414444 | 0 | 3 | | | | |
| NA17224 | 3432514 | 0 | 4 | | | | |
| NA17204 | 2435813 | 0 | 5 | | | | |
| NA17203 | 2848738 | 0 | 6 | NA17278 | 6007222 | 0 | 6 |
| NA17205 | 2512358 | 0 | 6 | | | | |
| NA17222 | 1660865 | 1 | 1 | NA17250 | 4988618 | 1 | 1 |
| NA17244 | 2664571 | 1 | 1 | NA17265 | 4252898 | 1 | 1 |
| NA17249 | 3143444 | 1 | 1 | NA17269 | 3631996 | 1 | 1 |
| NA17251 | 2920574 | 1 | 1 | NA17275 | 4430932 | 1 | 1 |
| NA17254 | 3345057 | 1 | 1 | | | | |
| NA17212 | 2546508 | 1 | 2 | NA17235 | 4352286 | 1 | 2 |
| NA17242 | 3801044 | 1 | 2 | NA17273 | 3591137 | 1 | 2 |
| NA17245 | 2704601 | 1 | 2 | NA17288 | 4805342 | 1 | 2 |
| NA17250 | 1842036 | 1 | 2 | NA17290 | 6112983 | 1 | 2 |
| NA17270 | 2960905 | 1 | 2 | | | | |
| NA17271 | 2261114 | 1 | 2 | | | | |
| NA17235 | 3051958 | 1 | 3 | NA17231 | 4222883 | 1 | 3 |
| NA17240 | 1774072 | 1 | 3 | NA17260 | 4248234 | 1 | 3 |
| NA17269 | 2483344 | 1 | 3 | NA17266 | 3675221 | 1 | 3 |
| NA17294 | 2671742 | 1 | 3 | | | | |
| NA17228 | 2683022 | 1 | 4 | NA17201 | 2888481 | 1 | 4 |
| NA17246 | 2294355 | 1 | 4 | NA17294 | 3095560 | 1 | 4 |
| NA17295 | 2005037 | 1 | 4 | | | | |
| NA17215 | 1844206 | 1 | 5 | NA17238 | 4709225 | 1 | 5 |
| NA17216 | 2169022 | 1 | 5 | | | | |
| NA17217 | 1312082 | 1 | 5 | | | | |
| NA17221 | 1345565 | 1 | 5 | | | | |
| NA17232 | 3641553 | 1 | 5 | | | | |
| NA17258 | 2925046 | 1 | 5 | | | | |
| NA17296 | 2616702 | 1 | 5 | | | | |
| NA17202 | 2402608 | 1 | 6 | NA17285 | 3389663 | 1 | 6 |
| NA17218 | 1270213 | 1 | 6 | | | | |
| NA17264 | 3205569 | 1 | 6 | | | | |
| NA17268 | 2579445 | 1 | 6 | | | | |
| NA17213 | 1831700 | 1 | 7 | NA17211 | 3549285 | 1 | 7 |
| NA17214 | 1526750 | 1 | 7 | NA17272 | 3567834 | 1 | 7 |
| NA17223 | 1604155 | 1 | 7 | | | | |
| NA17229 | 1758114 | 1 | 7 | | | | |
| NA17256 | 2906946 | 1 | 7 | | | | |
| NA17201 | 3056232 | 1 | 7 | | | | |
| NA17231 | 1759884 | 1 | 8 | NA17267 | 2058465 | 1 | 8 |
| | | | | NA17234 | 3197338 | 1 | 10 |
| | | | | NA17213 | 2492532 | 1 | 11 |
| | | | | NA17271 | 1927448 | 1 | 11 |
| | | | | NA17228 | 1362584 | 1 | 13 |
| | | | | NA17270 | 2051817 | 1 | 13 |
| | | | | NA17251 | 1208797 | 1 | 14 |
| | | | | NA17204 | 1625101 | 1 | 15 |
| | | | | NA17258 | 2481156 | 1 | 15 |
| NA17239 | 3769321 | 2 | 1 | NA17284 | 3288848 | 2 | 1 |
| NA17243 | 1732152 | 2 | 1 | | | | |
| NA17238 | 2767286 | 2 | 2 | NA17210 | 3215494 | 2 | 2 |
| NA17247 | 1980100 | 2 | 2 | | | | |
| NA17252 | 3795483 | 2 | 2 | | | | |
| NA17255 | 1856338 | 2 | 2 | | | | |
| NA17220 | 1561903 | 2 | 3 | NA17206 | 3017735 | 2 | 3 |
| NA17226 | 1889344 | 2 | 3 | NA17212 | 2300666 | 2 | 3 |
| NA17230 | 2720437 | 2 | 3 | NA17264 | 5766886 | 2 | 3 |
| NA17234 | 2879540 | 2 | 3 | | | | |
| NA17237 | 2292357 | 2 | 3 | | | | |
| NA17241 | 2857093 | 2 | 3 | | | | |
| NA17267 | 2529398 | 2 | 3 | | | | |
| NA17274 | 3310194 | 2 | 3 | | | | |
| NA17280 | 1699130 | 2 | 3 | | | | |
| NA17284 | 1932408 | 2 | 3 | | | | |
| NA17286 | 1745163 | 2 | 3 | | | | |
| | | | | NA17203 | 2771313 | 2 | 4 |
| | | | | NA17214 | 2006684 | 2 | 4 |
| | | | | NA17230 | 3683767 | 2 | 4 |
| NA17227 | 1715017 | 2 | 5 | NA17208 | 2257041 | 2 | 5 |
| NA17253 | 2915644 | 2 | 5 | NA17227 | 2205498 | 2 | 5 |
| NA17257 | 2303266 | 2 | 5 | NA17255 | 1377856 | 2 | 5 |
| NA17273 | 2352793 | 2 | 5 | NA17293 | 1976779 | 2 | 5 |
| NA17260 | 2205985 | 2 | 6 | NA17205 | 1888166 | 2 | 6 |
| NA17262 | 1750086 | 2 | 6 | NA17216 | 1479632 | 2 | 6 |
| NA17276 | 2121080 | 2 | 6 | NA17221 | 2050261 | 2 | 6 |
| NA17282 | 1745066 | 2 | 6 | | | | |
| NA17288 | 1529725 | 2 | 6 | | | | |
| NA17285 | 1682946 | 2 | 7 | NA17202 | 1641679 | 2 | 7 |
| | | | | NA17268 | 1644306 | 2 | 7 |
| | | | | NA17219 | 2528047 | 2 | 8 |
| NA17265 | 2004462 | 2 | 9 | NA17217 | 3025276 | 2 | 9 |
| | | | | NA17233 | 2035392 | 2 | 9 |
| | | | | NA17243 | 4940728 | 2 | 9 |
| | | | | NA17242 | 5307433 | 2 | 11 |
| | | | | NA17225 | 2239069 | 2 | 12 |
| | | | | NA17262 | 1743406 | 2 | 13 |
| | | | | NA17281 | 1348469 | 2 | 13 |
| | | | | NA17222 | 1175060 | 2 | 14 |
| | | | | NA17277 | 1057677 | 2 | 16 |
| | | | | NA17226 | 1927075 | 2 | 17 |
| | | | | NA17287 | 1963365 | 2 | 18 |
| | | | | NA17261 | 1354304 | 2 | 20 |
| | | | | NA17237 | 4085832 | 2 | 22 |
| | | | | NA17253 | 1300607 | 2 | 22 |
| | | | | NA17263 | 4652783 | 2 | 24 |
| | | | | NA17207 | 2056849 | 2 | 25 |
| | | | | NA17248 | 1404564 | 2 | 44 |
| NA17266 | 3606508 | 3 | 1 | NA17236 | 4613125 | 3 | 1 |
| NA17275 | 2724258 | 3 | 1 | | | | |
| NA17261 | 2670764 | 3 | 2 | NA17249 | 4996889 | 3 | 2 |
| NA17277 | 2942202 | 3 | 2 | NA17259 | 5376974 | 3 | 2 |
| | | | | NA17283 | 3359184 | 3 | 2 |
| NA17248 | 2821746 | 3 | 3 | NA17241 | 4802423 | 3 | 3 |
| | | | | NA17279 | 2607988 | 3 | 3 |
| | | | | NA17286 | 4188042 | 3 | 3 |
| NA17225 | 2642068 | 3 | 4 | NA17223 | 3578375 | 3 | 4 |
| | | | | NA17240 | 3672691 | 3 | 4 |
| | | | | NA17274 | 3983758 | 3 | 4 |
| | | | | NA17282 | 2824111 | 3 | 4 |
| NA17233 | 2970385 | 3 | 5 | NA17252 | 3604411 | 3 | 5 |
| NA17283 | 1990999 | 3 | 5 | | | | |
| | | | | NA17245 | 2084335 | 3 | 7 |
| | | | | NA17220 | 2583122 | 3 | 8 |
| | | | | NA17244 | 3213918 | 3 | 13 |
| | | | | NA17246 | 1617999 | 3 | 15 |
| | | | | NA17215 | 2990698 | 3 | 16 |
| NA17289 | 2397170 | 3 | 21 | | | | |
| | | | | NA17232 | 3978745 | 3 | 31 |
| | | | | NA17296 | 3136733 | 3 | 33 |
| | | | | NA17224 | 1731726 | 3 | 34 |
| | | | | NA17239 | 4588309 | 4 | 3 |
| NA17236 | 2294722 | 4 | 8 | | | | |
| NA17287 | 1602470 | 4 | 11 | | | | |
| NA17291 | 2818237 | 4 | 14 | | | | |
| | | | | NA17291 | 1458890 | 4 | 51 |
| | | | | NA17276 | 4171252 | 5 | 6 |
| | | | | NA17254 | 1349225 | 5 | 35 |
| NA17278 | 2006276 | 6 | 1 | | | | |
| NA17209 | 4107302 | 6 | 8 | | | | |
| | | | | NA17218 | 2361366 | 6 | 32 |
| NA17292 | 2255637 | 6 | 38 | | | | |
| NA17263 | 3368663 | 7 | 7 | | | | |
| | | | | NA17280 | 2204599 | 7 | 16 |
| | | | | NA17257 | 1610358 | 7 | 45 |
| NA17279 | 1646510 | 8 | 30 | | | | |
| | | | | NA17247 | 1045394 | 8 | 44 |
| NA17293 | 2491615 | 9 | 14 | | | | |
| | | | | NA17295 | 4975642 | 9 | 61 |
| NA17290 | 3075694 | 10 | 62 | | | | |
| | | | | NA17209 | 2910987 | 11 | 102 |
| NA17281 | 2089656 | 13 | 28 | | | | |
| | | | | NA17289 | 1210842 | 13 | 50 |
| | | | | NA17256 | 1755256 | 15 | 61 |
| NA17259 | 2017521 | 16 | 20 | | | | |
| | | | | NA17292 | 1378100 | 21 | 120 |

From the first and last parts of the gene amplified, the gaps greater than or equal to 100 bp were designated “major,” and any gaps less than 100 bp were designated “minor.” Major or minor values were assigned to each of the 96 Caucasians. For instance, NA17259 had values of 16/20-3/2, showing that this person, in experiment five, had 16 coverage gaps of size greater than or equal to 100 bp and 20 smaller gaps less than 100 bp for the first part of the gene. This same person had three major and two minor gaps for the last part of the gene. These values are just indicators of possible trouble and do not represent precise locations.

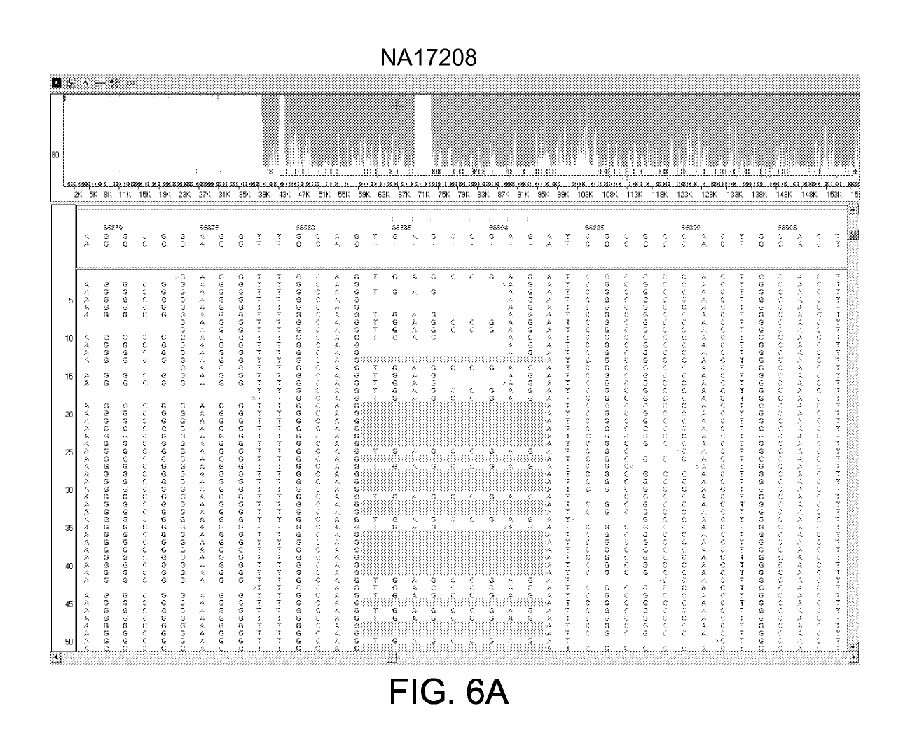

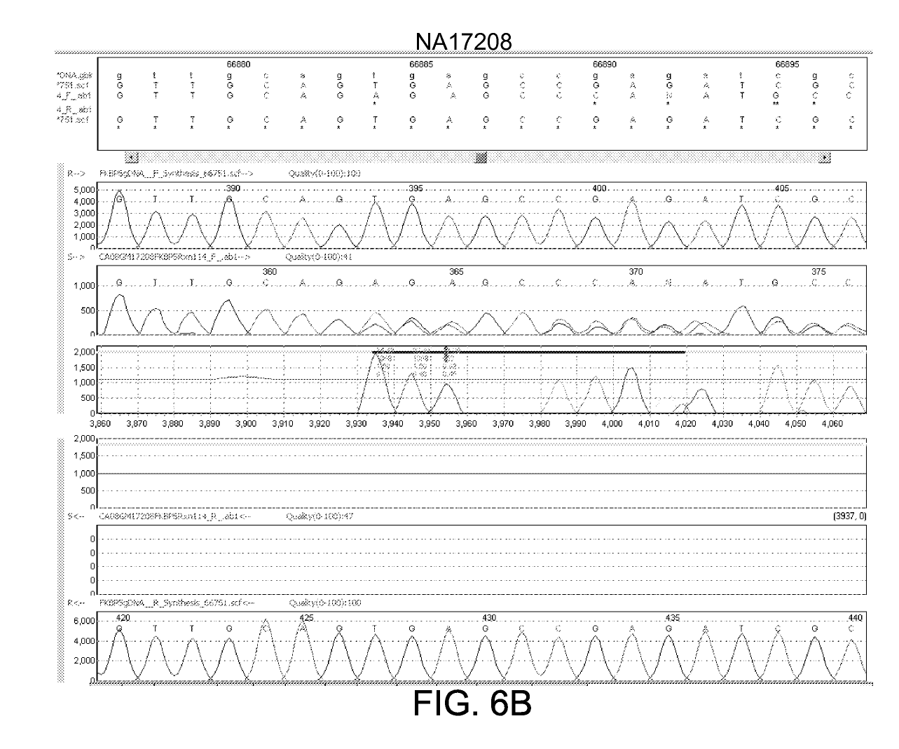

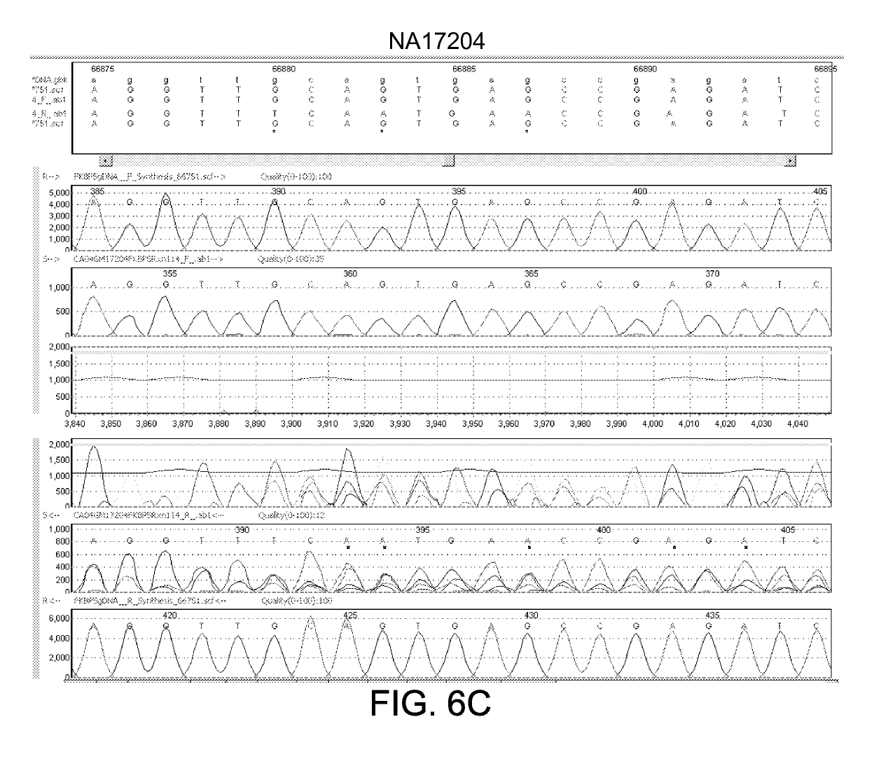

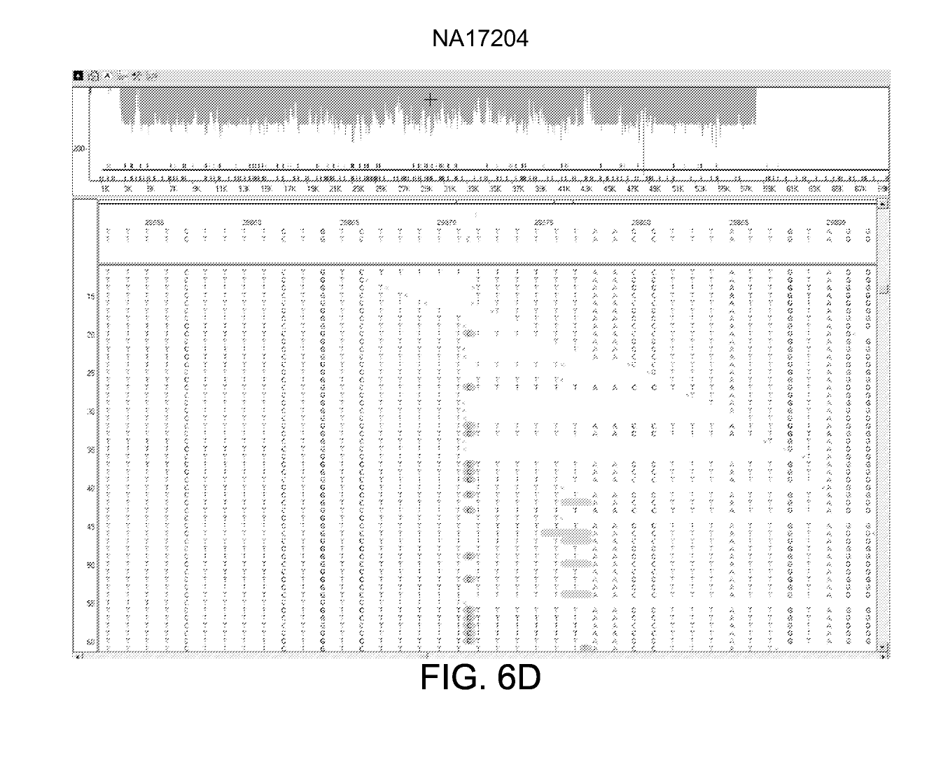

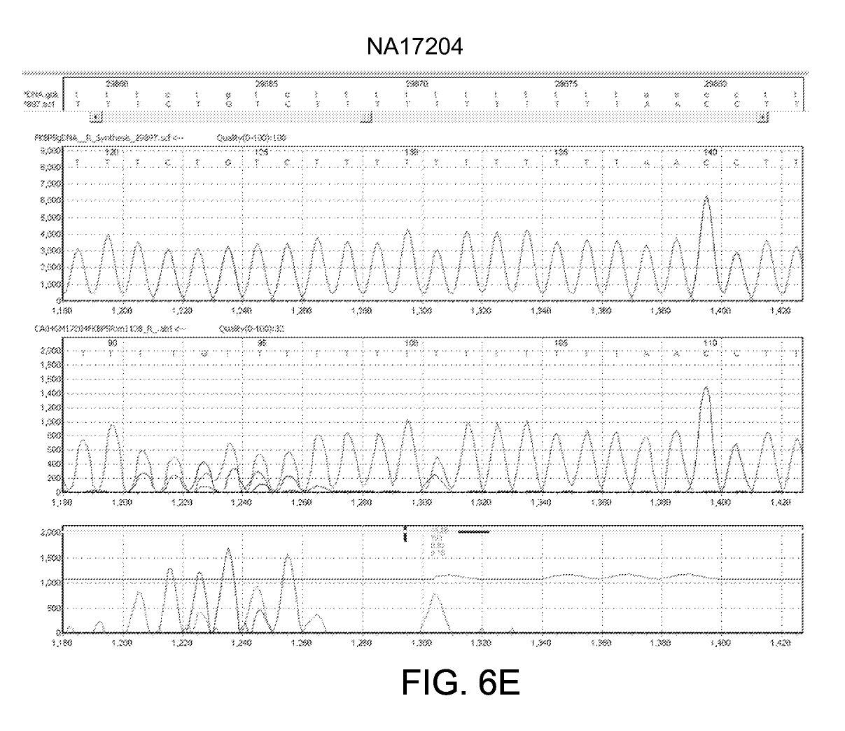

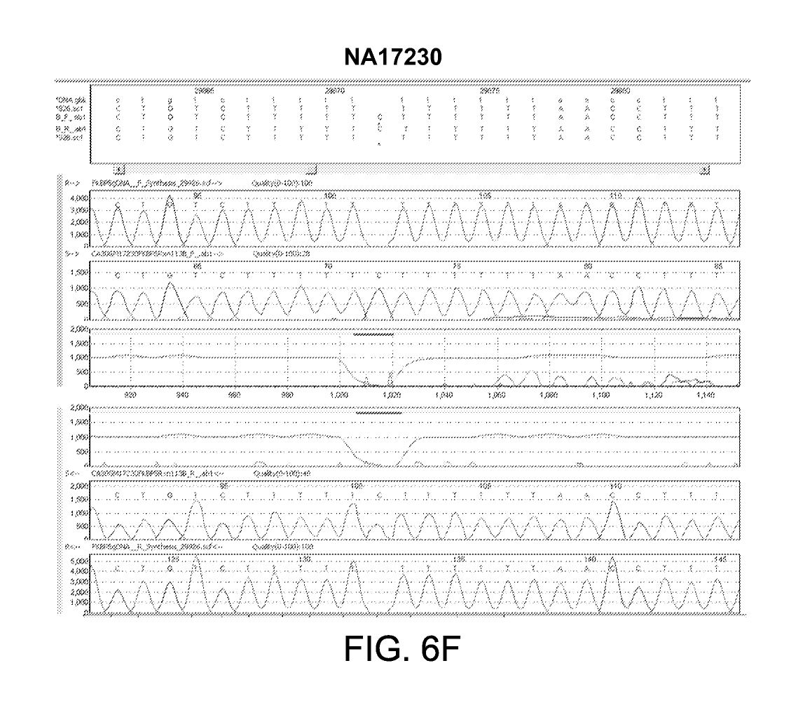

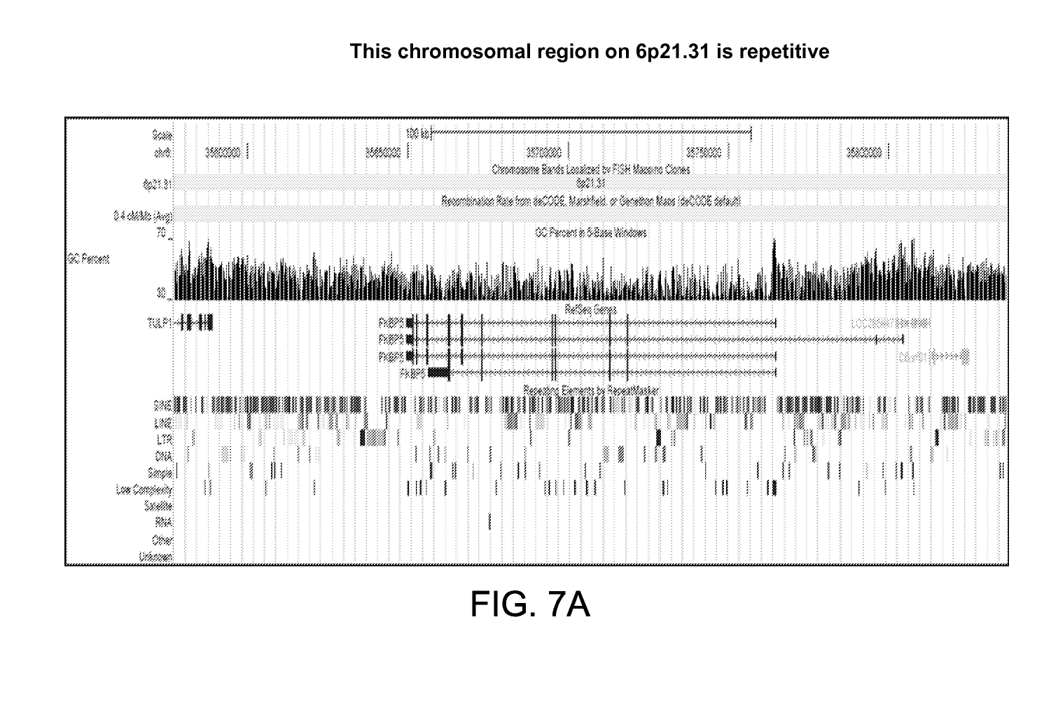

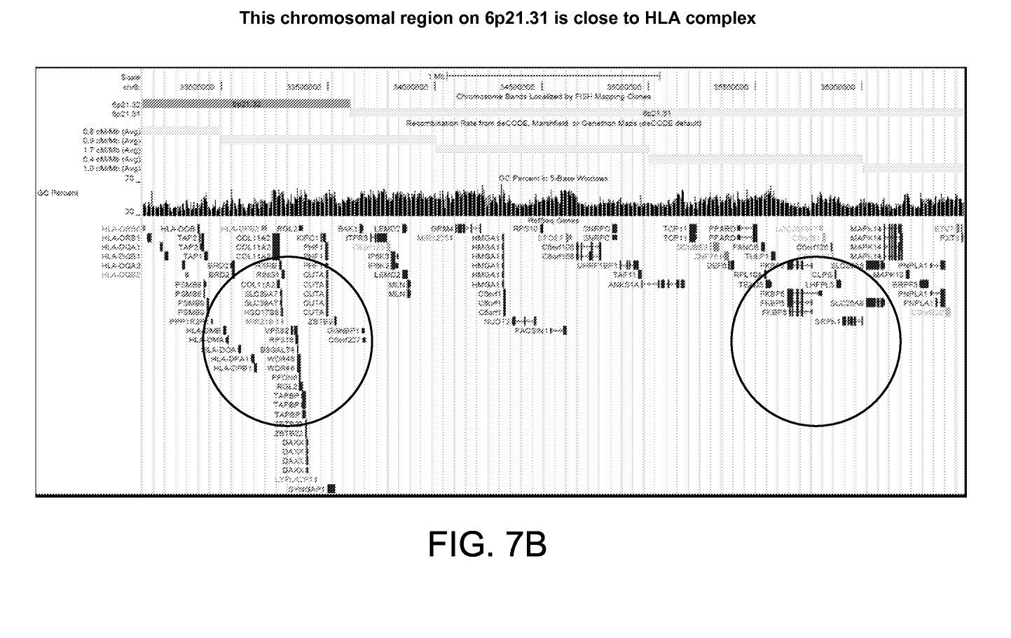

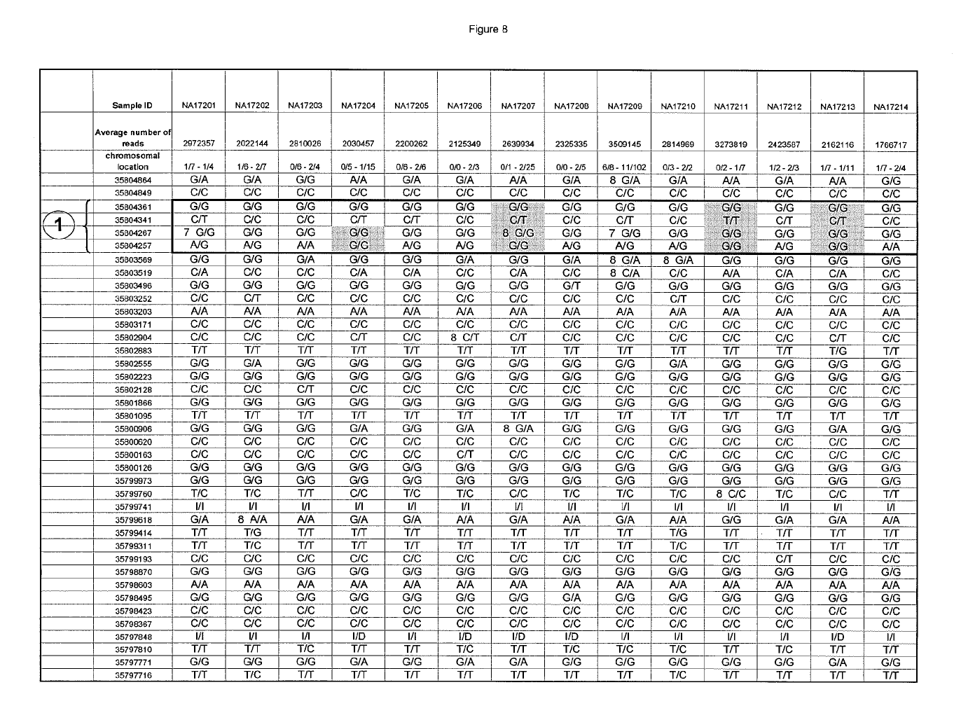

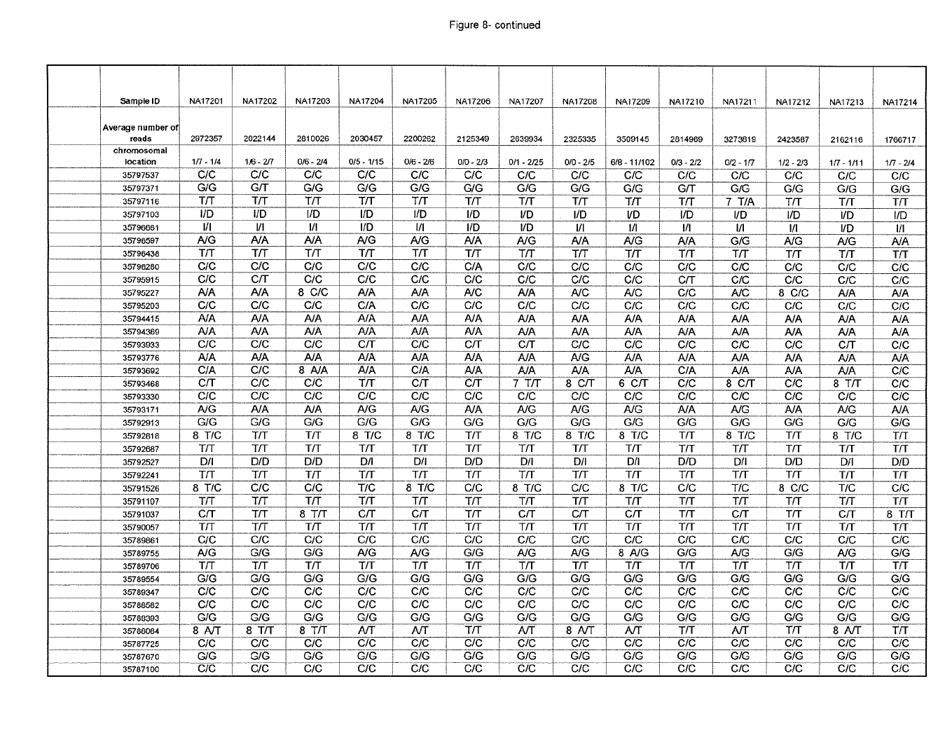

As a fourth form of validation, dbSNP130 was examined. Two hundred fifty-eight of the SNPs/Indels found were also in dbSNP, although the genotypes across all 96 individuals, utilizing this database, were not available to compare. In several cases, the dbSNP variant, although at the same chromosomal location, did not agree. For instance, at rs35311317 dbSNP has a C/T SNP while NGS found a C insertion. This was validated and the Sanger results agreed with NGS (FIGS. 6A-F).

The fifth means of validation was assessing whether these genotypes conformed to Hardy-Weinberg equilibrium (HWE) expectations. Deviations from HWE can be due to inbreeding or population stratification, but also can be due to problems with genotyping (Weinberg and Morris, American Journal of Epidemiology, 158(5):401-3 (2003)). Using P>0.001 (Wigginton et al., A Note on Exact Tests of Hardy-Weinberg Equilibrium, Center for Statistical Genetics, Department of Biostatistics, University of Michigan, Ann Arbor Mich.; and Institute of Genetic Medicine, Johns Hopkins University School of Medicine, Baltimore Md.), 25 loci were found to be out of HWE, and none of them were in linkage disequilibrium with each other, indicating the reason they deviated from HWE was most likely due to genotyping errors among one or more samples. Of the loci, 13 were discovered to be within areas of poor coverage and adjacent to large gaps in sequencing. The remaining 12 loci were indels, indicating the zygosity threshold determinations for indels may not be optimal.

The sixth form of validation was testing the method on two additional sample sets. The first set consisted of ten anonymized tumor samples over the same 160 kb region on chromosome 6. One hundred ninety-two kb were verified with Sanger sequencing. All polymorphic sites were detected except where there was no coverage in one of the CpG islands. All genotypes were concordant with Sanger sequencing with the exception of two where the Sanger results failed and therefore a comparison could not be made. The second set consisted of four anonymized and pooled DNA samples over a 5.5 kb region on chromosome 4. All variant sites were detected with no missed sites.

The seventh and final means of validation was the production of a so-called population reliability index based on experiment five (Table 9). The reliability index was to ascertain the number of gaps and therefore explain the remaining discordant calls. Experiment five, unlike the other experiments maintained the original read counts and therefore assured the gaps were not caused by lower coverage because of consolidation of the reads. From the first and last parts of the gene amplified, the gaps greater than or equal to 100 bp were designated “major,” and any gaps less than 100 bp were designated “minor.” Major or minor values were assigned to each of the 96 Caucasians. For instance, NA17259 had values of 16/20-3/2, showing that this subject, in experiment five, had 16 coverage gaps of size greater than or equal to 100 bp and 20 smaller gaps less than 100 bp for the first part of the gene. This same sample had three major or two minor gaps for the last part of the gene. Since these values are just indicators of possible trouble and do not represent precise chromosomal locations, a visual representation was made of the reliability index (FIG. 8). When viewing the population gap map, it is easy to see where there are consistent coverage problems that most likely are due to PCR, library preparation, sequencing, or could be biological, such as structural variation. Eight of these areas are bracketed on Table 10, and when looked at more carefully, contain repetitive elements. The chromosomal region also revealed possible structural variation, and two areas particularly stood out as being consistent across the samples: regions four and five. At first it was thought these gaps were true deletions, but region four had already been successfully sequenced using Sanger technology on all of the samples, and no sample revealed a deletion. Region five was the largest gap and was also perceived to possibly be a deleted area. Therefore, the area on some of the samples was sequenced through using Sanger technology, and the results showed a 3.3 kb deletion.

TABLE 10
Repetitive Elements on the Gap Map.
Repetitive Elements on the Gap Map

| Adjacent | | | | | | |
|---|---|---|---|---|---|---|
| to gap | Chromosomal | | | GC- | | Structural |
| areas | locations | SINE | LINE | rich | Other | variation |
| 1 | chr6: | ✓ | ✓ | ✓ | ✓ | ✓ |
| | 35804361-35804257 | | | | | |
| 2 | chr6: | | ✓ | | | ✓ |
| | 35786749-35786597 | | | | | |
| 3 | chr6: | ✓ | ✓ | | ✓ | ✓ |
| | 35781310-35780890 | | | | | |
| 4 | chr6: | | | ✓ | | ✓ |
| | 35764541-35763223 | | | | | |
| 5 | chr6: | ✓ | ✓ | | | ✓ |
| | 35737387-35734478 | | | | | |
| 6 | chr6: | ✓ | ✓ | | ✓ | ✓ |
| | 35682393-35681050 | | | | | |
| 7 | chr6: | ✓ | | | | ✓ |
| | 35674338-35673400 | | | | | |
| 8 | chr6: | ✓ | | | ✓ | ✓ |
| | 35656386-35656214 | | | | | |

The gap map of FIG. 8 was a visual representation of the Population Reliability Index. For each subject, variants detected within 200 bp surrounding a gap are shaded gray. With NGS, read coverage was gradual across areas and so genotypes adjacent to gaps were interpreted with caution. Gray shaded with bold text cells are discordant genotypes for that individual between NGS and Illumina and/or Affymetrix. The reliability index number for each individual was given in the first row. The corresponding raw read number for that sample was immediately below, in the second row.

The eight gaps and their genomic contents; short interspersed elements (SINEs), long interspersed elements (LINEs), GC-rich areas, and simple tandem repeats (STRs) are shown in Table 10 below. These repetitive elements were previously reported as causing difficulty with this sequencing technology. Region four has a 77 percent GC content, and region five showed SNPs that were out of HWE.

This accounted for many of the discordant results. However, some results appeared as outliers, not close to any of these areas. Three results, rs6926133, rs9348979 and rs4713904 gave consistent genotype results in all five experiments for three individuals. To verify further, these three individuals were sequenced using Sanger. For two of them, the Sanger results agreed with NGS, but for rs4713904, the Sanger results did not agree. This particular sample had a reliability index of 11/102, thus explaining the discordant genotype for that individual.

In summary, three reasons for discordant genotypes were found: low coverage unique to an individual or common to all samples across a genomic region, other platforms were in error, and preferential amplification.

### Subtle Changes in Parameter Settings Produce Different Results

For the first four in silico experiments, the initial read length of 49 bp increased on average to 66 bp after consolidation, and the percent of alignable reads decreased from 94% to 84%. The correlation between read count and percent of alignable reads were not as expected. For example, NA17222 with a lower read count had 95% alignable reads before consolidation and 91% after. NA17290, with a higher read count had 95% alignable reads before consolidation and 74% after, thus intimating that although original read count is important and a certain minimum threshold is necessary, the quality of those reads, as well as the insert size (Harismendy and Frazer, Biotechniques, 46:229-231 (2009)), is of equivalent importance. The percent alignable reads diminished on average from 68% to 44% after elongation for experiment 5. When comparing the five in silico experiments for numbers of called variants, parameter 4 produced the largest number (1113 calls), and parameter 3 produced the lowest (97 calls). The sensitivity and specificity of individual parameters was also assessed before application of the pattern recognition methodology. While parameter 1 displayed the highest sensitivity (90%)—meaning 90% of the called variants were correctly classified as true, it also showed 65% specificity—an indicator of too many FP. Parameter 3 displayed the highest specificity (86%). Parameter 5 introduced reads with sequencing errors into the alignment, resulting in numerous tri-allelic calls and consequent FP. After application of the pattern recognition methodology, a significant improvement was observed with both specificity and sensitivity increased to 98%.

### Methodology Outperforms Existing Software

MAQ (http://maq.sourceforge.net/) is an open source and easy-to-use software that has been used extensively for variation discovery (Clement et al., Bioinformatics, 26:38-45 (2010); Bansal et al., Genome Res., 20:537-545 (2010); Ahn et al., Genome Res., 19:1622-1629 (2009); and The 1000 Genomes Project Consortium, Nature, 467:1061-1073 (2010)). It maps short reads and calls genotypes. MAQ, version 0.7.1 was used to assess 20 of the 96 samples over the 120 kb region on chr6: 35,768,636-35,648,407. Using the default parameters, the SNP filter and loading both paired ends, the SNP and indel calls from MAQ were compared to the results obtained using the pattern recognition methodology. Overall MAQ detected a total of 435 SNPs and 13953 indels in the 20 samples. The pattern recognition methods provided herein identified a total of 292 SNPs and 24 indels. A variant was considered validated if it was seen in Sanger traces, Illumina/Affymetrix data, or dbSNP. From a set of 887 validated sites, the numbers of FP and FN between the two methods were compared. The methods provided herein exhibited 0% FP for both SNPs and indels. MAQ showed 9% FP for SNPs, with only 1.1% of the indels verified as true. As for false negatives, the methods provided herein showed 0.75% and 0.13% for SNPs and indels, respectively. MAQ showed 11% FN for SNPs and 0.26% for indels. To further evaluate the methods provided herein, the SNP and indel calls made using the methods provided herein were compared to those made on the same 20 samples over the same 120 kb region using the SAMtools, version 0.1.16 (Li et al., Bioinformatics, 25:2078-2079 (2009)) and GATK, version 1.1-10 (McKenna et al., Genome Res., 20:1297-1303 (2010)). Using BWA, version 0.5.9 as the aligner and the “mpileup”, “varfilter” and “Unified Genotyper” tools, FP and FN were obtained. The results, using SAMtools, showed 7% FP and 55% FN for SNPs. GATK showed 18% FP and 7% FN for indels. The high FN rate was likely due to this software's very stringent default parameters for calling a SNP or indel.

SNP In Hormone Response Element in LD with Silent (Synonymous) SNP

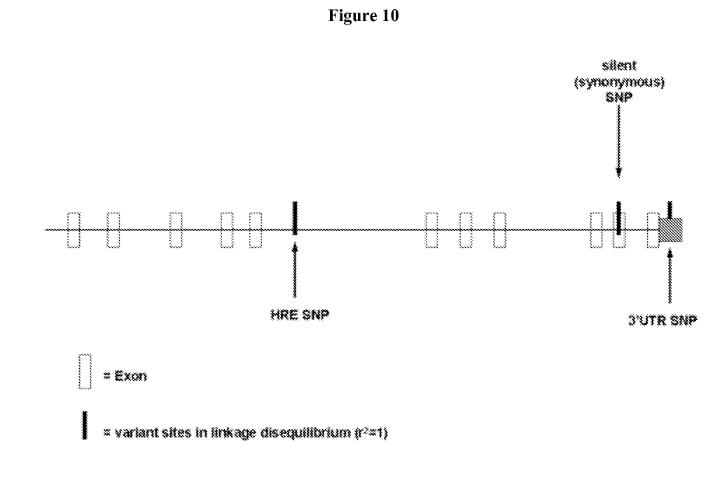

The method identified a SNP (rs73746499:T>C) at a critical position within a HRE (Hubler et al., Cell Stress Chaperones, 9:243-252 (2004) and Paakinaho et al., Mol. Endocrinol., 24:511-525 (2010)). rs73746499 was found to be at relatively high frequency in the study, with 3.1% of the 96 Caucasian subjects carrying the variant. Further inspection showed 22 additional SNPs and one 5 bp deletion in LD (r²=1) with rs73746499 (FIG. 10 and Table 10). 22 of the variants were in introns, one was a synonymous SNP in Exon 10 (rs34866878:C>T), and one was in the 3′UTR (rs41270080:G>T). Eleven of these variants discovered by using the methods provided herein, including the deletion, appeared novel and did not appear to have been reported elsewhere. The LD between them had also not been discovered or examined.

TABLE 10
Chromosome locations, location in gene, nucleotide
change, and accession numbers for the 24
variants in linkage disequilibrium (r² = 1).

| Chromosomal | Location | | |
|---|---|---|---|
| location | in | Nucleotide | RefSNP ID |
| NCBI36/hg18 | gene | change | dbSNP build 130 |
| 35721176 | Intron 1 | C > T | rs9767565 |
| 35718318 | Intron 2 | G > A | rs12110366 |
| 35709507 | Intron 3 | C > T | rs28675670 |
| 35698253 | Intron 3 | C > T | |
| 35693257 | Intron 5 | T > G | |
| 35669864 | Intron 5 | C > A | |
| 35689604 | Intron 5 | G > T | rs73748203 |
| 35688514 | Intron 5 | G > C | |
| 35688829 | Intron 5 | T > C | rs73748499 |
| 35686162 | Intron 5 | T > G | |
| 35681868 | Intron 5 | G > A | |
| 35679450 | Intron 5 | G > T | |
| 35678460 | Intron 5 | C > T | rs73746498 |
| 35677097 | Intron 5 | A > G | rs18878808 |
| 35674126 | Intron 5 | A > G | |
| 35674111 | Intron 5 | C > T | |
| 35672403 | Intron 6 | C > A | rs73746495 |
| 35663034 | Intron 7 | A > C | rs73746494 |
| 35660167 | Intron 8 | A > G | rs73746491 |
| 35658181 | Intron 8 | A > G | rs73746490 |
| 35657920 | Intron 8 | deletion | |
| | | of CTCCT | |
| 35656388 | Intron 8 | G > A | |
| 35652920 | Exon 10 | C > T | rs34866878 |
| 35650023 | 3′UTR | G > T | rs41270080 |

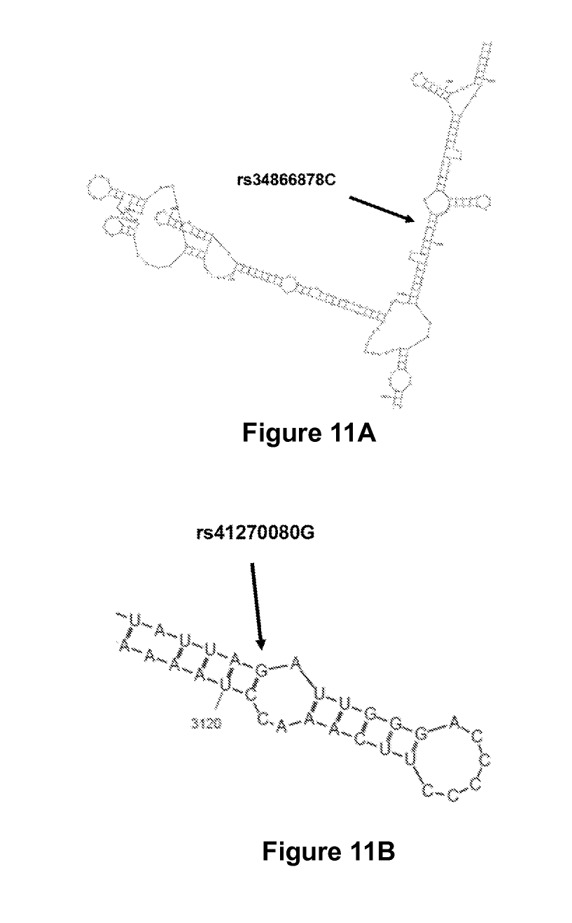

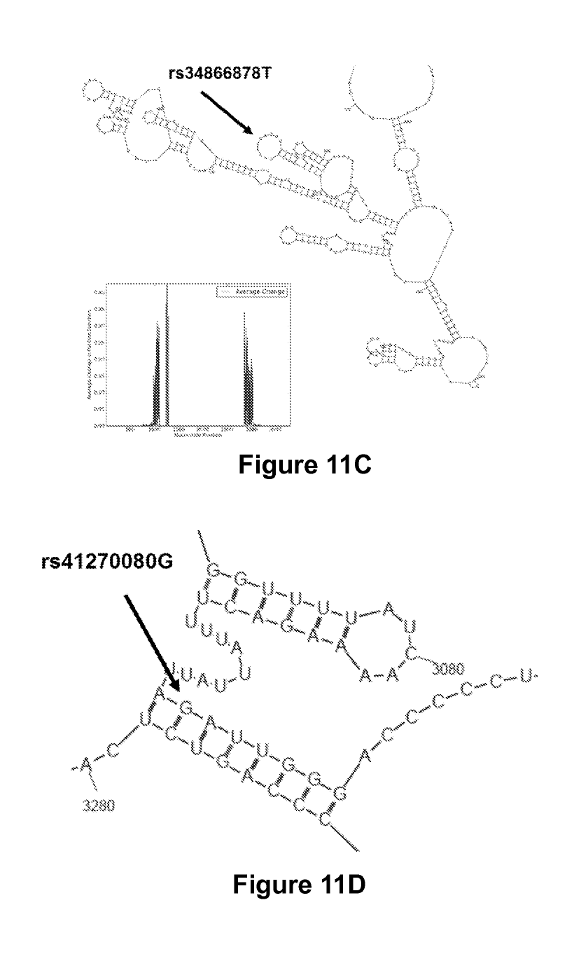

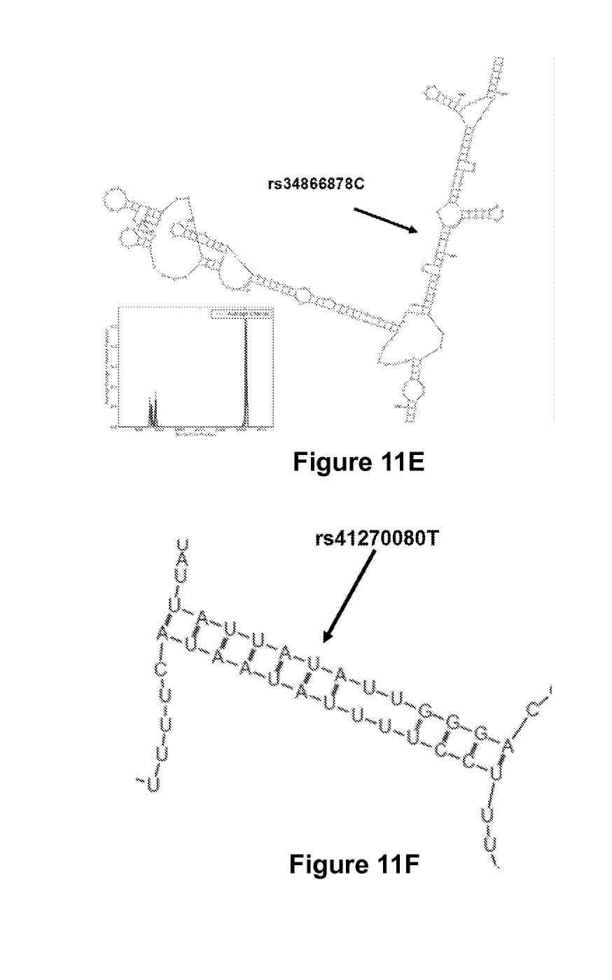

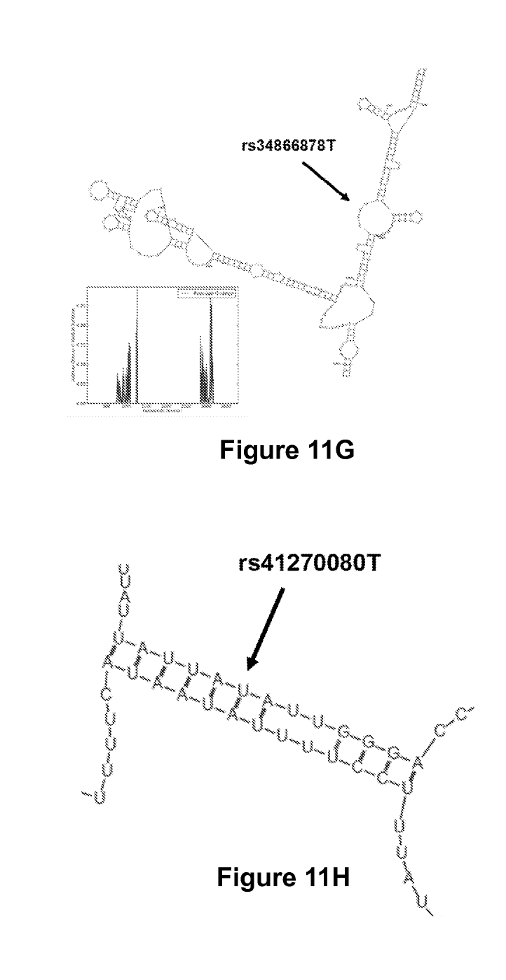

Since the Exon10 and 3′UTR variants were part of the mRNA and both synonymous SNPs and 3′UTR variants have been shown to have functional consequences such as inducing structural changes which could affect protein binding (Nackley et al., Science, 314:1930-1933 (2006); Duan et al., Hum. Mol. Genet., 12:205-216 (2003); Hunt et al., Methods Mol. Biol., 578:23-39 (2009); and Sauna et al., Cancer Res., 67:9609-9612 (2007)), drug interactions or alter mRNA stability, Mfold 3.1 (Zuker, Nucleic Acids Research, 31:3406-3415 (2003)) was used to predict the secondary structures for the full-length wild-type, Exon 10, 3′UTR, and (Exon 10⁻³′UTR) haplotype mRNA transcripts. The Exon 10 synonymous SNP showed a change in calculated free energy and secondary structure, whereas the wild-type, 3′UTR and (Exon 10⁻³′UTR) haplotype SNPs showed no changes (FIG. 11).

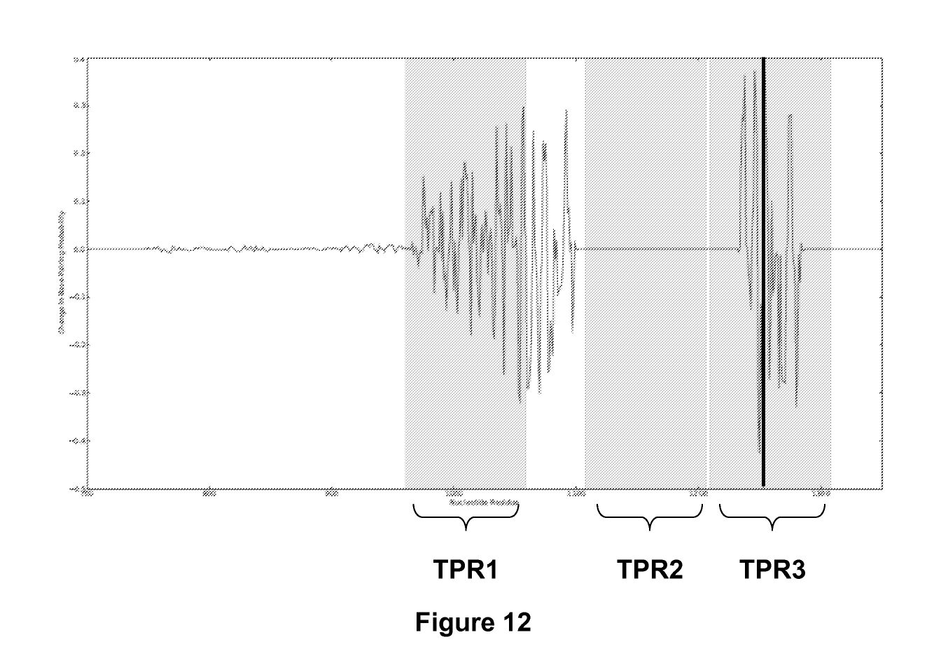

Since RNAs generally adopt multiple conformations, SNPfold (Halvorsen et al., PLoS Genet., 6:e1001074 (2010)) was used to determine whether the SNPs had a large effect on the RNAs structural ensemble. SNPfold computes all the possible suboptimal conformations of the RNA strand and determines the probability of base-pairing for each nucleotide. By evaluating all possible mRNA structures, it was predicted if the SNPs had an affect on the probability of base-pairing (accessibility) of critical interaction sites on the mRNA when compared to the wild-type. According to SNPfold, the Exon 10, 3′UTR, and haplotype (Exon 10⁻³′UTR) variants significantly disrupted the RNA structural ensemble in specific regions of the mRNA (FIGS. 11 and 12). Notably, the Exon 10 variant, which is part of TPR3, also disturbed an adjacent region corresponding to TPR1; an effect not observed with the 3′UTR variant alone. The interaction of immunophilins like FKBP5 with hsp90 occurs through the TPR domain and is conserved in plants as well as the animal kingdom (Owens-Grillo et al., Biochemistry, 35:15249-15255 (1996)). This area was found to be conserved, and not polymorphic, with the exception of the single synonymous SNP in Exon 10.

### Variants in RBP and RNP Binding Sites May Affect Posttranscriptional Gene Regulation

Because RNA-binding proteins (RBPs) and ribonucleoprotein complexes (RNPs) partly control gene expression by regulating RNA transcript translation and stability, data obtained by the PAR-CLIP (Photoactivable-Ribonucleoside-Enhanced Crosslinking and Immunoprecipitation; Hafner et al., Cell, 141:129-141 (2010)) method were used to explore whether the FKBP5 mRNA was bound by RBPs and RNPs. Data showed Argonaute (AGO) and trinucleotide repeat-containing (TNRC6) proteins, both part of the miRNA induced silencing complexes (Chen et al., Nat. Struct. Mol. Biol., 16:1160-1166 (2009)), binding to segments of RNA within the 3′UTR of FKBP5. AGO and miR-124, one of the most conserved and abundantly expressed miRNAs in the adult brain (Lagos-Quintana et al., Curr. Biol., 12:735-739 (2002)), were bound to the same site in Exon 9. Insulin-like growth factor 2 mRNA-binding proteins (IGF2BFs) was the most abundant RBP, binding to sites predominantly in the 3′UTR. The methodology provided herein uncovered genetic variants within seven of these binding sites; 5 of which appear to be novel (Tables 11 and 12).

TABLE 11
List of coordinates for RNA binding protein (RBP) binding sites from
PAR-CLIP data.

| | RefSeq Accession | | coordinate | coordinate |
|---|---|---|---|---|
| RBP name | Number | chromosome | start | end |
| IGF2BP1 | NM_004117 | 6 | 35649428 | 35649491 |
| IGF2BP3 | NM_004117 | 6 | 35649452 | 35649567 |
| IGF2BP2 | NM_004117 | 6 | 35649453 | 35649484 |
| IGF2BP2 | NM_004117 | 6 | 35649485 | 35649528 |
| IGF2BP3 | NM_004117 | 6 | 35649568 | 35649619 |
| IGF2BP2 | NM_004117 | 6 | 35650087 | 35650174 |
| IGF2BP3 | NM_004117 | 6 | 35650087 | 35650174 |
| IGF2BP1 | NM_004117 | 6 | 35650089 | 35650120 |
| IGF2BP3 | NM_004117 | 6 | 35650175 | 35650243 |
| IGF2BP3 | NM_004117 | 6 | 35650284 | 35650350 |
| IGF2BP1 | NM_004117 | 6 | 35650286 | 35650329 |
| IGF2BP3 | NM_004117 | 6 | 35650423 | 35650497 |
| IGF2BP3 | NM_004117 | 6 | 35650500 | 35650666 |
| IGF2BP2 | NM_004117 | 6 | 35650505 | 35650565 |
| IGF2BP1 | NM_004117 | 6 | 35650511 | 35650573 |
| IGF2BP2 | NM_004117 | 6 | 35650605 | 35650651 |
| IGF2BP1 | NM_004117 | 6 | 35650667 | 35650714 |
| IGF2BP3 | NM_004117 | 6 | 35650667 | 35650714 |
| AGO | NM_004117 | 6 | 35650669 | 35650698 |
| IGF2BP2 | NM_004117 | 6 | 35650669 | 35650727 |
| IGF2BP3 | NM_004117 | 6 | 35650715 | 35650777 |
| IGF2BP2 | NM_004117 | 6 | 35650732 | 35650777 |
| TNRC6 | NM_004117 | 6 | 35650810 | 35650831 |
| IGF2BP1 | NM_004117 | 6 | 35650822 | 35650904 |
| IGF2BP3 | NM_004117 | 6 | 35650828 | 35650904 |
| IGF2BP1 | NM_004117 | 6 | 35650906 | 35650942 |
| IGF2BP3 | NM_004117 | 6 | 35651065 | 35651103 |
| IGF2BP1 | NM_004117 | 6 | 35651243 | 35651342 |
| IGF2BP3 | NM_004117 | 6 | 35651243 | 35651393 |
| IGF2BP2 | NM_004117 | 6 | 35651247 | 35651338 |
| AGO | NM_004117 | 6 | 35655854 | 35655879 |
| miR124 | NM_004117 | 6 | 35655855 | 35655879 |
| IGF2BP3 | NM_004117 | 6 | 35673082 | 35673114 |

TABLE 12
List of seven SNPs within the sites identified to bind RBPs by PAR-CLIP
method.

| | | | | Frequency |
|---|---|---|---|---|
| | | | | in 96 |
| gene | chromosomal | | | caucasian |
| location | location | next-gen SNPs | RefSNP ID | individuals |
| 3′UTR | 35651356 | c.*234G > A | n/a | 0.005 |
| 3′UTR | 35651255 | c.*335G > A | n/a | 0.005 |
| 3′UTR | 35650642 | c.*948T > C | n/a | 0.005 |
| 3′UTR | 35650567 | c.*1023G > A | n/a | 0.005 |
| 3′UTR | 35650504 | c.*1086A > T | rs11545925 | 0.073 |
| 3′UTR | 35650454 | c.*1136G > T | rs3800373 | 0.240 |
| 3′UTR | 35649597 | c.*1993G > A | n/a | 0.005 |

### Discovery of Rare Variants Impacts Evolutionary Conclusions

The methods provided herein detected 267 novel rare variants (<1%) within the chromosomal region encompassing FKBP5. The negative Tajima's D value of −1.44 conflicted with previous reports of this region on chromosome 6 as being under balancing selection and upon inspection, the dissimilar reports were based on small datasets which disregarded low frequency variants (Kreitman and Di Rienzo, TRENDS in Genetics, 20:300-304 (2004) and Zan et al., J. Hum. Genet., 51:451-454 (2006)). The complete next generation sequencing data showed a dramatic increase in low frequency polymorphisms, thus changing the landscape of evolutionary conclusions.

Comparison with HapMap and 1000 Genomes Project

Realizing the genetic variation in the CEPH samples may not be identical to that found in these samples, and that the sample sizes are different, it was decided to see if the common polymorphisms detected by this method for this genomic region on chromosome 6 were also present in the HapMap and the 1000 Genomes (1KG) Project data deposited in dbSNP130. All the HapMap CEU common polymorphic sites were in agreement with these findings with the exception of rs3734257, which in the CEU population had a 1.7% frequency in 120 alleles and was monomorphic in our 192 alleles. One hundred sixty-eight common polymorphisms, of which 36% were supported by other platforms such as dbSNP, Sanger, Illumina and Affymetrix, were detected by this method. These polymorphisms were not found in the low or deep coverage 1KG pilots as noted in dbSNP130. Eighty-three of these markers had frequencies greater than 3%. Furthermore, two large gap areas, one of which there was prior Sanger data on, contained high frequency SNPs. These correspond to gaps four and five on the reliability gap map. Gap four is a GC-rich area, and this method was able to detect three out of the three high frequency SNPs within this region: rs9462103, rs13215797 and rs10947564, although because of very low coverage across the entire population and therefore unreliable genotypes, all three were excluded from the final data set. 1KG project detected rs13215797 alone. Gap five contained an Alu, and although a 3.3 kb deletion was detected in some of the samples using Sanger, 1KG also did not detect anything in this area.

These results demonstrate that running more than one experiment reduces the chance of false variant calls in low coverage areas because if one setting does not detect a SNP, another setting may pick it up. This assures that a putative SNP is not disregarded just because it is in a low coverage area, as it would be if only one set of parameters was used.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for assessing nucleic acid sequence information, wherein said method comprises:
(a) obtaining a collection of at least five sequence output data sets, wherein each of said sequence output data sets comprises a determined sequence that is assembled from a collection of sequence reads of a nucleic acid region and that is aligned to a reference sequence to identify a sequence difference between said determined sequence and said reference sequence, wherein at least one assembly or alignment parameter used to assemble or align said determined sequence is different for each of said sequence output data sets, and
(b) determining whether said sequence difference is (i) a processing artifact or (ii) a true sequence difference present in said nucleic acid region as compared to said reference sequence based on a rule set established for said collection of at least five sequence output data sets.

2. The method of claim 1, wherein said nucleic acid region is a region of a human chromosome.

3. The method of claim 1, wherein said collection of sequence reads was obtained using a second generation sequencing technique.

4. The method of claim 1, wherein said collection of sequence reads comprises sequence reads ranging from about 25 to 250 nucleotides in length.

5. The method of claim 1, wherein said determined sequence for each of said sequence output data sets is different.

6. The method of claim 1, wherein said collection of at least five sequence output data sets is a collection of nine or more sequence output data sets.

7. The method of claim 1, wherein said at least one assembly or alignment parameter is selected from the group consisting of a mutation percentage parameter, a coverage parameter, an alignment method parameter, and a matching base parameter.

8. The method of claim 1, wherein the determined sequence of at least one of said sequence output data sets was assembled or aligned using a matching base parameter of between 40 and 60 percent.

9. The method of claim 1, wherein the determined sequence of at least one of said sequence output data sets was assembled or aligned using a matching base parameter of greater than 90 percent.

10. The method of claim 1, wherein the determined sequence of at least one of said sequence output data sets was assembled from a collection of forward paired end sequence reads.

11. The method of claim 1, wherein the determined sequence of at least one of said sequence output data sets was assembled from a collection of forward paired end sequence reads and not reverse paired end sequence reads.

12. The method of claim 1, wherein the determined sequence of at least one of said sequence output data sets was assembled from a collection of forward paired end sequence reads and reverse paired end sequence reads.

13. The method of claim 1, wherein said sequence difference is a single nucleotide difference.

14. The method of claim 1, wherein said sequence difference is a single nucleotide deletion.

15. The method of claim 1, wherein said sequence difference is a multiple nucleotide deletion or insertion.

16. The method of claim 1, wherein said sequence difference is a complex deletion.

17. A method for assessing a mammal for homozygosity or heterozygosity, wherein said method comprises:
(a) obtaining a collection of at least five sequence output data sets, wherein each of said sequence output data sets comprises a determined sequence that is assembled from a collection of sequence reads of a nucleic acid region, wherein at least one assembly parameter used to assemble said determined sequence is different for each of said sequence output data sets, and
(b) determining whether said mammal is homozygous or heterozygous for a sequence within said nucleic acid region based on a rule set established for said collection of at least five sequence output data sets.

18. A method for assessing a mammal for homozygosity or heterozygosity, wherein said method comprises:
(a) obtaining a collection of at least five sequence output data sets, wherein each of said sequence output data sets comprises a determined sequence that is assembled from a collection of sequence reads of a nucleic acid region and that is aligned to a reference sequence of said nucleic acid region, wherein at least one assembly or alignment parameter used to assemble or align said determined sequence is different for each of said sequence output data sets, and
(b) determining whether said mammal is homozygous or heterozygous for a sequence within said nucleic acid region based on a rule set established for said collection of at least five sequence output data sets.
